(19) United States
(12) Patent Application Publication
(10) Pub. No.: US 2018/0157995 A1
(43) Pub. Date: Jun. 7, 2018

(54) SYSTEMS AND METHODS FOR TRACKING, MEASURING, AND IMPROVING APPLICANTS, CANDIDATES, RECRUITS, EXPERTS AND ANY RESOURCES, QUALIFICATIONS, AND FEEDBACK

(71) Applicant: Matthew C. O'Malley, Lake Balboa, CA (US)

(72) Inventor: Matthew C. O'Malley, Lake Balboa, CA (US)

(21) Appl. No.: 15/684,933

(22) Filed: Aug. 23, 2017

Related U.S. Application Data
(63) Continuation of application No. 13/102,051, filed on May 6, 2011, now abandoned.
(60) Provisional application No. 61/331,394, filed on May 5, 2010.

(51) Int. Cl. G06Q 10/00; G06Q 10/10; G06Q 30/00

(52) U.S. Cl. CPC G06Q 10/00; G06Q 30/00; G06Q 10/1053

(57) ABSTRACT

A system and method for locating resources and providing recruitment information. Including a memory device for storing the information regarding a at least one resource, a at least one resource criteria, a at least one resource match, and a at least one processing device for processing information regarding the information, criteria, resource and match. In one aspect, the processing device utilizes information regarding a at least one job opening, an applicant's contract, an interviewer's available date, an interviewer available time, and a interview schedule, stored in the memory device, and further wherein the processing device generates a message containing information regarding at least one of a job opening, an interview schedule, an interviewer, an applicant's contract, a date and a time, wherein the message is responsive to the job interview request, and a transmitter for transmitting the message to a communication device associated with an individual in real-time.

### RELATED APPLICATIONS

This continuation application claims priority to non-provisional application number 13/102,051 filed May 5, 2011; U.S. Provisional Application No. 61/331,394, filed May 5, 2010.

### BACKGROUND

### Field of the Invention

The field of the present inventions relates to electronic commerce and recruitment for a resource, an individual or a business entity and more particularly to a localized, segmented, automated, computerized method and system for the same.

### SUMMARY OF THE INVENTION

Referenced throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in another embodiment,” and similar language throughout this specification may, but do not necessarily, all refer to the same embodiment.

Also referenced throughout this specification are the terms and/or phrases “for example,” “for instance,” “say,” “the like,” “etc.,” or similar language which generally means that the language, description, and explanation utilized is association is merely to demonstrate an element, feature, item, list of items, purpose, way, means, method, and/or the like for what has been described in association, but depending on the usage and situation, it may not be meant to be exhaustive representation or demonstration, or meant to limit the invention to that particular precise formation. Many modifications and variations will be apparent to the practitioner skilled in the art.

Today, finding the right employee, contractor, and/or expert can become a time consuming process of posting, searching, researching, and screening. Furthermore, many steps are efficient and lack the ability to automate, track and collect feedback.

Starting with the job posting which are typically randomly created paragraphs of text that simply describe a job opening. Occasionally the job posting has a list of bullets highlighting the text for specific job requirements, but often there is little more detail. The task of determining whether a particular applicant is qualified or not, is often left to the applicant himself/herself, who then need to stop and read each advertisement to see if he/she is qualified before responding to the job posting.

Depending on the size and resources of the company, that's posting the job opening, the process of posting the job opening and finding a list of qualified applicants (“candidates”) can be left to one person, or a number of people, such as a department head, a member of the human resources department, an executive or partner in the company, an executive's assistant, and/or an office manager. These people may designate someone to post the job opening, a “Job Poster”. Unfortunately, it is unrealistic for this Job Poster who may lack the hands-on or experience knowledge necessary for the particular job opening and thus may not be equipped to create the ideal, let alone adequate job description, find the ideal/best candidates, and/or to best assess the ideal qualifications required, let alone all job openings within the company.

Many Job Posters simply start by finding and using a job posting previously used by his/her company, say at least once before, or the Job Poster may instead search online for what other companies are posting for similar job openings. The job description may request an applicant to submit a resume and his/her salary requirements, but often not much else. Consequently, the Job Poster is then left to wade through a pile of job applications trying to determine who is truly qualified, has the appropriate job experience, can handle the level of responsibilities required, lives within a reasonable commuting distance for the work location, is available when needed, fits the company's culture and is willing to work within the salary budget that has been allocated.

After the job opening has been posted for a period of time and applicants have inquired, comes the daunting and quite time-consuming task of trying to contact each applicant who appears qualified in order to schedule either a phone interview and/or an in person interview. Consequently, the current hiring systems can cause even highly qualified applicants to be lost to a company's competitors, simply because of highly inefficient ways and means to qualify applicants, and the employer's own delayed communications with qualified applicants.

Instead, both the job seekers, referred to herein as “Applicants”, and the “Job Poster” need a far more efficient system with tools to automatically and succinctly create the most appropriate Job Postings, with additional tools that can create conditional qualifications and surveys for both the Job Poster, and the job Applicant to complete. Followed by data and reports that can sort and rank the Applicants according to pre-determined criteria, and automation tools to contact the Applicants and schedule appointments as necessary, and/or collect the Applicant's feedback.

Further, the Job Poster needs the ability to see where and why Applicants are not qualifying for the Job Opening, to determine if there may be a shortage of qualified Applicants with a specific requirement or requirements relative to other time periods (say a year earlier) when the Job Poster has posted the same Job Opening.

This not only allows the Job Poster to make adjustments as needed, but to track the long-term ramifications of such adjustments relative to such things as the number of Applicants that eventually qualify as Job Candidates, the number of Candidates that get interviewed, the successfulness of the Candidate who becomes the employee or contractor.

Applicants on the other hand, can easily search for relevant job openings by listing their skills, education, experience, along with desired position(s), his/her ideal to maximum commute distances and salary expectations. This system could then contact both the appropriate Applicants, and other appropriate parties, such as the Job Posters, the company with the job opening, those people that will be conducting the job interviews when, and as, matches are created, and according to the conditions pre-set within the System.

Today's hiring practices also suffer from the lack of time available to assess each every Applicant. Consequently, many Applicants get ruled out before the interview process even begins. Further, the time consuming process of trying to interview Applicants fairly with, say the same questions from the same people under similar circumstances becomes virtually impossible. Even if several Applicants all get interviewed with same questions, having different people doing the interviewing can create subjective differences and challenges to later fairly comparing similarly qualified Candidates.

Ideally there would be a system that could interview virtually an unlimited number of Applicants with similar questions, criteria, and conditions, so as to create a relatively fair assessment for each unique opportunity and/or Job Opening. The system could be setup to allow Applicants to apply and interview on their time schedule. The system could provide the Applicants with instant feedback and with areas for suggested improvements.

Advanced systems could even provide Applicants and Companies with high tech analysis regarding computational assessments for speed, accuracy, honesty, and believability in answering interview questions. The system could allow for tools and experts in body language assessment, arousal assessment/lie-detecting, and/or peer groups to assess one's ability to interview well and to what degree, even before he/she becomes an Applicant in an interview for a specific job opening or position, both as practice for improving one's interview skills and/or as joining social communities of shared assessments.

Many hiring practices today also lack a well defined and choreographed system for collecting valuable feedback from the job applicants themselves. What's also needed is a system that collects, analyzes and quantifies correlations between job applicants and job qualifications, to help determine if the best candidates are truly being interviewed and/or hired.

A system where data can be collected from any and all the applicants who for whatever reasons did not become an employee or get hired for a project. Each applicant could be allowed to voice his/her feedback regarding his/her perception of the Company's reasoning for not being hired, and/or if he/she has/had any concerns regarding what he/she perceived to be issues regarding the job opening and/or company, such as unrealistic job qualifications given the salary, too few resources given the project scope and expectations, too small of a team given the project milestones, and/or other flaws in say, the management/structure, the interviewer, the company, the culture, the office, the software architecture or resources available, and/or timelines.

On the other hand, the applicant's feedback could reveal that most Applicants felt the Company's expectations and qualifications for a particular position are/were perceived to be relatively realistic by, say all or by an overwhelming number of job applicants. This too can be invaluable data for assessing hiring practices, listing measurable qualifications, and/or projects goals.

Another short-coming of the current hiring practices is the ability to accurately assess someone's software skills as they relate to a specific job requirement or skill expectation. Several companies and/or recruiters use software testing programs to gauge the applicant's skills for say, his/her typing speed and accuracy in Microsoft® Word®, the ability to explain features and functionality of programs such as Microsoft® Excel® and/or Microsoft® PowerPoint®.

However, there is a lack of standards among most software proficiency tests. Furthermore, the collected applicant results are often considered proprietary data. Consequently, it can be difficult for smaller companies or companies with a relatively short lifespan to accurately gauge a candidate's software skills. In some cases, it might be ideal if the software tests were coming directly from the software manufacturer and creator's themselves. This would also create a powerful two-way street of training, testing, and data correlations regarding software skills per region of the country.

Given adequate company usage, such a system could maintain an on-going system for assessing such things as, the number of applicants per region of the country that possess, say each necessary software skill, the combination of skills, and where there are deficiencies in skills and by what degree. These software skill measurements, collected per region, over time, can help track the successfulness of quantifiable steps that were taken by specific companies, educational facilities, and/or software companies to both increase and improve the pool of qualified applicants for each given software skill.

These skills could be measured beyond each software package and segmented into quantifiable components. For example, take a software program such as Adobe's® Flash® which can boast a large community of developers who are highly proficient in ActionScript® programming, but where some may not be nearly as proficient in artistic drawing or creative design work relative to others. Whereas this same software program may also have a large community of artists who are very proficient in designing, but some may lack some or all of the ActionScript® programming skills. Segmenting the skills for each given software program, especially according to job requirements and a particular project's needs, can segment applicants and make better candidates for each of these independent talent pools standout for the right company and/or project.

In some cases, hiring two candidates may create a relatively better outcome, when provided the system's added ability to highly distinguish each candidate's specific talents within a specific area of expertise and/or software skills. Unfortunately, many existing systems simply ask overly generalized questions to a particular Applicant regarding his/her software skills, such as: “Would you consider yourself, (A) an expert, (B) proficient, (C) capable, (D) a beginner, or (E) someone with no experience”. These vague delineations are highly subjective, can be highly skewed by current trends, and can change dramatically over a relatively short time with little ability for the Applicant to go back and update past records and/or perceptions.

In summary, the hiring process has many inefficiencies and valuable feedback data is often overlooked. The result is unnecessary hiring delays and far too much guesswork in solving many mission critical problems for both hiring entities and applicants.

As used herein, the term “modules,” and as employed herein, are considered computer-executable program stored on a computer-readable storage medium. These modules provide information to users of a “Sourcing Employers, Applicants, Resources, and Criteria Hub” (hereinafter “S.E.A.R.C.H.”) and a “Hiring Entity's Recruiting Database and System” (“H.E.R.D.S.”) and carry one or more sequences of instructions, wherein execution of the one or more sequences of instructions by one or more processors embodied therein causes the one or more processors to perform a method for providing information to a user using a transceiver.

Further, the term “modules” is used in an embodiment of the invention. Modules can be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

A module of executable code can be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, the term System, represents the overall functionality of the invention. The software system is sometimes referred to hereinafter as the H.I.R.E.S. 102 System or by the trade name, Skillustrate™. As used herein, the term “Campaign” 103 can be all types of information organized for specific purposes with instructions for delivery and tracking, and includes, but is not limited to job recruiting, job posting(s), job interview(s), job testing, job criteria, job resource(s), invitation(s), surveys, tests, assessments, Peer reviews, Expert reviews, advertising (or ‘ad(s)”), messaging (including marketing messages), information for the purpose of selling goods and/or services, or those messages that can be used for life cycle management and customer relationship management. Campaigns 103 with an advertising or messaging are generally directed towards a user using a transceiver, which includes, but is not limited to a communication device used for retrieving and/or sending information.

For example, the communication device can be a computing device, such as a desktop computer, laptop computer, tablet computer, or PDA, with software enabling the computing device to connect to the World Wide Web, Internet, and/or a cellular communications network with an ability to display and browse. For example, the communication device can also be a phone, such as a cell phone, mobile phone, smartphone, landline phone, PDA phone, or the like. The communication device can also be a Voice over Internet Protocol (VoIP) device.

Herein is a summary of an embodiment with terms and supporting definitions found through the specification. A computer-implemented method for locating a particular resource to fulfill a particular need, the steps comprising; collecting one or more applicants for the particular need; filtering the one or more applicants into at least one or more candidates based on qualifying criteria pre-assigned to the particular need; collecting a one or more responses from the at least one candidate for the particular need, wherein the candidate is then ranked against other candidates based on the criteria. A computer-implemented method of herein paragraph, further comprising collecting a feedback from the candidate, wherein the feedback indicates a reason why the candidate is qualified for the particular need. A computer-implemented method of herein paragraph, further comprising collecting the feedback from the candidate, wherein the feedback indicates a reason why the candidate is not qualified for the particular need.

Herein is a summary of an embodiment with terms and supporting definitions found through the specification. A computer-implemented method for scheduling an interview for a particular resource to fulfill a particular need, the steps comprising; collecting one or more applicants for the particular need; filtering the one or more applicants into at least one or more candidates based on qualifying criteria pre-assigned to the particular need; collecting one or more dates and times from the at least one candidates for the particular need, wherein a at least one interviewer would be available for the interview. A computer-implemented method of herein paragraph, further comprising collecting a feedback from the candidate, wherein the feedback indicates a reason why the candidate is scheduling the interview. A computer-implemented method of herein paragraph, further comprising collecting the feedback from the candidate, wherein the feedback indicates a reason why the candidate is not scheduling the job interview.

Herein is a summary of an embodiment with terms and supporting definitions found through the specification. A computer-implemented method for scheduling an interview for a particular resource to fulfill a particular need, the steps comprising; collecting one or more applicants for the particular need; filtering the one or more applicants into at least one or more candidates based on qualifying criteria pre-assigned to the particular need; collecting one or more dates and times from the at least one candidates for the particular need, wherein a at least one interviewer would be available for the interview.

Herein is a summary of an embodiment with terms and supporting definitions found through the specification. A computer-implemented method for scheduling a job candidate for a job interview for a particular job opening, the steps comprising; collecting one or more job applications from one or more job applicants for the particular job opening; filtering the job applicants and job candidates apart based on qualifying criteria pre-selected by a PAM-MGR, a recruiter and/or a job interviewer for the particular job opening; collecting one or more dates and times from one or more job interviewers for the particular job, wherein the job interviewers would be available for the job interview; automatically generating via a computer an optimized interview schedule for a plurality of dates and times the job interviewers would be available to conduct the job interviews for the particular job opening; forwarding a communication from the computer to the candidates; updating the dynamic schedule when the candidates select a particular available date and time for the interview.

### BRIEF DESCRIPTION OF THE FIGURES

FIG. 1 depicts a “Search Resources, Interview, Screen, Ad Target Network & Exchange System” 40.

FIG. 2 depicts the NEED 82, the JOINS 70, and the CASTING 80 in detail.

FIG. 3 is a flowchart that depicts an example embodiment of the process by which an account request becomes an account 60.

FIG. 4 is a flowchart that depicts the process by which new users can create an account and become a member.

FIG. 5 is a flowchart that depicts the process by which the Accounts 60 can create and/or manage such things as Campaigns, Billing, Budgeting, Bidding, Account Settings and Targeting.

FIG. 6 is a block diagram depicting an embodiment of the groupings of sub-systems of the “Search Resources, Interview, Screen, Ad Target Network & Exchange System” 40 and the communications among them.

FIG. 7 is a flowchart depicting a user creating an Account using the HIRES 102.

FIG. 8 is a flowchart depicting the user creating and modifying Account 60 roles and permissions.

FIG. 9 is a flowchart depicting the user creating and modifying Account 60 role's permissions.

FIG. 10 is a flowchart depicting the functionality available to users of SEARCH 100.

FIG. 11 is a flowchart that depicts an example of the SEARCH 100 system in more detail.

FIG. 12 is block diagram with an example of an embodiment depicting the relationship between the different elements and modules within.

FIG. 13 is a flowchart depicting the user utilizing the Billing, Budgeting and Billing Module (114).

FIG. 14 is a flowchart that depicts an example of the process by which the PAM-MGR 50 can create/modify a particular P.A.C. 104 and/or a particular P.I.N. 106 utilizing the PAM 118.

FIG. 15 is a flowchart further depicting an embodiment of the PAM-Mgr's 50 options for utilizing the PAM. 118 using the HIRES 102.

FIG. 16 depicts an example embodiment of potential Job Categories.

FIG. 17 depicts an example of potential Job Positions within a particular Job Category. FIG. 18 is a flowchart that depicts an example embodiment of MATCH.

FIG. 19 depicts an example of Questions for the Applicants that could represent the entire set of criteria for a particular job position created by the MATCH MGR(s) 51 or it could represent a subset of criteria that were selected by the PAM-MGR 50 for a particular job position.

FIG. 20 depicts an example of Education 268 levels completed that could represent the entire set of criteria for a particular job position created by the MATCH MGR(s) 51 or it could represent a subset of criteria and/or available responses that were selected by the PAM-MGR 50 for the particular job position.

FIG. 21 depicts an example of how generally the MATCH MGR 51 could have setup the Software Criteria for a particular Job Position.

FIG. 22 depicts an example of how the list of available Applicants Responses would eventually appear to the Job Applicants based on the preset criteria in FIG. 21.

FIG. 23 depicts an example screenshot of the user interface and Home Page as would be seen by an account with the role and permissions of a CASTING Account.

FIG. 24 depicts an example screenshot of the user interface after a particular CASTING user has logged into the HIRES 102 system.

FIG. 25 depicts an example screenshot of the CASTING user interface after the CASTING user has selected software skills under the TIMES menu heading.

FIG. 26 depicts an example screenshot of the user interface after the CASTING user has selected to create a test under the Software Skills menu heading.

FIG. 27 depicts an example screenshot of the user interface after the CASTING user has selected to create a test from scratch.

FIG. 28 depicts an example screenshot of the JOINS user interface and Home Page as would be seen by an account with the role and permissions of a JOINS Account.

FIG. 29 depicts an example screenshot of the user interface after a particular JOINS user has logged into the HIRES 102 system.

FIG. 30 depicts an example screenshot of the user interface after the user has selected to partake in a virtual interview with real-time feedback.

FIG. 31 depicts an example screenshot of a mobile device 540 and a third party website 1558 with a Widget 1546, a Content 542 and/or a JOINS Targeted Ad 1542 generated and/or targeted by the SEARCH 100 system.

FIG. 32 is a flowchart that depicts an example of the process by which the TIMES Mgr 52 can utilize the T.I.M.E. 122 module.

FIG. 33 is a flowchart depicting an example whereby a recipient comes to learn about and interact with an invitation to a particular Campaign 103 and then becomes a participant.

FIG. 34 is a flowchart depicting an example whereby an Account 60 user could create and utilize a particular Campaign 103 with Invitations for acquiring Applicants to partake in an Interview.

FIG. 35 is a flowchart depicting an example whereby a potential applicant can search, view, sort, and review a list of potential interviews based upon “Interview Methods” options available and perceived to be the most relevant to the potential applicant.

FIG. 36 is a flowchart depicting an example whereby an applicant has selected to partake in a Virtual Interview.

FIG. 37 depicts an example of the “T.I.M.E.S.” 122 module and the process of setting up different pre-criteria for all the Applicants who qualify for a particular NEED/Job Opening and who now have become a “Candidate”.

FIG. 38 depicts an example user interface screenshot of an Interview Scheduler generated by the TIMES 114.

FIG. 39 depicts an example selection made by a particular Applicant/Candidate using the Interview Scheduler.

FIG. 40 depicts a response from a particular Applicant/Candidate who has selected “Sorry, I am no longer interested in the position”.

FIG. 41 is a flowchart that depicts an example of the process by which the OPINE Mgr 56 can utilize the OPINE 124 module.

FIG. 42 depicts an example list potential reasons why a particular Applicant/Candidate was no longer interested in the Job Opening, e.g. PAC/PIN.

FIG. 43 is a flowchart that depicts an example of the process by which the DREAM Mgr 53 can utilize the DREAM 126 module.

FIG. 44 is an example screenshot of the DREAM user interface depicting a list of Applicants that have been prioritized and ranked based on conditions that have been established by the MATCH-MGR/Recruiter and/or Interviewer.

FIG. 45 is a flowchart that depicts an example of the process by which the CHOP-M Mgr 58 can utilize the CHOP-M 128 module.

FIG. 46 is a flowchart that depicts an example of the process by which the Affiliameter Mgr 41 can utilize the Affiliameter 112 module.

FIG. 47 is a flowchart that depicts an example of the process by which the ADSTATS Mgr 57 can utilize the ADSTATS 116 module.

FIG. 48 is a flowchart depicting an example embodiment whereby the ADSTATS MGR 57 can utilize the ADSTATS module to create and/or modify a particular Campaign 103 with target advertising.

FIG. 49 is a combination flowchart and block diagram depicting an example embodiment whereby an Account user with a particular role receives targeted advertisements, when he/she connects to the HIRE or a SEARCH-controlled or enabled entity.

FIG. 50 is a combination flowchart and block diagram depicting an example embodiment whereby a JOINS user receives targeted advertisements, when he/she connects to the HIRE or a SEARCH-controlled or enabled entity.

FIG. 51 of the accompanying drawings illustrates a general overview of an information retrieval client-server network 2 in which the invention may be implemented, including a variety of components that communicate over a public network 6, preferably the Internet 136.

### DETAILED DESCRIPTION OF THE INVENTION

The present invention discussed below includes systems, methods and articles of manufacture which define and/or locate a resource, created either by predefining the criteria required for or by the resource, and/or allowing other elements to judge the resource. The present invention may be implemented by a combination of hardware, software, and/or firmware, in various applications or may include a computer. The computer may be configured by a computer readable medium or program code to provide functionality. The program instructions may be those designed for the purposes of the present invention.

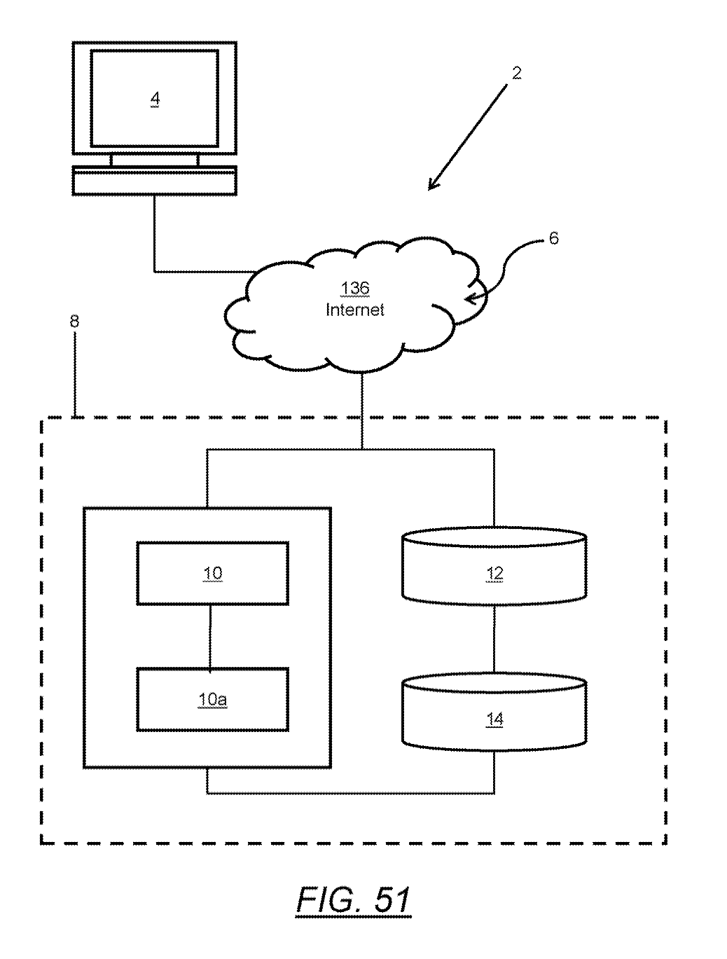

FIG. 51 of the accompanying drawings illustrates a general overview of an information retrieval client-server network 2 in which the invention may be implemented, including a variety of components that communicate over a public network 6, preferably the Internet 136 per one embodiment. The information retrieval client-server network 2 includes a client system 4 and a search system 8. The client system 4, using Uniform Resource Locators (URL), accesses web servers through, in one embodiment, over a local area network (LAN), wireless area network (WAN), or an internet service provider (ISP). The client system 4 in one embodiment may include a desktop computer, a personal digital assistant or cell phone, or generally, any device that includes a graphical user interface (GUI) and/or a voice response unit (VRU) and can access a network. The client system 4 typically includes one or more processors, memories and input/output devices. Typically the client 4 also includes a mouse, touch screen, keyboard, or other technological improvements therein, to effectuate a selection by the user.

The search system 8 includes one or more search engines 10, a computer 10a, including a processing system, one or more content servers 12 and one or more profile servers 14. Generally, servers may include a central processing unit (CPU), a main memory, a read-only memory (ROM), a storage device and a communication interface all coupled together via a bus. The search engine 10, including a program, processes a search query entered by a user, and communicates with the content server 12 or the profile server 14, to retrieve content. The content server 12 stores content associated with the system 8, and the profile servers 14 store profiles generated by users, both acting as information providers for the client-server network 2, accessed by the computer 10a, when the user submits a query into the search engine 10.

Servers include databases, which may be implemented in a single storage device or in a plurality of storage devices located in a single location or distributed across multiple locations. The databases are accessible to the servers and clients, within the client-server network 2. The information stored in the databases may be stored in one or more formats that are applicable to one or more software applications that are used by the clients and servers.

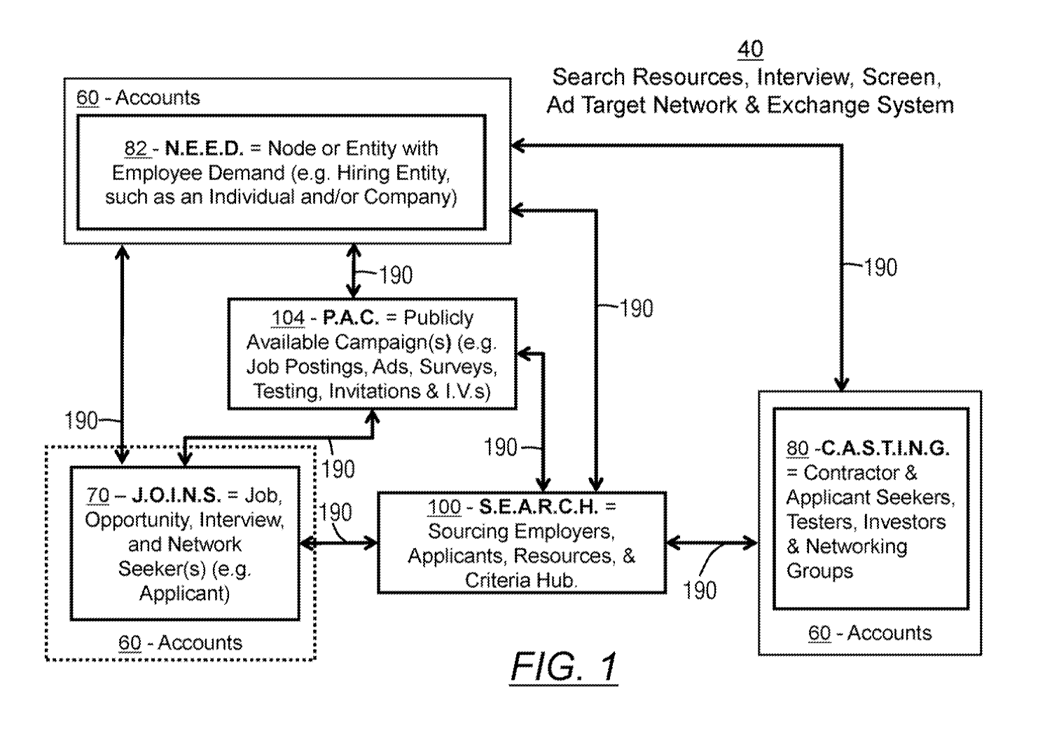

FIG. 1 depicts an embodiment of a “Search Resources, Interview, Screen, Ad Target Network & Exchange System” 40. The “Search Resources, Interview, Screen, Ad Target Network & Exchange System” 40 is comprised of a “Node or Entity with Employee Demand” (hereinafter “N.E.E.D.”) 82, a “Job, Opportunity, Interview, and Network Seeker(s)” (hereinafter “J.O.I.N.S”) 70, a “Publicly Available Campaign(s)” (hereinafter “P.A.C.” or “PAC”) 104, the S.E.A.R.C.H. 100, and a “Contractor and Applicant Seekers, Testers, Investors, and Networking Groups” (hereinafter “C.A.S.T.I.N.G.”) 80.

The JOINS 70 is comprised of users who participate anonymously and enroll to become a specific Role. The enrollment may have been required to participate in a particular PAC 104 and/or a “Private Invitation and/or Need” 106 Campaign 103 (hereinafter “P.I.N.”) 106 (also sometimes collectively referred to as PAC/PIN) from a particular Account 60 and/or the JOINS 70 user decided independently to enroll to create a personal Account 60 role with more permissions/privileges. The JOINS 70 and the CASTING 80 Accounts 60 are comprised of members and/or resources with specific roles and permissions. The NEED 82 is a specific type of CASTING 80 Account 60 role.

The S.E.A.R.C.H. 100 provides the “Search Resources, Interview, Screen, Ad Target Network & Exchange System” 40 a central repository to store, track and update all data, rules, definitions, segmentations, conditions, patterns, business logic, algorithms, algorithm rules, source code, code methods, presentation layer, architecture, tables, database schemas, software, and content necessary to function as needed. The SEARCH 100 connects to the NEED 82 from, in one embodiment, outside the network via a Communication Connection (hereinafter “CC”) 190, typically via a Transmission Control Protocol/Internet Protocol Connection (hereinafter “TCP/IP”), but all connections inside the “Search Resources, Interview, Screen, Ad Target Network & Exchange System” 40 can be any type of appropriate network connection.

The S.E.A.R.C.H. 100 could also technically be located within the NEED 82 environment, but generally is meant to be a separate entity. The SEARCH 100 is operatively connected to the CASTING 80 Accounts via the CC 190, typically via the TCP/IP connection, but could be a mobile network connection or similar. The SEARCH 100 is also operatively connected to the JOINS 70 (in some instances applicants, candidates, and/or job seekers) via the CC 190, typically via the TCP/IP connection, but could be a mobile network connection, or similar. The CASTING 80 can also connect directly to the NEED 82 via the CC 190 connection, but would generally connect via the World Wide Web or a Cellular network (more later ahead).

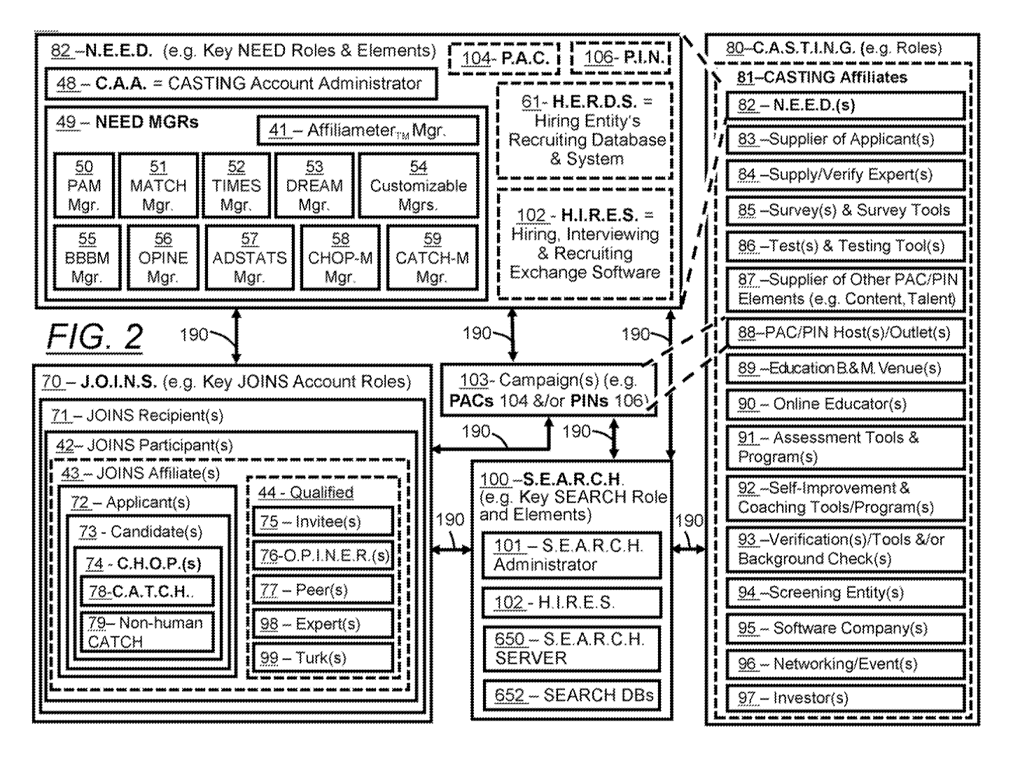

FIG. 2 depicts the NEED 82, the JOINS 70, and the CASTING 80 in detail in one embodiment. The NEED 82 is comprised of hardware and software including: the “Hiring Entity's Recruiting Database and System” (hereinafter “H.E.R.D.S.” or “HERDS”) 61, utilizing a “Hiring, Interviewing, and Recruiting Exchange Software” (hereinafter “H.I.R.E.S.” or “HIRES”) 102 user-interface. The HIRES 102 user-interface is sometimes referred to as a HIRES 102 system, which can represent the entire system available and interconnected to the NEED 82.

In some embodiments herein the NEED can be an Individual, entity, and/or Company. As an individual, the N.E.E.D. 82 individual (or NEED member) can be assigned and/or request a specific role with specific permissions to participate and/or manage Campaigns 103. The separate modules each have at least one key role called a Manager assigned to the separate modules. The same manager can have many roles and the collections of NEED managers are referred to as a NEED MGRs 49 group (or NEED MGRs). The N.E.E.D. 82 can also have several users who have several roles, but generally have at least one specific NEED MGRs 49 role. The NEED MGR 49 role who is assigned to creating Campaigns 103 to locate, assess, test, and engage a resource/need, such as an employee, a contractor, and/or material(s)/resource(s) is referred to as a Posting Automated Module Mgr(s) 50, hereinafter “PAM-MGR” 50.

The NEED 82 also includes, but is not limited to the following participants, members, roles, and/or users who enroll or are pre-assigned to utilize the HIRES 102 user-interface: a “C.A.S.T.I.N.G. Account Administrator” 48 (hereinafter “C.A.A.” or “CAA”) 48, the NEED MGRs 49 group, an “Affiliameter™ Manager” 41, the “P.A.M. Manager” 50 (hereinafter “PAM-MGR”) 50, a “M.A.T.C.H. Manager” 51 (hereinafter “MATCH Mgr”) 51, a “T.I.M.E.S. Manager” 52 (hereinafter “TIMES Mgr”) 52, a “D.R.E.A.M. Manager” 53, (hereinafter “DREAM Mgr”) 53, a “Customizable Mgrs” 54, a “B.B.B.M. Manager” 55 (hereinafter “BBBM Mgr”) 55, an “O.P.I.N.E. Manager” 56 (hereinafter “OPINE Mgr”) 56, an “A.D.S.T.A.T.S. Manager” 57 (hereinafter “ADSTATS Mgr”) 57, a “C.H.O.P.-M Manager” 58 (hereinafter “CHOP-M Mgr”) 58, and a “C.A.T.C.H.-M Manager” 59 (hereinafter “CATCH-M Mgr”) 59; where any above undefined naming conventions, term, and/or acronyms will be defined further ahead).

The CAA 48 Role classification is a specific CASTING 80 Role with administrative permissions that allows him/her to manage the Account 60. He/she can also have other roles. For instances, the CAA 48 could also possess the permissions of the PAM MGR role and/or all other NEED Mgrs 49 role's permissions. The Affiliameter™ Manager” 41 Role classification is a specific NEED 82 Manager Role with specific permissions that at a minimum, allows him/her to utilize an “Affiliameter™” module within the HIRES 102 system to manage Campaigns 103. He/she can also have other roles. For instances, the Affiliameter Manager 41 could also be the PAM MGR and/or all other NEED Mgrs 49.

The Posting Automated Module Manager 50 (or PAM-MGR) 50 Role classification is a specific NEED 82 Manager Role with specific permissions that at a minimum, allows him/her to utilize a P.A.M. 118 module within the HIRES 102 system to manage Campaigns 103. He/she can also have other roles. For instances, the PAM MGR 50 could also possess the permissions of the MATCH MGR 51 role and/or all other NEED Mgrs 49 role's permissions. Depending on the rules and conditions setup for the particular NEED 82, the NEED Mgr 49 roles and permissions can be setup to be exclusive and/or limited to a set number of participants. In addition, the level of permissions would not necessarily be the same among two people with the same role title. For example, a particular NEED 82 could have a plurality of PAM-MGRs 50, but each could have different capabilities and/or responsibilities. For instances, one particular PAM-MGR 50 could have broader privileges/permissions than his/her fellow PAM-Mgrs 50, but all PAM-MGRs 50 would have at least access to the PAM 118 module's base functionality.

The “Module for Applicant Testing & Criteria Hiring-Manager” 51 (or “MATCH Mgr”) 51 Role classification is a specific NEED 82 Manager Role with specific permissions that at a minimum, allows him/her to utilize a M.A.T.C.H. 120 module (or “Module for Applicant Testing & Criteria Hiring”) within the HIRES 102 system to manage Campaigns 103.

The “Testing & Interviewing Module for Event Scheduling-Manager” 52 (or “TIMES Mgr”) 52 Role classification is a specific NEED 82 Manager Role with specific permissions that at a minimum, allows him/her to utilize a T.I.M.E.S. 122 module (or “Testing & Interviewing Module for Event Scheduling”) within the HIRES 102 system to manage Campaigns 103.

The “Data Rank Every Applicant Module-Manager” 53 (or “DREAM Mgr”) 53 Role classification is a specific NEED 82 Manager Role with specific permissions that at a minimum, allows him/her to utilize a D.R.E.A.M. 126 module (or “Data Rank Every Applicant Module-Manager”) within the HIRES 102 system to manage Campaigns 103.

The Customizable Mgrs Role classification is a specific NEED 82 Manager Role with specific permissions that at a minimum, allows him/her to utilize a Customizable module within the HIRES 102 system to manage Campaigns 103.

The “Billing, Budgeting and Billing Module-Manager” 55 (or “BBBM Mgr”) 55 Role classification is a specific NEED 82 Manager Role with specific permissions that at a minimum, allows him/her to utilize a “B.B.B.M.” module (or “Billing, Budgeting and Billing Module”) within the HIRES 102 system to manage Campaigns 103.

The “Opinions and Pointers to Improve a NEED or an Employee-Manager” 56 (“OPINE Mgr”) 56 Role classification is a specific NEED 82 Manager Role with specific permission that at a minimum, allows him/her to utilize an “O.P.I.N.E.” 124 module (or “Opinions and Pointers to Improve a NEED or an Employee”) within the HIRES 102 system to manage Campaigns 103.

The “Applicant Data & Skills Tied to Advertising Targeting System-Manager” 54 (hereinafter “ADSTATS Mgr”) 57 Role classification is a specific NEED 82 Manager Role with specific permissions that at a minimum, allows him/her to utilize an ADSTATS 116 module (or “Applicant Data & Skills Tied to Advertising Targeting System”) within the HIRES 102 system to manage Campaigns 103.

The “Candidate(s) with Hiring Offer(s) Pending-Module-Manager” 58 (hereinafter “C.H.O.P.-M Mgr” or “CHOP-M M Mgr”) 58 Role classification is a specific NEED 82 Manager Role with specific permissions that at a minimum, allows him/her to utilize a CHOP-M module (or “Candidate(s) with Hiring Offer(s) Pending-Module”) within the HIRES 102 system to manage Campaigns 103.

The “Candidate who Accepts The Company Hire-Module-Manager” 59 (hereinafter “C.A.T.C.H.-M Mgr” or “CATCH-M Mgr”) 59 Role classification is a specific NEED 82 Manager Role with specific permissions that at a minimum, allows him/her to utilize a CATCH-M module (or “Candidate who Accepts The Company Hire-Module”) within the HIRES 102 system to manage Campaigns 103.

In an embodiment, the TIMES Mgr 52, for example, might have and/or request an outline of goals that the NEED wishes to accomplish for a particular Campaign. Working backwards in terms of accomplishments for instances, these goals might include:

The overall timetable goal that the NEED has set for hiring a candidate, also known as a CATCH where for instances that timetable could be expressed as say 120 days;

The number of CATCH-M MGRs involved in the final decision making and each CATCH-M MGR's availability during the timetable where for instances that number of CATCH-M MGRs could be say one (1) distinct person or one (1) person with distinct qualifications and/or authority;

The overall time limit set for all CHOP-M MGRs to submit final information and any recommendations to CATCH-M MGRs where for instances that timetable could be expressed as say sixty (60) days;

The target goal number of next round interviews per Candidate per CHOP-M MGR and/or CATCH-M MGR and overall time limit where for instances that goal number could be expressed as say two (2) Candidates per CATCH-M MGR;

The target goal number of Candidates (for CATCH-M MGR or next round interviews) before arranging next round interviews with CHOP-M MGRs and/or CATCH-M MGRs and overall time limit where for instances that goal could be expressed as say five (5) Candidate;

The set number of other CHOP-M MGRs required and the set number of potentially involved CHOP-M MGRs along the way, with each CHOP-M MGR's role and availability where for instances that set number of CHOP-M MGRs could be expressed as say three (3) distinct people or three (3) people with distinct qualifications and where the set number of potentially involved CHOP-M MGRs might include say ten (10) people.

The target goal number of Candidate interviews per CHOP-M MGR and overall time limit where for instances that goal number could be expressed as say two (2) Candidates per CATCH-M MGR and with an overall time limit of say fifteen (15) days;

The target goal number and/or time limit on acquiring a set number of Candidates before arranging interviews with CHOP-M MGRs where for instances that goal number could be expressed as say whatever comes sooner, thirty (30) Candidates or forty-five (45) days;

The target goal number and associated scores required per survey, test, and/or preliminary interview required for an Applicant to qualify as a candidate where for instances that goal number could be expressed as say a score of eighty (80) percent correct on a particular preliminary test or group of tests.

The TIMES Mgr 52 can use the system to compare each of these goals and elements against previous Campaigns 103 for the same company, similar companies, similar Campaigns for similar positions, similar requirements, and the like, to see in quantifiable and measurable terms how realistic each setup goal is when compared to historical data for similar situations and the like. For example, this comparison may indicate particular elements, rules, participants, times and/or goals that are relatively likely to fail, that are relatively likely to be accomplished, the relatively likelihood per the timeframe, the relatively likelihood per the participants, MGRs involved, PACs, etc.

In an embodiment, the NEED 82 can also contain the PAC 104, the PIN 106, the HERDS 61 and/or the HIRES 102. The NEED 82 can connect and communicate with other HIRES 102 located at the SEARCH 100 and/or at other NEEDs 82. The HIRES 102 software resides in at least one NEED 82 and/or in at least one SEARCH 100 location and can provide access to outside Accounts 60 such as JOINS 70 and/or other CASTING 80 Accounts. There could be a plurality of NEEDs 82 with HIRES 102, but generally there is at least one SEARCH 100 site. However there could be a plurality of SEARCH 100 sites, and/or as many SEARCH 100 sites as necessary to efficiently update, track, and synchronize all the connected HIRES 102 systems.

The CASTING 80 Accounts, the JOINS 70 Accounts, and users can connect to Campaigns, such as a “Publicly Available Campaign” 104 (hereinafter “P.A.C.” or “PAC”) 104, that was generated by the HIRES 102 and published and/or pushed out to such sources as websites. For instances, the JOINS 70 can connect to the HIRES 102 system located within a particular NEED 82 site, using his/her computer as a transceiver 68 (or communication device). The JOINs 70 can connect directly to the NEED 82 (with its HIRES 102, PAC 104, and PIN 106), the SEARCH 100 (with its HIRES 102), and/or the PAC 104 via a CC 190.

Depending on the conditions set on the HIRES 102 system and/or the login requirements of a particular PAC 104, the JOINS 70 user can participate anonymously, enroll, participate through a specific invitation received, and/or participate through a pre-assigned login which authorizes the JOINS to utilize the HIRES 102 system and/or the particular PAC 104. The JOINS 70 users include, but are not limited to the following participants, members, roles, and/or user types: a “Potential Applicant” 71, an “Invitee” 75, an “OPINER” 76, a “Peer” 77, an “Expert” 98, an “Applicant” 72, a “Turk” 99, a “Candidate” 73, a “CHOP” 74, and a “CATCH” 78.

The JOINS 70 user is someone, something, a proxy acting-on-behalf-of, and/or a role where the HIRES 102 utilization is currently and/or generally anonymous, whereas a “JOINS member” is someone, something, a proxy acting-on-behalf-of, and/or a role where the HIRES 102 utilization is currently and/or generally as someone logged in. In addition, a particular JOINS 70 users or member can be described by more than one role.

For example, a particular JOINS 70 user could be a Peer for a particular Peer Review Campaign, while being an Applicant for another PAC 104, while still being a Candidate for another PAC 104. A particular JOINS 70 user could become an Account 60 member/role for a particular PAC 104, while participating in another PAC 104 as an anonymous OPINER 76. In addition, technically a particular CASTING 80 Account member could also participate as a JOINS member.

In general, the JOINS 70 users connect to the HIRES 102 system and/or a particular HIRES generated Campaign 103 (PACs 104/PINs 106) and are seeking opportunities for work, feedback, self-improvement, and/or are giving others feedback. “Opportunities” can be for such things as job opportunities, including but not limited to part-time and/or full-time employment work, contract work, consulting, licensed professionals, internships, apprenticeships, mechanical Turk work, guild members, union members, non-union members, drivers, teachers, and/or students.

“Feedback” to a particular JOINS 70 user can come from computerized assessment programs and tools, accounts, managers, Peers, and/or Experts. “Self-improvement” suggestions and programs can come from computerized coaching programs and tools, professional career coaches, recruiters and/or the like.

“Giving others feedback” can be to the other JOINS members as a “Peer” and/or as a qualified “Expert”. The feedback can also be given to CASTING 80 Accounts regarding a wide variety of things, such as a particular Campaign 103 (e.g. Job Posting, Test, Interview, Invitation, Ad, etc.), Campaign 103 elements (e.g. a particular question, a particular interviewer, a particular piece of ad content, etc.), a Company's brand, image, teamwork, management style, employees, budgets, pricing, customer service, products, services, prospects, vision, goals, and the like.

The JOINS 70 role of the “Potential Applicant” 71 is someone who has been targeted to apply for a particular CAMPAIGN; someone who has participated in a Campaign 103 without completing an application, and/or someone who (or something that) participated in a Campaign 103 where an Application wasn't required.

The JOINS 70 role of the “Invitee” 75 is someone who has been invited to participate in a particular Campaign. The invitation can be allow anonymous participation, but typically would have the Invitee 75 become a member.

The JOINS 70 role of the “OPINER” 76 (or “Opinions and Pointers to Improve a NEED or an Employee Reply”) 76 is someone who has participated in a Campaign 103 where he/she has provided his/her feedback. This OPINER 76 feedback can be, but is not limited to: anonymously, via invitation, voluntary, in exchange for a bounty, in exchange for a reward, in exchange for a fee, in exchange for a discount, in exchange for a coupon, in exchange for a benefit, in exchange for points, in exchange for virtual currency, in exchange for bartering power/position/points, in exchange for industry prestige, in exchange for expertise validation, in exchange for other's feedback, in exchange for an opportunity, and/or some combination of these.

Like other JOINS 70 roles, technically a particular CASTING 80 Account member/role could also participate as an OPINER. Further JOINS 70 roles can also become CASTING 80 Accounts/roles as well. For example, someone who is considered a Peer for a particular Campaign could qualify as an Expert for another Campaign 103 and consequently become a CASTING 80 Account member/role when properly registered and validated, as in a “Supply/Verify Expert” 84.

The JOINS 70 role of the “Peer” 77 is someone who has offered to provide and/or has provided his/her feedback to another JOINS member and/or another CASTING member where he/she qualified as a “Peer” 77 based upon the rules and conditions for a particular Campaign. The base rule for qualifying as a Peer in general, is where two different users/members must have at least one profile element in common exactly and/or within a common range. For example, demographic data, such as someone's DOB (“Date of Birth”).

Further, even the DOB could be set with a relatively liberal plus/minus range of say, ten years, where a particular Campaign 103 with a request for Peer Reviews would allow anyone that was within a range of 10 years older and 10 years younger than the JOINS 70 member to participate as a Peer. The JOINS 70 user who is creating the Campaign 103 that is requesting Peer Review could also create rules for qualifying, along with minimum floors and maximum caps per rule or condition (for qualifying and/or participation), where for instances, no more than 20 Peer members can participate in a particular Peer Review Campaign.

In addition, a time limit to participate can be suggested and/or employed. These Peer 77 Review Campaigns 103 can be for a wide variety of things, including, but not limited to a particular JOINS 70 user's skills, appearance, hire-ability, attitude, and the like. The Peer 77 Review Campaigns 103 can also be targeted towards shared interest such as a survey that asks “what software program do ‘my’ Peers perceive as the most critical to work within ‘X’ industry?”

The JOINS 70 role of the “Applicant” 72 is someone who has completed an application for a particular NEED's 82 PAC 104 and/or PIN 106. Generally, the Applicant 72 role has an Account 60, so the particular 82 NEED and can follow-up with the Applicant 72, but some PACs 104 and/or PINs 106 could allow Applicants 72 to complete applications anonymously. This could be accomplished with unique identifier's assigned to each Applicant 72 that allowed the Applicant 72 to remain completely and/or relatively anonymous. This capability might allow people who could not and/or might not otherwise apply and/or participate in a particular PAC 104 and/or PIN 106 to now participate.

The JOINS 70 role of the “Turk” 99 is someone who has enrolled to participate as part of larger group of Turks to perform a collective task. The Turk task requests are presented to all JOINs 70 users in a specific PAC 104 and/or PIN 106. The Turk tasks can offer JOINS 70 users something in exchange for his/her participation and/or for completing a specific task. For example, the Turk task could request that Turks who wish to participate, vote on their favorite image (e.g. model, product shot, dating prospect, etc.), audio clip (e.g. radio ad, music, voice-over talent, speech, etc.) and/or video clip (e.g. TV ad, movie, screenplay. etc.). PACs 104 and/or PINs 106 with Turk task requests may also require JOINS 70 users to pre-qualify to participate as a TURK.

The JOINS 70 role of the “Candidate” 73 is someone who was the Applicant 72 for a particular PAC 104 and/or a particular PIN 106 and where he/she has met the pre-set qualifications to be considered a “Candidate” 73 and now typically get notified of such event by the NEED 82 that posted the particular PAC 104/PIN 106. This qualification entitles the Candidate 73 for the next stage of qualifying, such as a new stage of Candidate only surveys, Candidate only testing, Candidate only interviewing, and/or possibly a hiring offer right to the Candidate 73.

The HIRES 102 system generally has default settings where for example, the Applicant 72 becomes the Candidate 73 when he/she matches all the MATCH criteria for a particular PAC/PIN to qualify for the first Interview. However, each NEED 82 and/or NEED MGR can set its/his/her own stages and rules within each PAC/PIN for what specifically and measurably moves the Applicant 72 into the Candidate 73 pool, but this generally occurs within the initial state of criteria and no later than before the hiring offer.

The JOINS 70 role of the “Candidate(s) with Hiring Offer(s) Pending” (hereinafter “C.H.O.P.” or “CHOP(s)” 74 is someone who has at least one pending hiring offer from a particular PAC/PIN. The CHOP could have multiple offers pending.

The JOINS 70 role of the “Candidate who Accepts The Company Hire” (hereinafter “C.A.T.C.H.” or “CATCH(es)” 78 is someone who has accepted a hiring offer for a particular PAC/PIN. The CATCH 78 remains a CHOP 74 through the negotiations only becomes a CATCH 78 when he/she accepts the offer. The HIRES 102 system will track data during all of these critical periods per Job Industry, Category, Position, region of the country, etc. to create correlations where the NEED MGRs will have the ability to see such things as how the NEED 82/Company compares to others regarding the number of Applicants, Candidates, and CHOPs.

In addition, the time windows spent and relative success within each category can be measured and compared to others, such as: Number of Ads per Applicant Acquired Phase & relative success, Applicant Acquired per Invitation phase & relative success, Applicants to Candidates phase & relative success, MATCH to Interview Phase & relative success, Interviews to CHOPs Phase & relative success, and/or CHOPs to CATCH Phase & relative success.

Still utilizing the computer as the example communication device or transceiver 68, the CASTING 80 Account 60 Roles are made up of the following participants or users, a “CASTING Affiliate(s)” 81, the “NEED(s)” 82, a “Supplier of Applicant(s)” 83, the “ Supply/Verify Expert(s)” 84, a “Survey(s) & Survey Tools” 85, a “Test(s) & Testing Tool(s)” 86, a “Supplier of Other PAC/PIN Elements (e.g. Content, Talent)” 87, a “PAC/PIN Host(s)/Outlet(s)” 88, a “Education B. & M. (i.e. Brick & Mortar) Venue(s)” 89, a “Online Educator(s)” 90, a “Assessment Tools & Program(s)” 91, a “Self-Improvement & Coaching Tools/Program(s)” 92, a “Verification(s)/Tools &/or Background Check(s)” 93, a “Screening Entity(s)” 94, a “Software Company(s)” 95, a “Networking/Event(s)” 96, and/or a “Investor(s)” 97.

The “CASTING Affiliate(s)” 81 Role classification is a specific CASTING 80 Account 60 Role, where it was invited by the SEARCH Administrator, the CAA 48, or another Affiliate to the HIRES 102 system and has accepted the associated Terms of Use and participation.

The NEED 82 classification is a specific CASTING 80 Account 60 Role, where it has an assigned PAM Mgr 50 who has at least started the creation of a PAC/PIN for a need of the entity/NEED 82 itself, not for some other CASTING 80 Account. In addition, a CASTING 82 Account that connects to a particular NEED 82, in the role as a “Software Company” 95 to provide testing materials, can itself also be a NEED 82, when its own PAM Mgr starts the creation of a particular PAC/PIN to hire someone for the Software Company itself.

Example of the NEEDS 82 could be any individual, company, and/or entity that has a need for a resource. Instances of NEEDS 82 include, but are not limited to: a manufacturer, a supplier, a distributor, a retailer, a reseller, a dealer, a wholesaler, an importer/exporter, a government agency/entity, a non-profit entity, a union/Guild, an installer, a repair depot, a shipper, a customer care center, a repair depot, a communication network, an IT center, a website, a social network, an advertising agency/entity, a media outlet, a PR agency/entity, an insurance agency/entity, a hospital/clinic, a doctor/dentist office/clinic/entity, an architectural firm/entity, a legal firm/entity, a school/campus, a resort/park, a home/homeowner, and each of the other CASTING 80 Roles. Each NEED 82 can also act as another CASTING 80 Role for other NEEDs 82.

The “Supplier of Applicant(s)” 83 Role classification is a specific CASTING 80 Account 60 Role, where it supplies Applicants 72 to the HIRES 102 system.

The “Supply/Verify Expert(s)” 84 Role classification is a specific CASTING 80 Account 60 Role, where it supplies and/or pre-qualifies Experts for the HIRES 102 system. The Expert 98, himself or herself, once approved is also a JOINS 70 Account 60 Role member.

The “Survey(s) & Survey Tools” 85 Role classification is a specific CASTING 80 Account 60 Role, where it supplies Surveys to the HIRES 102 system.

The “Test(s) & Testing Tool(s)” 86 Role classification is a specific CASTING 80 Account 60 Role, where it supplies Tests and/or Testing Materials (e.g. Questions) to the HIRES 102 system.

The “Supplier of Other PAC/PIN Elements (e.g. Content, Talent)” 87 Role classification is a specific CASTING 80 Account 60 Role, where it supplies content, talent and/or elements to a Campaign 103 (typically not covered by other CASTING roles) for the HIRES 102 system.

Typically the “PAC/PIN Host(s)/Outlet(s)” 88 Role classification is a specific CASTING 80 Account 60 Role, where it supplies outlets for PAC(s) 104 and/or PIN(s) 106 for the HIRES 102 system.

The “Education B. & M. (i.e. Brick & Mortar) Venue(s)” 89 Role classification is a specific CASTING 80 Account 60 Role, where it supplies educational information, education transcripts, and education offers from educational venues (physical/brick and mortar) to the HIRES 102 system.

The “Online Educator(s)” 90 Role classification is a specific CASTING 80 Account 60 Role, where it supplies educational information, education transcripts, and education offers from online educational venues to the HIRES 102 system.

The “Assessment Tools & Program(s)” 91 Role classification is a specific CASTING 80 Account 60 Role, where it supplies assessment tools and programs (e.g. voice recognition and detection and arousal detection and assessment software) to the HIRES 102 system.

The “Self-Improvement & Coaching Tools/Program(s)” 92 Role classification is a specific CASTING 80 Account 60 Role, where it supplies self-improvement and/or coaching tools/programs to the HIRES 102 system.

The “Verification(s)/Tools &/or Background Check(s)” 93 Role classification is a specific CASTING 80 Account 60 Role, where it supplies verification(s), verification tools and/or background check(s) to the HIRES 102 system, typically regarding Applicants and Applicant's job history, but could also have an additional role as, say the “Supply/Verify Expert(s)” 84 role, if deemed appropriate by the standards and rules per role.

The “Screening Entity(s)” 94, Role classification is a specific CASTING 80 Account 60 Role, where it supplies screening of JOINS and/or pre-screening tools to the HIRES 102 system.

The “Software Company(s)” 95 Role classification is a specific CASTING 80 Account 60 Role, where it is a verified software producer, manufacturer, and/or company (e.g. Adobe, Microsoft, Quicken, Peachtree, and the like) and where they supply software and/or assessment tests to the HIRES 102 system.

The “Networking/Event(s)” 96 Role classification is a specific CASTING 80 Account 60 Role, where it sponsors SEARCH approved events (e.g. Job Fairs, Trade Shows, Networking events, online social networks, etc.) and provides information and/or offers on the HIRES 102 system.

Online social networks, such as a LinkedIn®, can connect and interact with the HIRES 102 system to exchange data, and/or promote events and/or services. JOINS members can request that his/her social network account be pulled from existing social networks, such as the profile information from such accounts as LinkedIn®, Facebook®, MySpace®, Monster®, HotJobs®, the Ladders®, and the like).

The “Investor(s)” 97 Role classification is a specific CASTING 80 Account 60 Role, where he/she/it supplies an investment towards a Campaign 103 on the HIRES 102 system.

Common participations in today's traditional job sourcing industry, search sites/firms, and recruiting world, such as: recruiters, headhunters, job fairs, job placement agencies, temporary job agencies, job boards, job websites (e.g. Monster®, HotJobs®, CraigsList®), social networks, and/or other resources for employees and contractors can fall under more than one CASTING 80 role, provided he/she, his/her company, and/or his/her employer obtains approval for a particular role either through SEARCH and/or the appropriate Accounts 60.

For example, a particular college and/or university could apply to become an approved “Education B. & M. Venue” 89 CASTING 80 Account 60 Role, but should the same Account 60 also provide online course, it could also apply and qualify as an approved “Online Educator” 90. Another example, could be for a recruiter who qualifies for both the “Supplier of Applicant(s)” 83 role and the “Supply/Verify Expert(s)” 84 role.

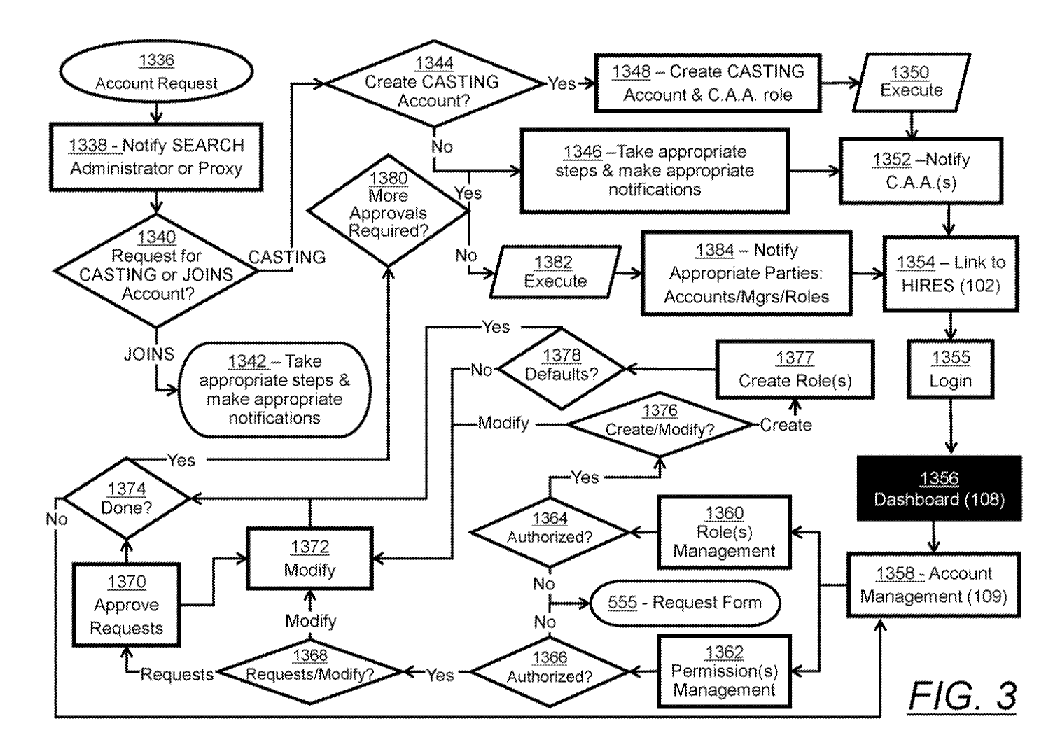

FIG. 3 is a flowchart that depicts an example embodiment of the process by which a user request becomes an Account 60. Starting with a step 1336 where an “Account Request” is sent to the SEARCH 100 in a step 1338, where a “Notify SEARCH Administrator or Proxy” function is invoked. Here the SEARCH Administrator 101, and/or someone he/she designates to authorize new Accounts and/or Account modifications (e.g. roles and permissions) can view the “Account Request” 1336 and determine in a query 1340 whether it is a “Request for CASTING or JOINS Account?

If the answer to query 1340 is for a “JOINS” 70 Account 60, the matter is passed to a terminator 1342 where a “Take appropriate steps and make appropriate notifications” is invoked. This figure and example details more regarding the CASTING Account request, but there are many similarities between the CASTING and the JOINS account setup.

If the answer to query 1340 is for a “CASTING” 80 Account 60, the matter is passed to a query 1344, which asks whether or not to “Create CASTING Account?” If the answer to query 1344 is “no”, the matter is passed to a step 1346, where a “Take appropriate steps & make appropriate notifications” is invoked. This could include several issues including, but not limited to, notifying the person and/or entity that sent the “Account Request” 1336, that there is more information required, and/or why he/she/they did not qualify at this time. This information gets passed to the appropriate parties, such as an Affiliate and/or Account that referred and/or invited the user to become an Account. This information and matter then gets passed to a step 1352 where a “Notify C.A.A.(s)” is also invoked, assuming there is a particular CAA 48 applicable to the Account Request 1336.

For example, if the Account Request 1336 was for an entirely new Account 60, with no existing Affiliations (explained more later), no existing invitations (explained more later), and/or no other existing Accounts or Account roles, there may not be any CAA(s) to notify in the step 1352. On the other hand, if the Account Request 1336 was from someone either referred by another Account 60 user, member or role (via a particular Affiliation); who was invited by another particular Account 60, and/or belongs to another existing particular Account, then step 1352 would invoke the appropriate notifications of each respective CAA 48.

If the answer to query 1344 is “yes” then the matter is passed to the next step where the SEARCH Administrator 101 and/or the Proxy invokes a “Create CASTING Account and C.A.A. role” in a step 1348. The step 1348 is completed in an “Execute” 1350 function, where the appropriate databases (such as the SEARCH DBs and the HERDS 61, not shown) are undated and synchronizations are preformed as needed and/or assigned.

The newly created CAA 48 is notified in the step 1352, generally via an electronic format, such as email, sms, and/or similar. The notification will include instructions and a method to link to the HIRES 102 in a “Link to HIRES (102) step 1354. This link connects the CAA 48 to the HIRES 102 where the CAA 48 logins and/or creates his/her login in a step 1355. Once login is verified, the CAA 48 obtains use of a Dashboard 108 of HIRES 102 functionality appropriate to his/her role and default and/or assigned permissions.

The CAA 48 can create additional Account roles, such as the NEED MGRs 49 utilizing an Account Management (109) module in a step 1358. In this embodiment example, the Account Management 109 module in step 1358 provides the CAA 48 the options of a “Role(s) Management” 1360 module or a “Permission(s) Management” 1362 module.

The first utilization of the HIRES 102, by the CAA 48 where he/she is initially the only role currently assigned to the entire Account 60, he/she can “modify” his/her role or permissions and/or “create” new roles within this particular Account 60. Generally, the CAA 48 role has the broadest permissions within a particular Account 60, but not necessarily. The CAA 48 role can be restricted and/or limited from accessing and/or editing certain Account data, such as Applicant and/or Candidate application data. In addition, the CAA 48 would generally have to request permission to access data that resides on another Account's HIRES 102 system.

When the CAA (or an Account user) invokes the “Role(s) Management” 1360 module, a query 1364 asks if the Account user is an “Authorized?” user/role. If the answer to the query 1364 is “no”, the Account user is sent to a terminator 555 Request Form, where he/she can make a request for authorization and/or make a specific request for a specific Role creation and/or modification to the appropriate NEED Mgr. 49 and/or the CAA 48.

If the answer to the query 1364 is “yes” the CAA (or the Account user) is passed to a query 1376 that asks if he/she wants to “Create (or) Modify?” a particular role. If the answer to query 1376 is “Modify”, the user is passed to a “Modify” 1372 module with the functionality appropriate to the particular user's current role and permissions.

If the answer to the query 1376 is instead “Create”, the user is passed to a “Create Role(s) 1377 module where, among other functions, such as select a new role to create, the user is ultimately asked if he/she will utilize the default settings for the particular Role he/she is requesting be created in a “Defaults?” 1378 query. If the answer to query 1378 is “yes”, as in utilize the “default settings”, the user is then passed to another query 1374 which asks if the user is “Done?” creating and/or modifying.

If the answer to query 1378 is instead “no”, as in do not use the default Role setting, the user is then sent to a “Modify” 1372 module to make the desired and appropriate modifications that his/her current role and permissions will allow to be executed or requested. After the user has made the modifications in module 1372, he/she can acknowledge that he/she is finished in the query 1374. If the answer to query 1374 is “no”, as in the user wishes to make more changes, he/she is then directed back to step 1358 “Account Management” (109) module.

From the “Account Management” (109) module, the user can also select the “Permission(s) Management” 1362 module option. A query 1366 asks if the Account user is an “Authorized?” role with the appropriate permissions for creating and/or modifying permissions. If the answer to the query 1366 is “no”, the Account user is sent to a terminator 555 Request Form, where he/she can make a request for authorization and/or request a specific permission modification to the appropriate NEED Mgr. 49 and/or the CAA 48.

If the answer to the query 1366 is “yes” the user is passed to a query 1368 that asks if he/she wants to see a list of pending permission requests or make permission modifications in a “Requests (or) Modify?” 1368 query. If the answer to query 1368 is “Modify”, the user is passed to the “Modify” 1372 module with the functionality appropriate to the particular user's current role and permissions.

Modifying permissions can include, but is not limited to requesting, approving, and/or executing modifications to one's own permissions and/or someone else's permissions. For example, a particular NEED Mgr could be presented with a list of pending permission request forms from a list of fellow Account members with subordinate roles who are requesting approval for the modifications.

If the answer to the query 1368 is instead view “Requests”, the user is passed to a “Approve Requests” 1370 module where the user is then shown a list of permission requests for that particular user, among other functions, may annotate, deny, delay for a particular action, delay for a particular event, delay for a particular confirmation/validation, delay for a particular accomplishment, delay for a particular amount of time, ignore, and/or approve each submitted permission request.

Some functions, such as approval, may also require other Account member approvals to become finalized. Some functions, such as delay for a particular accomplishment, could allow the Account user with the approving role the ability to quantify what the subordinate user needs to accomplish.

For example, the subordinate user making the request may be required to acquire a certain number of new Applicants 72 for a particular PAC 104 before obtaining the permissions (with its associated privileges) being requested. Another example could be where the approving role manger requires the subordinate user making the request to complete a survey and/or validate credentials before obtaining the permissions being requested.

If the approving role manager in module 1370 wants to modify the privileges associated with a permission request, he/she is then sent to the “Modify” 1372 module, where conditions can also be made and/or added. For example, the permission request could be conditionally approved with restrictions and/or limitations that are permit and/or that can be conditionally removed.

If the approving role manager in module 1370 or in the “Modify” 1372 is finished viewing, approving, and/or making modifications, he/she is then passed to the query 1374 which asks if the user is completely “Done?”

If the answer to query 1374 is instead “no”, as in the user wishes to make more changes he/she is directed back to step 1358 “Account Management” (109) module. If the user answers “yes” to the query 1374, the matter is sent to a “More Approvals Required” 1380 that asks if the matter has sufficient authorizations to be executed?

If the answer to query 1380 is “yes”, where the matter has insufficient authorization, then the matter is forwarded to the “Take appropriate steps and make appropriate notifications” 1346. Here the remaining steps, instructions, and requirements required to move things forward and/or get to the final execution are preformed. For example, approval may be required of more NEED Mgrs 49 and/or the CAA 48 to execute the creation and/or modification pending/requested. The information/notification is also forwarded to the CAA 48 whether or not his/her authorization is required for execution.

If on the other hand, the answer to query 1380 is “no”, where the matter has sufficient authorization, then the matter is forwarded to an “Execute” 1382 function. From the “Execute” 1382 function, information is passed to a “Notify Appropriate Parties: Accounts/Mgrs/Roles”, where notifications are sent to such parties as those who initiated the Account Request, Role Request, and/or Permission Request; those who invited and/or who has an Affiliate to the Account/Role/Permission.

The specific notification in step 1384 directed to the newly created and/or modified Account and/or Role is generally sent via an electronic format, such as email, sms, and/or similar. The notification will include instructions and a method to link to the HIRES 102 in the “Link to HIRES (102) step 1354. This link connects the Account and/or Role to the HIRES 102 where existing members can login and new members can create his/her own login in the step 1355. Once login is verified, the member obtains use of the Dashboard 108 of the HIRES 102 system with the functionality appropriate to his/her current role and assigned permissions.

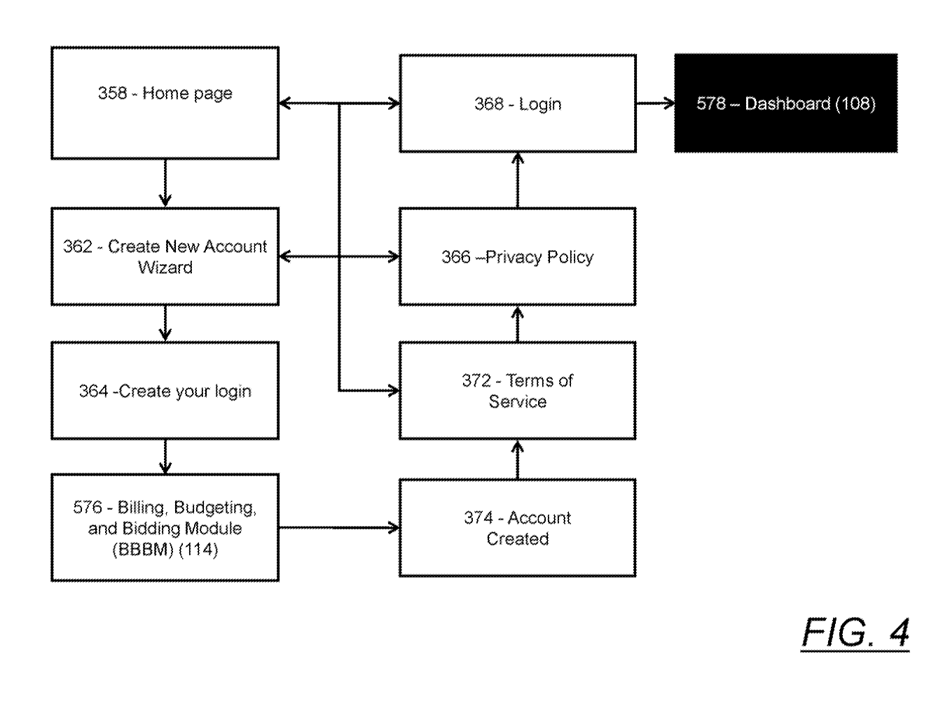

FIG. 4 is a flowchart that depicts the process by which new users can create an Account and become a member in one embodiment. This new user could come to the HIRES 102 system through a variety of methods, including, but not limited to a URL and/or link provided: in an email, a SMS/MMS message, via an Affiliate, via an invitation, in a search result via a Search Engine, in a HIRES 102 generated Campaign 103 (PAC 104 and/or PIN 106), in a third party advertisement and/or the like. The new user could also connect to the HIRES directly via a kiosk, computer, mobile device, and the like that is part of a public and/or private LAN, WAN, WIFI, Wi-MAX and/or mobile network. The new user could be referred by an existing CASTING Account, JOINS Account, from an anonymous user, a friend, and/or an associate.

A Home Page 358, a Privacy Policy 366, and a Terms of Service 372 section are accessible while the user remains anonymous and without having an existing account. The Home Page 358 contains a login field for the existing accounts via a Login 368, or the ability to create a new account using a Create New Account Wizard 362 function followed by a Create Your Login 364 function, and a Billing, Budgeting, & Bidding Module (114) in a step 576 (explained more later) to get to a next step of an “Account Created” 374 function. The user in this embodiment become a logged in member and has an Account 60 which now can access, display, and utilize a Dashboard (108) menu in a step 578 with functionality appropriate per his/her role and associated permissions.

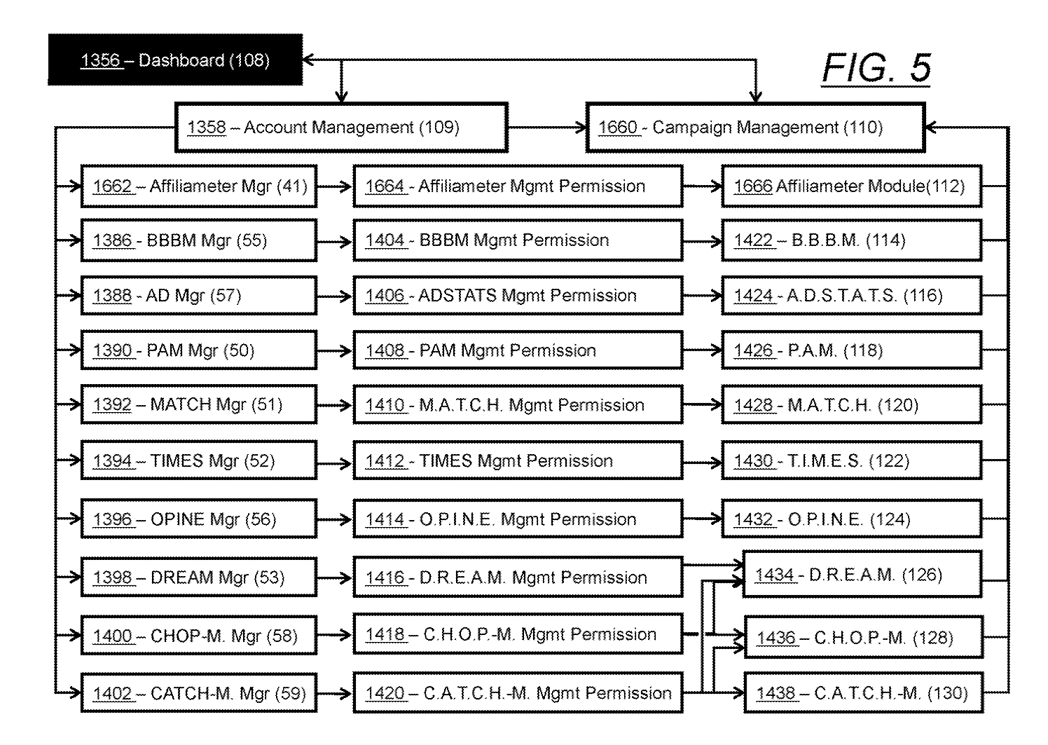

FIG. 5 is a flowchart that depicts the process by which the Accounts 60 can create and/or manage such things as Campaigns, Billing, Budgeting, Bidding, Account Settings and Targeting in one embodiment. From the Dashboard (108) in the previous FIG. 4, the Account 60 can utilized the user interface and move from step 1356 to either an Account Management (109) module 1358 or a Campaign Management 110 module 1660. Depending on the roles and permissions of the Account 60 user, he/she can navigate from the Account Management 109 module 1358 to either the Campaign Management (110) 1660 and/or any of the Manager (“MGR”) options from an Affiliameter Mgr (41) 1662 option, a BBBM Mgr (55) 1386 option, an AD mgr (57) 1388 option, a PAM Mgr (50) 1390 option, a MATCH Mgr (51) 1392 option, a TIMES Mgr (52) 1394 option, an OPINE Mgr (56) 1396 option, a DREAM Mgr (53) 1398 option, a CHOP-M. Mgr (58) 1400 option, and/or a CATCH-M. Mgr (59) option.

Depending on the roles and permissions of the Account 60 user, he/she can either request permission to perform a function limited to a particular NEED MGR from the necessary NEED MGR and/or others who can grant such permissions and/or roles; request the role of a particular NEED MGR and thus obtain the associated permissions and/or request the ability to view some particular content normally reserved to a particular NEED MGR, again from the necessary NEED MGR and/or others who can grant such permissions and/or roles, such as a higher ranking role, NEED MGR, Account 60 Administrator, and/or CAA.

If the Account 60 user has the proper management (“Mgmt”) permissions depicted in an Affiliameter Mgmt Permission 1664, a BBBM Mgmt Permission 1404, an ADSTATS Mgmt Permission 1406, a PAM Mgmt Permission 1408, a MATCH Mgmt Permission 1410, a TIMES Mgmt Permission 1412, an OPINE Mgmt Permission 1414, a DREAM Mgmt Permission 1416, a CHOP-M. Mgmt Permission 1418, and/or a CATCH-M. Mgmt Permission 1420; then he/she can obtain and utilize the functionality assigned and/or associated for that particular module.

Those modules with the assigned and/or associated functionality for the Account 60 user with the proper management (“Mgmt”) permissions are depicted in the following steps as an Affiliameter Module (112) 1666 step, a BBBM (114) 1422 step, an ADSTATS (116) step, a PAM (118) 1426 step, a MATCH (120) 1428 step, a TIMES (122) 1430 step, an OPINE (124) 1432 step, a DREAM (126) 1434 step, a CHOP-M. (128) 1436 step, and/or a CATCH-M. (130) 1438 step; where he/she can then obtain and utilize the functionality assigned and/or associated that particular module.

With the proper permissions, the Account 60 user can also obtain the associated functionality utilizing other modules, such as the Campaign Management 110 module. If a specific Campaign 103 has been specified already by the Account 60, the Campaign Management 110 module allows the Account 60 to determine if the Campaign 103 will utilize functionality from the Affiliameter Module 112, the BBBM 114, the ADSTATS 116, the PAM 118, the MATCH 120, the TIMES 122, the OPINE 124, the DREAM 126, the CHOP-M. 128, and/or the CATCH-M. 130 modules (each explained in detail later).

For example, the Account 60 user can go directly to the Campaign Management 110 module in step 1660 and create, edit, manage and/or view elements and content if they already have proper roles and/or permissions. In addition, the Account 60 user can go directly to the Campaign Management 110 create or edit elements without first attaching these elements to a specific Job Post Campaign, or a specific Ad Targeting Campaign, which can be done later.

The BBBM 114 allows the Accounts 60 to manage their own accounting, as well as the billing to other Accounts. As a condition for allowing the Account 60 access to another Account's data, Campaigns, and/or content such as Job Descriptions, Job Categories, Job Criteria, Job Interviewing Process and the like, the SEARCH 100 Administrator and/or a specific Account 60 Administrator can require and/or set financial consideration and/or budget constraints to other Accounts. An Account's 60 Administrator with the broadest privileges or permissions for that specific Account will be referred to as a Super Administrator. A SEARCH Administrator is the Administrator over all Accounts, including all the Super Administrators, CASTING Account Administrators (CAAs) 48, all CASTING Account users, Managers, and all JOINS Account users.

For example, the CASTING Account Administrator 48 may setup specific financial consideration with specific thresholds in dollar amounts, times, and/or tolerance settings for other Accounts to interact with his/her account's data. In addition, there could be specific thresholds in contents, roles, times, etc. related to Campaigns 103 and/or with specifically set flat fees for a given period of time, a given quantity of inventory, a fixed amount per Campaign 103 or Advertisement, a fixed amount per Action taken, variable amounts based on rules (explained later), impression-based for action taken, and/or some combination (e.g., cost per thousand impression, or CPM), cost-per-click (CPC), cost-per-action (CPA), and/or other segmentation rule-based (explained in more detail below) pricing approach. In an embodiment, the Account budget for allowing other Accounts access can be resolved before forwarding any Campaigns 103 to become an active PAC 104 or P.I.N. 106. The SEARCH 100 can manage any and all fees, including real-time and near real-time auction bids for inventory or specifically targeted segments, invoicing and collections

The ADSTATS 134 module (“Applicant Data & Skills Tied to Advertising Targeting System”) allows the Accounts 60 to target advertising to a particular segmentation element, category and/or group of elements. These segmentation elements can also have rules associated with them independent of a particular Campaign 103 or linked specifically for a particular Campaign. Segmentation can be relative to several elements such as a Job Post, Job Category, Job Position, Company, Geography, Demographics, Psychographics, Behavioral, Contextual, Mood, etc.; can be relative to time, such as the time of day, day of week, etc.; can be relative a budget, such as a monetary constraint per Campaign, per action taken by the user, per result of a particular action such as a Click, Conversion or Page View, etc.; and/or some combination of these elements and incorporating rules, such as Boolean operator rules (and, or, not, etc.), weighting, prioritizing, sequencing, etc. and will be explained in more detail later.

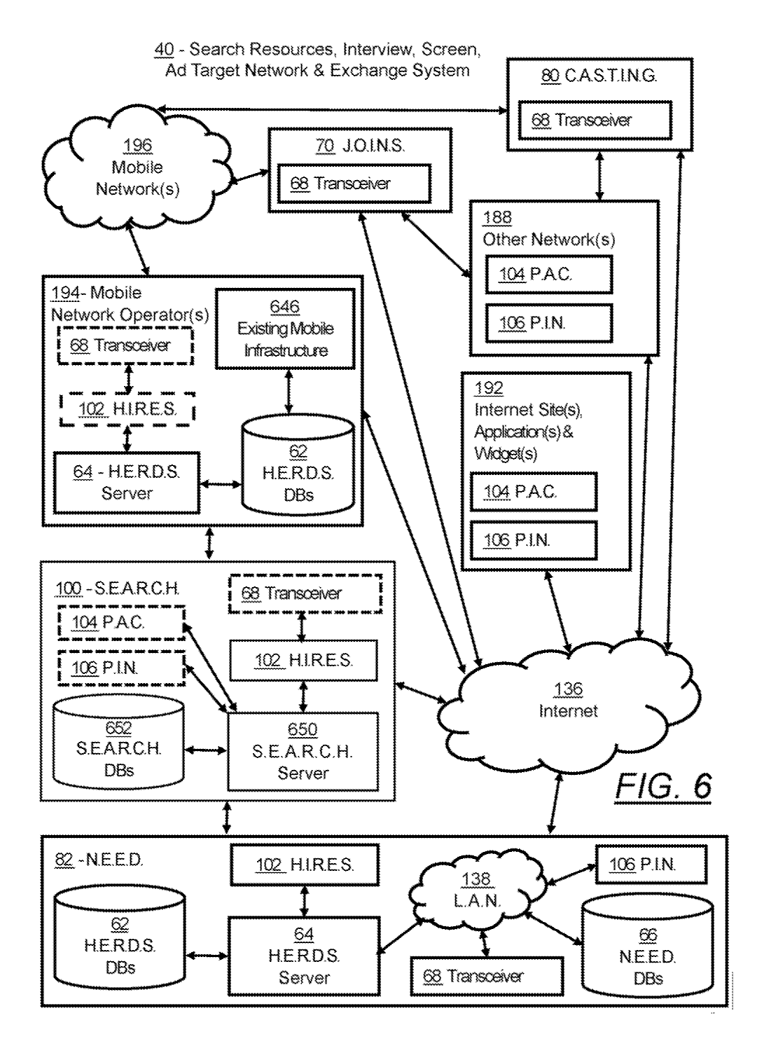

FIG. 6 is a block diagram depicting an embodiment of the groupings of sub-systems of the “Search Resources, Interview, Screen, Ad Target Network & Exchange System” 40 and the communications among them. The SEARCH 100 is the central hub for users to utilize the HIRES 102. The HIRES 102 is the software application that allows users via the Transceiver 68 (such as a computer) to create, modify, monitor, track, report, ad target, and manage content and resources.

Content can include, but is not limited to text, “Short Message Service (hereinafter “SMS”), audio, images, video, text to speech, speech to text, graphics, animation, avatars, charts, polls, advertising, promotional materials, (such as marketing materials, Lifecycle Management (hereinafter “LCM”) data, Customer Relationship Management (hereinafter “CRM”)data, job descriptions, hiring criteria, testing structure and systems, assessments (such as voice recognition assessments, arousal (lie-detector) assessment, body language assessment, Peer review, Expert review), demographic data, psychographic data, user profile data, contact information, email history/usage, temporal information (schedules, calendars, task lists, appointments, interviews), feedback, “Frequently Asked Questions” (hereinafter “FAQs”), search results, rankings, processes, know-how, and the like.

Resources can include, but is not limited to humans (such as employees, contractors, licensed professionals, instructors, and the like), machines, computers, software, time, materials, money, credit, and the like. The content, resources, and any instructions, such as data, tables, source code, software, schema, business logic, algorithms, and algorithm rules, regarding such decision as when, where, and how the content should interact, calculate, generate, and be displayed can all be stored in a SEARCH DB 652 and sent to a SEARCH Server 650 which is also synchronized with other NEEDs and third-party databases/sources.

The SEARCH is connected to an Internet 136 which in turn allows for connections to the NEED 82, an “Internet Site(s), Application(s) and Widget(s)” 192, an “Other Network(s) 188, the JOINs 70, the CASTING 80, and a Mobile Network Operator(s) 194. The SEARCH 100 can also connect directly to the Mobile Network Operator(s) 194 and the NEED 82 via some sort of means adequate and designated as a communication line other than the Internet 136.

The NEED 82 can include a HERDS DBs 62 that is connected to a HERDS Server 64 which contains and/or supplies the HIRES 102 system that is accessible to connected users with his/her Transceiver 68 (such as a computer) that are connected to a L.A.N. 138 (or similar). The NEED 82 can connect a NEED DBs 66 to allow interaction with existing entity databases with relevant content and resources that can be synchronized as needed to stay relatively current and/or can draw data from the past, such as, job postings, job descriptions, hiring criteria, interviews conducted, employee records, department budgeting, and the like.

Campaigns, such as Job Postings can be pushed out to the PAC 104 located at such places as the “Internet Site(s), Application(s) and Widget(s)” 192 or the Campaigns 103 can be maintained internally and not made available to the public using a “Private Invitation and/or Need” 106 Campaign 103 (hereinafter “P.I.N.”) 106. Generally, the P.I.N. 106 would require a password, Pin code, biometric ID, and/or similar ID to secure the access to the Campaign, Invitation, and/or Content.

The Mobile Network Operator(s) 194 comprises of an Existing Mobile Infrastructure 646 and similar to the NEED 82, can also have the HERDS DBs 62 and HERDS Server 64. The Mobile Network Operator 194 can also utilize the HIRES 102 system internally and/or utilize the HIRES 102 located in the SEARCH 100, by connecting via the Internet 136; and/or connect directly. The Mobile Network Operator(s) can send Campaigns 103 to the JOINS 70 and the CASTING 80 users to display on his/her transceiver 68, which in this instance could be a cellular phone, via the Mobile Network Operator(s) 196, such as via traditional cellular transmissions utilized for GSM, CDMA, TDMA, 3G, 4G, and the like.

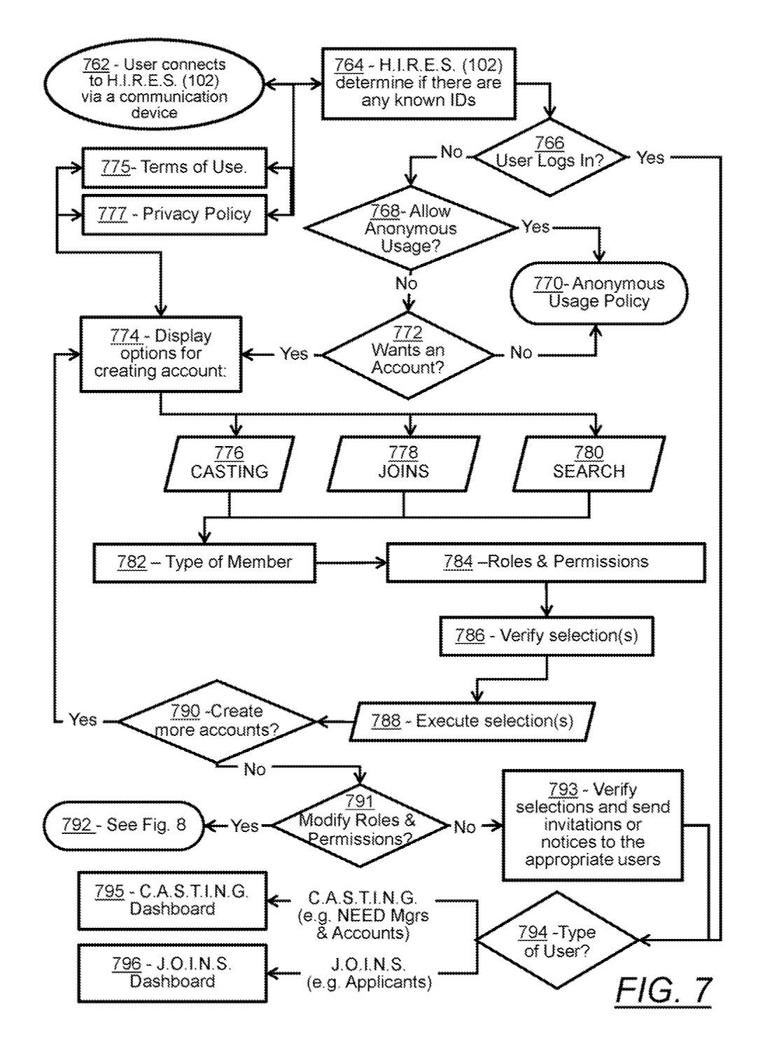

FIG. 7 is a flowchart depicting an embodiment of a user creating an Account using the HIRES 102. Starting with a step 762 where a “User connects to HIRES (102) via a communication device”, where he/she can view the Terms of Use in a step 775 “Terms of Use” or the Privacy Policy in a step 777 “Privacy Policy”.

In a step 764 a “HIRES (102) determines if there are any known IDs” for the user. When the user first comes to HIRES 102 a unique session ID is created and stored at least until the user disconnects, creates an account, or logins, and/or possibly beyond. This allows for anonymous usage while still retaining essential data for the user and allowing for relative efficient functionality. In addition, the HIRES system can maintain tracking cookies per communication device, per IP address, and/or per user depending on what is known, what can be retained, and the permissions and roles of the user.

A query 766 asks if a “User Logs in?” If the answer is “yes” to query 766 the user jumps to a query 794 which ask a “Type of User?” If the answer to query 766 is instead “no”, the user passes to a query 768 which asks if the HIRES (102) and/or NEED has been setup to “Allow Anonymous Usage?” If the answer to query 768 is “yes” the user receives a 770 terminator with an “Anonymous Usage Policy”. If the answer to query 768 is “No” then the user is sent to a query 772 which asks the user if he/she “Wants an Account?”

If the user decides the answer to query 772 is “no”, then the user receives the 774 terminator with the “Anonymous Usage Policy”, which in this instance may read differently than the policy reading that was presented to the user who came in from query 772. If the answer to query 772 is “yes”, where the user wants an account, the user is passed to a step 774 that “Displays options for creating (an) account.”

From step 774, the user has the options to create different account types, starting with a CASTING account 776 option, a JOINS account 778 option, and a SEARCH account 780 option (the differences of each account option: CASTING, JOINS, and SEARCH are all explained in more detail throughout specification). After the user makes his/her account selection and enters any requested information that may be required, he/she advances to a step 782 with a “Type of Member” where he/she can selected or may be required to designate a particular membership type and/or role, such as selecting a specific NEED type Account MGR. From step 782, the user passes to a step 784 where a “Roles and Permissions” allows the user to review and/or modify an existing role and/or Permission; and/or request to review, create, add and/or modify additional Roles and Permissions.

In a step 786 the user “Verifies selection(s)” and a step 788 “Executes selection(s)” along with any default setting associated with the type of Account 60, member, role and/or permissions. A query 790 ask whether the user wants to “Create more accounts?” for such people as co-workers, company subordinates, employees, work associates, friends, family, recruiters, employment verifiers, and the like.

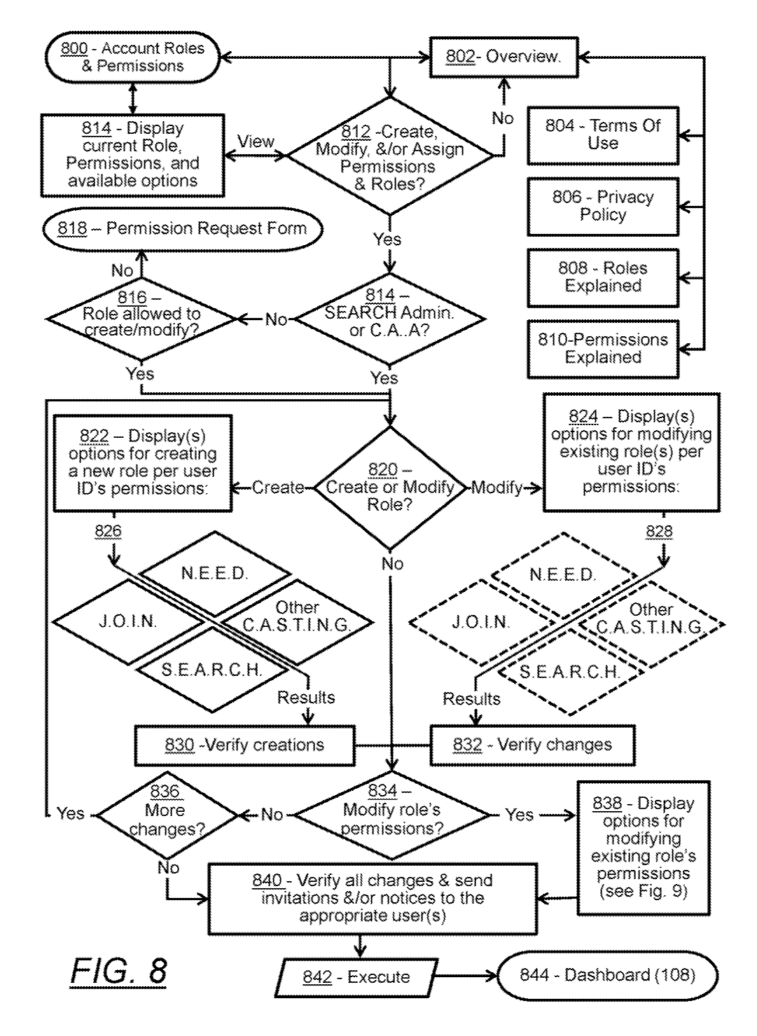

If the answer to query 790 is “yes”, the user is routed back to step 774. If the answer to query 790 is “no” the user is passed to a query 791 that asks if the user wants to “Modify Roles & Permissions?” If the answer to query 791 is “yes” the user is passed to a terminator 792 “See FIG. 8”, which explains more of details and functionality on setting up roles and permissions.

If the answer to query 791 is instead “no”, then the user is passed to a step 793 that “Verifies selections and send invitations or notices to the appropriate users”. The system then tracks which invitations get accepted and when. This information can be reported back to a particular user who may have, say a designated role of monitoring new members, roles, permissions, a particular employee, members from a particular department, and/or a members actual system participation and/or usage.

A query 794 asks what “Type of User?” is currently logged in. If the answer to query 794 is that the user is the CASTING Account user type then the user gets passed to a 795 terminator which is the “CASTING Dashboard” with the functionality appropriate to that type of Account, membership, user's role and permission settings.

If the answer to query 794 is that the user is a JOINS (such as a “Job Seeker”) then the user is passed to a 796 terminator which is the “JOINS Dashboard” with the functionality appropriate to that type of Account, membership, user's role, and permission settings. There could also be other types of accounts such as a SEARCH Account user type, which is not shown, but would obtain the functionality appropriate to that type of Account, membership, user's role, and permission settings.

FIG. 8 is a flowchart depicting an embodiment where the user is creating and modifying account 60 roles and permissions. Starting with a step 800 “Account Roles and Permissions” where the user is already connected to HIRES (102) via a communication device, he/she can “Display current Role, Permissions, and available options” in a step 814.

The user can also go to a step 802 “Overview” which provides more detailed information in a step 804 for the “Terms of Use”, a step 806 for the Privacy Policy”, a step 808 “Roles Explained”, and a step 810 “Permissions Explained”.

A query 812 asks whether the user wants to “Create, Modify, and/or Assign Permissions and Roles?” If the answer to query 812 is “no”, the user is routed back to step 802 “Overview”. If the answer to query 812 is “yes” the system determines in a query 814 whether the user is a “SEARCH Admin. or C.A.A.?” and/or the like with sufficiently broad privileges.

If the answer to query 814 is “yes” then the user, who is either a SEARCH Admin. or C.A.A., is passed to a step 820 “Create or Modify Role?” If the answer to query 814 is “no” then the user, who is neither the SEARCH nor the CASTING/Super Administrator and is passed to a query 816 which asks if the “Role (is) allowed to create/modify?” If the answer to query 816 is “yes”, the user is also passed to the step 820. If the answer to query 816 is “no” the user is passed to a terminator 818 which is a “Permission Request Form”, where the user can request the ability to change his/her role, and/or for someone else to change his/her role. This request would be passed to the appropriate role or roles for determination(s), generally a manager and/or Super Administrator.

For those user's with the proper roles and permissions back at query 820 “Create or Modify Role?”, he/she can select to create a new role and get passed to a step 822 which “Display(s) options for creating a new role based on user ID's permissions:”. His or her permissions allow them to create a new role in a section 826 with the choices of N.E.E.D, J.O.I.N.S., C.A.S.T.I.N.G., and S.E.A.R.C.H. The results of section 826 get passed to a step 830 which “Verifies (the) creations”. From there the user gets passed to a query 834 which asks if the user wants to “Modify role's permissions?”

Back at query 820, the user also has the option to “modify” an existing role and then gets passed to a step 824 which “Display(s) options for modifying existing role(s) per user ID's permissions:”. His or her permissions allow them to modify an existing role in a section 828 with the appropriate choices of N.E.E.D., J.O.I.N.S., C.A.S.T.I.N.G., and S.E.A.R.C.H. The results of the section 828 get passed to a step 832 which “Verifies (the) changes”. From there the user gets passed to the query 834 which asks if the user wants to “Modify role's permissions?”

If the answer to query 834 is “no” the user gets passed to a query 836 that asks if the user has “More Changes?” to make. If the answer to query 836 is “yes” then the user is passed back to the query 820 “Create or Modify Roles?”. If the answer to query 836 is “no” then the user gets passed to a step 840 which “Verifies all changes and sends invitations and/or notices to the appropriate user(s)”.

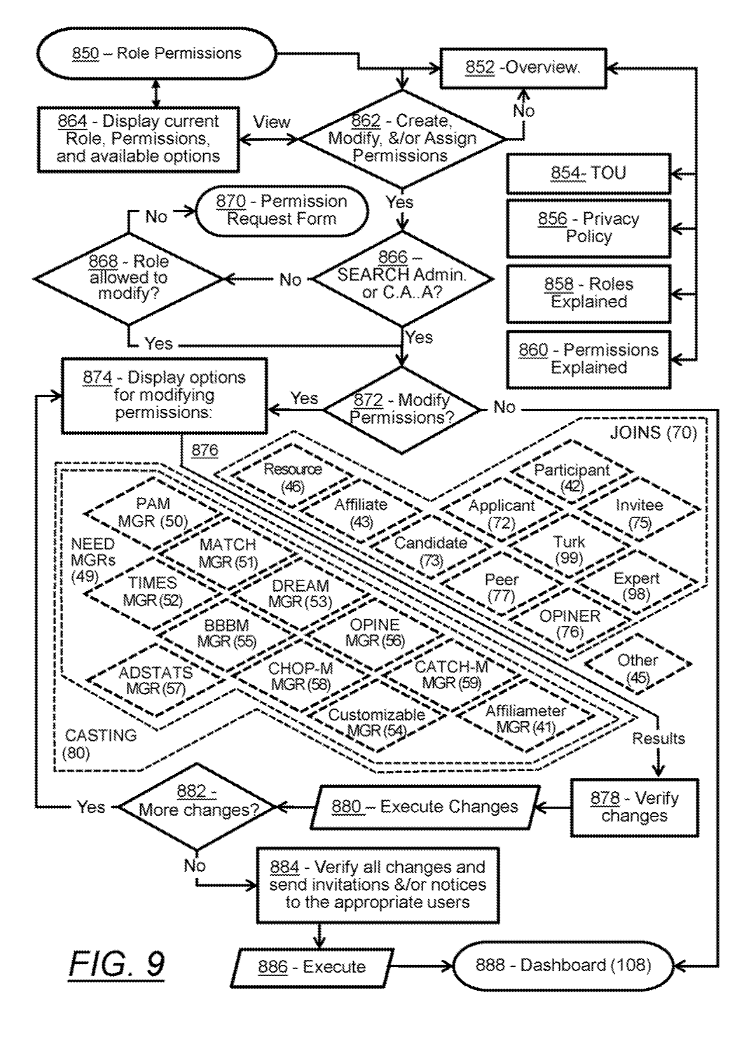

If the answer back at query 834 had been “yes” to “Modify role's permissions?” then the user would be passed to a step 838 which “Displays options for modifying (an) existing role's permissions (see FIG. 9)”. From step 838, the user gets passed to the step 840 which “Verifies all changes and sends invitations and/or notices to the appropriate user(s)”. From step 840, the user is passed to an execution 842 to “execute” before passing on to a terminator 844 back to the Dashboard (108).

FIG. 9 is a flowchart depicting an embodiment where the user creating and modifying Account 60 role's permissions. Starting with a step 850 “Role Permissions” where the user is already connected to HIRES (102) via a communication device, he/she can utilize a “Display current Role, Permissions, and available options” in a step 864.

The user can also go to a step 852 “Overview” which provides more detailed information in a step 854 for the “Terms of Use”, a step 856 for the Privacy Policy”, a step 858 “Roles Explained”, and a step 860 “Permissions Explained”.

A query 862 asks whether the user wants to “Create, Modify, and/or Assign Permissions?” If the answer to query 862 is “no”, the user is routed back to step 852 “Overview”. If the answer to query 862 is “yes” the system determines in a query 866 whether the user is a “SEARCH or CAA?” and/or the like, with sufficiently broad privileges.

If the answer to query 864 is “yes” then the user who is either a SEARCH or CAA and/or the like with sufficiently broad privileges, who is passed to a step 872 “Modify Permissions?” If the answer to query 866 is “no” then the user, who is neither the SEARCH nor the CASTING Account Administrator 48 is passed to a query 868 which asks if the “Role (is) allowed to modify?” If the answer to query 868 is “yes”, the user is also passed to the step 872. If the answer to query 868 is “no” the user is passed to a terminator 870 which is a “Permission Request Form”, where the user can request the ability to change his/her role, and/or for someone else to change his/her role. This request would be passed to the appropriate role or roles for determination(s), generally a manager and/or CASTING Account Administrator 48.

For those user's with the proper roles and permissions back at query 872 “Modify Permissions?”, who select modify, get passed to a step 874 which “Display(s) options for modifying permissions:”. His or her current permission setting determine what changes he/she is allowed to make in a section 876 with the choices of a CASTING 80 subset of: a NEED MGR 49 subset of: a PAM MGR 50, a MATCH MGR 51, a TIMES MGR 52, a DREAM MGR 53, a BBBM MGR 55, an OPINE MGR 56, an ADSTATS MGR 57 a CHOP-M MGR 58, a CATCH-M MGR 59, a Customizable MGR 54, and/or an Affiliameter MGR 41; or choices of a JOINS 70 subset of: a Participant 42, an Affiliate 43, a Resource 46, an Applicant 72, a Candidate 73, an Invitee 75, an OPINER 76, a Peer 77, an Expert 98, and/or a Turk 99; and/or an Other 45 (catch all) option. The Results of section 876 get passed to a step 878 which “Verifies (the) changes”.

From there the user gets passed to an execution 880 to “execute changes” before passing on to a query 882 that asks if the user has “More Changes?” to make. If the answer to query 882 is “yes” then the user is passed back to the step 874 “Display(s) options for modifying permissions:”. If the answer to query 882 is “no” then the user gets passed to a step 884 which “Verifies all changes and sends invitations and/or notices to the appropriate user(s)”. From step 884, the user is passed to an execution 886 to “execute” before passing on to a terminator 888 back to the Dashboard (108).

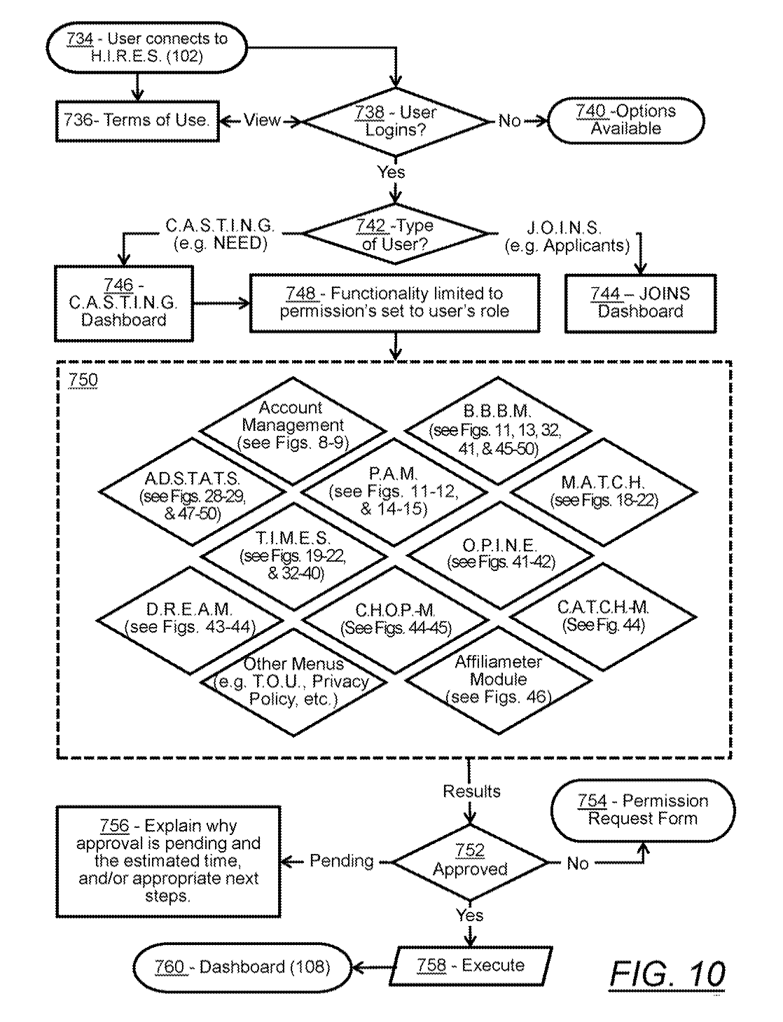

FIG. 10 is a flowchart depicting an embodiment of the functionality available to users connected to the HIRES 102. Starting with a step 734 where a “User connects to HIRES (102)”, where he/she can view the Terms of Use in a step 736 “Terms of Use” or after logging in with a step 738. If the answer to the query in 738 “User Logins?” is “no”, a terminator 740 provides “Options Available”.

If the answer to query 738 is “yes”, next is a query 742 for the “Type of User?”. If the user is a JOINS (or Job Seeker(s)) then the user is sent to a step 744 “JOINS Dashboard”. If on the other hand, the user is a CASTING account then the user is sent to a step 746 CASTING Dashboard, where a Step 748 provides the user “Functionality limited to permission's set to user's role”.

From step 748 the user has access to typically all the functionality outline in a section 750 where the associated figures numbers that explains that module's functionality in more detail are listed. The “Results” of the user functionality and usage are sent to a query 752 “Approved?”, where it determines if the selected functionality and related results have been ‘approved” for the user. If the answer to the query is “no” then a terminator 754 provides a “permission request form”. If the answer to query 752 is “pending” then a step 756 “Explains why approval is pending and the estimated time, and/or appropriate next steps”. If the answer to query 752 is “yes” then an “Execute” 758 step is taken and the user is sent back to the Dashboard 108 at a terminator 760.

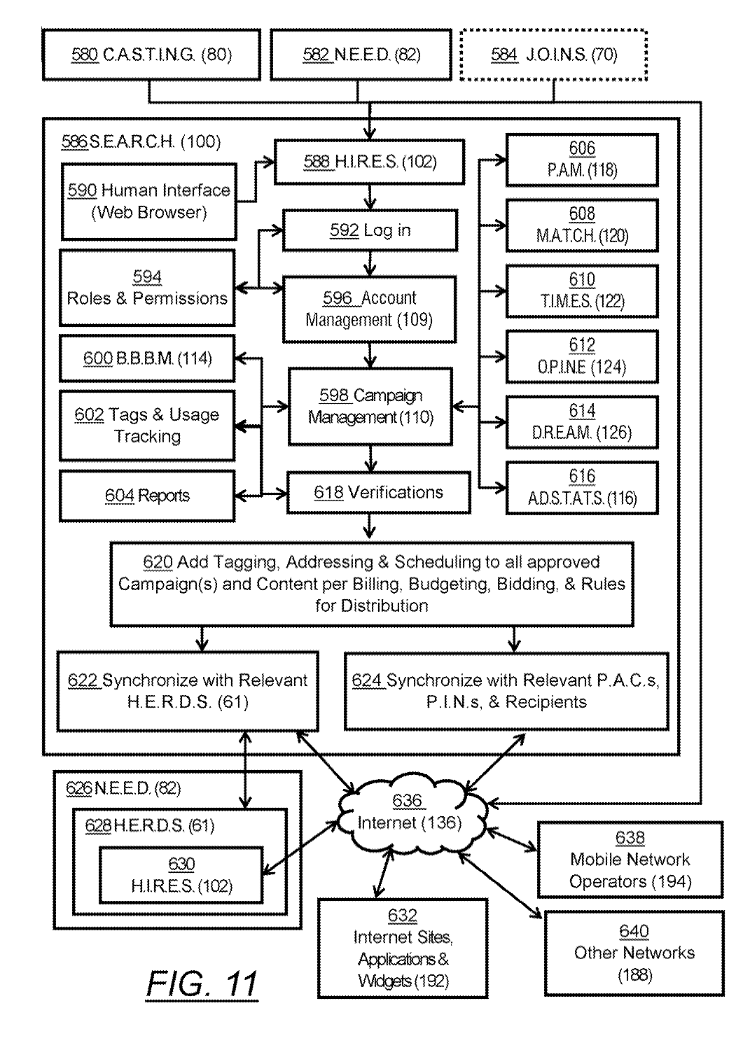

FIG. 11 is a flowchart on an embodiment that depicts an example of the SEARCH 100 system in more detail. In a step 580 CASTING (80), a step 582 NEED (82), and a step 584 JOINS (70) each user type can connect to the SEARCH 100 in step 586 via a step 588 by connecting to the HIRES 102. The HIRES 102 pulls a Human Interface (Web Browser) in step 590 which allows the user to login in a step 592. An Account Management module 109 is resourced in step 594 and an appropriate Roles and Permissions are pushed in step 596.

Next the user can create or manage an existing Campaign 103 in a step 598 Campaigns. Depending on the user's roles and permissions (explained throughout) he/she can utilized a step 600 B.B.B.M. 114, a step 602 Tags and Usage Tracking, a step 604 Reports, a step 606 P.A.M. 118, a step 608 M.A.T.C.H. 120, a step 610 T.I.M.E.S. 122, a step 612 OPINE 124, a step 614 D.R.E.A.M. 126, and/or a step 616 A.D.S.T.A.T.S. 134 (more details further ahead) to create or manage Campaigns 103.

When the user is done with the Campaign Management in a step 598, he/she verifies and executes the completion in a step 618 Verifications. Next a step 620 where an “Add Tagging, Addressing & Scheduling to all approved Campaign(s) and Content per Billing, Budgeting, Bidding, & Rules for Distribution” is executed and the appropriate elements either get pushed to a step 622 Synchronized with Relevant HERDS 61 or a Step 624 Synchronize with Relevant P.A.C.s., P.I.N.s and Recipients.

From step 622 the appropriate elements get pushed out to either the NEED 82 in step 626 or the Internet 136 in a step 636. Either direction, the elements get synchronized with the elements already within the NEED's 82 HERDS 61 in a step 630. From the step 624 the appropriate elements also get pushed out to the Internet 136 in the step 636. From there the appropriate elements get propagated and synchronized with the Internet Site(s), Application(s) and Widget(s) (192) in a step 632, to the Mobile Network Operator(s) (194) in a step 638 and to the Other Network(s) (188) in a step 640.

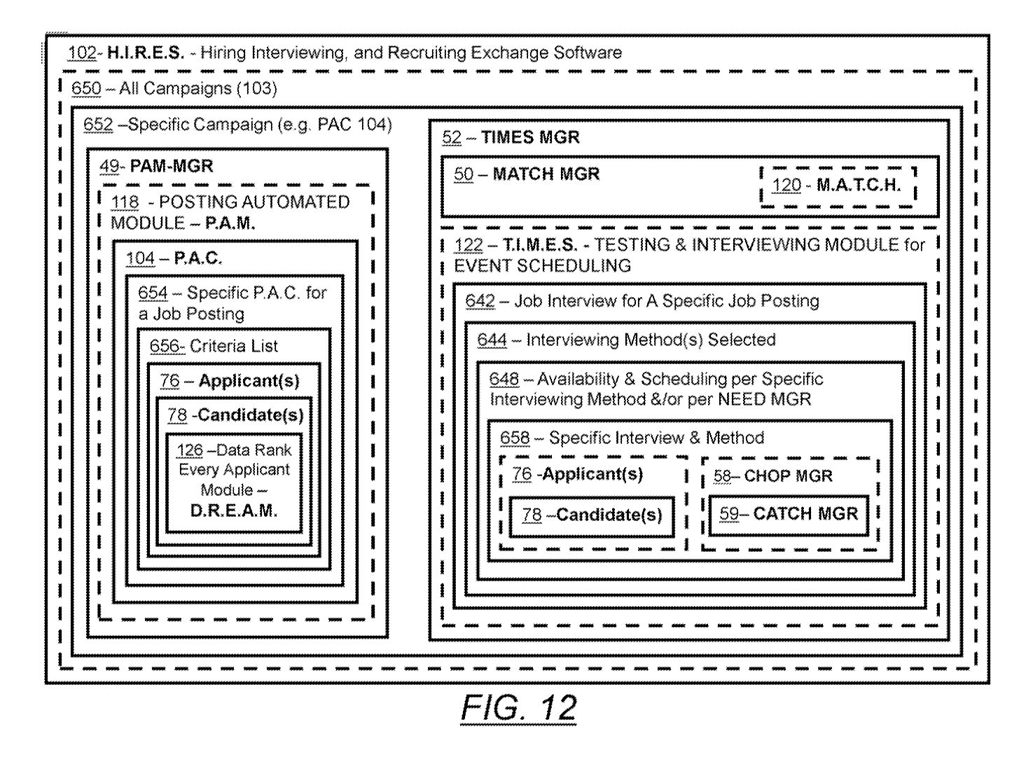

FIG. 12 is block diagram of an embodiment depicting an instance of the relationship between the different elements and modules within. Starting with the H.I.R.E.S. 102 Hiring, Interviewing, and Recruiting Exchange Software system, a user can create, modify and/or review All Campaigns (103) depicted with a delineation 650. Within All Campaigns the user can navigate to and enter a Specific Campaign (e.g. PAC 104) depicted with a delineation 652.

From 652 and depending on roles and permission the user possesses, he/she can either conditionally navigate and enter areas/modules and/or obtain functionality as a PAM MGR 49 and/or as a TIMES MGR 52. As the PAM MGR 49, he/she can invoke the Posting Automated Module 118, where the system has rules and conditions for posting content relevant to a particular Campaign and/or the like. The PAM MGR 49 can navigate to and enter a particular PAC 104 with a Specific PAC for a Job Posting 654 and create, modify, and/or review a Criteria List 656.

The Criteria List 656 can contain information about an Applicant(s) 76 and the Applicant(s) 76 for the Specific PAC for a Job Posting 654 can contain information regarding a Candidate(s) 78 and any associated data in a DREAM 126 (Data Rank Every Applicant Module).

Back to the Specific Campaign 654 delineation, where if the TIMES MGR 52 also has MATCH roles and permissions, he/she may enter a MATCH MGR 50 to utilize a MATCH 120 module.

As a user with TIMES MGR 52 roles and permission, he/she can navigate to and enter a TIMES 122 (Testing & Interviewing Module for Event Scheduling) module. From module 122, the TIMES MGR 52 can create, modify, and/or review a Job Interview for A Specific Job Posting 642 and from 642, the user with the appropriate role and permissions can create, modify, and/or review an Interviewing Method(s) Selected 644 and from 644, he/she can create, modify, and/or review an “Availability & Scheduling per Specific Interviewing Method and/or NEED MGR” 648.

From 648, he/she can create, modify, and/or review a Specific Interview & Method 658, and from 658, he/she can create, modify, and/or review information regarding the Applicant(s) 76 and/or a related sublet of the Candidate(s) 78. If the user has the role and permissions of a CHOP-M MGR 58, he/she can create, modify, and/or review information that the CHOP-M MGR 58 has permission to access and/or if the user has the role and permissions of a CATCH-M MGR 59, he/she can create, modify, and/or review information that the CATCH-M MGR 59 has permission to access.

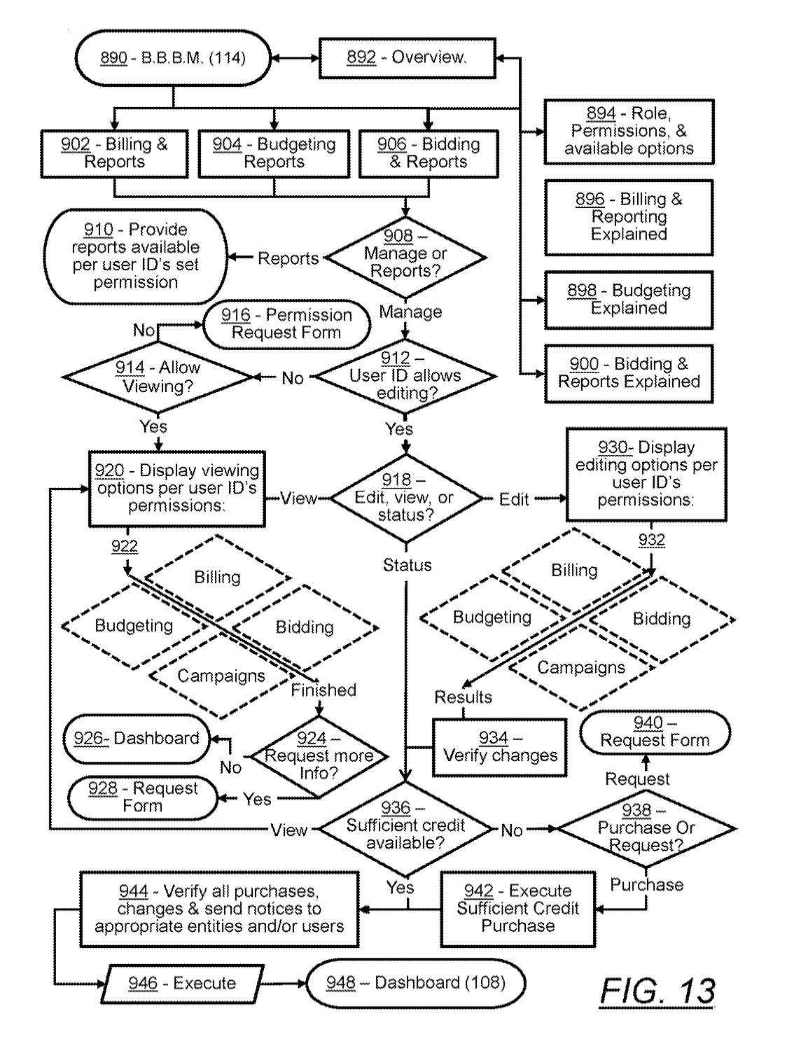

FIG. 13 is a flowchart depicting the user utilizing the Billing, Budgeting and Billing Module (114) in one embodiment. Starting with a step 890 “B.B.B.M.” where the user is already connected to HIRES (102) via a communication device, he/she can go to a step 892 “Overview” which provides more detailed information in a step 894 for “Role, Permissions, and Available Options”, a step 896 for “Billing and Reporting Explained”, a step 898 for “Budgeting Explained”, and a step 900 for “Bidding and Reports Explained”.

From step 890, the user has the option to go to a step 902 for “Billing and Reports” where he/she can view and manage both their Account's 60 Receivables from other Accounts 60 in the system and their Account's 60 Payables to other Accounts 60. This information would include such billing information as historical information regarding when, by whom, and for how long the balance for each particular bill was outstanding.

Another option is a step 904 for “Budgeting and Reports” allows the user to view and manage Account budgeting. For example the user could establish budget constraints for particular user's, user roles, user permissions, periods of time, for particular campaigns, and/or any other element that allows for segmentation and/or delineation.

Another option is a step 906 for “Bidding and Reports” where the user can view and/or manage the bidding process for a particular element of a campaign, such as bid for a particular advertisement to be targeted for a particular audience/users (or segmentation of an audience/users) based upon a set of pre-determined rules, weights, and/or thresholds. For instances, the user could place a bid to run a particular Campaign 103 which is an advertisement, while a particular P.A.C. or P.I.N. is running with a particular job category, with a particular job position, and/or with a particular job criteria, such as a particular software expertise and/or level of expertise.

Another instance could be for a Campaign 103 bid for running a particular P.A.C. or P.I.N. for particular websites, entities, events, locations, times of day, and/or for a particular class of users with particular roles and/or permissions. For instance, bids could compete against other bids strictly within some delineated designation; such as only compete against others from the same particular Account as the bidder; only all Accounts outside the bidder's particular Account; against a particular Account or group of Accounts; All Accounts, and/or the like.

And where bids can incorporate a desired (to what degree) and/or requirements for targeting a segment with temporal requirements, resolution requirements, inventory requirements, rotation requirements, sequence requirements, minimum/maximum requirements, appearance requirements, placement requirements, ranking requirements, and/or the like. In addition these bids can be automatically recalculated for actual usage and performance, where the system could apply preferences to bidders with more measurable success, say in terms of attracting applicants, candidates, hires, page-views, actions/non-actions, click-throughs, purchases/purchasers, and/or the like.

From steps 902, 904, and 906, the user can advance to a query 908 where he/she can “Manage or (go to) Reports?” If the answer to query 908 is “reports” the user is passed to terminator 910 where he/she is “Provide(d) reports available per user ID's set permission”. If the answer to query 908 is “Manage” the user is passed to a query 912 that asks if the “User ID allows editing?”.

If the answer to query 912 is “no” the user is passed to a query 914 which asks if the user is “Allow(ed) viewing?”. If the answer to query 914 is “no” the user is passed to a terminator 916 for a “Permission Request Form”, similar to the examples cited earlier to request permissions from a manager and/or administrator.

If the answer to query 914 “Allow Viewing?” is “yes” then the user is passed to a step 920 where a “Display viewing options per user ID's permissions:” allows the user to advance to a section 922 where the user's role and set permissions allows for the appropriate visibility of Billing, Budgeting, Billing, and Campaigns. When finished with the section 922, the user advances to a query 924 where he/she is asked “Request more information?”

If the answer to query 924 is “no” the user is passed to a terminator 926 and back to the Dashboard. If the answer to query 924 is “yes” the user is passed to a terminator 928 where he/she can request more information with a “Request Form”.

If answer back at query 918 was “edit” the user is passed to a step 930 where it “Display(s) editing options per user ID's permissions:” and allows the user to advance to a section 932 where the user's role and set permissions allows for the appropriate editing capabilities of Billing, Budgeting, Billing, and Campaigns. When finished with the section 932, the user advances to a step 934 where the user “Verifies Changes”.

From step 934, the user is passed to a query 936 which asks if the user's account has “Sufficient credit available?”. If the answer to query 936 is “no” the user is passed to a query 938 where it asks if the user wants to “Purchase or Request?” credit. If the answer to query 938 is “request” the user is passed to a terminator 940 “Request form” where he or she can request more credit and/or some modification to the Account's credit.

If the answer to query 938 is “purchase” more credit, the user is passed to a step 942 where the user can “Execute Sufficient Credit Purchase”. This option could also allow the user to buy credit beyond what is currently required and/or offer discounts, time limits, and/or incentives. From step 942 the user is passed to a step 944, along with the users who answered “yes” to query 936 “Sufficient credit available?”.

The step 944 “Verifies all purchases, changes, and send(s) notices to appropriate entities and/or users. Some of these notifications can be selected by the user and some notifications may be preset for and/or by a particular account, a particular role, a particular user, and/or some other segmentation, user segmentation, and/or delineation, such as a particular Campaign 103 requested alert of a particular bid, such as a dollar amount and/or the first bid. From step 944 the user gets passed to an execution 946 to “execute” step 944 and then the user is passed to a terminator 948 which sends the user back to the Dashboard (108).

A key initially for the H.I.R.E.S. 102 System is to populate the job database with what are generally assumed to be the most commonly posted job opening and the associated top criteria used within an industry for hiring someone for that specific job opening. This data will be derived from both the PAM-MGRs 50 and Job Applicants.

PAM-MGRs 50 who enters in either new or existing job posts and the job qualifications associated to the specific job posts, along with the specific conditions, elements, and requests. Also from the job Applicants who use the HIRES 102 System to apply for a specific job and/or a job in general, along with the on-going surveys and qualification questions asked of Applicants along the way. The survey questions and data collected from Applicants will be used to qualify a particular job Applicant and in turn, will further the data collected for analysis.

This on-going data that get's collected can also be routinely pulled, integrated, and analyzed from existing job databases, such as Craigslist.com®, Facebook.com®, Linkedln.com®, Monster.com®, Hotjobs.com®, company web postings, government web listings, and the like; by building a schema to appropriately table, and ideally normalize, the data from variety of job postings and website, along with each posting's associated qualifications and requirements. This allows the System to monitor, track, generate, and display correlations and illustrate changing trends in what is considered a necessary job qualification and what is considered a “must have” per industry, per specific job title, per city, per window of time. In addition, this data can be collected from historical Job Posts and Job Qualifications used in the past on job posting boards and company websites and made available to the Campaign Management to, say the PAM-MGR 50.

In another embodiment, the PAM-MGR (and/or other NEED-MGRs) can set the System to simply schedule an interview with every interested job Applicant, but more realistically, the PAM-MGR 50 can request that each Applicant answer a series of questions regarding his/her existing skills and background to pre-qualify as a Candidate for the Job Opening.

When the Job Posting is finished and posted, parties interested in the positions will be able to click on a weblink to answer questions pre-arranged by the PAM-MGR required for applying for the specific Job Opening. The PAM-MGR creates the list of questions by uses the M.A.T.C.H. 120 to build out the rules and conditions for Job Applicants, along with the associated relevance of each question (question prioritization and weighting) and the most desired answers to least desired answer (answer range and weighting for each).

After the PAM-MGR selects which questions are relevant for the job opening, then he or she can also selects the ideal answers and prioritize the top questions or all questions in the order of importance. This prioritization of the questions creates the criteria for screening the Applicants.

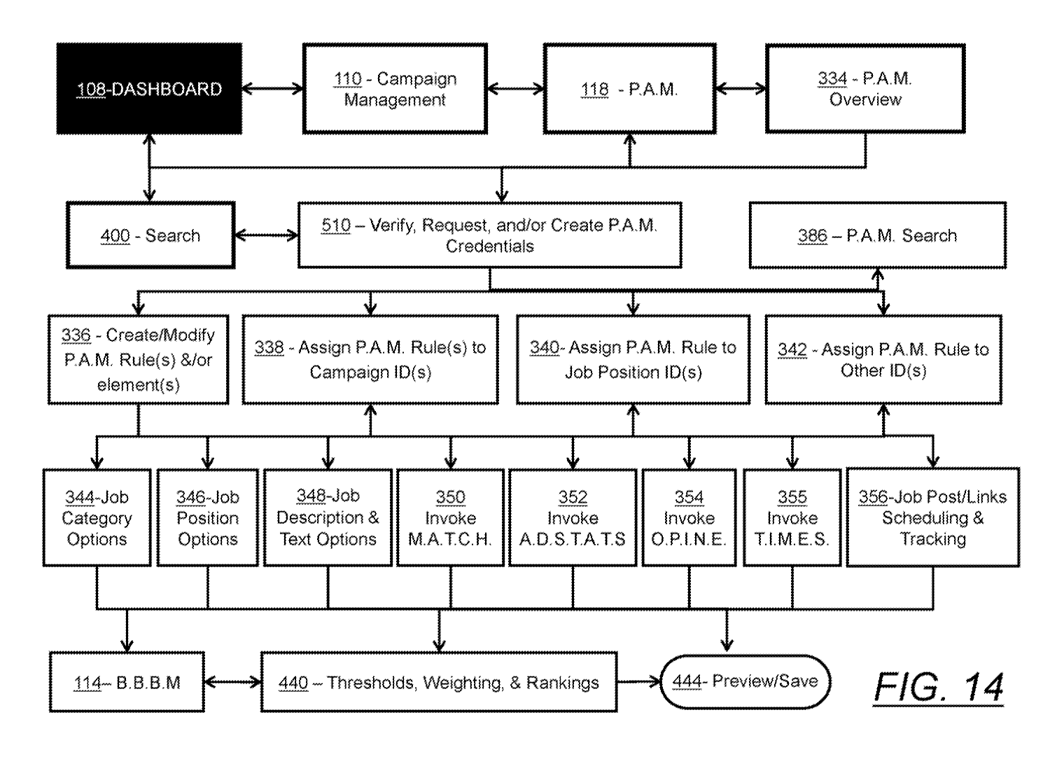

FIG. 14 is a flowchart that depicts an embodiment and example of the process by which the PAM-MGR 50 can create/modify a particular P.A.C. 104 and/or a particular P.I.N. 106 utilizing the P.A.M. 118. These PAM-MGRs 50 will have the ability to post a job that fits within a list of pre-defined Job Categories each with a sub-category of Job Positions.

A Campaign Management 110 function is accessible from the Dashboard 108 and from the Campaign Management 110 function, an Account 60 can access the P.A.M. 118 and in turn a P.A.M. Overview 334 that explains the purposes and functionality of using P.A.M. A Search 400 function allows for overall search for existing Campaigns 103, Campaign 103 elements and/or other features such as functionality explanations.

A “Verify, Request, and/or Create P.A.M. Credentials” 510 function screens and educates the user of what functionality his/her role and permissions has in terms of access and limits. A “P.A.M. Search” 386 allows the user to search for P.A.M. specific elements and/or features. A “Create/Modify P.A.M. Rule(s) and/or element” 336 function allows Accounts 60 to create a new P.A.M. 118 rule and/or element from scratch and/or select existing P.A.M. 118 rule or element. An “Assign P.A.M. Rule(s) to Campaign ID(s)” 338, an “Assign P.A.M. Rule to Job Position ID(s)” 340, and an “Assign P.A.M. Rule to Other ID(s)” 342, each allow the Account 60 the ability to pick and choice where and how to apply existing P.A.M. Rule(s) and/or a newly created P.A.M. Rule.

The Account can create and/or modify an existing P.A.M. Rule(s) and/or element(s) using a “Job Category Options” 344 module option, a “Job Position Options” 346 module option, a “Job Description and Text Options” 348 module option, an “Invoke M.A.T.C.H.” 350 module option, an “Invoke A.D.S.T.A.T.S.” 352 module option, an “Invoke O.P.I.N.E.” 354 module option, an “Invoke T.I.M.E.S.” 355 module option, and/or a “Job Post/Links Scheduling and Tracking” 356 module option.

The “Job Category Options” 344 module option is for assigning, modifying, or creating a new Job Category, Job Category rule, and/or Job Category element from, say an existing PAM rule, Job Category Campaign, Job Category rule and/or Job Category element. The “Job Position Options” 346 module option is for assigning, modifying, or creating a new Job Position, Job Position rule, and/or Job Position element from, say an existing PAM rule, Job Position Campaign, Job Position rule and/or Job Position element. The “Job Description and Text Options” 348 module option is for assigning, modifying, or creating a new Job Description and Text, Job Description and Text rule, and/or Job Description and Text element from, say an existing PAM rule, Job Description and Text Campaign, Job Description and Text rule and/or Job Description and Text element.

The “Invoke M.A.T.C.H.” 350 module option is for assigning M.A.T.C.H. criteria and/or using elements from existing P.A.M. based from an existing MATCH criteria. The “Invoke A.D.S.T.A.T.S.” 352 module option is for assigning ADSTATS targeting criteria and/or using elements from existing P.A.M. based from an existing ADSTATS targeting criteria. The “Invoke OPINE” 354 module option is for assigning OPINE criteria and/or using elements from existing P.A.M. based from an existing OPINE criteria. The “Invoke TIMES” 355 module option is for assigning TIMES criteria and/or using elements from existing P.A.M. based from an existing TIMES criteria. The MATCH, the ADSTATS, the OPINE, and the TIMES are HIRES modules that all herein referenced, are explained throughout specification.

The “Job Post/Links Scheduling and Tracking” 356 module option is for assigning, modifying, creating, linking, tracking and scheduling a new Job Post (e.g. Campaign 103, PAC/PIN), Job Post Link, and/or Job Post Schedule from, say an existing PAM rule, Job Post/Links Scheduling and Tracking Campaign, Job Post/Links Scheduling and Tracking rule, and/or Job Post/Links Scheduling and Tracking element. And not to be confused with the TIMES module and TIMES criteria for coordinating and scheduling between the NEED and the Applicants, whereas the “Job Post/Links Scheduling and Tracking” is specific for coordinating, scheduling, and tracking the actual job post Campaign(s), and any associated elements, content, ads, times, links, locations, and/or weblinks.

These P.A.M. module options 344, 346, 348, 350, 352, 354, 355, and 356 are tracked and measured independently, and collectively as a unit against and relative to a particular Campaign 103, and/or Campaign element to measure their effectiveness and success rates against different Campaign 103 elements, MATCH Rules, ADSTATS Rules, TIMES Rules, DREAM Rules, Billing Rules, Budgeting Rules, Bidding Rules, Account Rules, and Real-time Reporting. The PAM-MGR 50 can use a B.B.B.M. 114 module option to assign Billing, Budgeting, and Bidding Rules to the Job Post and/or PAM Rule(s).

A “Thresholds, Weighting & Ranking 440 module option can be set up to place a variety of weighting, prioritizations, and rules to the collective measurements and results. For example, a particular Job Post ID may be far more effective at attracting applicants at a particular time of day when relatively compared to other times of day and thus more weight could be applied towards placing the Campaign 103 at the favorable time slot in, say locations, such as websites, applications, advertising platforms, mobile platforms, and/or the like that allow for temporal type targeting.

The HIRES 102 measures a Campaign's success and this data can also be incorporated into the selection of a future Campaigns 103 for similar Job Postings. A Campaign's relative success in attracting a large pool of potential Applicants, Applicants who Inquire, Applicants who qualify as Candidates and Candidates who the NEED makes an offer to, can also be measured and incorporated in the selection of future Campaign(s) 103 and Campaign 103 elements by the PAM-MGRs 50.

For example, the PAM-MGR 50 could request to see a list generated and displayed of those Campaign 103 elements where collected measurable data relatively supports, and to what relative degree, the quantifiable and ranked successful of each Campaign element, say for finding a Candidate relatively quickly for a particular computer software skill for, say a particular region of the country. In addition, where and when the Job Opening Campaign should run/appear (and perhaps include data where relatively proven not best to appear locations, times and the like), along with projected cost-benefit analysis based upon historical data for the suggestions and elements.

Further the list could generate and display element combinations with historical success, such as this salary for this part of the country, with a specific text description, a specific ad location, and a specific photo performs some percentage points relative, say better, than same the same conditions, with say either a different specified salary or range of quantifiably less effective salary options; a different specified part of the country or range of quantifiably less effective location options; a different specified text description or range of quantifiably less effective text description options; a different specific ad location or range of quantifiably less effective ad location options; or a specified photo or range of quantifiably less effective photo options.

Each new PAM Campaign 103 could be set to run against previous PAM Campaigns 103 in general and/or against similar PAM Campaigns 103 to track and make sure that the new PAM Campaign 103 is in fact performing similarly, and/or report back that it is off by a quantifiable degree/amount, and make suggested changes based on the area where the new PAM Campaign 103 deviates from methods that are, say proven relatively more tried and true. New and modified PAM Rules that create Campaigns, such as Job Posts, can be previewed against an existing Campaign 103 to see the results and/or saved with a Preview/Save 444 function.

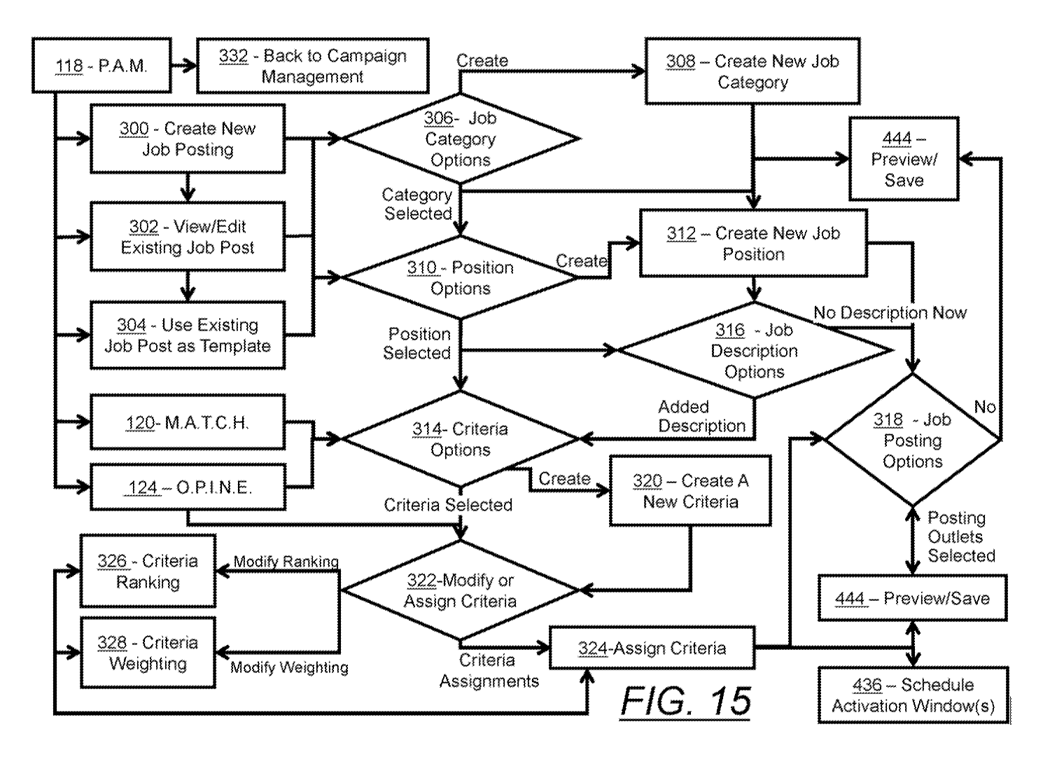

FIG. 15 is a flowchart further depicting an another embodiment of the PAM-MGR's 50 options for utilizing the P.A.M. 118 using the HIRES 102. Starting with the PAM 118 function where the PAM-MGR 50 has the options to utilize a “Create New Job Posting” 300 module option, a “View/Edit Existing Job Post” 302 module option, a “Use Existing Job Post as a Template” 304 module option, the MATCH 120 module option, and/or the OPINE 124 module option.

From module options 300, 302, and 304, the PAM-MGR 50 can precede to a query 306 which offers “Job Category Options”. If the PAM-MGR 50 declines all existing Job Categories and instead chooses to “create” a new job category, he/she is passed to a “Create New Job Category 308 where the PAM-MGR 50 creates the new job category. From there the PAM-MGR 50 is passed to a “Create New Job Position” 312 function.

If the PAM-MGR 50 selects an existing job category back in query 306, he/she is passed to a query 310 which offers existing “Position Options”. If the PAM-MGR 50 declines all existing Job Positions and instead chooses to “create” a new position, he/she is passed to the “Create New Job Position” 312 function. From there the PAM-MGR 50 has the option to add a job description using a “Job Description Options” 316 where he/she can use existing descriptions and/or create new elements of the job description. From function 312, the PAM-MGR 50 can also skip the query 316 and advance to a “Job Posting Options” 318 query.

If the PAM-MGR 50 selected an existing position back at query 310, he/she has the option to advance to query 316 or to a query 314 for “Criteria Options” which can also be accessed from the MATCH 120 and the OPINE 124. The query 314 allows the PAM-MGR 50 designate specific criteria for the Job Posting use existing criteria in the HIRES 102 system. The HIRES 102 can sort the criteria as to how it relates to any element within a particular Campaign, a group of Campaigns, and/or all Campaigns, such as criteria most used for this particular Job Category, Job Position, but also for an accumulation of elements utilizing any type of delineation available in the database.

For example, the PAM-MGR could request a ranking of those criteria either used most often by, say the MATCH MGR(s) and/or found to be most successful in hiring candidates for Job Positions for a particular period of time (e.g. temporary hires) for a particular duration (e.g. during the summer), for a particular salary range (e.g. $25-$27 per hour), within a particular region (e.g. Los Angeles, Calif.).

This ranking could reflect the values relative to each criteria element's bearing on the position among the other elements listed. For example, using the previous example set for ranking criteria by the MATCH-MGR, the HIRES 102 might generate a result that reflects that most job posts (e.g. 98%) for this particular position, say an Adobe Flex developer, included a criteria that the job Applicant be an expert in ActionScript 3.0 scripting language.

This criteria could be further delineated with how that criteria was satisfied. For example, say 70% of those, above, used a test provided directly from Adobe to test the Applicant's skills, while another 12% used the Company's own test, another 8% used a third party's test, 7% let the Applicant simply check off his/her perceived expertise, and 2% did not require any specific criteria questions around ActionScript 3.0 expertise.

The ranking could go on to reflect correlations from each piece of criteria, such as how critical each criteria element was in filling the position in terms of quality of hire, speed of filling position, accuracy in gauging expertise, and the like. This data could be collected by a number of participants before the hire, during the interviewing, after the hire, and at time intervals after the hire to compare the perceived value and accuracy over time. In addition, each NEED Mgr could apply his/her own score and scoring system to each Applicant, Candidate, CHOP, and/or CATCH.

Further, the PAM-MGR can isolate criteria factors, such as the perceived acceptable commute distance which is more likely to be more relative to the Company's location than to the particular type of Job Position. Here the PAM-MGR can change factors to add criteria known to work well for general elements of the Company's typical job postings, such as a ranking of different methods and the associated successes for describing what the Company does relative to the department with the Job Opening, and/or different methods and the associated successes for describing the Company's benefit package relative to known competitors within the HIRES 102 system.

The PAM-MGR 50 is free to use existing criteria that may not appear among the higher ranking criteria as long as it was, say pre-approved by a MATCH MGR. The PAM-MGR 50 can also request new criteria by advancing to a “Create A New Criteria” 320 function, but generally new criteria is added by the MATCH MGR or by someone with MATCH MGR privileges and permissions. In small entities (e.g. smaller companies), typically the PAM-MGR 50 would also have MATCH MGR type permissions added to their role.

After creating the new criteria the MATCH MGR 51 advances to a query 322 that offers the MATCH Mgr. 51 the ability to “Modify or Assign Criteria”. If the MATCH MGR chooses to create assignments for the criteria, he/she is passed to an “Assign Criteria” 324 function (which was explained in detail in the previous Figure and explained more under MATCH).

If the MATCH MGR 51 elects to modify the criteria, he/she can either select a “Criteria Ranking” 326 function for ranking the criteria requirement for the job posting or select a “Criteria Weighting” 328 for applying weighting to the criteria (which will be explained in detail under MATCH later). After assigning and modifying the criteria, the MATCH MGR 51 can either use the Preview/Save 444 function, a Schedule Activation Window(s) 436 function, or a query 318 for further “Job Posting Options”.

The “Job Posting Options” 318 query allows either the PAM-MGR 50 and/or the MATCH MGR 564 with the proper permissions to select outlets and/or locations for posting his/her PAC 104 or PIN 106. If the user (the PAM-MGR 50 or MATCH MGR 51) wants to skip query 318, he/she can proceed to the Preview/Save 444 function. If the user wants to schedule a time window for the posting to become active, he/she can use the “Schedule Activation Window(s)” 436 function.

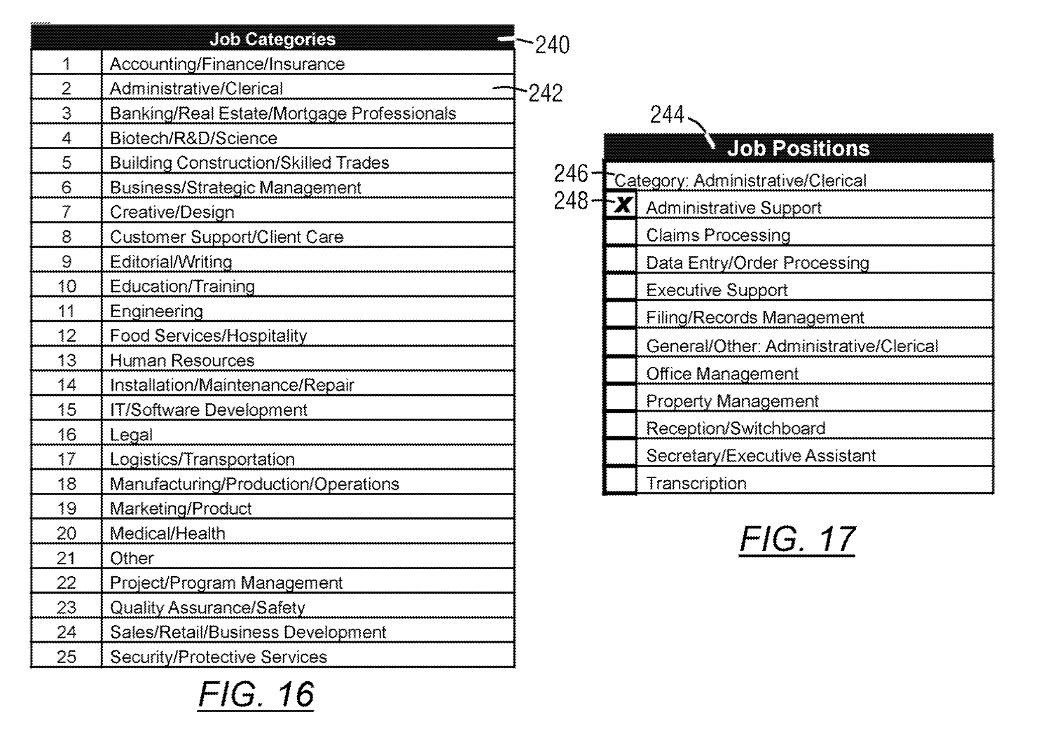

FIG. 16 depicts an list example embodiment of potential Job Categories. A “Job Categories” 240 list can include all known Categories available to the Account 60, Role and/or his/her Permission settings. The Job Categories 240 list can be restricted to only include those Job Categories that have been pre-approved by the NEED 82. Within these Job Categories will be a list of pre-defined Job Positions, for example an Administrative/Clerical 242 option/position.

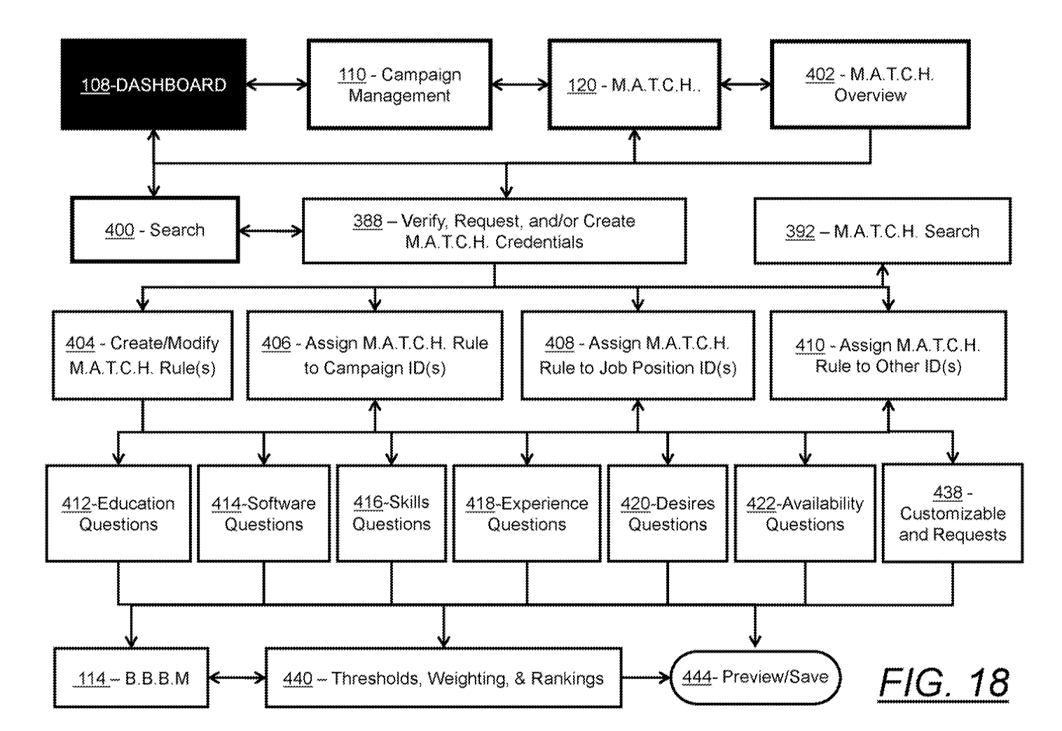

FIG. 17 depicts an example of potential Job Positions within a particular Job Category in one embodiment. A user with the PAM-MGR role and permissions and/or at least equivalent to the PAM-MGR permissions can then select a Job Position that best fits the NEED's (Company's/Employer's) job opening. If the PAM-MGR 50, in the previous FIG. 16, selected the “Administrative/Clerical” 242 option/position then in this FIG. 17 embodiment example a “Category: Administrative/Clerical” 246 is generated. Here the PAM-MGR 50 has indicated a selection of an “Administrative Support” 248 position as the more granularly specific Job Position.

If there already is a pre-defined Job Category (title) that fits the Job Position (employer's job opening), the PAM-MGR 50 may be encouraged to use it, depending on past usage, success rates, and/or company policy. In general, using existing Job Categories is meant to help create normalized and standardized data for generating valuable data comparisons. If on the other hand, no existing Job Category in FIG. 16 is ideal for the new Job Position that is being posted, the PAM-MGR 50 is encouraged to create a new Job Category independently and/or use a similar Job Category to start the PAM creation process and make changes to the “template-like” Category/Position where necessary.

Using the existing options/defaults helps prevent the Job Categories 240 from becoming overly polluted with data that doesn't necessarily belong under a specific Job Category 240 (and/or position). For example, if every PAM MGR 50 created a unique title for each posting the system could end up with several job titles for positions that are the same and/or relatively similar, such as: “software developer”, “programmer”, “developer”, “software engineer”, “computer software engineer”, but each with less data associations, due to limited usage. Consequently, PAM MGR can also create data associations for newly created fields for say, a Job Category or Job Position, to borrow the associated data until the independent field, say the Job Position has, say surpassed some threshold of quantifiable data to exist independently of the borrowed associated (Job Position) data correlations.

For example the PAM MGR 50 may want to delineate Flash developers from My-SQL developers, but neither has sufficient data and/or are new positions. The PAM MGR 50 can create both these new positions borrowing data associated and correlations from the parent for, say “developers” until the data collected surpasses some predetermined requirement, condition, and/or quantity, say as soon as at least 10 Applicants, and/or at least 3 Candidates are simply associated with the new position, or instead where these Applicants and/or Candidates must meet some predefined conditions, say perform a specific function, view some particular content, participate in a particular function, qualify and/or interview for a particular PAC 104 (not shown) before he/she surpasses the conditional requirement.

When the PAM MGR 50 is finished setting up the Job Category 240, and subsequent positions, rules and conditions, the PAM-MGR 50 will then rename the Job Category appropriate for the Job Position to be filled. This newly created Job Category and/or Job Position can then be made available to other PAM-MGRs within the same NEED/Company, within the same Industry, globally to everyone attached to the SEARCH 100 via the HIRES 102, and/or be determined to be highly unique/specialized to one specific NEED/company and/or PAM-MGR. In some cases, the PAM-MGR could request that the new Job Category and/or Job Position remain confidential to a particular NEED/account/company, NEED/user/individual, role, and/or third-party, which utilizes the HIRES 102 System.

For instances, if the NEED 82 hires a recruiting firm which is already a CASTING 80 role using the HIRES 102 System and/or becomes the CASTING 80 role of the “Supplier of Applicant(s)” 83 role, it would have access to the NEED's 82 specific pre-built JOB Categories/Positions and unique qualifications/requirements. The HIRES 102 System could also generate weblinks to the PAC 104 and/or PIN 106 with unique URLs per PAM-MGR, per CASTING Account, per Role (each Recruiting Firm and/or specific Recruiter) and/or some combination of these where this unique URL/ID assigned to track the successfulness of each PAC/PIN 104/106, each PAC/PIN element, and each PAC/PIN contributor both individually and overall for the quality of Applicants and Candidate relative to the other CASTING 80 Roles and/or NEEDs-MGRs 49 (also see more under Affiliates and Affiliameter™).

FIG. 18 is a flowchart that depicts an example embodiment of the MATCH. A Campaign Management 110 function is accessible from the Dashboard 108 and from the Campaign Management 110 function, an Account 60 can access the MATCH 120 and in turn a MATCH Overview 402 that explains the purposes and functionality of using MATCH 120. A Search 400 function allows for overall search for existing Campaigns 103, Campaign 103 elements and/or other features such as functionality explanations.

A “Verify, Request, and/or Create MATCH Credentials” 388 function educates the user of what functionality his/her role and permissions has in terms of access and limits. Full MATCH 120 functionality is limited to a user role which is at least equivalent to the same permissions required to be a “M.A.T.C.H. Mgr.” 51 hereinafter a “MATCH Mgr” 51. The MATCH MGR utilizes MATCH to create/modify criteria requirements for a particular NEED to be used in a particular P.A.C. 104 and/or a particular P.I.N. 106.

A “MATCH Search” 392 allows the user to search for M.A.T.C.H. specific elements and/or features. A “Create/Modify M.A.T.C.H. Rule(s)” 404 function allows Accounts 60 to create a new M.A.T.C.H. 120 from scratch and/or select existing M.A.T.C.H. 120. An “Assign M.A.T.C.H. Rule to Campaign ID(s)” 406, an “Assign M.A.T.C.H. Rule to Job Position ID(s)” 408, and an “Assign M.A.T.C.H. Rule to Other ID(s)” 410, each allow the Account 60 the ability to pick and choice where and how to apply existing M.A.T.C.H. Rule(s) and/or a newly created M.A.T.C.H. Rule.

The MATCH can be setup and utilized for a variety of isolation purposes, such as isolating Candidates from a pool of users and/or Applicants in a user database for a particular function, purpose, project, event, and/or job. In this example, the MATCH has been setup for isolating Candidates for, say employment and/or a job, where the Account can create and/or modify an existing M.A.T.C.H. Rule(s) using a “Education Questions” 412 module option, a “Software Questions” 414 module option, a “Skills Questions” 416 module option, an “Experience Questions” 418 module option, a “Desires Questions” 420 module option, an “Availability Questions” 422 module option and/or a “Customizable and Requests” 438 module option.

The “Education Questions” 412 module option is for assigning criteria related to the applicant's education overall and/or relative to the job. Where for example, the MATCH MGR can select a minimum education requirement or apply points to those with more education. For example, an education-scoring-system could be created and/or shared, where a plurality of points are awarded per, such things as per grade completed.

The education-scoring-system then generates a cumulative-education-score-per-person. The cumulative-education-score can incorporate many attributes where points are either added or subtract for such things as a grade someone receives per a course/class and where a plurality of bonus points can be added or subtracted for such things as, Master degrees, licenses and/or registrations obtained. In addition, multipliers can be used to adjust certain values. For example, an education-source-value can be multiplied against a course/class grade, where the education-source-value is derived from such things as an institution that provided the course/class grade.

Where a panel of education-source-judges could be assembled from, say the NEED MGRs, along with qualified Peers and Experts (more on Peers and Expert throughout specification) who could create a range of values for such things as different degrees, different licenses, and/or the education-source-value. For instances, the education-source-value could be based upon a range of elements, measurements and conditions; including each education-source-judge's subjective view of the particular education source; the actual number of years the education-source has offered, say a particular Bachelor Degree; an average first year's income for graduates of the education-source; a percentage of graduates who are employed within a two year period of graduation; a number of graduates who are employed in their degree five years post he/she graduation, and later.

The education-source-value's algorithm can be adjusted to meet an overall goal, such as to give weighted preferences and reward to those who attending more challenging schools, programs, classes, and the like and subtract points from those who did not; to reward those who had/have better grades; to reward those who are working in the field of his/her degree; and the like.

Depending on the goals for the panel of education-source-judges, the algorithm employed to generate the cumulative-education-score-per-person could include, say an education-source-value multiplier, and be setup where a “person A” who has been working for more than the past five years in a field from his/her degree from an “Education-source M” where the education-source's first year graduate income is higher than, say another “Education-source O”, where than “Person A” ranks higher than a “Person B” where all other things being equal with the “Person A”, but where the “Person B” graduated from the “Education-source O”. And where “Person A” consequently ranks higher than a “Person C” who also graduated from the same “Education-source M” and where all other things are equal to the “Person A”, except that “Person C” has either, say been working less than the past five years in the field from his/her degree or instead had, say a lower grade point average than “Person A”.

In an embodiment, the system creates a cumulative-education-success-score-per-teacher which is based upon the same data that creates the cumulative-education-score-per-person, where only the classes taken by the person with a particular teacher are part of the cumulative-education-success-score-per-teacher for that particular teacher. The cumulative-education-success-score-per-teacher could be used for differentiating which teachers have had more or less students who have gone on to graduate (particular levels of education/degrees); have had more or less students who have gone on obtain a particular credential/license; have had more or less students who have gone on to work within their chosen field per his/her degree; have had more or less students with some measurable degrees of, say happiness, travel, freedom, relationship/family (measured by, say a survey); have had more or less students with some measurable amount of income, accomplishment, goal, title, performance, rank, prestige, honor, authorship, creativity, and the like.

The cumulative-education-success-score-per-teacher could also be used for calculating a teacher's income, raise, annual budget, ability to acquire or not acquire tenure, and the like. The education-scoring-system that generates the cumulative-education-score-per-person can go beyond college graduates to incorporate much younger students. Where for example, the cumulative-education-score can incorporate attributes where points are either added or subtract for such things as spelling, reading, reading at a certain proficiency level, a test score for, say math (or any subject), and the like; and where a plurality of bonus points can be added or subtracted for such things as, a particular age when the student did the accomplishment.

In addition, a student-accomplishment-bonus can be awarded for participation in, say athletic accomplishments, team sports, band, singing groups, school plays, Future Farmers of America, Cub Scouts/Girl Scouts, art competitions. Further, the student-accomplishment-bonus could have multipliers or extra points. For example, an extra-merit could be added to the student-accomplishment-bonus, for such distinctions and events as one point for participating in a school sponsored spelling bee, and another point for each competition won; and another merit point for making the school's basketball team and every game he/she suits up; and another point for every game he/she started; and so on.

Rules could be established as to whether a teach could only receive credit for those previous/past students where the future proficiency was directly attributable from, say a similar subject taught, say computer science to someone who is today an accomplished software developer; where a panel of judges would/could determine what is specifically and is not specifically attributable to each specific teach and to what degree. On the other hand, perhaps a system that would be less subjective and easier to institute would instead allow teachers to receive any credit (or demerit) attributable to the previous/past student for all that's student's future success going forward, or for a particular window of time, say only for the next four (4) years.

Returning to the MATCH and the “Software Questions” 414 module option which is for assigning criteria related to the applicant's software expertise overall and/or relative to the job. Where for example, the MATCH MGR can create and/or select existing software questions related to a particular job opening for the Applicant to answer. The MATCH MGR can also allow and/or employ third-parties, such as the actual manufacturers of the each particular software package to generate the questions. In addition, the Company (NEED) offering a job opening (PAC/PIN) could select what version of the software it is currently running, where ideally that would be the software version the Applicants would be tested upon.

Other third-party Accounts who offer testing programs could also be made available to create a range of methods for measuring and testing software competency. In addition this range of methods used by a variety of Accounts will allow the SEARCH and HIRE system to track and compare software test suppliers against each other, and their questions against each other, in terms of helping properly isolate those Applicants with better software skills than others, and who then goes on to become successful hires, and/or helps the company become measurably more successful. There is more on methods and testing software skills throughout the specification.

The “Skills Questions” 416 module option is for assigning criteria related to the applicant's existing skills overall and/or relative to, say the job. The “Skills Questions” are meant for skills other than the Software “Skills” in the previous module. For example, “skills” could include such things as testing for communication skills, writing skills, selling skills, presentation skills, speaking skills, organization skills, spelling skills, memorization skills, situational skills, problem-solving skills, team-building skills, managing skills, and the like.

The “Skills Questions” could also include tests for such specific thing as acting skills, modeling skills, singing skills, athletic skills, driving skills, riding skills, carpentry skills, cleaning skills, teaching skills, patient-care skills, and the like. Where all the “Skills Questions” collectively and individually, along with each user answer builds a database of questions/answers that have proven successful for hiring quality Candidates and/or other metrics, such as increased company revenues or profits, and to what degree compared to others, and per each user segmentation and/or delineation available.

The “Experience Questions” 418 module option is for assigning criteria related to the applicant's experience overall and/or relative to, say the job. For example, the “Experience Questions” could include traditional temporal questions of Applicants regarding the number of years/months/days he/she has worked for a particular company; within a particular job industry, job category, job position, and the like.

The “Experience Questions” could also include questions regarding experience performing a particular task, such as selling, accounting, and where more details could request associated dollar amounts for specific events, periods of time, the Applicant's career, last position, and/or relative to his/her company, department and/or the competition.

The “Experience Questions” could also include questions regarding experience working on particular types of equipment, such as construction, manufacturing equipment and the like; working with services, such as shipping services, payroll services, collection services, and the like; working with elements, such as cooking, mixing certain types of chemicals, handling hazardous waste, and the like; working with parts, such as automobile engines, assembling toys, assembling computers, and the like; where the questions can test the Applicant's knowledge of each experience, item, and ask the Applicant to quantify his/her experience in terms of such things as temporal, monetarily, and/or seniority attained by when and/or over how long.

The “Desires Questions” 420 module option is for assigning criteria related to the applicant's desires overall and/or relative to, say the particular company and job opening. The “Desires Questions” for example could include questions regarding the Applicant's desires for his/her career in terms what he/she would like to be doing job-wise at some point in the future, say in 2, 4, and 6 years, where the answers could be expressed in terms of salary, bonus, annual department budget, responsibilities, and the like.

The “Desires Questions” could also include questions regarding the Applicant's desires for his/her career in terms what he/she would like to ascend to level-wise at some point in the future, say in 2, 4, and 6 years, where the answers could be expressed in terms role, title, responsibilities, number of subordinates, number of superiors, and the like.

The “Availability Questions” 422 module option is for assigning criteria related to the applicant's availability overall and/or relative to, say the job. The “Availability Questions” for example could include questions regarding an Applicant's availability in terms of whether he/she is currently working, and if so, does he/she plan to work around his/her existing job, or leave his/her existing job. If not leaving, what hours and days he/she is available. If leaving, how soon he/she could be available to work full-time and/or how much of a notice he/she will need to give his/her current employer.

The “Availability Questions” could also ask Applicant's who are, say consultants, independent contractors, and/or professionals, such as accountants, attorneys, doctors, architects and the like; for his/her hours of availability and/or hours not available. The “Availability Questions” could also ask if he/she is willing to work “off-hours” such as evenings, weekends, and/or holidays, and if so, what premium is applied for such hours.

The “Customizable and Requests” 438 module option is for creating, assigning, and/or requesting new criteria that is not an option within the other six module options and assigning the criteria to the applicant from an overall perspective and/or relative to, say the job.

For example, the ability to create a particular MATCH criteria based upon someone's appearance. In another embodiment, where another component of the system would be to analyze a series of elements in the database, say images and/or video clips. For instance, to create a combined composite of a person's facial features from a plurality of facial features of different people and compare those images to build an ideal facial composite for, say a model, with a range of acceptable deviations. Where that acceptable range of facial features (or other body features) would then be compared against existing images of known facial features within the database.

For example, if there was a particular need for someone with a specific facial feature for, say a modeling, acting, news reporter, or like position; a MATCH MGR could retrieve a group of images of, say model's headshots (faces) from existing images in the database (e.g. from still photos, video frames, and/or the like) where the MATCH MGR could then go through and isolate what facial features he/she considered as acceptable and/or not acceptable per feature, per image and/or randomly.

The system could generate a list of commonly used delineations per search type (e.g. a modeling verses acting search) where the MATCH MGR could utilize the list of commonly used delineations for inputting an acceptable range of features such as ages, heights, weights, hair colors, eye colors, dress sizes and shoe sizes; for a model. The system could then load those images that meet that initial acceptable range of delineated features, so the MATCH MGR can go through the generated list of initial images and input his/her more detailed and/or granular features of what he/she wants, by checking off features and associated values that are acceptable and not acceptable within a wide range of facial image features, for say a hair's length/color(s)/style/relative location/symmetry, a head's shape/dimensions/relative location/symmetry, a forehead's shape/dimensions/exposure/relative location/symmetry, an each ear's location/protrusion/dimensions/relative location/symmetry, an each eye's shape/color/dimension/relative location/symmetry, an each eyelash's shape/dimensions/relative location/symmetry, an each eyebrow's shape/dimensions/relative location/symmetry, a nose's shape/dimensions/surface area/exposure/nostril shape/nostril symmetry, a lip's shape/color/dimension/relative location/symmetry, a set of teeth's shape/color/dimensions/exposure/relative location/symmetry, an each check's shape/color/dimension/relative location/symmetry, a neck's shape/dimension/relative location/symmetry, and/or the like.

For facial features with a color value, the color value can go well beyond, say simply listing color terms such as blond, brown, black, red, for hair, to include actual Pantone values or HSB (Hue, Saturation, and Brightness) and for what percentage of the hair is that value. For example, a brown hair value could be expressed as the majority, say 80% of the hair is estimated to be within a range that is plus/minus 5% of a particular HSB value, broken out as Hue =30%, Saturation =70%, Brightness 46%. For hair with multiple colors, the system could express the hair as a mix of several values with an estimated percentage of each value with a plus/minus value. Of course, Applicants could list his/her willingness to change a feature, say his/her hair color and to what degree where that data could also be incorporated in the MATCH isolation criteria.

For features with a “relative location” value, the relative location value can be expressed in terms of relative to the overall size and shape of, say the head, where comparisons can be made to other heads for similar sizes, shapes, and the relative location for the particular feature. If the feature is a symmetrical item, such as an eye, than the “relative location can also be expressed relative to the other eye.

For features with a symmetry value, the symmetry value can be expressed relative to a center line, say that splits the face into two or more quadrants, and where perfect symmetry would place the symmetrical features equally apart from or equal distance from a line, say the center line running horizontally and vertically when compared to the other paired symmetrical feature. Where deviations could be scored numerically in terms of total distance of the deviance in each direction, measured by size units necessary for delineating Candidates by the MATCH Mgr, such as millimeters, or even smaller, micrometers, if necessary and available.

For features with a “shape” value, the shape value can be expressed in terms of a perimeter placed over a two-dimensional (and/or three dimension) grid, where units or pixels are expressed as either within the shape's perimeter and on, or outside the shape's perimeter and off; creating a distinction value of the total pixels inside and outside and each pixels exact location within the grid and where the grid resolution granular enough for delineating Candidates by the MATCH Mgr. For the teeth, the shape could be expressed for each tooth where each tooth was completely exposed or just the shape of those teeth that are exposed during a particular facial expression, such as a smile.

For features with a “dimension” value, the dimension value can be expressed in terms of overall length and width, and/or even the dimensions any given location, say the height of the lips at the center of the face. For the teeth, the dimensions could collected and delineated per tooth, if available from image, other images, and/or other data collections means (more below).

For features with an “exposure” value or a “protrusion” value, the exposure value or the protrusion value can be expressed in terms of estimated mass volume, such as the mass volume of a nose in three-dimensional shape from where the feature meets and/or connects to the surface of face or head. For the exposure value, it can also include the relative mass volume to some other feature, say the person's head, or the symmetrical feature. For the protrusion value, it can also include the distance the feature protrudes from the surface, in terms of greatest protrusion, protrusion at a particular point, and/or protrusion relative to another feature and/or point.

Ideally all images being compared would be taken with the same camera, same resolution, from the same distance, with the same lighting, where the facial features all perfectly and equally centered. However more realistically, images would come from a variety of camera, resolutions, exposure time, lens depth fields, angles, centering, distance, framing issues, and the like. Consequently, the system should/could make mathematical calculations and adjustment to best account for such discrepancies and/or based upon input from the MATCH MGR, other NEED MGRs, and/or input from the Applicant, Peers, and/or Experts.

In addition, all or some dimensions can be collected from the actual Applicant's facial features using measuring tools and entered as data, such as from the Applicant and/or from another source, and/or verified by another source, say the specific and qualified CASTING account of the “Verification(s)/Tools and/or Background Check(s)” 93 CASTING Account where, say data for a particular facial feature was measured and entered) verses relying on computational interpretations strictly from the images and/or a series of images. The verified facial feature measurement can also be employed to improve the system's attempted mathematical calculations and adjustments on existing images for the same Applicant's/user's/subject's face, where the percentage of correction for the verified facial feature measurement may/could be applied to the other feature and facial calculations. In some cases, it may be prudent and preferred to only include Candidates with verified facial measurements or later merged with non-verified facial measurement for further isolating and comparison purposes.

MATCH MGR could enter numeric values with plus/minus thresholds, or more likely, click on those features associated with each delineate feature. The MATCH MGR would only have to make one selection for one feature on one image to create a feature list, where the default tolerance range may be set to already allow for a slight plus/minus threshold of “x” units from the selected feature by the MATCH MGR for a particular feature value and/or all associated feature values.

The MATCH MGR could add features for a particular feature, say for facial hair, a tattoo, an ear piercing, a nose piercing, glasses, contacts, baldness, and the like, and/or in a specific location, say a mustache, or the MATCH MGR could indicate that such a feature is either entirely unacceptable or may be consider, if modified, e.g. shaved off. The MATCH MGR could setup the opposite criteria, where the system would generate a list Candidates from a list of Applicants who do not fall with the range, as designated by the MATCH MGR for a particular feature (or group of features) each within a designated plus/minus range. For example, the MATCH MGR may not want any Candidates to have a particular and quantifiable color range of hair, where that color range would be excluded from the available list of Candidates.

In addition and if available, the MATCH MGR could incorporate multiple images from the same person, say from multiple angle's to also select a feature such as a nose's side view. The MATCH MGR could indicate and request a list be generated with Candidates with the widest range of a particular feature, such as facial expressions from all images available. The MATCH MGR could also indicate he/she wants Candidates with the broadest range of features for, say for hair length across all images available.

Images can also allow for a labeling where, for instances, particular facial expressions can be labeled by a group of judges, such as the NEED MGRs, and/or qualified Peers and Experts, who apply labels (or meta-tags) to facial expressions, whereby the system can then generate a list of similar images to isolate like images to display for the judges to also judge in terms of proper expression labeling.

In addition, the system can create a plurality of Applicant who did not meet the MATCH MGR the list of MATCH Candidates, but are relatively close, but for, say a feature or an item that is unknown, such as the Applicant's dress size or shoe size, where the system can send out a notification, say in an email or SMS to the Applicant to fill in the missing information. In other situations, the MATCH MGR may choose to make an exception adjustment for a particular Applicant, and/or thus expand the Candidate MATCH profile range just mathematically enough to include this particular Applicant, along with a generated list regarding how many more Applicants would also now become Candidates with this particular exception adjustment.

In one embodiment, a system and a method store a plurality of images in a content database and where a MATCH MGR, who is an Account user and manager with the proper role and permissions, views and inputs acceptable features for isolating a CATCH from the plurality of images in the content database. The MATCH MGR inputs acceptable features to create a Candidate MATCH profile range, where the Candidate MATCH profile range of acceptable features generates and displays a list of MATCH Candidates from the plurality of images in the content database.

Whereby a DREAM MGR, who is an Account user and manager with the proper role and permissions, can display and views the list of MATCH Candidates to further indicate a plurality of specific features determined and indicate what is specifically acceptable and unacceptable, to what degree, along with establishing points and demerit values associated per specific feature and degree to create a DREAM Candidate profile range. The system generates a list of prioritized DREAM Candidates based upon the DREAM Candidate profile ranges and associated points.

A CHOP-M MGR 58 can view the list of prioritized DREAM Candidates and can adjust the points, any thresholds, and any weighting to regenerate a prioritize list of CATCH Candidates whereby Candidates under a certain threshold of points are no longer in the consideration to become a CATCH and those above the threshold are considered to be within a Candidate CATCH profile range.

A CATCH-M MGR 59 can view the list of prioritized CATCH Candidates and select the top CATCH from the list or another CATCH from the list of prioritized CATCH Candidates to become the CATCH. Depending upon a CATCH Goal, the CATCH can comprise of one person, one item, one service, one place, a plurality people, a plurality of items, a plurality of services, a plurality of places, and the like, and/or some combination of these.

The MATCH Mgr., the DREAM Mgr., the CHOP-M MGR 58, and the CATCH-M MGR 59., may either be each different people with different distinct roles and permissions, all the same person with all the proper roles and permission assigned, and/or some combination of appropriate people, roles, and permissions to complete the candidate selection process. In addition, there could be a plurality of people who equally partake in any one Mgr role and/or the Account could specifically delineate the role and permission of, say the MATCH Mgr. to where there is, say one MATCH MGR for a range of defined job positions and another for another range of defined job positions.

In another instance, one “MATCH MGR A” may be responsible solely for selecting certain MATCH criteria, while another “MATCH MGR B” is solely responsible for other criteria. Some decision stages may have a plurality of NEED MGRs who can vote on criteria, points, thresholds, weights, and the like, and where the value of a NEED MGR's vote may or may not be equal to another NEED MGR's vote. For example, a particular “CATCH-M MGR A” who has five (5) years of experience with the company could be given, say five (5) votes when it comes to deciding who is the final CATCH, whereas another particular “CATCH-M MGR B” with three (3) year experience would be then given three (3) votes, assuming there were other CATCH-M MGR(s) voting that could collective out vote the “CATCH-M MGR A”.

In another example, the CATCH-M Mgrs 59 could be given votes where each NEED MGR may not have to apply all of his/her votes to one potential CATCH within the list of prioritized CATCH Candidates, but instead can apply votes per CATCH Candidate as he/she sees fit until his/her available vote total is exhausted. For example, during an NFL football draft, five (5) members of an NFL team's coaching and recruiting staff could all have the designated role and permissions of a CATCH-M MGR 59., but each may have a different total number of votes, based upon, say their years of experience, and/or the past ability to quantifiably and successfully draft a quality NFL play called a “CATCH-M MGR's Overall Success Score”.

Where the “CATCH-M MGR's Overall Success Score” is based upon past success of draft selections, more specifically, based upon a success scoring system, where for example, any past draft pick the CATCH-M MGR 59 applied his/her votes towards, is then scored, measured, tracked, normalized, and compared, for such things, as games played, games won, margin of victory, playoff appearances, Pro-Bowl appearances, and potentially even more granular past success scoring system measurements, such as those typically used for fantasy sporting leagues competitions, such as passing yards, rushing yards, receiving yards, TDs scored, tackles made, interceptions lost/made, fumbles lost/recovered, field goals made/missed/blocked, extra points made/failed, and the like; where points are awarded or subtracted per event, and where the data can be normalized to create fair comparisons between players at unlike positions.

For example, say between a wide-receiver and a defensive end, where the system also factors in the NFL's overall present value associated with that particular position based upon the collective average pay for player's at that position, length of his career, and the cumulative score of player's who were drafted at that position and at what draft number location within all the rounds. For instance, if the present average salary for an Offensive Tackle was $6 million/year and the average career was 4 years and there were 70 Offensive Tackles drafted within a particular year with a cumulative draft spot location total of 8960 (i.e. adding up and combining all the draft number locations for this position within the draft), then the system could for instances, factor in all these data components and created a position's value score which can be used to compare this particular position relative to all other position's value score.

These position's value score is also factored into a player's value score and eventually a cumulative value score is created for the particular player where that score can be included in the CATCH-M MGR's overall success score, based upon the cumulative value scores for either those player's voted on by the CATCH-M MGR 59 that were actually drafted by the team or include all those player's no matter what team he ends up playing for. The CATCH-M MGR's overall success score can create the basis or can actually be based upon the number of points he/she has for voting towards any potential NFL player in the draft at any given decision point or a collective point total that gets consumed in total for any give draft event or day.

The system also factor in such things, as the team's present need at a particular team position, as was, say previously agreed upon by all the CATCH-M Mgrs 59 either before the draft, before the draft day, or before the draft round; and as is adjusted, say either round by round and/or pick by pick, based upon earlier draft picks taken by the CATCH-M Mgrs 59 team where pick that may have filled or partially filled the what as pending need, and based upon the number of quality potential players still remaining for the draft, including those taken by other NFL teams in relation to the total pool of perceived and/or pre-applied player value scores, as determined, say collective in advance by the CATCH-M Mgrs 59 and/or other NEED MGRs, and could be based upon college statistics similar to those mentioned above for NFL players.

In another embodiment, the CATCH does not have to be a human, but instead could be a product, location, service, product part, and the like. For instances, the CATCH could be a vacation trip through, say Europe, where the MATCH MGR generates a list of acceptable features for isolating a CATCH from the plurality of European city descriptions within the content database of, say the HERDS DB. The MATCH MGR inputs acceptable features to generate a Candidate MATCH profile range, where the Candidate MATCH profile range of acceptable features generates and displays a list of MATCH Candidates from the plurality of European city descriptions in the content database.

Whereby a DREAM MGR, who is an Account user and manager with the proper role and permissions, can display and views the list of MATCH Candidates to further indicate a plurality of specific features where he/she determines and indicates what are specifically acceptable and unacceptable and to what degree, along with establishing points and demerit values associated per specific feature and to what degree to generate a DREAM Candidate profile range for such things as say a specific set of costs and types of, say hotels, amenities and value score; cars, features and value score; local sites/attractions and value score; local restaurants, cuisine, and value score; each with a set of attributes and a range of tolerance.

The value scores could be created by a number of means, including either a value score that could be created and assigned by a NEED MGR (e.g. MATCH MGR, DREAM MGR, CHOP-M MGR 58, and/or CATCH-M MGR); the value score could come from an existing database containing a star rating system where, say five stars is considered the best and a zero star rating is considered the worst; the value score could be created by a select list of Peers and/or Experts based upon some defined segmentation profile by the NEED MGR and where those who qualify within the segmentation come either supplied with an existing value scores and/or where new values scores are generated, say with the star rating system; and/or some combination of these means and the like. These value scores can be further restricted by such factors as, say only include Peer value scores and/or Expert value scores that where collected within a certain period of time; as long as the Peer and/or the Expert has actually traveled to the city; as long as the Peer and/or Expert visited the city during the same time period of the year, say within 60 days plus/minus of the targeted travel day. The system then generates a list of prioritized DREAM Candidates based upon the DREAM Candidate profile ranges and associated points.

A NEED MGR, such as the CHOP-M MGR 58 can view the list of prioritized DREAM Candidates and can adjust the points, any thresholds, and any weighting to regenerate a prioritize list of CATCH Candidates whereby Candidates under a certain threshold of points are no longer in the consideration to become a CATCH and those above the threshold are considered to be within a Candidate CATCH profile range for such things as a distance between cities, where it may not be realistic to travel that distance; Boolean operations where the appropriate NEED MGR can say select only one city per country and if one city scores a certain number of points above all other cities within that country, it then places the other lower cities from that same country below the cutoff threshold. Theses below the threshold cutoff line cites for a particular country could reemerge, should a NEED MGR with the appropriate permissions decide to eliminate the highest city for that country for some particular reason, and thus remove the condition for removing one, some or all of the cities from that particular country that were previously below the cutoff threshold line.

A CATCH-M MGR can view the list of prioritized CATCH Candidates and select the top Candidate or another Candidate from the list of prioritized CATCH Candidates to become the final CATCH. Depending upon a CATCH Goal, the CATCH can comprise of one European city or a plurality of European cities. If the CATCH Goal includes visiting, say four European cities, where no two cities can be within the same country and where no travel segment between cities should exceed, say 500 kilometers, then the CATCH-M MGR could also selective select and/or eliminate European's cities from the list of prioritized CATCH Candidates to see how it effects the remaining options on the list. For instance, by eliminating just one city from the list of prioritized CATCH Candidates, such as Rome, Italy, the list might bring back other cities to the formula such as, say Nice, Italy, and thus change several of the collective four city arrangements offered in the list of prioritized CATCH Candidates.

These M.A.T.C.H. module options 412, 414, 416, 418, 420, 422, and 438 are tracked and measured independently, and collectively as a unit against and relative to a particular Campaign 103, and/or Campaign element to measure their effectiveness and success rates against different Campaign 103 elements, PAM Rules, ADSTATS Rules, TIMES Rules, DREAM Rules, Billing Rules, Budgeting Rules, Bidding Rules, Account Rules, and Real-time Reporting. The MATCH MGR 51 can use a B.B.B.M. 114 module option to assign Billing, Budgeting, and Bidding Rules to, say the Job Post.

A “Thresholds, Weighting & Ranking 440 module option can be set up to place a variety of weighting, prioritizations, and rules to the collective measurements and results. For example, a particular Job Criteria ID, say one for a particular software skill which may prove to be far more effective at attracting applicants who are best suited for a particular Job Opening when relatively compared to other Job Criteria IDs over time and thus more weight could be applied towards that particular Job Criteria ID for that particular software skill.

The HIRES 102 measures a NEED Criteria ID's (e.g. a Job Criteria) success and this data can also be incorporated into the selection of a future NEED Criteria for similar Job Postings. A NEED Criteria ID's relative success in attracting a large pool of potential Applicants, Applicants who Inquire, Applicants who qualify as Candidates and Candidates you get offers can also be measured and incorporated in the selection of future NEED Criteria ID(s) and Campaign 103 elements by the MATCH MGR 51.

For example, the MATCH MGR 51 could request to see those Criteria elements that data supports as being the most successful for finding a Candidate the fastest for a particular software computer skill for a particular region of the country and to what degree certain thresholds for the Criteria have relatively affected the Candidate pool for the better or for the worse.

For example, data could support that requiring Applicants to answer at least 17 out of 20 questions correct on a particular software skill test to pass compared to allowing 15 out of 20 as passing, might reflect a reduction in the number of Candidates who qualify for a particular job position by 33%. If this reduction, saves the company time in the interviewing process, while still hiring the type of Candidate the Company is seeking, then the MATCH MGR 51 can utilized this knowledge in new job postings.

On the other hand, if past employees or Contractors who the Company felt were well-suited for the same position were shown to occasionally score below 17 out of 20, but above 15 on the same test, the MATCH MGR may want to keep the passing level at 15 for the job opening. In addition, the MATCH MGR could see if Applicants are typically getting the same question wrong and determine if the question is in fact relevant for the position, if it's perhaps worded poorly, and/or if corrections could be made to the test to provide better results. If the test is provided by a Software Company or another third party, this change in question(s) can be set to override the existing test question and/or where a request-change is sent back to the author of the test and/or the criteria.

Each new MATCH Element could be set to run against previous MATCH Elements in general and similar MATCH Elements to track and make sure that the new MATCH Element is in fact performing relatively similar, or report back that it is off by a quantifiable degree, and make suggested changes based on the area where the new MATCH Element deviates from methods that are relatively more tried and true. New and modified MATCH Element and Rules resulting in measurably successful surveys, tests, and/or Interviews that can be previewed against an existing MATCH Elements to see the results and/or saved with a Preview/Save 444 function.

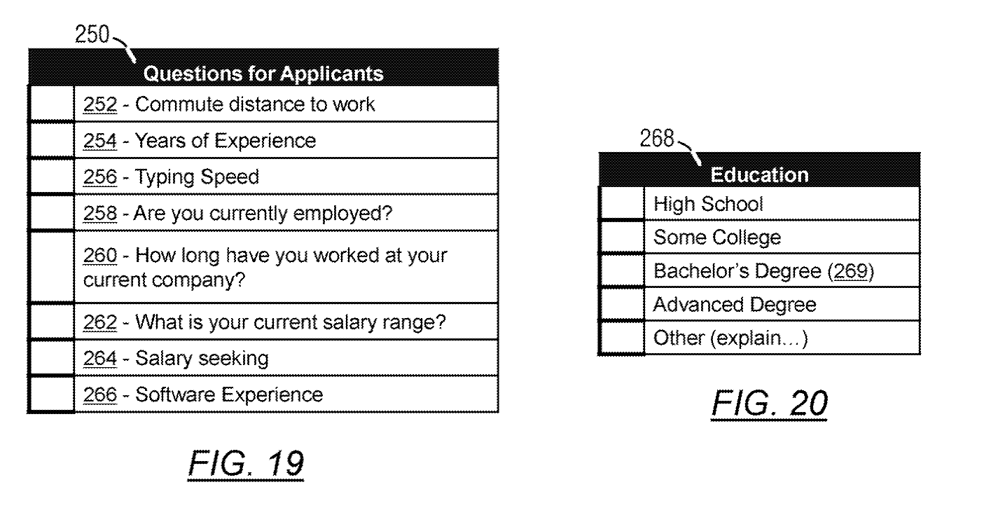

FIG. 19 depicts an embodiment and an example of Questions for the Applicants that could represent the entire set of criteria for a particular job position created by the MATCH MGR(s) 51 or it could represent a subset of criteria that were selected by the PAM-MGR 50 for a particular job position. When the PAM-MGR 50 has selected a particular Job Position to Post, the HIRES 102 then generates and prompts the PAM-MGR 50 with a list of criteria questions that are predetermined to be relevant for that type of specific position. Depending on the rules and conditions established within the HIRES 102 system the PAM-MGR 50 can be allowed to go through the list of criteria to determine which criteria questions are most relevant for the current Job Opening, to what degree the questions/content is relevant, and in what order the questions should appear.

On the other hand, the MATCH MGR 51 could pre-establish that certain criteria must appear for certain job positions, and/or job openings. For example, if it's important that the Job Applicant be an expedient typist, the MATCH MGR 51 can set a minimum number of Words per Minute and/or Accuracy required to be considered a Candidate, to obtain an interview, and/or be hired for a particular position. The MATCH MGR 51 can also prioritize where this specific Job Requirement ranks among all the other Job Requirements, e.g. 1^{st}, 2^{nd}, 3^{rd}, or some other level among the total number of questions for the Applicants participating and/or targeted. This is not necessarily the same as the sequential order in which the questions will actually appear to a particular Applicant.

For example, the number one desired skill may have a particular question associated with it, but it may appear in a position other than number one, randomly, and/or based on some other criteria, such as based on the number of Applicants who have applied. If no one has applied or only a relatively small number, this question may appear first or at least early in the sequence order, but if there are several Applicants, this question order could float after a particular threshold, say of Applicants, Candidates, and/or time has been met.

The MATCH MGR 51 could also pre-establish that certain criteria can not be used, and/or that certain questions must flow in a certain order. For example, criteria could have a hierarchy of follow-up questions that would or would not become available when selected by the PAM-MGR. For example, the PAM-MGR had permission to include or not include a criteria for being a good typist, once the PAM-MGR selected that criteria, a list of criteria follow-on questions could become available to discern to what degree the Applicant was or was not a good typist. With follow-on questions asking such thing as what software, for how long, submit examples, number of words per minute, for how long typing at that designated speed(s)/accuracy(s), and/or an actual typing test.

FIG. 20 depicts an embodiment example of Education 268 levels completed that could represent the entire set of criteria for a particular job position created by the MATCH MGR(s) 51 or it could represent a subset of criteria and/or available responses that were selected by the PAM-MGR 50 for the particular job position. Depending on what preset education criteria was set by the MATCH MGR 51 beforehand, a more detailed list of questions within each education category relevant to that position could be mandatory or available for possible inclusion.

For example, a list for the “Highest Level of Education Completed”, where the MATCH MGR 51 would simply click the appropriate level required. This list would then eventually appear as a question to the Job Applicants inquiring about the position.

When the PAM-MGR 50 has selected a particular Job Position to Post, the HIRES 102 then prompts the PAM-MGR 50 with a list of education criteria questions that are predetermined to be relevant for that type of specific position by the MATCH MGR. Depending on the rules of the HIRES 102 system the PAM-MGR 50 can be allowed to go through the list of education criteria to determine which education responses are made available to the Applicant.

For example, the minimum education allowed for the position may be, say a Bachelor Degree 269, but the PAM-MGR 50 may allow for additional responses to collect data regarding where and how the Applicants breakout in terms of education. The education criteria may allow the applicant to expand into where the degree was from, what courses were taken, how long ago the courses were taken, and/or to expand on details of his/her education.

The details could reveal that the current threshold of at least a Bachelor Degree is removing 90% of the Applicants. An analysis of the data over time could reveal that by making a minor adjustment to allow for Applicants who fall short by X measurement, say a certain number of education credits from his/her Bachelor Degree could also be allowed to qualify, and according to the data generated, say increase the pool of qualified Applicants from 10% to 25% without greatly reducing the quality of Applicant pool according to historical data on those Applicants who would not otherwise qualify relative to historical data on how he/she has performed at the same or similar positions in the past.

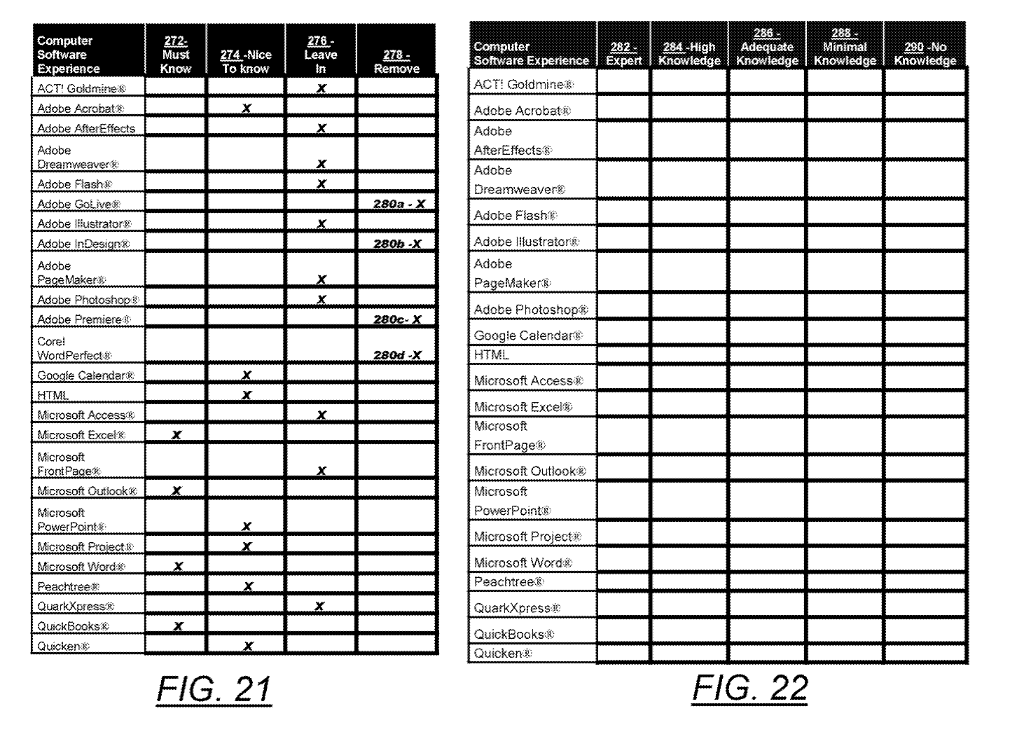

FIG. 21 depicts an embodiment and an example of how generally the MATCH MGR 51 could have setup the Software Criteria for a particular Job Position. Depending on the rules setup by the MATCH MGR 51 these software skill requirements can be pre-established and set by the MATCH MGR 51. The MATCH MGR 51 can also allow certain other roles and/or permission ID sets to adjust or create these settings. For example, the MATCH MGR 51 may grant permission to a particular PAM-MGR 50 to select these settings for a particular job, but not necessarily grant the same privileges to all PAM-MGRs 50 or for all job positions.

In this instance, each row lists a unique software program. The columns represent the degree in which the Applicant is required to be familiar with each software program to qualify as a Candidate for a particular Job Position. A “Must Know” 272 column allows the MATCH MGR 51 or for the NEED Mgr with at least equivalent to the MATCH MGR 51 permissions and privileges to indicate which software programs the Applicant “must know” to qualify as a Candidate for the particular Job Position.

A “Nice to Know” 274 column allows the MATCH MGR 51 to indicate which software programs that it would be “nice” if the Applicant knew them for the particular Job Position. A “Leave in” 276 column allows the MATCH MGR 51 to indicate which software programs that should be “left in” as possible responses by the job Applicants for the particular Job Position.

A “Remove” 278 column allows the MATCH MGR 51 to indicate which software programs should be “removed” as possible responses for the job Applicants for the particular Job Position. For example, existing data analysis may reflect that is a correlation between having too many possible responses available for the Applicant regarding what existing software program skills he/she possesses and Applicants abandoning the PAC or PIN at this particular step in the Application process.

Each criteria in the Application (e.g. PAC/PIN) would ideally have a timestamp relative to how long is considered too for the Applicant to reply to that particular question relative to other factors, such as other questions in the same section of the Application, relative to other applicants applying the same position for the same PAC and/or PIN now and/or from previous PACs and PINs for the same position. If the questions must be answered or answered in a particular order that data is also collected and analyzed.

On the other hand, data may also indicate that only presenting the Applicants with software applications known to be critical for success for a particular job position also tends to bias the responses by the Applicants towards those particular software program requirements. Consequently, data analysis over time may indicate that it is better for a particular job positions to include more or less responses that are perceived to be relevant software programs for a particular job opening to prevent applicants from gaming the system, e.g. his/her responses to what is perceived to be desired by the Company.

In addition, tracking the responses and time intervals for these responses could lead to discovering skills, such as a particular software program that may have not be considered critical or important for a particular job position. For instance, historical data could reflect that a particular criteria element, originally thought to be relatively insignificant (such as a particular software program skill) has been found in a majority of successful hires. Success could be measured by a system employing such quantifiable data items and correlations as job performance/reviews by managers, Peers, clients, recruiters; longevity at the position; production output; revenue generated and attributable to the particular hire; individually and/or collectively that have been determined to prove more important than previously considered by the MATCH MGR 51.

For instances, data analysis of historical data may create a correlation between good and bad hires based on a particular software program, such as Adobe Photoshop, where it was originally considered relatively uncritical or unimportant for a particular job position, such as a clerical position. However, the particular software skill, and/or a particular feature or degree of skill for the particular software skill may prove to be an excellent indicator or far greater indicator than previously perceived regarding the likelihood of the hire to perform well at the particular position.

In FIG. 21, an “Adobe's® GoLive®” 280a, an “Adobe's® InDesign®” 280b, an “Adobe's® Premiere®” 280c, and a Corel's® WordPerfect®” 280d have been marked for “removal” from the Job Application for a particular job position and/or a particular PAC and/or PIN. Meaning these potential applicant questions regarding his/her applicable skills will be removed from the criteria.

FIG. 22 depicts an embodiment and an example of how the list of available Applicants Responses would eventually appear to the Job Applicants based on the preset criteria in FIG. 21. In this instance, the Applicant would see all software except those that the PAM-MGR 50 marked as “Remove” from application and/or survey.

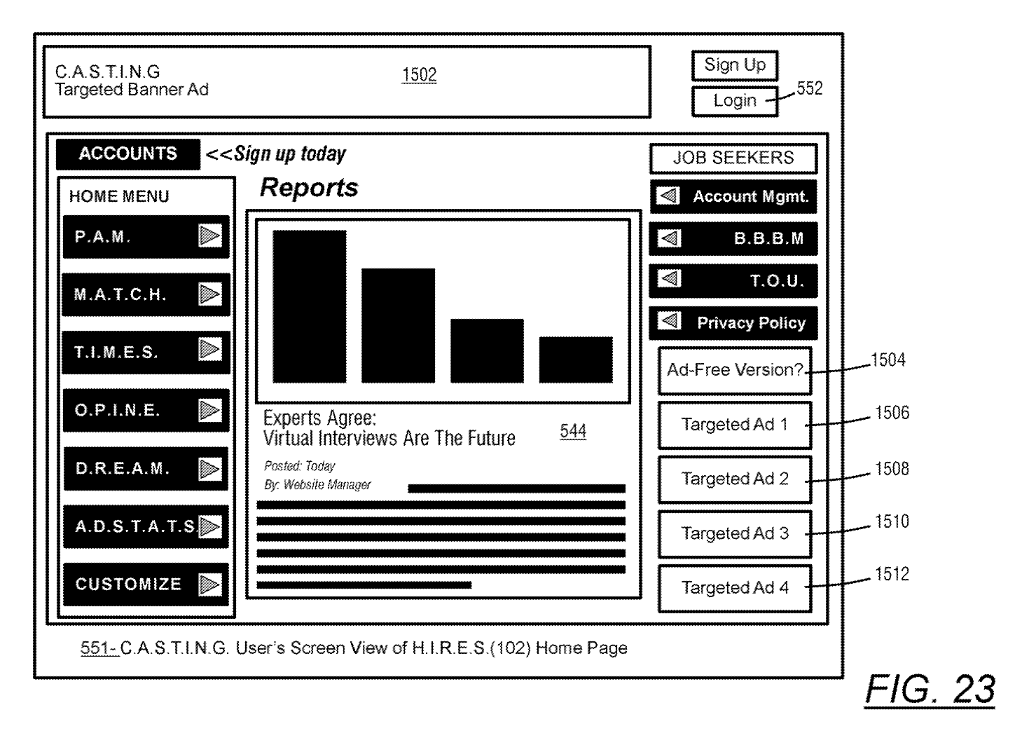

FIG. 23 depicts an embodiment and an example screenshot of the user interface and Home Page as would be seen by an account with the role and permissions of a CASTING Account. A “CASTING User's Screen View of HIRES Home Page” 551 appears based either on a particular URL assigned to CASTING accounts, based on such things as a CASTING user ID and/or segmentation rules, a cookie ID, a session ID and/or any other known information about the user and/or the transceiver communicating with the HIRES 102 system, such as a GPS location; triangulation, X, Y, Z coordinate system, and/or IP address. A “login” 552 function allows the user to login to the HIRES 102 system to obtain the privileges assigned to his/her particular role and permission settings.

Before a CASTING user has logged into the home page and/or other HIRES webpages the system could still have displayed content, advertisements, target advertising that are generated and displayed based upon information known about the Transceiver, the CASTING users in general and/or from information known about the particular CASTING user, say based upon his/her IP address, cookie(s), session IDs, and the like.

The Casting Home Page depicted as a “CASTING User's Screen View of HIRES (102) Home Page 551 screenshot, also has an example display of a CASTING Targeted Banner Ad 1502 which can be supplied and based upon such things as ADSTATS inventory and rules, including such things as the specific CASTING user type, roles & permissions; current/relative usage, historical usage, and/or navigation.” The site could allow for a variety of functionality based upon the Account 60 type; the CASTING user's roles and permissions; and/or whether the Account 60 is a paid subscriber/member or not.

A function 1504 depicted with an “Ad-Free Version”, is an example where the CASTING user could accept, reject, and/or modify the content, advertising, and/or targeting components of the user interface, where a Target Ad (1) 1506, a Target Ad (2) 1508, a Target Ad (3) 1510, and a Target Ad (4) 1512 could be targeted towards the CASTING USER based upon such things as which Account had the highest advertiser Bid for the targeting the current conditions and/or CASTING user of the HIRES through the ADSTATS 116 and/or the BBBM 114, and/or inventory rules.

The content, advertisements, inventory, Ad Targeting rules and the like displayed for the CASTING User on the “CASTING User's Screen View of HIRES (102) Home Page 551 are typically generated, interactive with, and pushed out by the connected SEARCH 100, but could also be generated and pushed out by a local file server and database, such as the HERDS Server 64 and HERDS DBs 62 (shown in FIG. 6).

This content and targeted advertisement further benefit from any data known about a particular CASTING user when he/she logs into the HIRES system utilizing a Login 552 function. For example, the CASTING user can select to view and/or interact with specific website content such as, say an article depicted by an area 544. The content selected by the user reveals information about the user and the duration, manner of usage, and navigation in/out of this article/content can be stored and compared with other users to build data table for advertising and content interaction success rates, such as, but not limited to click-throughs, views, dwell times, links in/out, actions taken/not-taken, abandonments, revisits, and/or actual purchases.

This home page could also be displayed on a mobile device (not shown) and could also have the same functionality, targeted content and/or targeted advertisements that could be pushed and/or pulled from the SEARCH 100 and/or NEED 82 that can either is requested by the CASTING user, already queued up on the mobile device, and/or driven by other events, such as the CASTING user's user-interface navigation, ability to provide information and/or reply to a particular question by another Account manager, and/or from a particular JOINS 70 users, and could also factor in the time of day, GPS coordinates, location tracking, triangulation, and/or some combination of these methods and/or with Campaign rules and conditions, such as whether there is a relative urgency to fill a particular PAC 104 by a particular moment in time, by a particular Candidate 73 with a particular MATCH 120 for a particular NEED 82 or not.

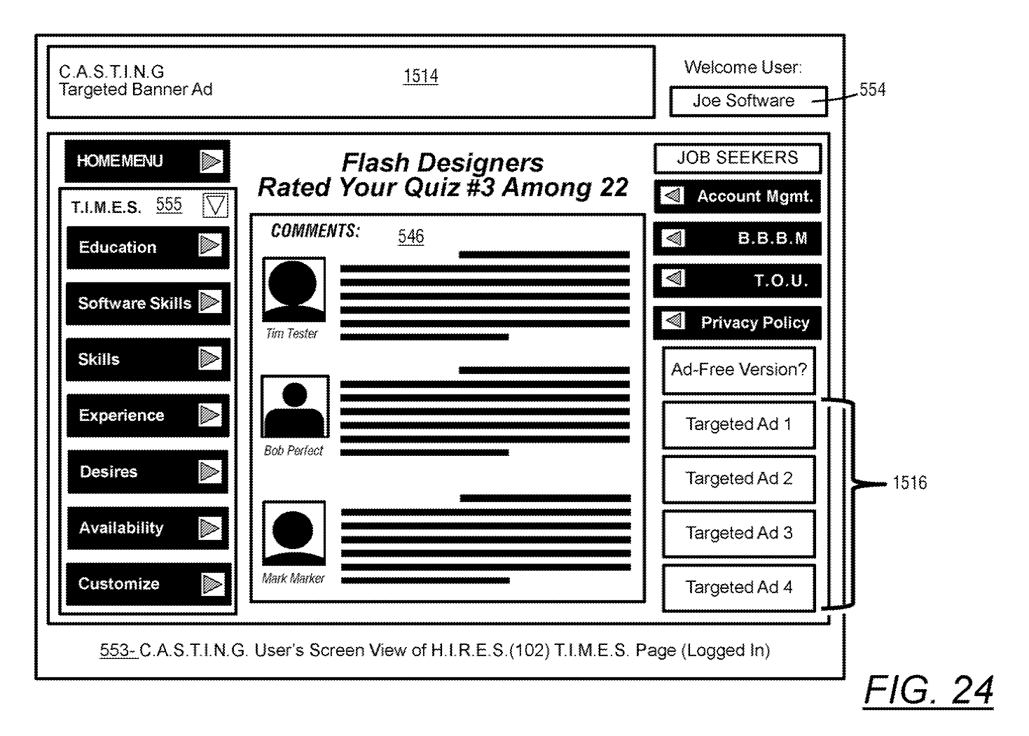

FIG. 24 depicts an embodiment of an example screenshot of the user interface after a particular CASTING user has logged into the HIRES 102 system. In this instance, a “CASTING User's screen View of HIRES 102 TIMES Page (Logged In)” 553 screen, the CASTING user, a “Joe Smooth” 554 has logged in and advanced to the TIMES 122 module by utilizing a TIMES 555 menu selection.

To advance to the TIMES module the user's role and permissions would require that the user had a roles that was at least equivalent to a “Testing and Interviewing Scheduler(s)” 52, hereinafter a “TIMES Mgr” 52 and/or permission settings at least equivalent to the TIMES MGR 52.

Note that the targeted ads depicted in section 1516 could update with such events as each page change to the “CASTING User's screen View of HIRES 102 TIMES Page (Logged In)” 553 screen and/or per such things as the CASTING user's usage, as the time of day, GPS coordinates, location tracking, triangulation, and/or some combination of methods, and/or with Campaign rules and conditions, such as whether there is an urgency to fill a particular PAC 104 by a particular moment in time, by a particular Candidate 73 with a particular MATCH 120 for a particular NEED 82 or not.

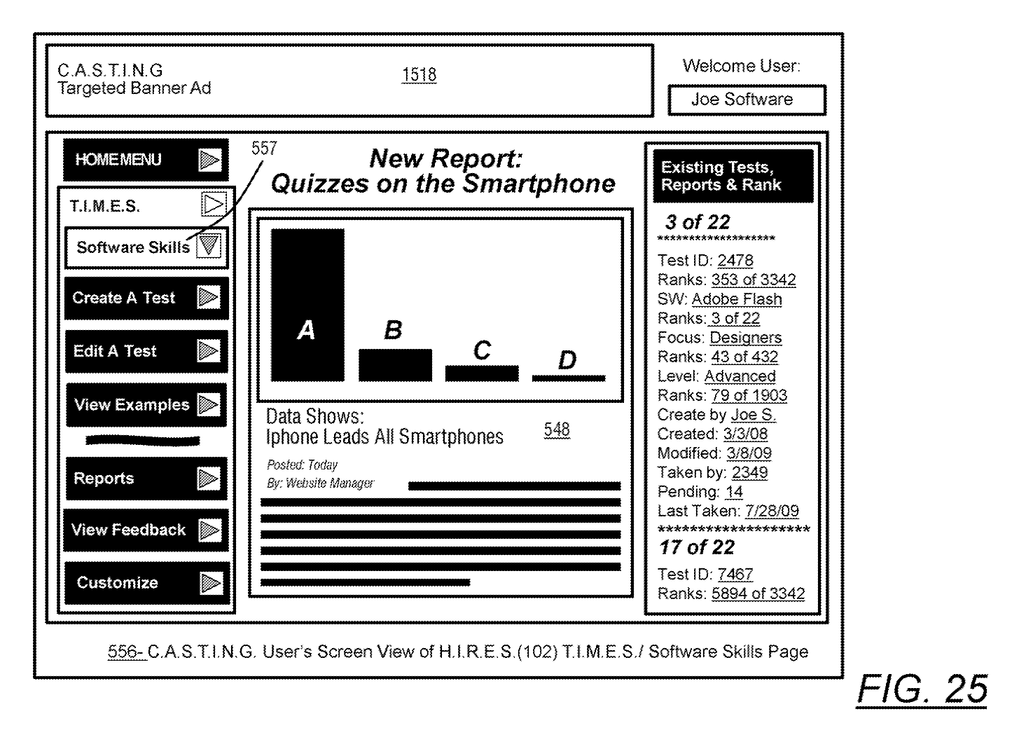

FIG. 25 depicts an embodiment and an example screenshot of the CASTING user interface after the CASTING user has selected software skills under the TIMES menu heading. In this instance, a “CASTING User's screen View of TIMES/Software Skills Page” 556, has been selected utilizing a “Software Skills” 557 menu selection. This causes the subsequent and appropriate menu selections to change.

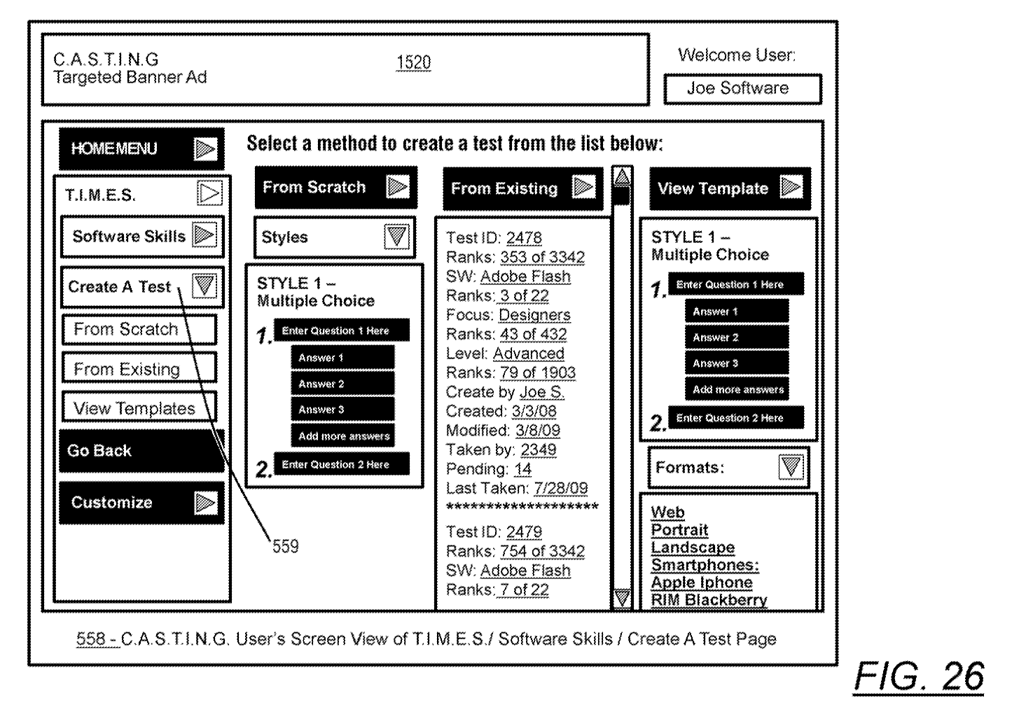

FIG. 26 depicts an embodiment of an example screenshot of where the user interface after the CASTING user has selected to create a test under the Software Skills menu heading. In this instance, a “CASTING User's screen View of TIMES/Software Skills/Create A Test Page” 558, has been selected utilizing a “Create A Test” 559 menu selection. This causes the subsequent and appropriate menu selections to change accordingly.

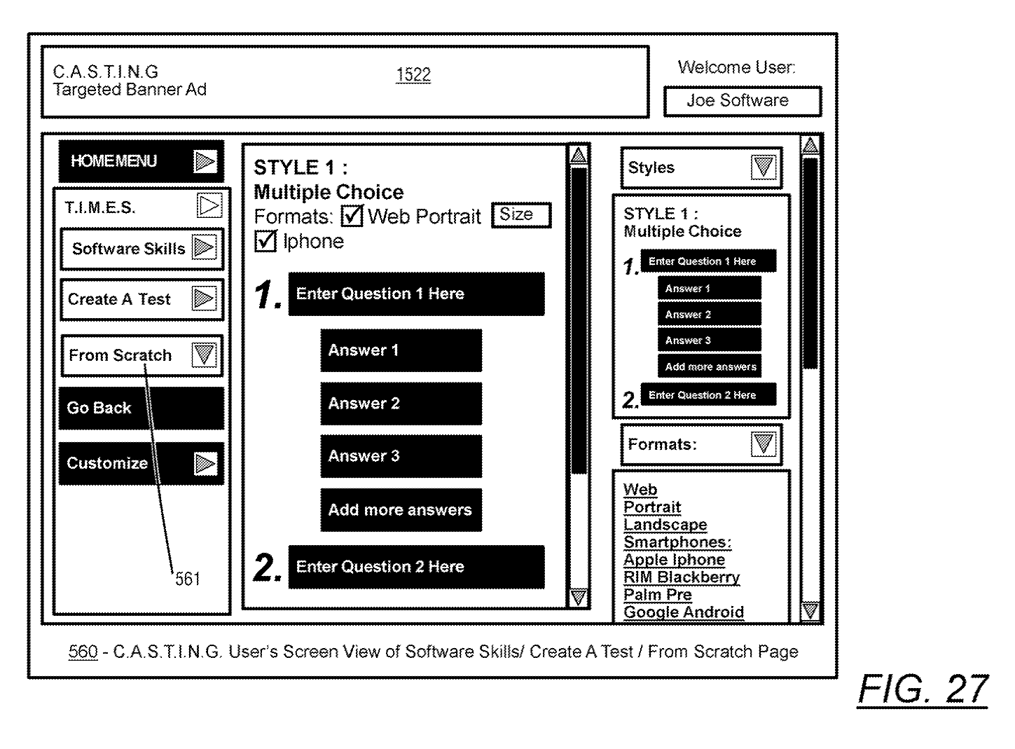

FIG. 27 depicts an embodiment of an example screenshot of the user interface after the CASTING user has selected to create a test from scratch. In this instance, a “CASTING User's screen View of TIMES/Software Skills/Create A Test/From Scratch Page” 560, has been selected utilizing a “From Scratch” 561 menu selection. This causes the subsequent and appropriate menu selections to change accordingly.

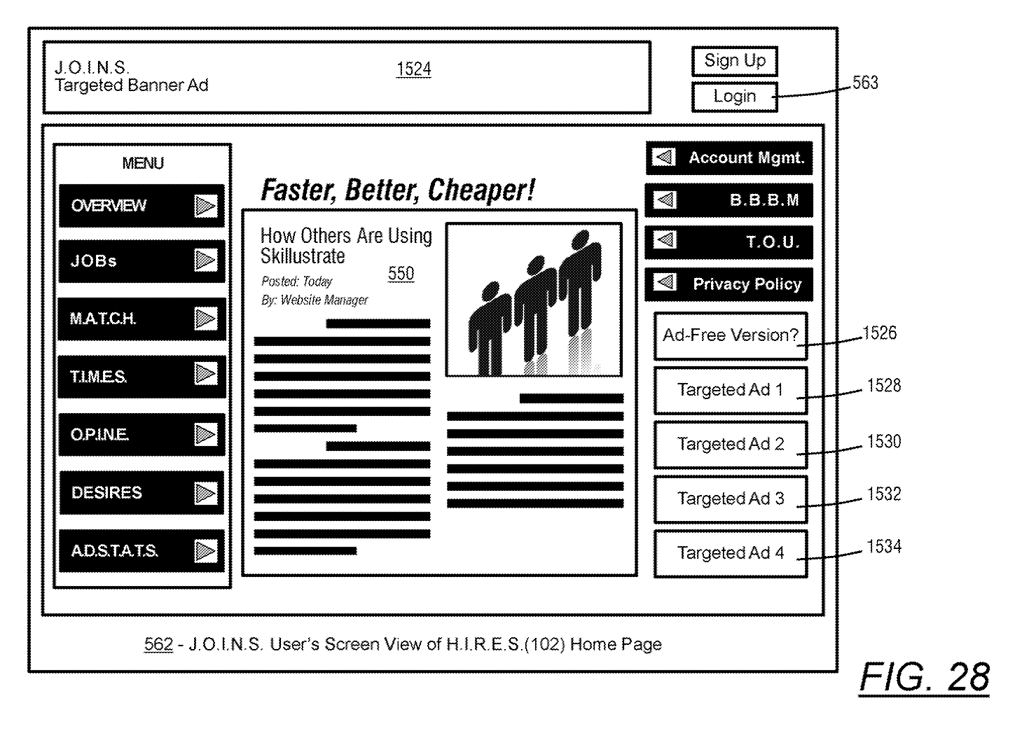

FIG. 28 depicts an embodiment of an example screenshot of the JOINS user interface and Home Page as would be seen by an account user with the role and permissions of a JOINS user. A “JOINS User's Screen View of HIRES Home Page” 562 appears based on a particular URL assigned to JOINS accounts, based on a cookie ID, IP address, and/or a session ID within the communicating device with the HIRES 102 and NEED system. A “login” 563 function allows the user to login to the HIRES 102 system to obtain the privileges assigned to his/her particular role and permission settings.

Before a particular JOINS user has logged into the home page and/or other HIRES webpages the system could still have displayed content, advertisements, target advertising that are generated and displayed based upon information known about the Transceiver, the JOINS users in general and/or from information known about the particular JOINS user through, say based upon his/her IP address, cookie(s), session IDs, and the like.

The “JOINS User's Screen View of HIRES (102) Home Page 562 screenshot, also has an example display of a JOINS Targeted Banner Ad 1524 which can be supplied and based upon such things as ADSTATS inventory and rules, including such things as the specific JOINS user type, roles & permissions; current/relative usage, historical usage, and/or navigation.” The site could allow for a variety of functionality based upon the Account 60 type; the JOINS user's roles and permissions; and/or whether the Account 60 is a paid subscriber/member or not.

A function 1526 depicted with an “Ad-Free Version”, is an example where the JOINS user could accept, reject, and/or modify the content, advertising, and/or targeting components of the user interface, where a Target Ad (1) 1528, a Target Ad (2) 1530, a Target Ad (3) 1532, and a Target Ad (4) 1534 could be targeted towards the JOINS USER based upon such things as which Account had the highest advertiser Bid for targeting the current conditions and/or JOINS user of the HIRES through the ADSTATS 116 and/or the BBBM 114, and/or inventory rules.

Accounts could bid/compete against other bidders to target completely different elements, conditions, segments, and/or user segmentations, but where the total bid amount placed is factored into which bidder's Campaign (PAC/PIN), Ad, Content, and the like; out weighs and beats out other bidders in terms of say dollar amount per bid, per appearance, per budget over time for a particular appearance on the page, a particular occurrence (how often), a particular rank (top to bottom, where top is, say the best) and/or the like. As well as delineating the bidding pool to specific segments, such as a particular time of day for the appearance and/or the bidding, particular website for the appearance, a particular geographic location for the bidders, a particular user segment for the bidders and/or a particular geographic location for the appearance, based upon, say an IP address.

The content, advertisements, inventory, Ad Targeting rules and the like displayed for the JOINS User on the “JOINS User's Screen View of HIRES (102) Home Page 562 are typically generated, interactive with, and pushed out by the connected SEARCH 100, but could also be generated and pushed out by a local file server and database, such as the HERDS Server 64 and HERDS DBs 62 (shown in FIG. 6).

This content and targeted advertisement further benefits from any data known about a particular JOINS user when they log into the HIRES system utilizing the Login 563 function. For example, the JOINS user can select to view and/or interact with specific website content such as, say an article depicted by an area 550. The content select reveals information about the user and the duration, manner of usage, and navigation in/out of this article/content can be stored and compared with other users to build data tables, schema, business logic, algorithms, and/or algorithms rules for advertising and content interaction success rates, such as, but not limited to click-throughs, views, dwell times, links in/out, actions taken/not-taken, abandonments, revisits, and/or actual purchases.

This home page could also be displayed on a mobile device (not shown) and could also have the same functionality, targeted content and/or targeted advertisements that could be pushed and/or pulled from the SEARCH 100 and/or NEED 82 that can either be requested by the JOINS user, is already queued up on the mobile device, and/or driven by other events, such as the JOINS user's user-interface navigation, ability to provide information and/or reply to a particular question by another Account manager, and/or from a particular CASTING 70 users, and could also factor in the time of day, GPS coordinates, location tracking/triangulation, and/or with Campaign rules and conditions, such as whether there is a relative urgency to fill a particular PAC 104 by a particular moment in time, by a particular Candidate 73 with a particular MATCH 120 for a particular NEED 82 or not.

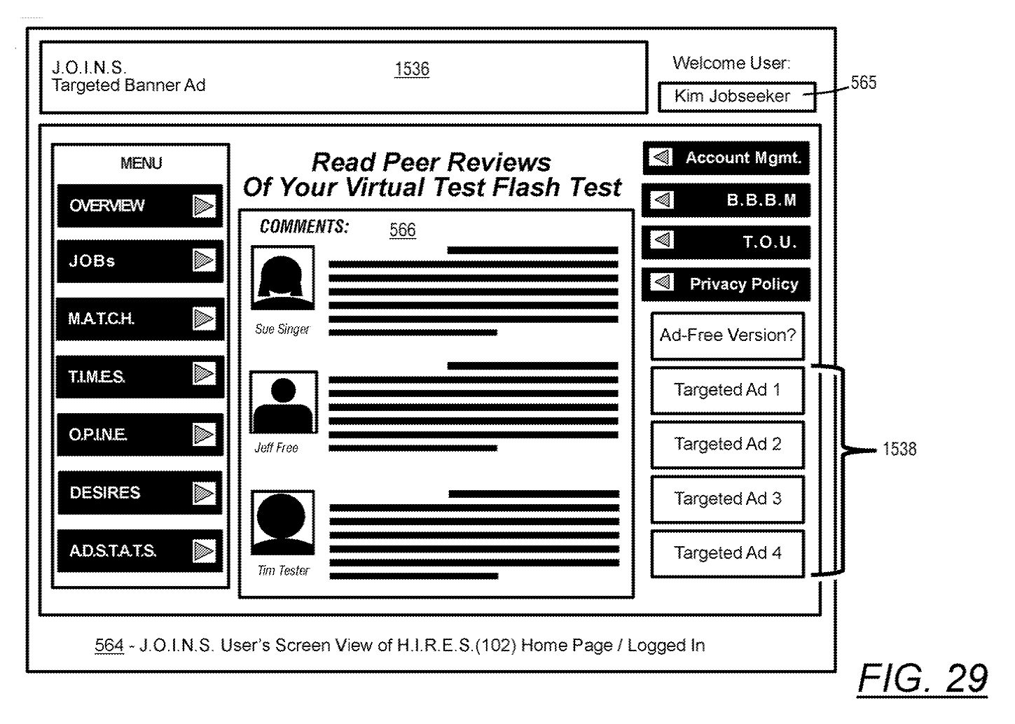

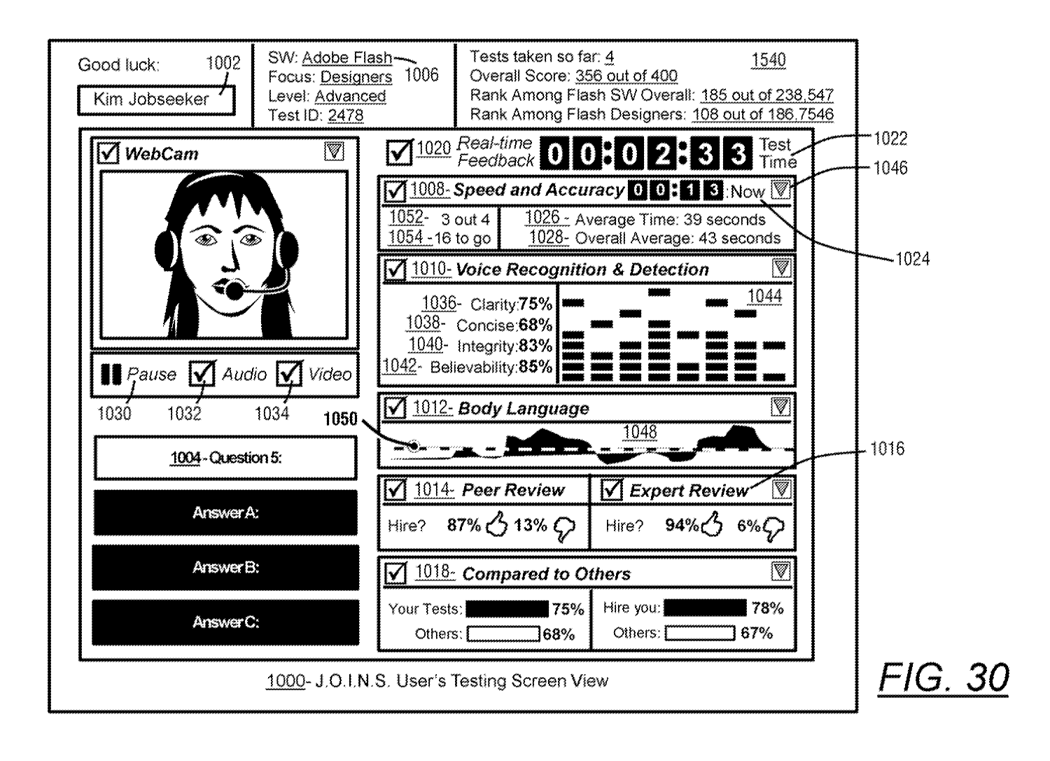

FIG. 29 depicts an embodiment of an example screenshot of the user interface after a particular JOINS user has logged into the HIRES 102 system. In this instance, a “JOINS User's Screen View of HIRES 102 Home Page/ Logged In” 564, where the JOINS user, a “Kim Jobseeker” 565 has logged in. This causes the subsequent, appropriate menu selections, targeted content, and/or targeted ads to change accordingly.

In this example, the JOINS user “Kim Jobseeker” sees a home page with content relevant to her specifically. A “Comments” 566 section reflects comments left by other users that represent feedback directed to a subject that this particular JOINS user has indicated an interest towards and/or as feedback to this particular user specifically.

For instances, this feedback could be from such groups as a group of PAM-MGRs with inside knowledge regarding the specific job position; a group of PAM-MGRs with knowledge in general about similar job positions; a group of Applicant Peers with specific feedback for the specific job opening, job position, company, and/or similar job opening, positions, companies, or the like; a group of Applicant Peers with feedback in general about similar job positions; and/or a group of Applicant Peers with feedback in general for the similar job opening, job position, companies, and the like. If this particular user had applied for a particular job, the feedback could be specific to that particular job opening, position, company, questions asked on the Applicant, his/her answers given, and/or the like.

The feedback can be isolated to one particular group and/or come from a collection of groups. The ability to give and receive feedback to a particular JOINS user can be set by a number or parties. For instances, the HIRES 102 system can allow the Company with the PAC and/or PIN to grant, deny, and/or allow feedback to Applicants. This ability and/or the level of functionality applied to this feature may also be dependent upon the Applicant seeking the feedback and/or dependent on the group's willingness to provide the feedback.

This ability and/or the level of functionality applied to this feedback feature may be dependent on fees paid by the Company with a particular PAC and/or PIN; dependent on fees paid by the Applicant seeking the feedback; and/or dependent on fees paid by the groups seeking to provide the Applicant the feedback.

For example, a particular company may allow feedback for a particular PAC only to Applicants who meet some group of conditions, but who did not qualify for the job position, and only from pre-qualified MATCH MGRs, such as Software Companies who's testing tools employed by the Company (NEED) for the particular PAC; where pre-qualified NEED Mgrs, such as those NEED Mgrs that were involved with a face to face interview and that currently employed by the Company; and/or pre-qualified PAM-MGRs, such as those PAM-MGRs who are Job Recruiters hired by the company.

The HIRES 102 system could be set to prescreen particular feedback, a segment of feedback, and/or all feedback regarding the how appropriate the responses are and to avoid certain types of language usage or an interpretation of discrimination, inflammatory remarks, and/or remarks that may lead to legal repercussions (for such things as libel). This prescreen tool would incorporate previous case law for known terms and comments ruled by the courts to be inappropriate for hiring in general and/or for a particular set of circumstances and conditions.

To provide feedback the user's role and permissions would require that the user had a role that was at least equivalent to an “Opinions and Pointers to Improve a NEED or an Employee Reply” 76, hereinafter an “O.P.I.N.E.R.” 76 and/or a user with permission settings at least equivalent to the OPINER 76. The OPINER 76 permissions are setup using the OPINE 124 module.

FIG. 30 depicts an embodiment of an example screenshot of the user interface after the user has selected to partake in a virtual interview with real-time feedback. In this instance, a “JOINS User's Testing Screen View” 1000, and a particular user, “Kim Jobseeker” 1002 is logged in. She is currently on a question 5 (1004). The test is for an Adobe Flash 1006 software program skills assessment. She has selected a variety a test monitoring, assessments, and feedback tools, starting with a “Speed and Accuracy” system's 1008 checkbox option, a “Voice Recognition and Detection” 1010 system's checkbox option, a “Body Language” 1012 system's checkbox option, a “Peer Review” 1014 system's checkbox option, an “Expert Review” 1016 system's checkbox option, and a “Compared to Others” 1018 system's checkbox option.

She can obtain all this feedback after taking the test and/or she can select a “Real-time Feedback” 1020 system's checkbox option to see the feedback as it comes in real-time and/or near real-time. This real-time feedback can have preset thresholds where the feedback only appears when a predetermined event occurs, such as where an amount of data has been collected and surpasses a threshold to create a meaningful result, and/or only after an answer was given.

The results can be finite and limited or the results can be dynamic and change over a window of set time. For example, if the results are to be finite and limited for, say the “Peer Review” 1014 system, where the threshold may require at least 6 Peers to respond with useable data within a certain period of time, before the “Peer Review” 1014 system displays any results. These results could be for a preset question, questions, and/or criteria. If for example, the “Peer Review” 1014 system is per question, then the results would changes as the questions change, assuming there is sufficient usable data input that can be measured and surpasses preset thresholds.

On the other hand, the results for “Peer Review” 1014 system could be dynamic and change over time as more and more Peers add their feedback. The window of time to respond could be limited to such windows of set time as: the time it takes for the Applicant to answer the next question, the time it takes for the Applicant to finish the entire test, while the Applicant remains a possible Candidate, remains a possible hire, while the Applicant's account is in good standing (e.g. membership fees paid), and/or as long as the Applicant is willing to let the Peers add his/her opinions.

These opinions do not have to come while the Applicant is taking the test and/or in a live interview, but can instead come from Peers, Experts, and/or software assessment tools that can review all the available content and/or data after a test, interview, and/or the like.

The range of assessment tools and the specific features available will depend on the survey, test, interview, and/or specific questions being asked. Some questions will lend themselves better to certain types of assessments and/or will have more content and/or data collected for creating better measurements, assessments, and relative correlations. The user creating the question(s), generally the MATCH MGR, can notify the Applicant regarding the type of assessments, measurements, feedback data, and the like that exists and/or is available for a particular survey, test, interview as a whole, and/or for a particular question in terms of perceived accuracy, existing user feedback data regarding the perceived accuracy, and the quantifiable accuracy.

For example, a question with a finite range of possible answers and a single correct answer would lend itself to testing the Applicant's accuracy to answer the question, better than a subjective question that allows the Applicant to answer with anything that comes to the user's mind. However, over time data collected, measured, and quantified, even for the most subjective questions and user feedback can start to build a correlation database for both a perceived accuracy of the given answer from, say words used and the like, and a quantifiable accuracy for a given answer.

The perceived accuracy could come from, say a predefined segment of Peers and/or Experts (e.g. Peer Groups and Expert Groups) with similar job experience and the quantifiable accuracy could come from assessing the words used against a pre-defined database. As the amount of possible answer and the range of acceptable answers grew and improved, values such as the perceived accuracy and the quantifiable accuracy can be combined and compared with others who have answered the same question and/or questions.

In addition, the level at which Peer data and/or Expert data is incorporated can be weighted to how the community at large and/or the assessment tools gauge the particular Peer's or Expert's opinions and feedback as a whole and/or relative to conditions, say for a particular question and/or jobs. This collection of Peer and Expert data, opinions, and feedback creates a ‘checks and balances’ system for constantly assessing the collective wisdom of the community as a whole, and/or a segment of wisdom based on someone's collective expertise towards a particular question and/or job.

For example, a question regarding what is the best method for selling a new product into a niche market, may have a range of experts who have supplied potential answers to the question. Depending on the expert's measurable direct experience within the Industry, type of product, type of distribution channels, and/or niche market, can also be incorporated to determine the weight given to his/her responses. For instance, three experts (A, B, and C) may supply suggested answers to this particular question regarding a new product, which in this example could be a 3D projector for a high-end cinema.

For this example, say Expert A has 15 years expertise in selling digital products at retail, Expert B has 20 years expertise in selling projectors to cinemas, and Expert C has 3 years expertise at selling 3D projectors to the movie industry. The MATCH MGR who created the question can pre-establish a set of rules by which these different experts will have their answers weighted that the Experts provide to build a pool of available answers. A collective score could be derived from the number of years of experience per relevant channel of expertise and selling.

Another method would first measure the experts equally, and then based on the answers given and the answers later reviewed to be best for the questions, the system would go back and build a profile of the type of expert and experience which measurably proved to be most accurate. This profile could then be used for similar questions, job positions, and/or job categories where the data was measurably proven to maintain relevance over time.

Back to FIG. 30, the “Speed and Accuracy” 1008 system's checkbox option would allow the system to track the speed and accuracy of the answers provided to questions by the Applicant relative to other Applicants who are also currently applying for the same PAC and/or PIN; others who have applied for similar PACs and/or PINs; others who have answered the same question(s); and/or others who have answered similar questions and/or the like. An example of could be for a question asking how far he/she was willing to commute, where the system measurably compares how quickly others answered a similar question, say where the commute could have been for entirely different job, company, and/or location by similar enough to draw quantifiable correlations.

A “Test Clock” 1022 reflects the overall elapsed time that the applicant has been active for the current test. In this example, depicted as two (2) minutes and thirty (33) seconds. A “Now Clock” 1024 reflects the elapsed time since answering the previous question 4 and/or the time since question 5 (1004) first appeared on screen. In this example, depicted as thirteen (13) seconds. An “Average Time: 1026 tells the Applicant what his/her average response time to a question has been for this particular survey, test, and/or interview. An “Overall Average” 1028 tells the Applicant what his/her average response time has been to all questions from all surveys, tests, and/or interviews collectively.

The NEED MGR who creates the survey, test and/or interview, generally a CHOP-M MGR 58, can pre-determine what functionality the Applicant will or won't be allowed to use for the particular survey, test, interview, and/or a particular question. For example, some tests or test questions may allow the Applicant to use a “Pause” 1030 button to temporarily pause the survey, test, and/or interview. The CHOP-M MGR 58 can predetermine whether this time delay while the “pause” 1030 button is active counts against the Applicant's overall time for the test and/or for the particular question when and where the pause took place.

The system could be set to notify the Applicant regarding the conditions surrounding the use of the Pause 1030 button. In addition, the use of certain functions could be conditional to the Applicants. For example, the ability to use the Pause 1030 button may come only after the Applicant has, say answered a pre-determined number of questions, a pre-determined number of questions correctly, and/or after the Applicant has taken a pre-determined number of surveys, tests, and/or interviews and the like.

Another example of functionality limitations that might dependent on the Applicant's prior usage or type of usage could be for receiving feedback for such things as the “Peer Review” 1014 system, where the Applicant must partake in provide a pre-determined amount of Peer Review before being allowed to receive and/or view the Peer Reviews regarding him/her.

A number correct 1052 area reflects the number of questions the Applicant has answered correctly so far on the current survey, test, and/or interview. Some questions can be removed from this total, for such questions as those predetermined to be subjective. A number of questions “To Go” 1054 area reflects the number of questions the Applicant still has remaining for a particular survey, test, or interview. This “Number or Questions To Go” 1054 area may be hidden from the Applicant and/or may be subject to the Questions answered.

For example, certain Questions may branch out into deeper and/or more detailed questions depending on the answer given by the Applicant. For instances, if the Applicant answers that he/she has “no experience” with a particular software program, the test could move on to ask about another software program. However, if the Applicant answers that he/she considers him/her to be an “Expert” with a particular software program, and then a preset list of follow-up questions could be setup to ascertain and quantify to what degree he/she is an Expert.

The “Voice Recognition and Detection” 1010 system's checkbox option allows the System to track the Applicant's voice and his/her responses while participating in a survey, test, and/or interview. The system could be setup where the Applicant could pick and choice which specific voice analysis he/she wanted performed. He/she would be notified of the level of accuracy associated with the variety of functions and features. He/she would also be presented with a list of privacy issues that he/she would likely need to pre-approve.

In addition, the system could be setup to allow the Applicant to control who and when others could or could not view his/her results, not just for voice recognition, but all the data collected. For example, the Applicant could pre-establish and verify that he/she is okay with the voice recognition and detection analysis, but as long as he/she can control who has access to the data and for how long the data is kept.

For instances, the Applicant could take a virtual interview to practice answering questions for a particular type of job position and utilize all the tracking and assessment tools, but restrict the results to him/herself personally and/or require that other Accounts, who ask for visibility, first must get his/her prior approval and/or pay per assessment and/or per survey, test, and/or interview. The virtual interviews, and incorporated applicant questions, can be conducted by automated software, by humans who are, say either with the company which is planning to hire a CATCH, a recruiter, a pre-selected Expert, a pre-selected Peer (such as a friend or co-worker), a random CASTING and/or JOINS user who volunteers to administer a particular test, a computer-simulated interviewer, and/or some combination of these, depending how and if the interview is broken down into segments, and/or how long the interview is conducted.

For the “Voice Recognition and Detection” 1010 system to function, the Applicant should activate an “Audio” 1032 checkbox option. In addition, the particular survey, test, and/or interview should be built for the Voice Recognition and Detection 1010 system. Meaning the Applicant would answer some if not all the questions using his/her microphone online or via a supplied microphone, if the interview is conducted in person.

After the Applicant is directed to utilize and/or self selects the Voice Recognition and Detection 1010 system, he/she would then go through a series of audio-testing functions to test the audio quality, audio levels, and the like, of the recording equipment to determine the likelihood to obtaining an audio track suitable for those assessments requested by the Applicant and/or by the NEED.

If it is the first time the Applicant has used the Voice Recognition and Detection 1010 system, there could be a series of sample questions for the Applicant to answer to help set a baseline response for ongoing comparison data, measurements, and correlations. The more audio and data that the system collects, measures, and tracks on the Applicant, especially initially, the more proficient the system can become at also deciphering the inflections and tones within his/her speech patterns.

If the Applicant has the “Voice Recognition and Detection” 1010 system set for real-time feedback, he/she may see a digital visual representation of the audio levels in a meter window 1044 area. Depending what data, measurement, and assessments are being collected via the audio and the speed at which the results can be properly generated, the Applicant will see readout values and the correlated percentage for such assessments, among other possibilities, as a Clarity 1036 meter, a Concise 1038 meter, an Integrity 1040 meter, and a Believability 1042 meter.

The Applicant can also collapse the window by clicking a toggle arrow 1046 in the upper corner of the window. This allows the system to continually collect data without distracting the Applicant. At any time the Applicant wants to see the data and meters, he/she can re-click the toggle arrow 1046 which remains visible with the identifying title of the particular assessment tools, in this instance the “Voice Recognition and Detection” 1010 system.

The Clarity 1036 meter could incorporate a range of data, including but not limited to the range of difficulty in which the assessment tools have in comprehending the answer of the Applicant when compared to other Applicants, and/or in relations to an internal preset. The internal preset can come from a range of Experts, Peers, and/or others who could provide such elements, as the best answer known so far, a range of satisfactory answers, a threshold of time in which to answer, and/or the like.

The comparisons can be based upon specific words used, the number of words used, the arrangement of the words, the inflections, the tone, the timing, the pace, the flow, the pitch, the frequency, the amplitude, the volume, background noise, and/or the pronunciations relative to himself/herself to other questions, test, and/or interview; relative to a defined segment of users for the same question, test, interview, and/or in general; and/or relative to all users for the same question, test, interview and/or in general; and/or the like. The comparisons can be also based upon specific changes that occur with the words used, the number of words used, the arrangement of the words, with the inflections, the tone, the timing, the pace, the flow, the pitch, the frequency, the amplitude, the volume, background noise, and/or the pronunciations within the same question relative to himself/herself; relative to a defined segment of users for the same question, test, and/or interview; and/or relative to all users for the same question, test, and/or interview; and/or the like.

The system can collect and check for Body Language anomalies and/or tendencies that might appear where the user/person is using making uncommon or inappropriate gestures, such as not looking at something that would feel more appropriate, say at the camera lens, or the person who is asking the questions; and/or a measurable tendency to be distracted by, say others, a cell phone, the time, and the like; a measurable tendency to look down or away at random times and/or in conjunction with a discernable event, such as a tough question or after a certain measurable period of time has elapsed in all interviews and the like.

The system can also setup a series of methods for collecting, testing, and comparing a user's Body Language, where some Peers and Experts review groups/segments in their review process see and hear both the video and the audio, while other review groups/segments may only see the video and/or only hear the audio. This allows the user to compare the review group's feedback to see if there are any bias and/or anomalies, say where the review groups who could not hear the audio scored the Body Language as, for instance, confident, where as those review groups who heard the audio scored the Body Language as not confident.

The Voice Recognition and Detection 1010 system can also be setup to take into effect people with territorial dialects, vocabularies, and/or vernaculars. For instances, the Voice Recognition and Detection 1010 system should be able allow for and to relatively compensation for Applicants who have consistent speech patterns, but relatively unique compared to others, and/or compared to the internal preset dialect. The Voice Recognition and Detection 1010 system will also compare the Applicant's answers to other answers which he/she has given in the past, for such things as similarities in word usage, style, tone, inflection, pace, pitch, volume, timing, frequency, flow and/or vocabulary, and the like.

The Concise 1038 meter could incorporate a range of data measurements, including but not limited to the speed with which the Applicant is able to answer a particular question. The system could also monitor common stalling tactics and/or methods in general and regarding the particular Applicant, such as repeating the question back before answering, or saying things such as “ummmm” or “ahhhhh” to delay the answer. Demerit points could be incorporated for the amount the Applicant discernibly and measurably utilized such stalling tactics.

The system would build a keyword and phrase usages chart listing terms most often used, where, when and how, to determine if terms are being used correctly. Also checking to see if words are being pronounced correctly and build a list of words, pronunciations, and usage that could take into account, such things as the type of job and area of the country where a particular word may be used differently than in say another part of the country.

The system would build database charts of available, discernible, and measurable industry accepted acronyms, vocabulary, definitions, vernacular, and slang, per each system delineation, such as per Industry Category, per Job Category, per Job Position, per Skill Required, per Experience, and per Education level and Education location. In addition, per Company, per demographic segmentation, per psychographic segmentation, per software skills and the like to build out a highly comparative way to assess and compare, not only a user's voice, vocabulary, and confidence, but also for other measurable components, such as Body Language, Speed and Accuracy, and the like.

The system would also collect and check for phrases in the user's vocabulary that may tend to be over utilized in occurrence frequency in general and/or for the particular question. For instance, the user may over use a particular phrase, such as: “That's no problem . . . ” or “I don't particularly like . . . ” when comparing that phrase usage to some segment, segment of users, subset, and/or all other Candidates within the system for, say the same Job Position and/or region of the country, and who scored relatively higher in computerized analysis reviews, Peer Reviews and/or Expert Reviews. The system could reveal to the user where his/her particular voice, tone, and/or vocabulary skills measurably and relative fit or may not relatively fit currently.

For example, someone interviewing for, say an Executive Assistant may be interested to discover that his/her current voice and vocabulary skills most closely match those who are applying for the position of, say either a “marketing executive”, a “used car salesperson”, or as a “waitress”. The system could do an analysis of the user answering questions that are geared to reveal his/her vocabulary skills, understanding and pronunciations of industry terms, definitions and acronyms, traditionally used industry software applications, and its corresponding functionality terms and/or the like. And where the data results and measurements could be compared with, say other users in general and other users within that Industry to reveal exactly where the user is relatively strong and/or deficient in terms of, say his/her vocabulary, enunciations, definitions, software terminology understanding, and the like.

The system could collect and check for other anomalies when compared to a database of others, such as pauses made before answering, where in some cases the pause is perceived by the assessment tools and reviewers, as a relatively smart/good thing or poor/bad thing, say depending on the measurable length of the pause, what is actually said or not said afterward, and the like. Where these relatively smart/good and poor/bad habits can be shared with others who have, say similar and/or the opposite issues. Other anomalies and/or tendencies might appear where the user/person is using the correct words, but in a strange order/sequence or inappropriately; where certain words are difficult to understand; tendencies to fade off at the end of each sentence, tendencies to laugh during the answers, tendencies to use too many buzz words, tendencies to use too many double negatives and the like.

In additional the system could create merit and/or demerit points for the length of answers. For example a too concise answer may not be completely accurate or actually incorrect. Over time the Voice Recognition and Detection 1010 system would develop a range of acceptable responses, based upon measurable data and feedback from assessment tools, reviewers, and users such as the MATCH MGR.

For instance, a question might ask: “If the Applicant is currently employed?” The range of preset answers, or an “acceptable answer pool,” might include such words as: “yes, no, part-time, full-time, contractor, contractor-basis, and self-employed”, but the Applicant might answer with: “I am currently interning”. Later when the answer is reviewed by a human and/or an assessment tool, the system could add this answer to the pool of appropriate answers based on the number of times others use it, and/or by simply letting a user with the appropriate permissions, such as the MATCH MGR 51, add it the “acceptable answer pool”.

The MATCH MGR 51 may decide to also add the words “internship and volunteer”. These modifications will improve the ability to assess the appropriateness of words used within an answer and the data over time. Consequently, the assessment score may change over time, based upon acquiring more data and improving data correlations. In addition, the system would help each Applicant identify smart/good and poor/bad habits and help him/her remove the, say annoying stalling tactics/habits and help improve their overall communication skills in ways that can be measured, discerned, and compared to previous testing and assessment scores.

The Integrity 1040 meter could incorporate a range of data, including but not limited to the number of conflicting words, transition words, and the like, that the Applicant using within the same response to answer a particular question. For example, answering with both the words “yes” and “no” within the same answer may or may not represent a lack of integrity, but the number of times the Applicant appears to shift his/her response would be tracked. The system would also track transitional word usage for such words as “but” “still, “however”, to determine a possible contradiction within the answer.

Demerit points could be incorporated for the number of perceived contradictions within a given answer to a particular question. Over time the Voice Recognition and Detection 1010 system would develop a range of acceptable responses and a range of contradictions the average Applicant makes in general, for a particular question, the number of contradictions a particular Applicant makes in general, to a particular question, and relative to others.

The system could also educate the Applicant to the number of demerits he/she received and why. The Applicant could challenge each demerit and preset a case for someone to review, such as the MATCH MGR 51 for the particular question where the demerit was received. The MATCH MGR 51, in turn, could adjust the demerit tolerances if a bona fide argument has been presented. This in turn, improves the data and data correlations. Changes to the assessment, measurements, rules, tools, and thresholds, can also be set to a review committee and would be tracked for their affects (e.g. improvements/declines) on the system and regarding NEED feedback, CASTING feedback, SEARCH feedback, perceived and/or quantifiable data accuracy improvements/declines, Applicants feedback, the perceived and/or quantifiable improvements in the Applicants being hired.

The “Body Language” 1012 system checkbox option allows the System to track the Applicant's body language and his/her gestures when participating in a survey, test, and/or interview. He/she would be notified of the level of accuracy associated with the variety of functions and features. He/she would also be presented with a list of privacy issues that he/she would need to approve.

In addition, the system could be setup to allow the Applicant to control who and when others could or could not view his/her results, and not just for his/her body language, but all the data collected. For example, the Applicant could pre-establish and verify that he/she is okay with the “Body Language” 1012 system analysis, but as long as he/she can control who has access to the data and for how long the data is, say kept in the database, and/or a particular NEED database.

Generally for the Body Language” 1012 system to function and collect data, the Applicant should activate a “Video” 1034 checkbox option. In addition, the particular survey, test, and/or interview must be built for the “Body Language” 1012 system. Meaning the Applicant would answer some if not all the questions using his/her webcam online or a supplied video camera, if the interview is in person.

After the Applicant is directed to utilize and/or selects the “Body Language” 1012 system, he/she would then go through a series of video-testing functions to test the video quality, the lighting and video levels, the framing of the shot, and the like, of the recording equipment to determine the likelihood to obtaining a video signal and resolution suitable for those measurement and assessments requested by, say the Applicant and/or by the NEED. If the system perceives that adjustments would improve the ability to make body language assessments, depending on the current shot, the system could either suggest/request changes, and/or require changes be made before the system would advance.

If it is the first time the Applicant has used the “Body Language” 1012 system, there would be a series of sample questions for the Applicant to answer to help set a baseline response for ongoing comparison data and correlations. The more video and body language that the system measures, collects and tracks on the Applicant, especially initially, the better the system can become at also deciphering the movements and gestures within his/her overall behavioral patterns.

In addition the Body Language 1012 assessments system could provide the user with tools to properly setup, such as a viewable overlay that shows the user how and where to frame his/her face and specific facial components (e.g. mouth, eyes, and the like) for best assessing his/her Body Language. This allows the user to cross compare other video clips of himself/herself for determining relatively most liked and disliked mannerisms and gauging the number of frames/seconds/minutes the users is in that position and/or with that facial expression relative to others.

This facial cross compare capability can also be run against other interviews to see how the user is improving overtime, run against other JOINS users per all categories, such as industry, job category, per demographics, e.g. a gender, per a city/zip, to make comparison. In addition, these comparison can be generated, and calculated without necessarily revealing any other individual user's faces, say by simply stating numerical data.

For instance, the numerical data might say that the user has improved his/her Body Language twenty-two (22%) percent when scored by Expert Reviewers over his previous Body Language in the past thirty (30) days, and he/she's Body Language has increased relatively higher than any other JOINS user in his/her, say Job Category and State, by a matter of percentage point improvement. The user can elect to have his/her Body Language data compared to others for assessing comparative improvements, but the user can ask that his/her actual face either not be revealed to other users; excluded from specific users; segments of users; and/or only revealed to specific users for a specific purpose and/or period of time. If the user has, say model Body Language, he/she could even sell his data for others to try and emulate with comparative data and/or actually reveal his/her face.

The system can incorporate Peer and Expert opinions and feedback to increase the number of data points and increase the accuracy. Peers and Experts can review video at times convenient to them and the collective assessment also helps build a library of gestures per the particular Applicant, per segment; and/or per Applicant's in general.

For example, if a particular gesture made by a particular Applicant is in general considered relatively negative or positive. The system can run an assessment to look for similar images, whereby breaking down such elements as the particular Applicant's facial expression, eye movement, hand gestures, and body posture, all relative to other frames within the video.

If other video frames or series of frames with similar elements are also annotated by the system, by Peers, and/or by Experts as relatively negative or positive gestures, the system can begin to catalog these types of gesture for assessing this particular Applicant in other video clips, and also to compare these gestures to other Applicant with similar feedback to create libraries of likely negative, indifferent, and positive gestures.

In addition, the system can analyze video frames that did not prompt any feedback, positive or negative, to create a library of postures and gestures less likely to be construed as negative or positive; in other words, relatively neutral.

For example, tracking the Applicant's eyes and the number of times he/she looks away from the camera may create a wealth of Peer and Expert feedback. When the Applicant looks down, Peers and Experts may perceive this movement as relatively negative. This kind of feedback is somewhat subjective, but with large enough sample size, the data becomes more dependable and recommendations can be made to the Applicant to try and change a particular body movement and/or behavior.

Subsequent surveys, tests, and/or video with the Body Language 1012 system employed can then compare if looking down less actually does improve this particular Applicant's Body Language towards a more positive score. If it does, the data assessment is reinforced and/or the system can assess for bias.

If looking down less actually does not improve his/her scoring results, the Applicant may need to look to other correlations in the data and can also submit feedback to the appropriate parties and entities, such as the NEED, the MATCH MGR that Applicant followed the given recommendations in a subsequent test where he/she looked down half as much, but his/her overall score did not change significantly. The system can search the video and look for other similar factors in the Applicants body language in each video frame marked as negative when compared to frames marked as relatively positive and/or those that did not prompt any response. This type of Applicant feedback and/or anomalies can greatly help perfect the data points being collected and distinguish which mannerisms are actually causing the negative feedback for a specific Applicant.

FIG. 30, section 1048 is an example embodiment of what the visual depiction could appear as regarding the overall feedback of the particular Applicant's Body Language, where the dashed line 1050 represents the middle where the feedback was non-existent and/or averaged out to zero between the negative and positive body language feedback. The black area above the dashed line 1050 represents the body language that was collective perceived and/or quantified to be positive and the dark area below the dashed line 1050 represents the body language that was collective perceived and/or quantified to negative over time.

The Applicant can be allowed and/or request to view specific feedback per Peer and/or Expert. They can praise and/or complain about particular elements of the feedback also about a particular Peer, and/or about a particular Expert. Depending on the amount of data required and available, the visual depiction regarding Body Language can be in real-time, near real-time, and/or delayed by some quantity of time. The Applicant can request to view the feedback per survey, test, interview, Peer, Expert, and/or per user segment.

The Applicant can compare his/her Body Language to others applying for the same job position, same job category, against those of the same age, with similar qualifications, and/or similar feedback. For example, if the Applicant's overall Body Language Feedback generates a collective score of, say 64%, where 14% of his/hers collective gestures were considered more positive than negative, then this Applicant could not only compare himself/herself with Applicant's with his/her similarities, but also with Applicant's with a relatively similar Body Language score where the system could rank users on a leaderboard per segment. The system can factor in the number of relative complaints regarding a particular Peer or Expert from past and future personal reviews, collective reviews, where weight can be added and/or subtracted based upon litigate and/or numerous praise and/or complaints.

In this example, the Applicant could find out what type of people have similar Body Language, in terms of such data points as education, skills, experience, testing scores, interviews taken, demographics, psychographics, desires, feedback, and other data delineations measured, collected and tracked. The Applicant could go on to monitor his/her improvements relative to a particular group with a similar Body Language score and/or monitor his/her progress against others segments, such as those with a similar education, experience, demographics, psychographics, desires, feedback, and other similar data segments, individually or collectively.

In addition to Body Language video and Voice Recognition audio that is comparable, the system has the ability to delineate material within content that is, say addressable and/or searchable by characteristics associated with a video &/or audio segment, such as per a particular person by name, facial expression, facial data, per hand gesture, per body language &/or movement, per answer, per statement made, per word, per tone, per vocabulary index, per comparative audio/voice index data, per comparative video index data, per group/segment name, Peer group, Expert Group, group collective expression; per psychographics of a person or group/segment, known background info (eg, political, union, school, &/for sports affiliations), weather that day, location (eg country, state, city, zip, &/or events), per time of day, per news events that day locally and/or internationally, &/or some combinations of these segmentations and the like.

These characteristics association can be supplied by a plurality of judging sources, such as computerized assessment tools, by the individual in the video or heard in the audio, by outsiders, such as random people, those who qualify as Peers per a selected specific characteristic &/or group of characteristics, an Experts per a selected specific characteristic &/or group of characteristics, and/or some combination of these judging sources.

The “Peer Review” 1014 checkbox option and the “Expert Review” 1016 checkbox option both provides the Applicant the ability to receive reviews on a range of subjects and elements, such as, but not limited to those already listed and overall factors, such as: hire-ability, likeability, friendliness, appearance, dress, personality, selling skills, presentation skills, organization skills, passion, pride, punctuality, and the like.

Some Job Categories and Job Positions require very specific skills and/or unique qualifications. Sometimes these skills and qualifications can be very subjective. For example, an interior designer may and may not come off well in an interview, but sometimes equally, if not more important is his/her portfolio of work. In these types of specialty fields and circumstances, the Applicants could upload his/her portfolio of work and/or provide links to a website of his/her work. The Applicant can invite Peers and Experts in general, and/or Peers or Experts with a specific background to critique his/her work.

For instance, the Applicant could limit the invitation to Peers who are from a particular part of the country, live in a downtown loft, went to a particular art school, read (or liked) a particular author, are about the same age (eg. plus or minus 2 years from DOB), own a vacation home, etc. These limitation or segmentation factors could be utilized independent of each other or utilized collectively. The Applicant could limit the invitation to Experts who were educated at a particular school, use a particular software design program, have at least 10 years experience, own their own firm, etc.

More and more Job Categories and Job Positions require similar visual critiques, including such groups as: Photographers, Cinematographers, Graphic Designers, Editors, Artists, Web Designers, POP Display Designer, Contractors, Drafts-person, Architects, Dentist, Dermatologist, Plastic Surgeons, Models, Dancers, TV and Movie Creators, Actors, News Anchors, Sportscasters, Entertainers, Comedians, Singers, Bands, Speakers, Beauticians, Make-up Artist, Home Remodelers, Crafts-person, Artisans, Body Shop Repair-person, and Metal Workers. The system could allow each to build a community of Peers and Experts, where each participant, whether a Peer, Expert, or Applicant can upload images and videos and critique and compare with each other.

Job Positions such as Comedians, Voice-over talent, Singers, Writers, Speech Writers, Speech Providers, Motivational Speeches, Master of Ceremonies, Wedding Performers, etc. could also upload samples of written scripts and/or audio tracks for building communities, critiquing and comparing with each other.

In addition, some Job Positions may require an Applicant to be properly registered and licensed, say as a CPA, Attorney, Patent Attorney, Architect and the like. The system could collect data from the proper licensing agencies to validate the users' credentials, and send out request to, say either the licensing agency, the particular JOINS user, CASTING user and/or whomever was appropriate to find missing information and/or explain discrepancies, where that information would be collected and track like a person's credit report. Further, the system would allow further details and testing to help quantify and validate the user's (registered person's) current skills where a NEEDs MGR could request and/or select test questions from recent made-available registration exams and/or create new questions that were similar enough to appropriately test for particular areas of knowledge desired by the NEED and/or Job Opening.

The system could also be setup to allow the users contemplating a particular career and/or about to take a particular registration exam, to test out his/her skills, where not only the answers are critiqued but other assessments tools could be employed, such as speed and accuracy, Peer and Expert reviews to help determine one's interest for such a career and/or prepare for the actual test.

The “Compared to Others” 1018 system's checkbox option allows the Applicant to determine what elements and/or factors he/she would like the System to track and compare and to whom the comparison(s) should be drawn. The system can also make suggestions for drawing comparisons. If it is the first time the Applicant has used the Compared to Others” 1018 system, there would be a series of questions for the Applicant to answer to create either on-going and/or real-time comparisons.

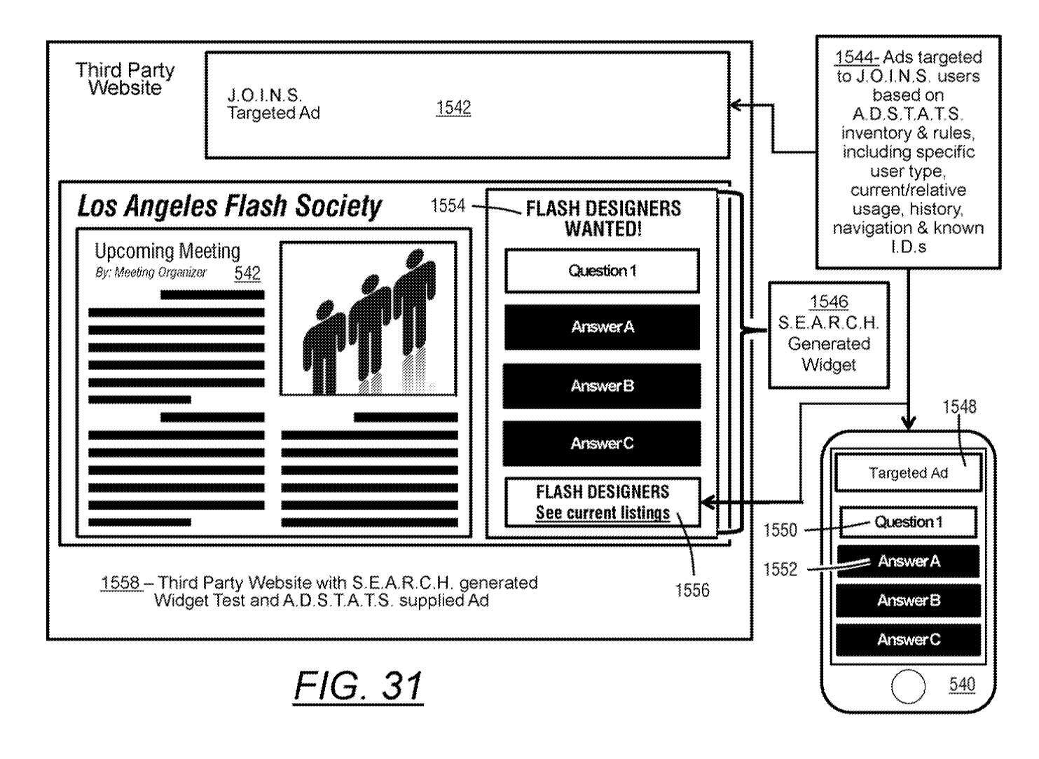

FIG. 31 depicts an embodiment of an example screenshot of a mobile device 540 and a third party website 1558 with a Widget 1546, a Content 542 and/or a JOINS Targeted Ad 1542 generated and/or targeted by the SEARCH 100 system. An “Ads Targeted to JOINS (70) users based on ADSTATS inventory and rules, including specific user type, current/relative usage, history, navigation and known I.Ds.” 1544 is the content and/or ad targeting between a “Third Party Website with SEARCH generated Widget Test and ADSTATS supplied Ad” 1558 and SEARCH 100.

Starting with the “Third Party Website with SEARCH generated Widget Test and ADSTATS supplied Ad” 1558 area that delineates an example of a screenshot that the JOINS 70 user could see when visiting a particular website that is connected to SEARCH 100. For example, there could be a JOINS Targeted Ad 1542 that could appear at the top of a website page where the advertising supplied by SEARCH incorporates information either known for users who visit this site in general, information known about the particular JOINS 70 user; and/or information collected through current usage.

For example, the JOINS 70 user can select to view and/or interact with specific website content such as, say an article depicted by area 542. This content selected reveals information about the user and the duration, manner of usage, and navigation in/out of this article/content can be stored and compared with other users to build data tables, schema, correlations, and logic for advertising and content interaction success rates, such as, but not limited to click-throughs, views, dwell times, links in/out, actions taken/not-taken, abandonments, revisits, and/or actual purchases.

The area delineated by the brackets from a SEARCH Generated Widget 1546 is an example of content that could be pushed and/or pulled from the SEARCH 100 that can either be requested by the JOINS 70 user, already queued up on the webpage, and/or driven by other events, such as the JOINS 70 user's navigation. The Search Generated Widget 1546 content in this example is a test to attract Flash® software developers with a “Flash® Designers Wanted” 1554 headline example and with Questions and potentials answers below. At the bottom of the

SEARCH Generated Widget 1546 area could be a call to action and/or a link 1556, which in this example reads: “Flash® Designers: See current listings”. So if the JOINS 70 user clicks the link, he/she can interact with Campaigns pushed out from the SEARCH 100 that meets the particular request and/or conditions of the link.

The mobile device 540 also can have content and/or a targeted ad 1548 that could be pushed and/or pulled from the SEARCH 100 that can either is requested by the JOINS 70 user, already queued up on the mobile device 540, and/or driven by other events, such as the JOINS 70 user's user-interface navigation, ability to provide an answer 1552 to a particular question 1550 correctly, ability to answer questions promptly, time of day, GPS coordinates, location tracking/triangulation, and/or with Campaign rules and conditions, such as whether there is a relative urgency to fill a particular PAC 104 by a particular moment in time, by a particular Candidate 73 with a particular MATCH 120 for a particular NEED 82 or not.

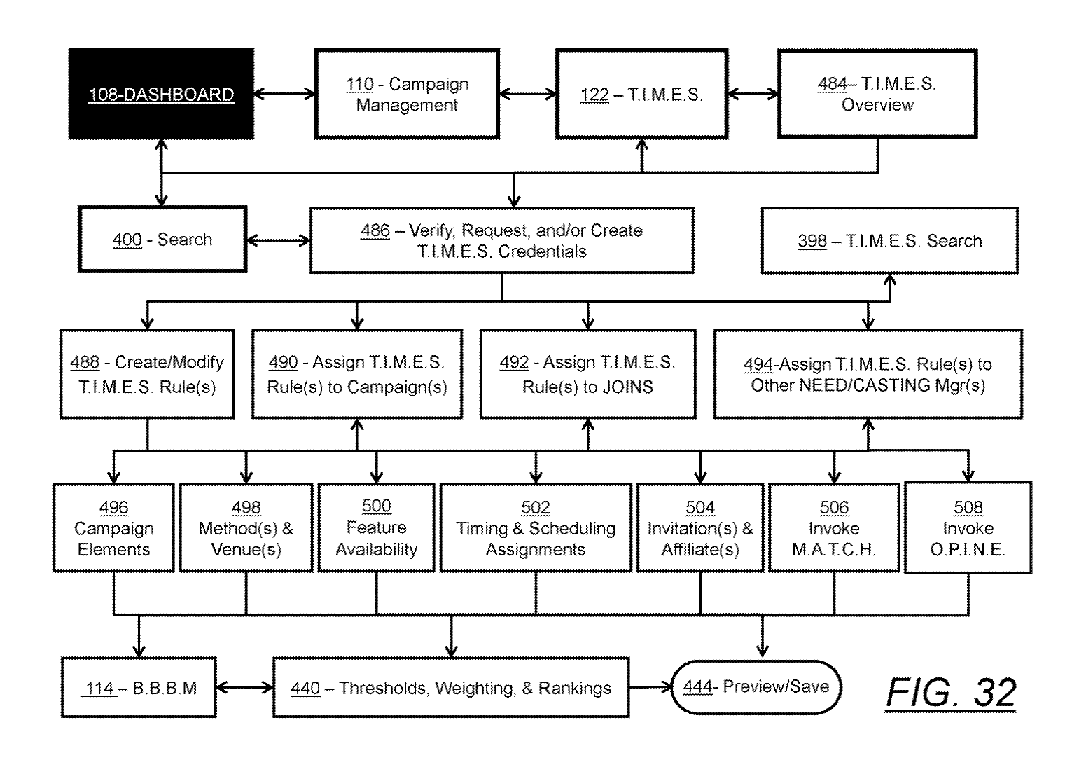

FIG. 32 is a flowchart of an embodiment that depicts an example of the process by which the TIMES Mgr 52 can utilize the T.I.M.E. 122 module. The role of the TIMES Mgr 52 is to create, manage and/or schedule measurable events, such as surveys, tests, interviews and/or the like. The Campaign Management 110 function is accessible from the Dashboard 108 and from the Campaign Management 110 function, an Account 60 user can access the T.I.M.E.S. 122 and in turn a T.I.M.E.S. Overview 484 that explains the purposes and functionality of using T.I.M.E.S. 122. A Search 400 function allows for overall search and for searching for existing Campaigns 103, Campaign 103 elements and/or other features such as functionality explanations based upon the Account 60 users current role and permissions.

A “Verify, Request, and/or Create T.I.M.E.S. Credentials” 486 function screens and educates the user of what functionality his/her role and permissions has in terms of access and limits. Generally, the proper role for utilizing the T.I.M.E.S. 122 is the TIMES Mgr 52 and/or someone with at least the same permissions levels as those that are assigned by the default settings to the TIMES Mgr 52 role, by say the CAA. Depending on how the particular Account and/or CAA decides to set up the T.I.M.E.S., user's who try to access the T.I.M.E.S. without the proper credentials and/or permissions to create, modify or manage the T.I.M.E.S. 122, may or may not have permission to view, access, or utilize certain functions, Campaigns 103, and/or Campaign 103 elements.

A “T.I.M.E.S. Search” 398 allows users with the proper permissions to search for T.I.M.E.S. specific elements and/or features. A “Create/Modify T.I.M.E.S. Rule(s)” 488 function allows an Account 60 user to create a new T.I.M.E.S. 122 element and/or rule from scratch and/or select an existing T.I.M.E.S. 122 element and/or rule to modify and/or use as a template. An “Assign T.I.M.E.S. Rule(s) to Campaign(s)” 490, an “Assign T.I.M.E.S. Rule(s) to JOINS” 492, and an “Assign T.I.M.E.S. Rule to Other NEED/CASTING Mgrs(s),” 494, each allow the Account 60 user with the proper permissions the ability to pick and choice where and how to apply existing T.I.M.E.S. elements and/or rule(s) and/or a newly created T.I.M.E.S. element and/or rule.

The Account 60 user can create and/or modify an existing T.I.M.E.S. Rule(s) using a “Campaign Elements” 496 module option, a “Method(s) and Venue(s)” 498 module option, a “Feature Availability” 500 module option, a “Timing and Scheduling Assignments” 502 module option, an “Invitation(s) and Affiliate(s)” 504 module option, an “Invoke MATCH” 506 module option, and/or an “Invoke OPINE” 508 module option.

The “Campaign Elements” 496 module option is for selecting elements of an existing Campaign 103 to modify the TIMES and/or utilize as a template.

The “Method(s) and Venue” 498 module option is for assigning the Methods that will be allowed for the measurable event, such as the survey, test, and/or interview. This includes assigning event Method(s) and Venue, such as, but not limited to: face-to-face at the office, face-to-face at another venue, at the office with a virtual interviewer, at another venue with a virtual interviewer, by telephone-live, by telephone-virtual interviewer, by telephone-IVR, online-webcam-live, online webcam virtual interviewer, online-test, online-audio, online-video, and/or some combination of event methods and/or venues.

The “Feature Availability” 500 module option is for assigning features and/or functionality restrictions on a particular Campaign, segment of Applicants, segment of Candidates, a particular Applicant, and/or a particular Candidate. For example, the TIMES Mgr 52 may wish to restrict the use of “Peer Review” and/or “Expert Review” only to those Applicants who have qualified as Candidates for a particular PAC, for a particular test, and/or only to those Candidates who have prior experience using both the “Peer Review” and/or “Expert Review” functionality. For instances, when the Applicant takes a video interview, the Applicant could be allowed to check off a box requesting Peer or Expert review of that particular interview.

In another example, the TIMES Mgr 52 could instead allow all Applicants to utilize the “Peer Review”, but limit the functionality to certain aspects, such as only for providing a hire-ability score and/or only for providing feedback through pre-selected characterization terminology vs. free-flowing comments, to help avoid ambiguity, help normalize the results, and/or avoid over-the-top comments.

For instances, the “pre-selected characterization terminology” utilized for scoring and/or reviewing the Applicant could also be in the form of preset checkboxes for Peers and/or Experts to check-off along a continuum from very positive to very negative feedback that appears as a Lickert Scale for each. For instances, the continuum could cover ten check boxes starting from “very-believable” to “not-very believable” regarding a particular answer giving by a particular Applicant who asked for the feedback/review and/or feedback from the Peer and/or the Expert regarding his/her overall view of the Applicant verses just feedback for one answer.

The continuums could either be created from scratch by TIMES MGR 52; taken from previous Campaigns 103 based on success rates; and/or could utilize a contextual data and algorithm(s) whereby the system searches for keywords within a particular Campaign, the MATCH criteria, a particular Question, and/or known material regarding the specific Applicant to determine the appropriate list of feedback continuums to provide the Peers and Experts who will be giving feedback/reviews. The algorithm employed to select the characterization terminology could also incorporate previous Campaigns 103 where either similar Candidates were sought, similar keywords employed, based upon a particular hiring success rate, a particular scoring success rate, and/or which continuums were utilized previously for the same and/or similar positions within the company, a defined segment, and/or overall.

For example, after ascertaining that a particular Applicant has prior experience selling a particular product to a particular audience, based upon either a MATCH criteria screening process, his/her resume or provided materials, data that was pulled from another job database (such as from HotJobs®, Monster®, Linkedln® and the Like), a previous interview and/or the like; where the system could then ask the Applicant the following: “Can you give an example, where you sold this [insert the appropriate product/service type from the data, e.g. car, house, college, insurance, mutual fund, travel package, apparel, appliance, software, hardware, business, service, etc.] and then explain where and how you, the Applicant, had to overcome a relatively significant objection by, say a key or important prospect?”

For this example, the system would have known that the Applicant had prior selling experience and that Applicant was now being asked to give an example and/or more details. The system could accept as short/minimal as an answer as given by the applicant and/or wait for the Applicant to surpass some pre-determined threshold for the particular answer in terms of say a word total, specific words and/or temporal conditions, before offering feedback and/or advancing to, say the next question.

The answer threshold could be for the Applicant to complete some sort of measurable response, such as a checkbox to a question, the number of characters entered in a particular text field, the particular words typed and/or spoken within the Applicant's answer, and/or a temporal requirement. Once satisfied, the Peer and/or Expert could give feedback in real-time, slightly delayed, and/or at a time later in the future. Further, the system could also incorporate Peer and/or Expert scoring terms for the continuums for scoring the Applicant that were based upon a historical calculations of those terms considered best-suited for a particular type of sales and/or Applicant. The feedback could be blocked from certain parties, such as the applicant, segments, other applicants, and/or others until permission was granted through some threshold of roles, permissions, status, time, and/or monetarily.

The Peer and Expert review can be set and limited by the TIMES Mgr 52 who may setup a number of pre-assigned continuums for all the questions, the full interview/quiz/survey, and/or specific continuums for each question. The TIMES MGR 52 could allow the Applicant to turn on/off some of this Peers and Expert functionality and/or select only certain continuums to utilize.

For instances, the TIMES MGR 52 could setup continuums for an overall interview that may not be adjusted by the Applicant and may include a feedback question that says something like: Overall the Applicant appears/appeared to be and/or have:

1) great-presentation-skills to poor-presentation-skills,

2) great-communication-skills to poor-communication-skills,

3) great-selling-skills to poor-selling-skills,

4) great-people-skills to poor-people-skills,

5) great-creative-skills to poor-creative-skills,

6) very-likeable to very-annoying,

7) very-calm to too-animated, and

8) very-believable to very-un-believable.

The TIMES Mgr 52 could require the Peers and Experts to grade/score each continuum; only one continuum that feels most relevant; only those continuums that feel relevant, but at least one; and/or only those continuums that feel relevant and where the Peers and the Experts can skip any and all that he/she doesn't feel are relevant.

The system would track which continuums Peers and Experts tend to utilize most/least often overall when applied to specific questions. With a sufficient sampling size, these specific question continuums could be automatically assigned as defaults to future questions with similar positions within the hierarchy of the surveys, tests, and/or interviews previously utilized and ranked.

For instance, when system determines that the Applicant has selling experience, the hierarchy of data, would determine that, depending on, say the type of sales and MATCH criteria, what question should be asked next and/or what feedback continuums should be utilized. The continuums would also have a list of common keywords associated with them. For example, the continuum “great-selling-skills to poor-selling-skills” would have a list of keywords that appear in the question relative to this particular continuum that it is associated with.

For instances, the ranking of keywords (and/or groups of related terms) associated with this particular continuum of “great-selling-skills to poor-selling-skills” might appear like this (where the number shown is an example of a keyword(s) score):

1) Sell/sells/selling/sold =239,238

2) Sale/sales =224,987

3) Purchase/purchases/purchasing/purchased =224,311

4) Buy/buys/buying/bought =223,986

5) Deal/deals/dealing/dealt =223,276

6) Product/products =221,363

7) Retail/retailing/retailed =220,070

8) Trade/trades/trading/traded =219,762

9) Close/Closing/closed =218,542

In the above example, the term “sell” and along with its most common and acceptable other forms for past, present, plural and action forms rank first in the list of nine examples and have combine keyword(s) score of “239,238” for the number of times these keywords are associated with this particular continuum. This list of keyword associates could extend as deep and as detailed as the system is setup by the TIMES Mgr 52. The TIMES Mgr 52 can modified the grouping or non-grouping of the terms, so that “sell” and “selling” were considered and ranked independently and/or combined based upon some pre-determined rules of semantics. On the other hand, the TIMES Mgr 52 could combine terms, even seeming unrelated terms, such as “sale/sales” and “boat/boats/boating” (not shown in list) for say, a boat sales job.

These keyword groups and grouping can be done from scratch and/or utilizing the keywords generated from the actual questions from another Campaign, and/or from the particular Campaign 103 the TIMES Mgr 52 is currently creating and/or has been created.

The feedback continuums can have several intermediate steps for delineations, such the Applicant appears/appeared either:

1) very-much-presentable,

2) somewhat presentable,

3) nothing-stands-out,

4) somewhat-not-presentable, or

5) very-much-not-presentable.

Depending on the preset rules by the TIMES Mgr 52 regarding whether feedback per question was or was not mandatory, the Peers and/or Experts could and/or would then select one of the above values along the continuum that he/she felt best described the Applicant for a particular question where the continuum was assigned.

The continuums could be customized for a particular Campaign 103 and/or could incorporate commonly used feedback terms and/or comments, including, but limited to such examples as, the Applicant appears/appeared: very-well-prepared-for-the-question to not-very-well-prepared-for-the-question, very-attentive to not-very-attentive, very-interested-in-the-question to very-disinterested-in-the-question, and very-succinct-in-the-answer to not-very-succinct-in-the-answer. Used properly, these types of preset checkboxes can help create normalized data for better discerning, measuring, tracking, comparing, and correlating of Peer and/or Expert feedback.

In addition, there could be continuums to grade and/or score a particular Applicants on his/her overall performance on a particular survey, test, and/or interview, with such feedback continuums as, the Applicant appears/appeared to be and/or have: very-well-prepared to not-very-well-prepared, very-attentive to not-very-attentive, very-interested-in-the-questions to very-disinterested-in-the-questions, very-succinct-in-the-answers to not-very-succinct-in-the-answers, very-sharp to not-very-sharp, very-educated to not-very-educated, very-well-read/informed to not-very-well-read/informed, very-polished to not-very-polished, very-prepared to not-very-prepared, very-comprehensive to too-much-rambling, and very hire-able to not-very-hire-able.

In addition, Applicants, Peers, and Experts could give feedback on the continuums utilized in terms of how relevant or not relevant each continuum appeared to be per question, how to improve a particular continuum, which continuums would be better combined, which continuums should be to remove and why, etc. The Applicants, Peers, and/or Experts could offer suggestions where others could vote on and/or rank in order of importance. Where the highest ranking suggestion among Applicants, Peers, and Experts would likely get attention first and/or sooner than, say relatively lower ranking suggestions.

The “Feature Availability” 500 module has many other features that can be applied and/or offered within a Campaign besides the feedback continuum per many of the features covered with FIG. 30.

The “Timing and Scheduling Assignments” 502 module option is for incorporating the current and future calendars of any participants that are required and/or potentially may participate in the event that is being scheduled, such as a survey, test, and/or interview. Events are a particular type of Campaign. Among other elements, Campaigns 103 can have PACs, PINs, PAC and PIN elements, events, participants, targeted ads, and/or content.

When using the “Timing and Scheduling Assignments” 502 module option for a survey or a test, this generally means selecting a particular PAC or PIN and scheduling the specific times, deadlines, and/or rules by which Applicants can take a particular survey or test, and/or a series of surveys and tests. For example, there can be a series of surveys and tests that Applicants must take and score appropriately before taking the subsequent survey and/or test.

Generally, there is a present threshold in surveys, tests and scoring, whereby the Applicant qualifies to partake in an interview for a particular PAC or PIN. However, some surveys, tests, and/or interviews allow anyone to take at anytime. This can be for practice and/or discovering Applicants who may have otherwise have been eliminated, and who may represent a potential hire, to offer valuable skills for a portion of what is currently required or needed, and/or to offer valuable feedback to improve the overall system. In addition, the system may make suggestion and help improve the Applicant, building an on-going relationship where has his/her improvements are measured and tracked over time. If a particular Campaign allows the Applicant to improve and/or update information during the period of time the Candidate search is taking place, a particular Applicant could go from not qualify to qualifying if he/she, say completed some education, successfully, retook a test about, say some software, and/or redid an interview.

Some surveys, tests, and/or interviews can be offered to a limited audience of Applicants, Peers, and/or Experts for a limited period of time without necessarily being linked to a particular PAC, PIN, and/or specific job opening. For example, Accounts 60 can create surveys, tests, and/or interviews just for collecting data, collecting future prospects, testing Campaign 103 elements, fostering required skills among local applicants, and/or for generating advertising revenue with A.D.S.T.A.T.S. (explained in more details ahead).

In addition, Accounts can create tests with, for instance, a mock sales situation where a particular JOINS user has to sell to a particular product to a buying party via text fields, video and/or audio. This buying party would be setup with a script to follow based upon answers given by the JOINS user and could be a live person and/or an automated VRU (Voice Response Unit) based upon voice recognition of the JOINS user's and specific answers. Where the VRU has a navigation script to follow per JOINS user answer and whether it falls within the acceptable answer pool and not.

For responses that fall outside the acceptable answer pool, those unacceptable answers or responses either fall into an unacceptable answer pool(s), or an undefined response pool where the response was unrecognized and/or undefined. There can be a plurality of unacceptable answer pools, say one for each incorrect answer in a multiple choice question, where the VRU has a default follow-up question per each unacceptable answer pool. There can also be separate script navigation for whether the JOINS user's response was determined to be an undefined response, determined to be an unrecognized response, and/or where a threshold of time has elapsed creating an expired non-response where the navigation script could have separate follow-ups per each response scenario.

The undefined responses and the unrecognized response can then both be analyzed regarding what is the proper response pool and follow-up question and where each incorrect answer may each have a unique follow-up direction within the navigation script. In addition, any undefined response would be stored and analyzed to determine if it should move to either the acceptable in the future and thus added to the list of acceptable answer pool that may potentially be give to a particular question. The navigation script of questions could continue until some preset condition was satisfied by, say a certain amount of questions were asked, answered, a fixed day and time was met (e.g. ends at 5 pm, Wednesday) and/or a certain amount of time consumed (e.g. 30 minutes, not including up to 3 allowed pause moments, but a limit of 3 total pause minutes).

The TIMES Mgr 52 is responsible for making sure that all the required participants, Campaign 103 elements, and schedules coordinate and flow relatively logically and the system can display data relations, such as Gant charts and the like to help make sure all the necessary elements are accounted for and available.

In an embodiment, the TIMES Mgr 52, for example, might have and/or request an outline of goals that the NEED wishes to accomplish for a particular PAC. Working backwards in terms of accomplishments for instances, these goals might include:

The overall timetable goal that the NEED has set for hiring a candidate, also known as a CATCH where for instances that timetable could be expressed as say 120 days;

The number of CATCH-M MGRs involved in the final decision making and each CATCH-M MGR's availability during the timetable where for instances that number of CATCH-M MGRs could be say one (1) distinct person or one (1) person with distinct qualifications and/or authority;

The overall time limit set for all CHOP-M MGRs to submit final information and any recommendations to CATCH-M MGRs where for instances that timetable could be expressed as say sixty (60) days;

The target goal number of next round interviews per Candidate per CHOP-M MGR and/or CATCH-M MGR and overall time limit where for instances that goal number could be expressed as say two (2) Candidates per CATCH-M MGR;

The target goal number of Candidates (for CATCH-M MGR or next round interviews) before arranging next round interviews with CHOP-M MGRs and/or CATCH-M MGRs and overall time limit where for instances that goal could be expressed as say five (5) Candidate;

The set number of other CHOP-M MGRs required and the set number of potentially involved CHOP-M MGRs along the way, with each CHOP-M MGR's role and availability where for instances that set number of CHOP-M MGRs could be expressed as say three (3) distinct people or three (3) people with distinct qualifications and where the set number of potentially involved CHOP-M MGRs might include say ten (10) people.

The target goal number of Candidate interviews per CHOP-M MGR and overall time limit where for instances that goal number could be expressed as say two (2) Candidates per CATCH-M MGR and with an overall time limit of say fifteen (15) days;

The target goal number and/or time limit on acquiring a set number of Candidates before arranging interviews with CHOP-M MGRs where for instances that goal number could be expressed as say whatever comes sooner, thirty (30) Candidates or forty-five (45) days;

The target goal number and associated scores required per survey, test, and/or preliminary interview required for an Applicant to qualify as a candidate where for instances that goal number could be expressed as say a score of eighty (80) percent correct on a particular preliminary test or group of tests.

The TIMES Mgr 52 can use the system to compare each of these goals and elements against previous Campaigns 103 for the same company, similar companies, similar PACs for similar positions, similar requirements, and the like, to see in quantifiable and measurable terms how realistic each setup goal is when compared to historical data for similar situations and the like. For example, this comparison may indicate particular elements, rules, participants, times and/or goals that are relatively likely to fail, that are relatively likely to be accomplished, the relatively likelihood per the timeframe, the relatively likelihood per the participants, MGRs involved, PACs, etc.

For instances, if a particular CATCH-M MGR's availability has been known to be a relatively major bottleneck in accomplishing timeline goals in the past, the system and/or the TIMES Mgr 52 can look for how the company has worked relatively successfully with the same CATCH-M MGR in the past, relatively successful workarounds that have been employed in the past where perhaps other CATCH-M MGRs were made available/utilized, and/or a system to notify key stakeholders and/or the CATCH-M MGR of the potential delay, problem and/or concerns in meeting the expressed goals within the timeline either beforehand, after a preset threshold, and/or at a particular stage known to be problem/bottleneck in the past.

The TIMES Mgr 52 uses the system to coordinate the collectively calendars of the participants to schedule any face-to-face, phone conversation, and/or live event, such as a webcam-live interview. (More details on creating and modifying schedules are described throughout the specification.)

The “Invitation(s) and Affiliate(s)” 504 module option is for creating, selecting, modifying, managing, assigning, and tracking invitation, invitation links, affiliates, affiliate hierarchy, and any BBBM, such as fees, associated with invitations and/or affiliates. The “Invitation(s) and Affiliate(s)” 504 module allows the TIMES Mgr 52 to build out invitations with links that can be monitored and tracked regarding such components as who and when someone used the invitation/link (e.g. what specific user at what specific date and time), for what purpose (e.g. what Campaign and Campaign Goal), how long he/she used the link (e.g. time logged in per use and in total), where he/she abandon the invitation and/or the link and it's specific content, who sent the invitation/link, when the invitation/link was sent, what instructions were included with the invitation/link, and were any success fees involved with any step in the process?

In addition, data can be collected and tracked for such things as the daily totals, monthly totals, campaign totals, element totals, user segment totals, and the like. Further, data totals can be collected and tracked regarding the invitation/link usages for such things as the overall volume of traffic generated, the web-pages views generated verses consumed, the mobile-pages views generated verses consumed, the content and content elements generated verses consumed, the Ads views generated verses consumed, and the like.

For example, the TIMES Mgr 52 could create an invitation link from scratch for a particular PAC, inviting applicants to apply for a particular job via a particular link. This invitation could be sent to a group of recruiters, whereby each recruiter would receive an invitation link to forward with a unique identifier/ID. This would allow the system to track how many invitations each recruiter set, how many were opened per Recruiter, how many were utilized per Recruiter, and how many were successful in terms of some pre-established threshold. (Also see more under an Affiliameter embodiment).

For instance, the invitation/link sent to a particular Recruiter and eventually sent by particular Recruiter when then caused someone (an Applicant) to apply for a PAC; the invitation/link found a particular Applicant who successfully completed a particular requirement, such as a survey, test, and/or interview; the particular Applicant became a Candidate; the particular Candidate became a CHOP, and/or the particular CHOP became a CATCH” and of which can be measured, tracked and scored.

Each step along the way could have an associated bounty, reward, and/or success fee associated with it. In addition, the TIMES Mgr could setup the “Invitation(s) and Affiliate(s)” 504 system to allow the original Affiliate recipient (Affiliate “A1”) the ability to create Sub-Affiliates (Sub-Affiliates: “B1, B2, and B3”) where “A1” is willing to share his/her bounty, reward, and/or success fee with “B1, B2, and/or B3”, independently and/or collectively. A1 can set a portion of the fee he/she is willing to provide per stage of success, per B1, B2, and B3, and/or if A1, is willing to let the Sub-Affiliates, further delineate the bounty, reward, and/or success fee with other Sub-Affiliates (C1, C2, C3, C4, and C5). (Also see more under the Affiliameter embodiment).

In addition, “A1” could setup different amounts for the bounty, reward, and/or success; different rules for allowing Sub-Affiliate participation, and/or different time windows for participation per Sub-Affiliate. For example, the TIMES Mgr could send a weblink with a unique ID and unique instructions to “A1”, where A1 clicks the weblink to connect to a URL with an invitation to participate in a recruiting exercise. The invitation could explains the terms of use, the privacy policies, the terms for participating, the timeframe for participation, the goals, requirements, and any associated bounty, rewards, and/or success fees. The invitation could go on to show A1 how to create Sub-Affiliates and create his/her own terms and rules for the Sub-Affiliates.

When Al accepts all the appropriate terms and conditions, the system allows A1 to mass email contacts an initiation that uniquely identifies and credits him/her as the associated inviter. The system also creates unique IDs per recipient to track the level in which each recipient participates. So later the system can specifically generate a report regarding each recipient ID as to whether he/she ever eventually participated in a Campaign and became a Participant and/or whether he/she became an Applicant; as to whether he/she ever created a login and the correlated user data (a profile/name), as to whether he/she ever eventually became a Candidate; as to whether he/she ever became a CHOP and/or a CATH; and from which specific Campaign ID initially and specific Recruiter ID initiated each, if any subsequent Recruiters, so to track who, where, how, and when the original recipient specifically came, from the start to the moment, and each measured, collected and tracked interaction along the way.

Depending on original terms and rules set by the TIMES Mgr, A1 may be able to create unique invitations, unique terms, unique deadlines, etc., per email address and/or per potential Sub-Affiliate. A1 could create invitations that are conditional whereby the recipient can become a Sub-Affiliate, once he/she surpasses a particular threshold, such as takes a survey, a test, participates in an interview, and/or obtains some preset number of friends and/or contacts to participate.

Each Invitation, participant, change, interaction, and associated link is monitored and tracked. The system can be setup to allow Affiliates and Sub-Affiliates to conditionally view other Invitation Campaigns, and/or element of Invitation Campaign, regarding each Campaign's relative successfulness over time, in acquiring participants, acquiring Applicants, acquiring Candidates, acquiring CHOP(s), acquiring CATCH(es). Data that tracks and measures relative successfulness along the hierarchy of Affiliates and Sub-Affiliates, per event, and can reflect what changes and/or methods proved to be relatively more effective, rewarding and/or for what particular purpose/goal, say for example either at finding Applicants relative more quickly and/or finding relative more qualified Candidates.

In addition, Affiliates can have his/her bounty, reward and/or success fee tied to a competition among other Affiliates for a particular accomplishment and/or a set period of time. For example, every year there could be a bonus bounty, reward and/or fee for the Recruiter/Affiliate who has been most successful in acquiring the highest number of CATCH(es) per a particular Company, a particular Job Category, a particular Job Position, and/or a particular region of the country. Another competition example, could be for acquiring the highest number of Applicants to participate in a particular PAC, PIN, survey, test, and/or interview. For instances, there could be a competition to see which Affiliate could acquire the most Applicants to participate in a new virtual interview created for a new PAC within the next 30 days.

Another competition example among Recruiters/Affiliates could be utilized to determine who acquired the most Applicants and/or or Candidates in, say a twelve month period, in terms of total bounties, rewards, and/or success fees; acquired the most Sub-Affiliates, and/or acquired the most Clients/NEEDs.

The system can be setup to provide a boilerplate of default instructions per invitation and can be based upon relatively successful invitations' used in the past for such elements as: similar PACs, similar Job Categories, similar Interview Methods, and/or similar Affiliate credentials. For example, the TIMES Mgr could create an invitation for Affiliates to acquire Applicants to participate in a virtual interview for a particular software program used for CAD-design by Architectural Drafts-persons.

In this example, the system could offer the TIMES Mgr example templates and/or suggestions base upon successful Invitation Campaigns 103 that incorporate element from “virtual interviews” for “Architectural-related software”, where the system creates user-defined fields for the TIMES Mgr to insert the name of the specific software. The time window for participation, if already set and setup, would come from the “Timing and Scheduling Assignments” 502 module; the interview method, if already set and setup, would come from the “Method(s) and Venue” 498 module; and any criteria for participation, if already set and setup, would could from the “Invoke MATCH” 506 module.

The system would check for known and/or potential timing and/or resource conflicts and notify the TIMES Mgr accordingly. The system would allow for grammar and spell checking. The system could check for known and/or likely conflicts, say among Recruiters and NEEDs based upon historical correlation data. The system could suggest attaching elements to the invitation that are likely to be relevant and/or attractive to the Affiliate recipient and/or the Applicant recipient.

For Affiliate recipients for instance, there could be language suggested and/or added regarding how successful, in terms of bounties, rewards, and/or success fees other Recruiters/Affiliates have been using similar invitations. For Applicant recipients for instance, there could be language suggested and/or added regarding how successful other Applicants have been at finding a rewarding career and/or new positions utilizing the system's unique tools and methods.

The system would track exactly what text edits were made (per editor/MGR per iteration) and the total of edits and iteration made to the overall content for the Campaign, and where there can be a plurality of edits after publishing where the system tracks edits and iterations made along with the number of Applicants per iteration. In addition the system would track suggestions made by users (JOINS/CASTING/NEED MGRs and the like), and user-input fields to continually improve further suggestions and minimize the number of required and/or likely adjustments needed to, say a particular job offer for a particular company in the future. And thus creating a highly efficient standard job post for each particular job and/or other campaign function that can be tweaked, if and as needed, but where even the tweaks can come with details suggestions based upon historical successfulness. The system could also track and create exactly who suggested and/or made the changes. Customization can be personalized into many segments, such as: per TIMES Mgr, per Company, per Job Category, per Job Position, per PAC/PIN, and/or per Affiliate.

The “Invoke MATCH” 506 module option is for assigning M.A.T.C.H. criteria and/or using elements from existing T.I.M.E.S. based from an existing MATCH criteria. Once the TIMES Mgr selects a particular Campaign 103 element to create a TIMES rule around, such as a particular PAC or a Campaign 103 schedule to become a PAC. The “Invoke MATCH” 506 module loads in MATCH criteria already assigned to the Campaign 103 and/or that Campaign 103 element. Some MATCH has been pre-assigned as mandatory and some MATCH allows the TIMES Mgr to select as needed and/or as appropriate per, for example, such things as the total time allowed and/or remaining in the Campaign, the total number of Applicants sought and/or so far, the total number of Candidates sought and/or so far collected and/or some combinations of these elements.

If a particular TIMES Mgr also had permissions equal to at least the default level of permissions assigned to a MATCH MGR, then he/she can also create and/or modify the MATCH. If TIMES Mgr had insufficient permissions to act as the MATCH MGR and if there was no MATCH shown to be assigned for a particular Campaign 103 and/or a particular Campaign 103 element that the TIMES Mgr was currently working on, the TIMES Mgr and/or the system could be setup to notify the MATCH MGR that necessary information for the PAC/PIN is missing and the timeframe requirements, etc. Generally, the MATCH MGR would create a base set of default MATCH to avoid this particular issue, the system can build a default list for particular cases where the MATCH MGR fails to meet the specific deadline and not stop the Campaign. (There are more details regarding MATCH on earlier Figs, such as FIG. 18).

The “Invoke OPINE” 508 module option is for assigning OPINE criteria and/or using elements from existing T.I.M.E.S. with existing OPINE criteria. Assigning OPINE permissions and privileges to a Campaign 103 allows participants to provide his/her feedback. (More details on OPINE further ahead).

These T.I.M.E.S. module options 496, 498, 500, 502, 504, 506, and 508 are tracked and measured independently, and collectively as a unit against all data elements and relative to, say a particular Campaign, and/or Campaign 103 element to measure their relative effectiveness and success rates against different Campaign 103 elements, PAM Rules, MATCH Rules, ADSTATS Rules, DREAM Rules, Billing Rules, Budgeting Rules, Bidding Rules, Account Rules, and Real-time Reporting. The TIMES Mgr 52 can use a B.B.B.M. 114 module option to assign Billing, Budgeting, and Bidding Rules to the TIMES Rule(s).

A “Thresholds, Weighting & Ranking 440 module option can be set up to place a variety of weighting, prioritizations, and rules to the collective measurements and results. For example, a particular TIMES Rule ID for a particular Invitation Campaign 103 that allows Applicants to select his/her preferred method to Interview may be far more effective at attracting applicants when relatively compared to Invitation Campaigns 103 that only offer a single method to Interview, such as only Live over the Phone, or only via a Webcam and with a virtual interviewer; and thus more weight could be applied towards placing Campaigns 103 with Invitation Campaigns 103 that allow Applicants to select his/her preferred method to interview.

Each NEED can measures a Campaign's success and this data can also be incorporated into the selection of a future Campaigns 103 for similar TIME Rule(s) and/or TIME Related Campaigns. A Campaign's relative success in attracting a relatively large pool of potential Applicants, Applicants who Inquire, Applicants who qualify as Candidates and Candidates the NEED makes an offer to, can also be measured and incorporated in the selection of future Campaign(s) and Campaign 103 elements by the TIMES Mgr 52.

Each new TIME Campaign 103 could be set to run against previous TIME Campaigns 103 in general and similar TIME Campaigns 103 to track and make sure that the new TIME Campaign 103 is in fact performing similarly, or report back that it is off by a quantifiable amount and to relative degree, and make suggested changes based on the area where the new TIME Campaign 103 deviates from methods that are relatively more tried and true, so credit and changes can be suggested and/or made based upon measurable results. New and modified TIMES Rules resulting in TIME Campaigns, such as invitations to surveys, tests, and/or Interviews can be previewed against an existing TIME Campaign 103 to see the results and/or saved with a Preview/Save 444 function.

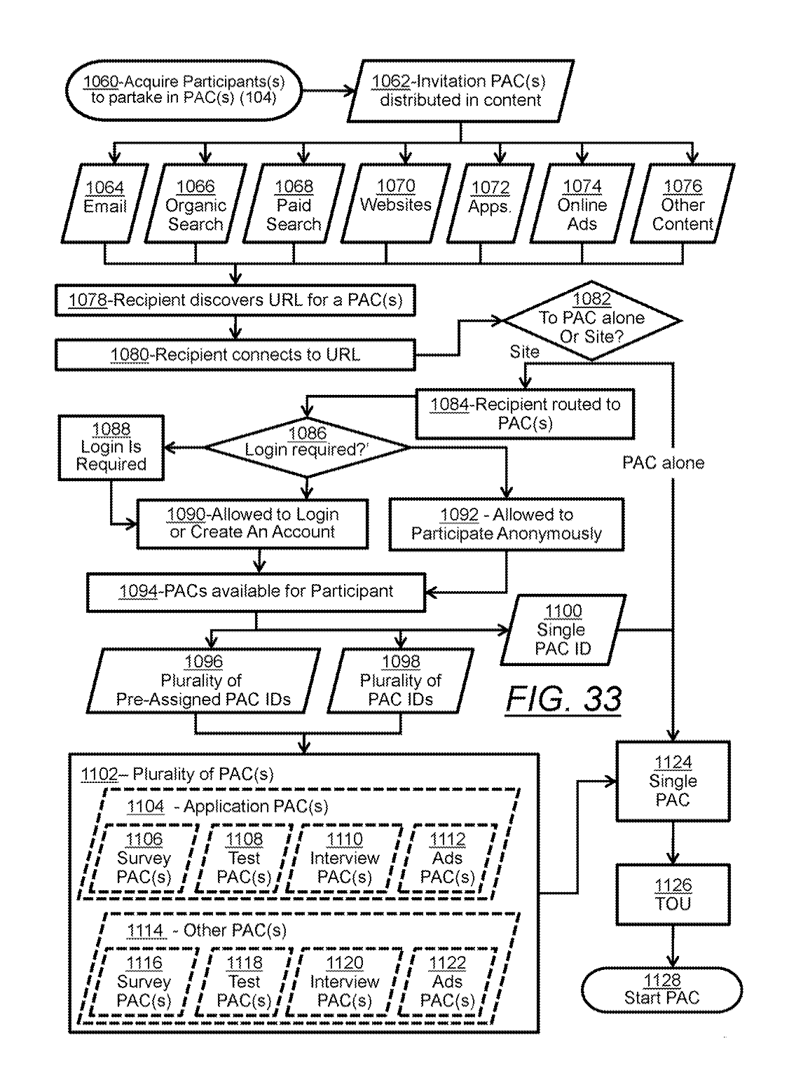

FIG. 33 is a flowchart depicting an embodiment with an example whereby a recipient comes to learn about and interact with an invitation to a particular Campaign 103 and then becomes a participant. Starting with a step 1060 “Acquire Participant(s) to take partake in PAC(s) (104)” where an Account who is already a member of the HIRES (102) with the appropriate role and permissions distributes invitation to potential Applicants. In this example, the recipients come to learn about a particular PAC via a step 1062 “Invitation PAC(s) distributed in content where the inviting Account can have utilized a plurality of content methods and locations for placing invitations for participants to become Applicants, starting with an “Email” 1064 content option, an “Organic Search” 1066 content option, a “Paid Search” 1068 content option, a “Websites” 1070 content option, an “Apps.” 1072 content option, an “Online Advertisements” 1074 content option, and an “Other Content” 1076 content option.

The “Email” 1064 content option allows Accounts to try and target/acquire and track PAC participants through email campaigns where the email can contain a URL to a specific PAC and/or a website with potentially a plurality of PACs. These emails can, among other options, be targeted to a particular person, and/or a particular type of person, based upon know information from previous interactions, say regarding the demographics, psychographics, previous HIRES interactions, web usage, and the like.

The “Organic Search” 1066 content option allows Accounts to try and target/acquire and track PAC participants through generating addressable web pages containing content with meta-tags and keywords likely to be searched by, say a job seeker (e.g. text, images, audio, video, keywords, articles; industry expert names; and the like); and/or content relevant to a particular job/NEED (e.g. with location, salary, skills required, company, position titles and the like) also likely to show up in the page ranks of a potential PAC participant's organic web search, where the generated webpage content can, among other options, also contain a call to action to a particular URL to a specific PAC and/or the website with the PACs.

The “Paid Search” 1068 content option allows Accounts to target and track PAC participants through paid search keywords and the like with purchased meta-tags and keywords likely to be searched by, say a job seeker (e.g. text, images, audio, video, keywords, articles; industry expert names; and the like); and/or keywords relevant to a particular job/NEED (e.g. regarding the location, salary, skills required, company, position titles and the like), where the generated Paid Search advertisers can, among other options, either contain a call to action to a particular URL to a specific PAC and/or the URL to a website with the PACs.

The “Websites” 1070 content option allows Accounts to try and target/acquire and track PAC participants through generating addressable web pages containing content likely to be discovered/view/read/heard by, say a job seeker (e.g. text, images, audio, video, keywords, articles; industry expert names; and the like); and/or content relevant to a particular job/NEED (e.g. with location, salary, skills required, company, position titles and the like) also likely to capture a job seeker, Peer reviewer, and/or Expert reviewer, where the generated webpage content can, among other options, also contains a call to action to a particular URL to a specific PAC and/or the website with the PACs.

The “Apps” 1072 content option allows Accounts to target and track PAC participants through software applications and widgets (not to be confused with Job/NEED “Applications” where the JOINS users apply for a NEED/Job). These software applications could loaded to appear on standalone devices/transceivers such as computers and/or mobile devices, but more likely to appear and interact with other devices on a network and/or the World Wide Web. These software applications could be for such things as an App for tracking job opportunities; an App for learning skills to obtain a particular job; an App for finding applicants, candidates and/or resources to complete a task, and the like, where the Apps can, among other options, either contain a call to action to a particular URL to a specific PAC and/or the URL to a website with the PACs.

The “Online Advertisements” 1074 content option allows Accounts to target and track PAC participants through online advertisements that can be targeted to appear to a particular person using a particular webpage, mobile device, and/or a particular type of person, based upon know information from previous interactions, say regarding the demographics, psychographics, previous HIRES interactions, web usage, and the like. These Advertisements can, among other options, either contain a call to action to a particular URL to a specific PAC and/or the URL to a website with the PACs.

The “Other Content” 1076 content option allows Accounts to create other content and advertisements methods not listed above to target and track PAC participants through Other Content means, such as a generated and trackable online newsletter, blog sites, and/or even physical content such as mailers, flyers, mailed-newsletters, print material, tv ads, radio ads, billboards, and the like. These Other Content and Advertisements can, among other options, either contain a call to action to a particular URL to a specific PAC and/or the URL to a website with the PACs where the URL tracks where the content and advertisement appeared and when.

After a particular recipient learns of a PAC via one of the content options 1064, 1066, 1068, 1070, 1072, 1074, or 1076, that recipient advances to a step 1078 “Recipient discovers URL for a PAC(s)”. From there the Recipient advances to a step 1080 “Recipient connects to URL, where the recipient actually clicks a URL link or types into a web browser window.

From step 1080, the recipient advances to a query 1082 “To PAC alone Or Site?” where the query looks to determine if URL connection is directed towards a particular Website (which may or may not require additional navigation to get to the PAC and/or which may have a plurality of PACs) or directed towards a particular self-contained single PAC. If he/she is directed towards the PAC alone the recipient advances to a step 1124 “Single PAC” where he/she a step 1126 “TOU” which allows the recipient to review and accept or reject the Terms of Use before starting the PAC in a step 1128 “Start PAC” and thus becoming a PAC participant.

If the answer to the query 1082 was instead direct recipient towards a particular Website the recipient advances to a Site in a step 1084 “Recipient routed to PAC(s)” where he/she may be required to login in a query 1086 “Login Required?”. If the login is required the recipient is routed to a step 1088 “Login Is Required” where the recipient is either already a registered Account or creates an Account in a step 1090 “Allowed to Login or Create An Account”. If the answer to the step 1086 is that the Login is not required, the recipient can either login in the step 1090 or instead decide to participate anonymously in a step 1092 “Allowed to Participate Anonymously” where the recipient/user is passed to a step 1094 “PACs available for Participant”.

From the step 1094, the system looks for unique identifiers contained within the URL and/or any other identifiers, say from the recipient/user's cookie ID(s), session ID(s), IP address, and the like to determine if the recipient/user should be presented with options or automatically forwarded toward a single PAC or a plurality of PAC options. If he/she is to be automatically forwarded or if he/she selects a single PAC, he/she is then passed to a step 1100 “Single PAC ID” where he/she is then forwarded as described above, to the Singe PAC step 1124, then step TOU 1126, before starting the PAC in the step 1128 as a participant.

If the system decides from identifiers in step 1094, to display or instead only offer a plurality of PACs, the recipient/user could pass through either a step 1096 with a “Plurality of Pre-Assigned PAC IDs” or a step 1098 with a “Plurality of PAC IDs” some of which may not have been Pre-Assigned to any of the known IDs of the recipient/user. From steps 1096 and 1098, the recipient/user passes to a step 1102 with a “Plurality of PACs” where there is a list of options in an option 1104 with “Application PAC(s)” and an option 1114 with “Other PACs”.

The “Application PAC(s)” 1104 options contain the options for applying for a particular Job Application via a “Survey PAC(s)” 1106 option, a “Test PAC(s) 1108 option, an “Interview PAC(s)” 1110 option, and an “Advertisement PAC(s)” 1112; and the “Other PAC(s)” 1114 options contain the options for all other PACs/Pins via a “Survey PAC(s)” 1116 option, a “Test PAC(s) 1118 option, an “Interview PAC(s)” 1120 option, and an “Advertisement PAC(s)” 1122.

Once the recipient/user selects a single PAC from the options in the step 1102, he/she is passed to the step 1124, then step TOU 1126, before starting the PAC in the step 1128 as a participant. All the data regarding the recipient/user along his/her route and decision tree utilized become a Participant is collected, stored and tracked to help determine what has or has not be successful relative to other data set, PACs/PINs and the like.

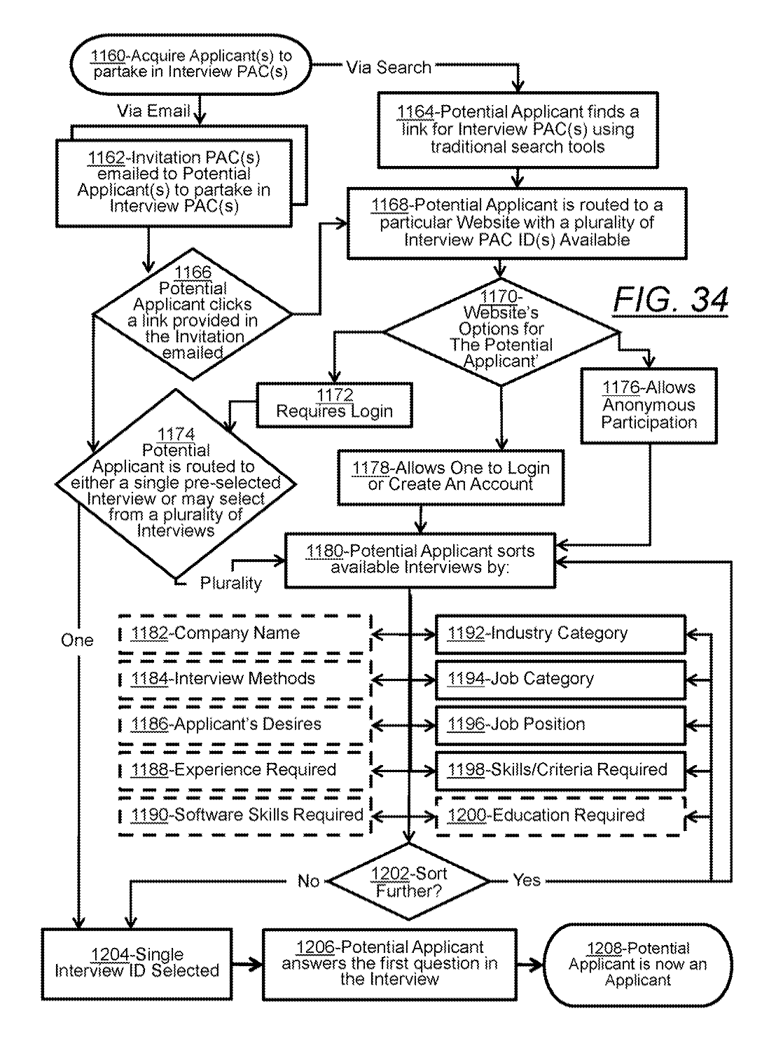

FIG. 34 is a flowchart of an embodiment depicting an example whereby an Account 60 user could create and utilize a particular Campaign 103 with Invitations for acquiring Applicants to partake in an Interview. Starting with a step 1160 “Acquire Applicant(s) to take partake in Interview PAC(s)” where the Account is already a member of the HIRES (102) with the appropriate role and permissions to send recipients and/or potential Applicants invitations. In this example, the Account can utilize two methods for acquiring Applicants, one, “via email” invitations; or two, “via search” employing invitation links.

In this example, the Account can choose to utilize either Web Search methods or Email to invite potential applicants to participate in an Interview PAC. The “Via Search” methods could be through, say organic web search results with URL links and/or paid web search advertisements based upon keywords purchased for paid search ads (as explained in FIG. 33); where a “Potential Applicant finds a (URL) link for Interview PAC(s) using traditional search in a step 1164; or the Account utilizes email sending out email invitations by advancing to a step 1162 where an “Invitation PAC(s) emailed to Potential Applicant(s) to partake in Interview PAC(s)” is invoked.

The recipient of the email in step 1162 has either never used the system or has, but is a new potential applicant for a particular PAC/PIN in this instances, even if he/she is currently an existing JOINS member. The recipient can invoke the URL link contained in the email invitation that will employ an 1166 query that asks if a “Potential Applicant clicks a link provided in the Invitation emailed”.

If the answer to query 1166 is no, then potential applicant does not advance. If the answer to query 1166 is yes, the system reviews the data provided to determine if the potential Applicant should be routed to a query 1174 that asks if a “Potential Applicant is routed to either a single pre-selected Interview or may select from a plurality of Interviews”. If the answer to 1174 is “one” pre-selected Interview based upon the identifiers provided and known about the URL and, say the user, the users' device/transceiver, device/transceiver location, time of day, and other relevant information, such as is the PAC/PIN still available and/or has any criteria or material changed, say for the MATCH; he/she is then passed to a function 1204 with a “Single Interview ID Selected”.

If on the other hand, the answer to query 1166 is also yes, but the system reviews the data provided and determines that the potential Applicant should be instead routed to a step 1168 with a “Potential Applicant is routed to a particular Website with a plurality of Interview PAC ID(s) Available” which is the same step the Potential Applicant would progress to from step 1164.

From step 1168, the potential applicant is passed to a query 1170 that asks what are a “Website's Options for the Potential Applicant”. If the answer to query 1170 is found in a function 1176 that says the website “Allows Anonymous Participation” then the potential applicant may advance to step 1180 where a “Potential Applicant sorts available Interviews by:” where a relevant and available list of Interviews is generated.

If the answer to query 1170 is found in a function 1178 that says the website “Allows One to Login or Create An Account” then the potential applicant may login or create an Account and advance to step 1180. If the answer to query 1170 is instead found in a function 1172 that says the website “Requires Login” then the potential applicant must already have an account and must login before preceding to step 1174 is this example.

If the answer to 1174 is not a single, but a “plurality” of Interviews are available to the potential applicant based upon the identifiers provided and known about the URL and, say the user, the users' device/transceiver, device/transceiver location, time of day, and other relevant information, such as is the PAC/PIN still available and/or has any criteria or material changed, say for the MATCH; he/she is then passed to the function 1180.

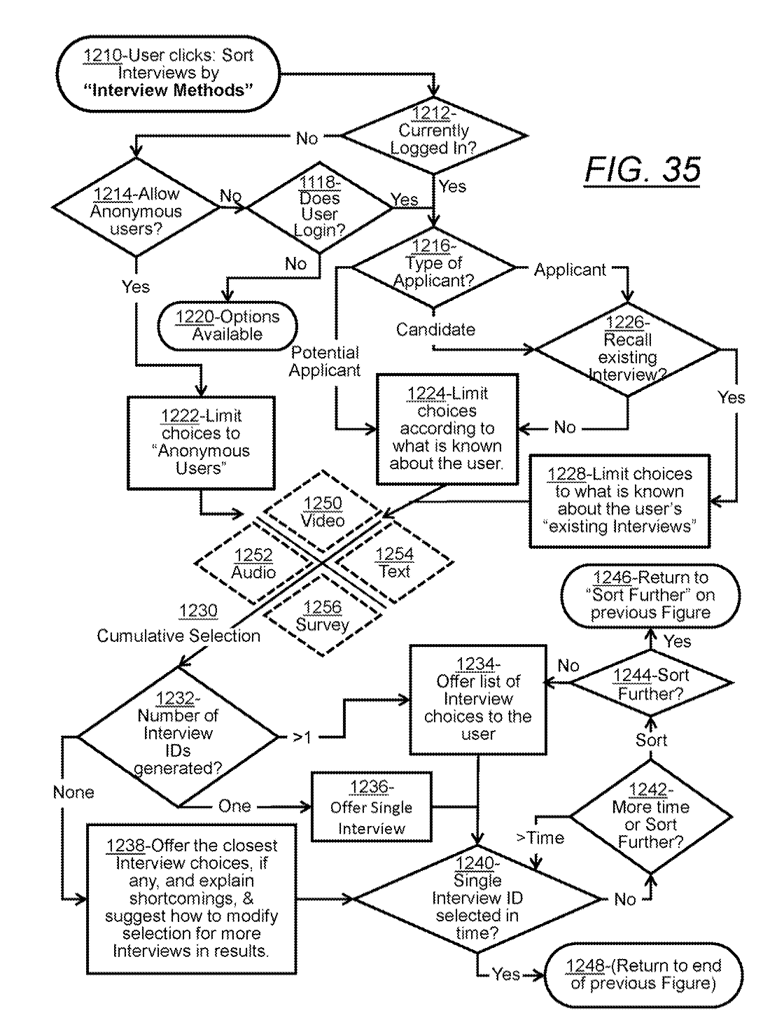

From step 1180, the potential applicant can search, view, sort, and review a list of potential interviews based upon what keyword(s) and/or meta-tag(s)s used to categorize the interviews available options are perceived to be the most relevant to the potential applicant starting with a “Company Name” 1182 search/interview option, an “Interview Methods” 1184 search/interview option (also see example in FIG. 35), an “Applicant's Desires” 1186 search/interview option, an “Experience Required” 1188 search/interview option”, a “Software Skills Required” 1190 search/interview option”, an “Industry Category” 1192 search/interview option, a “Job Category” 1194 search/interview option, a “Job Position” 1196 search/interview option, a “Skills/Criteria Required” 1198 search/interview option, and/or an “Education Required” 1200 search/interview option, and/or some combination of these search/interview options and where some search/interview options may not be available due to rules and conditions pre-determined by the Account and/or a particular MGR.

If the potential applicant searches and sort the potential interview options, he/she may also utilize a query 1202 which asks “Sort Further?” that allows the potential applicant to sort his/her search results even further, say to now rank the results according to certain keywords, meta-tags, and/or other elements, such as time, place and the like. If the answer to query 1202 is “yes” then the potential applicant is routed back to function 1180 (plus additional search and sort methods outlined).

If the answers to query 1202 is “no” then the potential applicant is routed to the step 1204 where the potential applicant makes his/her selection with the “Single Interview ID selected”. From step 1204, he/she is routed to a step 1206 with a “Potential Applicant answers the first question in the Interview” and from there, he/she shifts to a “Potential Applicant is now an Applicant” in a 1208 function/terminator.

FIG. 35 is a flowchart depicting an embodiment of an example whereby a potential applicant can search, view, sort, and review a list of potential interviews based upon “Interview Methods” options available and perceived to be the most relevant to the potential applicant. Starting with a function 1210 where a “User clicks: Sort Interviews by “Interview Methods” (as depicted example FIG. 34).

From function 1210, the system performs a query 1212 to determine if the potential applicant is “Currently Logged In?” If the answer to query 1212 is “yes” the potential applicant is passed to a query 1216 that asks for “Type of Applicant?” If the answer to the query 1212 is “no” the potential applicant is instead passed to a query 1214 that asks “Allow Anonymous Users?”

If the answer to query 1214 is “yes” the potential applicant is passed to a function 1222 with a “Limit choices to ‘Anonymous User’” before passing to the option pool found in a 1230 option pool section. If the answer to query 1214 is “no” the potential applicant is instead passed to a query 1118 that asks “Does User Login?”.

If the answer to query 1118 is “no” the potential applicant is passed to a terminator 1220 with an “Options Available” is displayed to the potential applicant. If the answer to query 1118 is “yes” the potential applicant is instead passed to the query 1216 that asks for the “Type of Applicant?”

If the answer to query 1216 is “Applicant” or “Candidate” that information is stored and any relevant identifiers are retrieved and/or employed in a query 1226 with a “Recall existing interview?” where the Applicant or Candidate can recall an existing interview. If the answer to query 1216 is “Potential Applicant” where he/she is not a known Applicant or Candidate that information is stored and any relevant identifiers are retrieved and/or employed as he/she is passed to a function 1224 with a “Limit choices according to what is known about the user” before the potential applicant is passed to the option pool found in the 1230 option pool section.

If the answer back in query 1226 is “no” the Applicant and/or Candidate is also passed to the function 1224 before being passed to the option pool found in the 1230 option pool section. If the answer back in query 1226 is “yes” the Applicant and/or Candidate is instead passed to a function 1228 with a “Limit choices to what is known about the user's ‘existing interviews’” before being passed to the option pool found in the 1230 option pool section.

The functions 1222, 1224, and 1228 all direct the user (e.g. Potential Applicant, Applicant, and/or Candidate) to the option pool 1230 where he/she can select from the interview method options of a “Video” 1250 interview method option, an “Audio” 1254 interview method option, a “Text” 1254 interview method option, and/or a “Survey” 1256 interview method option where the cumulative selections get passed to a query 1232 which asks “Number of Interview IDs generated?”

The “Video” 1250 interview method option allows the user to generate, view, sort, and select from a list of interviews that employ video methods. For example, the user might see interviews that are either, offer/require video recorded when conducted face-to-face; video recorded when conducted online; and/or allow you to submit your recorded video clips for an entire interview and/or a portion of an interview, say a particular question asking for example of, say a particular applicants fashion modeling skills, home building skills, before/after automobile body work or detailing skills, before/after remodeling results, before/after plastic surgery results, and the like. The video clips could allow for client testimonials and/or references that meet a list of pre-set criteria and/or limitations such as, within the last twelve (12) months from, say clients who were not known to the Applicant more than twenty-four (24) months ago.

In addition, the system could be setup to allow for extending the exchange and/or follow-up where for example, the NEED Mgr may require that any reference and/or (i.e. client) testimonial provided by a particular users also include the contact information of the specific reference party who gave the reference and/or testimonial and where that reference party can be requested to answer follow-up questions that may or may not be recorded. These requests can be password protected interactions, and/or require actual Account membership. These interactions is where the system can help normalize a series of endorsements or references with detailed specific follow-up questions/answers where the system can automate the process of contacting these reference parties and making sure specific questions are asked and hopefully answered (similar to the TIMES module and it's functionality).

The questions that are answered by the reference party are stored, track and can generate a comparative database where the comparison can be made between different references by the same reference party; between different reference parties for the same particular user and/or questions to quantitatively see where exactly reference parties tended to agree and/or disagree and to what degree, say along a continuum scale per question/answer in terms of set checkboxes used to score and/or describe the reference and/or in words chosen to answer a question, describe the reference, and/or a situation.

In addition, these follow-up references and reference parties along with the associated responses can be compared to other Applicants and Candidates relative to the Job opening at present, and/or to past Job openings and/or Candidates to flag for potential hyperbole usage, where say a particular Candidate did not matchup to the reference provided when compared to data collected over time by Company managers or instead, a situation showing how a particular Applicant or Candidate has quantitatively evolved from either limited endorsements and testimonials, limited scores, and/or limited specifics; from reference parties, to over time broader, bolder and more detailed statements/endorsement that have held up under actual working conditions with the Company.

Theses types of reference and reference party analysis can help reveal what job industries, categories, and positions, are better suited for references, flag references and reference parties as suspect and specifically why, flag references that may indicate strong growth potential and/or limited upside when compared to existing data.

The “Audio” 1254 interview method option allows the user to generate, view, sort, and select from a list of interviews that employ audio methods. For example, the user might see interviews that are either, offer/require audio recorded when conducted face-to-face; audio recorded when conducted online; and/or allow you to submit your recorded audio clips for an entire interview and/or a portion of an interview, say a particular question asking for example of, say a particular applicants speaking skills, voiceover talent, singing skills, selling pitch skills, how the Applicant overcame a specific objection, explanation to a particular item on the Applicant's resume, and the like. The audio clips could allow for client testimonials and/or references that meet a list of pre-set criteria and/or limitations such as, no longer than two (2) minutes per clip and/or testimonial; no more than ten (10) minutes total running time for all material, and say, only particular audio formats, such as WAV files and/or the like.

The “Text” 1254 interview method option allows the user to generate, view, sort, and select from a list of interviews that employ text methods. For example, the user might see interviews that are either, offer/require text inputs when conducted face-to-face; when conducted online; and/or allow you to submit your text for an entire interview and/or a portion of an interview, say a particular question asking for example of, say a particular applicants business correspondence writing skills, advertising/marketing writing skills, and the like. The text examples could allow for links to other writing projects, such as speeches made, patent drafted, novels written, screenplays written and the like. The text examples could also be for client testimonials/references that meet a list of pre-set criteria and/or limitations such as, no longer than say one-thousand (1000) words per text entry clip and/or no more than, say ten (10) pages of text content total for all material, and say, only particular text formats, such as Word files and/or only a particular typestyle of, say “Times New Roman” font at twelve (12) point size, double spaced, and/or the like.

The “Survey” 1256 interview method option allows the user to generate, view, sort, and select from a list of interviews that employ survey methods. For example, the user might see interviews that are either, offer/require survey inputs when conducted face-to-face; when conducted online; and/or allow you to submit your survey answers for an entire interview and/or a portion of an interview, say a particular question asking for example of, say a particular applicants feedback, views, comments, and/or specific answers regarding, say the Applicant's view of his/her own selling skills, communication skills, listening skills, design skills, marketing skills, and/or the like.

The survey examples could also be for getting the Applicant's OPINE feedback (see other Figs) for say, his/her views on the Company, Offer, brand, product and/or the like. The survey could also have a list of pre-set criteria and/or limitations such as, surveys with less than twenty (20) questions and/or surveys with certain style answer forms, such as fill-in-the-blank, multiple choice surveys, and/or the like. Where the Applicant can search, sort, and/or select interviews based upon those surveys with, say a particular question type and/or those with a limited number of questions, say no more than twenty (20) and/or those that are or are not timed. These search, view, and sort options may or may not be available, depending on how the functionality was preset by the appropriate NEED MGR.

If the answer in query 1232 is “greater than one (>1)” the user is passed to a function 1234 where an “Offer list of Interview choices to the user”. If the answer in query 1232 is “One” interview where the system has clearly identified a single interview ID, then the user is instead passed to a function 1236 with an “Offer Single Interview” to the user. If the answer in query 1232 is “none” the user is passed to a function 1238 where an “Offer the closest Interview choices, if any, and explain shortcomings (to the user's search/sort request), and suggest how to modify selection for more Interviews in (his/her) results”.

The functions 1234, 1236, and 1238 all direct the user (e.g. Potential Applicant, Applicant, and/or Candidate) to a query 1240 which asks if a “Single Interview ID selected in time?” where the user must select a single interview ID within a preset amount of time. If the answer to the query 1240 is “yes” the user is passed to a terminator 1248 with a “(Return to end of previous Figure)”. If the answer to the query 1240 is “no” the user is instead passed to a query 1242 which asks the user if he/she wants a “More time or Sort Further?” functionality.

If the answer to the query 1242 is “More time (>Time)” the user is passed back to the query 1240 with an additional preset amount of time. If the answer to the query 1242 is instead “Sort” the user is passed to a query 1244 which asks the user if he/she wants a “Sort Further?” functionality. If the answer to the query 1244 is “no” the user is passed back to function 1234, but if the answer is “yes” the user is passed to a terminator 1246 with a “Return to “Sort Further” on previous Figure”.

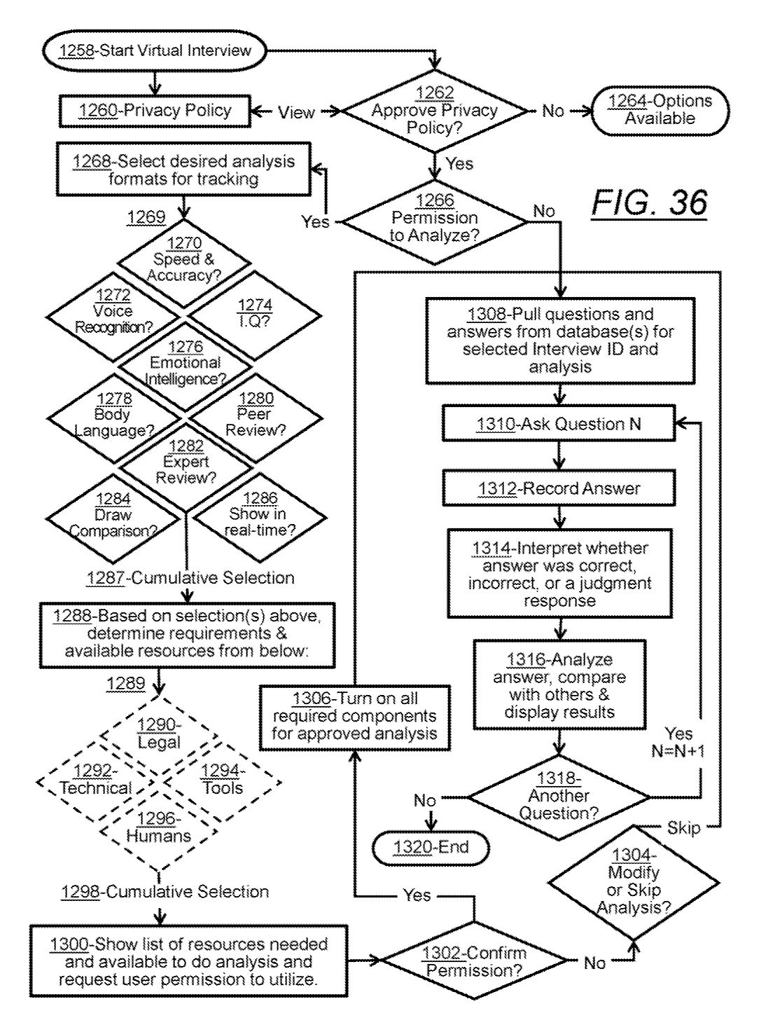

FIG. 36 is a flowchart depicting an embodiment of an example whereby an applicant has selected to partake in a Virtual Interview. Starting with a function 1258 with a “Start Virtual Interview” and where the Applicant can either view a “Privacy Policy” or invoke a query 1262 which asks whether the Applicant “Approve(s) Privacy Policy?” If the Applicant answers query 1262 with a “no” the user is passed to a terminator 1264 where he/she see an “Options Available”.

If the Applicant answers query 1262 with a “yes” the user is instead passed to a query 1266 which asks the Applicant if he/she wants to allow the system a “Permission to Analyze?” the data, the Applicant and/or the results. If the answer to query 1266 is “no” the Applicant is passed to a function 1308 with a “Pull questions and answers from database(s) for selected Interview ID and analysis”.

If the answer to query 1266 is “yes” the Applicant is instead passed to a function 1268 with a “Select desired analysis formats for tracking” where the Applicant is then passed to an option pool 1269 starting with a “Speed and Accuracy?” 1270 analysis option, a “Voice Recognition” 1272 analysis option, an “I.Q.?” 1274 analysis option, an “Emotional Intelligence?” 1276 analysis option, a “Body Language?” 1278 analysis option, a “Peer Review?” 1280 analysis option, an “Expert Review?” 1282 analysis option, a “Draw Comparison?” 1284 analysis option, and/or a “Show in real-time?” 1286 analysis option where a “Cumulative Selection” 1287 is generated based upon the Applicants inputs that are then reviewed, verified, and passed to a 1288 function with a “Based on selection(s) above, determine requirements and available resources from below.”

The “Speed and Accuracy?” 1270 analysis option allows the Applicant to indicate whether he/she would like the system to track his/her speed and accuracy performance levels perceived during and/or after the entire Virtual Interview and/or at any particular moment during and/or after the Virtual Interview. The options for Speed and Accuracy can incorporate mechanical and/or human methods of analyzing many factors of the Applicants ability to respond prompt and accurately to queues and/or questions within the virtual interview. A range of analysis and/or opinions, say from a mechanical means, a human Expert, and/or a human non-Expert could then be compared and/or averaged for a particular question/answer.

Applicants can indicate who views and can interact with his/her content, data, system interactions (e.g. with PACs/PINs). For each feature and in total, the Applicant can request that, say only Humans provide feedback, no Humans should provide feedback, only computerized analysis should provide feedback, and/or some combinations per analysis options and/or overall.

The “Voice Recognition” 1272 analysis option allows the Applicant to indicate whether he/she would like the system to track his/her Voice Recognition performance and levels perceived during and/or after the entire Virtual Interview and/or at any particular moment during and/or after the Virtual Interview. The options for Voice Recognition can incorporate mechanical and/or human methods of analyzing many factors of the audio, including those associated with so called “Lie Detector” testing that actually measure a person's arousal. So the system can collect comparative data points over time for his/her arousal at different questions to gauge such things, as the user's understanding of the material, the sincerity of his/her overall answers and/or per comment/answer. A range of analysis and/or opinions, say from a mechanical means, a human Expert, and/or a human non-Expert could then be compared and/or averaged for a particular question/answer.

The “I.Q.?” 1274 analysis option allows the Applicant to indicate whether he/she would like the system to track his/her I.Q. levels during and/or after the entire Virtual Interview and/or at any particular moment during and/or after the Virtual Interview. The options for I.Q. can incorporate mechanical and/or human methods of analyzing many factors of the Applicants intelligence to answer questions within the virtual interview. A range of analysis and/or opinions, say from a mechanical means, a human Expert, and/or a human non-Expert could then be compared and/or averaged for a particular question/answer.

The “Emotional Intelligence?” 1276 analysis option allows the Applicant to indicate whether he/she would like the system to track his/her Emotional Intelligence performance levels perceived during and/or after the entire Virtual Interview and/or at any particular moment during and/or after the Virtual Interview. The options for Emotional Intelligence can incorporate mechanical and/or human methods of analyzing many factors of the Applicants emotional intelligence to answer questions within the virtual interview. A range of analysis and/or opinions, say from a mechanical means, a human Expert, and/or a human non-Expert could then be compared and/or averaged for a particular question/answer.

The “Body Language?” 1278 analysis option allows the Applicant to indicate whether he/she would like the system to track his/her Body Language performance and levels perceived during and/or after the entire Virtual Interview and/or at any particular moment during and/or after the Virtual Interview. The options for Body Language can incorporate mechanical and/or human methods of analyzing many factors of the Applicants body language within the virtual interview. A range of analysis and/or opinions, say from a mechanical means, a human Expert, and/or a human non-Expert could then be compared and/or averaged for a particular question/answer.

The “Peer Review?” 1280 analysis option allows the Applicant to indicate whether he/she would like the system to supply and track Peer Reviews during and/or after the entire Virtual Interview and/or at any particular moment during and/or after the Virtual Interview. Who, how, what, when and where another users qualifies as a Peer can be predetermined by the NEEDS MGRs and/or allowed to be created and/or modified by the Applicant.

For example, the Applicant who is a Registered Nurse may wish to make any user who is of the same gender and who works in, say the Medical Industry (Job Industry Category) his/her personal qualifications to be a Peer. However when it comes to seeking actual “Peer Reviews” the Applicant may choice to restrict the qualifications even further, say to exclude any users who work for the same Hospital the Applicant works for, used to work for, and/or exclude anyone within the same city or state. This allows the Applicant some additional privacy and/or anonymity. In addition, he/she could flip the gender to the opposite gender.

The “Expert Review?” 1282 analysis option allows the Applicant to indicate whether he/she would like the system to supply and track Expert Reviews during and/or after the entire Virtual Interview and/or at any particular moment during and/or after the Virtual Interview. Who, how, what, when and where another users qualifies as an Expert can be predetermined by the NEEDS MGRs and/or allowed to be created and/or modified by the Applicant.

For example, the Applicant who is Patent Attorney may wish to make any user who is registered patent attorney with USPTO as his/her qualification to be a recognized Expert. However when it comes to seeking actual “Expert Reviews” the Applicant may choice to restrict the qualification further, say to only include those Experts who have, say filed at least twenty (20) patent applications, but with, say not more than fifteen (15) years of experience. This allows the Applicant some additional perimeters for controlling the pool of Experts to a particular skill and/or say, those with relatively recent experience.

The “Draw Comparison?” 1284 analysis option allows the Applicant to indicate whether he/she would like the system to track, generate, and/or display data correlation comparisons during and/or after the entire Virtual Interview and/or at any particular moment during and/or after the Virtual Interview. These comparison can either to the Applicant's earlier interviews with the same or similar job position; to the Applicant's earlier interviews for unrelated jobs; the Applicant's earlier interviews with the same or similar questions; to the Applicant's earlier interviews for unrelated questions; and/or to other Applicant's for these same conditions of related/unrelated jobs and/or questions; and the like.

The “Show in real-time?” 1286 analysis option allows the Applicant to indicate whether he/she would like the system to track, generate, and/or show his/her results in real-time, near real-time, and/or only at some point in the future. For example, the real-time results may provide Peer comments about a particular Applicant's Body Language even before he/she answers a question, so that the Applicant can, say make correction if necessary. This capability could be employed, say during a rehearsal of certain virtual interviews, if even an available option.

Another example would be for near real-time results, where the Applicant could place an offset to the feedback, where for instance, the feedback results to a particular question may not appear for a set period of time, and/or not until the Applicant has answered the question. The options for real-time and near real-time feedback would be dependent on the number of users that were currently logged in that qualified as Peers and/or Experts per the conditions either set by the Applicant and/or the particular NEED MGRs.

If no Peers and/or Experts were available for real-time feedback, the system could perform a number of workaround functions and/or suggestions. For example, the system could go out and try to attract offline Peers and Experts who would otherwise qualify as Peer and Expert to login and participate in the Applicants real-time review by sending these parties, say an email, voicemail, and/or a SMS message to come participate, where the Applicant could get a dashboard status of the communications steps taken and whether any potential Peers and/or Experts replied with an accept and/or rejection.

The system could also make suggestions as to what time of day and which days (based upon historical data), that represents the best opportunity for obtaining real-time feedback and/or reviews based upon the Applicants and/or the NEED MGRs Peer and Expert qualification requirements.

The system could also make suggested changes to the Peer and/or Expert qualifications whereby these other user's who are currently online, but do not “qualify” under the current perimeters could become “qualified” Peers and/or Experts. For instances, the Applicant may allow users who have done a certain type of software coding/developing to be considered an “Expert”, but if the Applicant were to loosen the qualifications to allow coders/developers of more software types to judge his/her virtual interview the system would then have a larger pool of potential online Experts to request their real-time feedback and/or review of the Applicant's virtual interview.

The system also allows the Applicant to request only anonymous feedback and/or only feedback that can be tracked back to a specific user. In addition the Applicant can only request voluntary feedback; or instead also offer a bounty; a fee, a reward and/or point system; some sort of barter, discount, coupon, service, benefit; offer some sort of exchange, say his/her reciprocal feedback, industry or expertise prestige; a virtual currency; and the like; and/or some combination of these; to attract feedback and/or reviews where there can be different bounties, fees, and/or rewards associated with different Interviews, for each question, for different Peer qualification criteria, for different Expert qualification criteria, for different times of day, for whether the feedback is real-time, near real-time, and/or provided later, and if later, say within a particular period of time.

The above in the “Cumulative Selection” 1287 is passed to another option pool 1289 that contains a “Legal” 1290 option, a “Technical” 1292 option, a “Tools” 1294 option, and a “Humans” 1296 option, where the a “Cumulative Selection” 1298 is generated based upon the Applicants inputs that are then reviewed, verified, and passed to a 1300 function with a “Show list of resources needed and available to do analysis and request user permission to utilize”.

The “Legal” 1290 option reviews the Applicants above selections for legality and privacy issues relevant to his/her location, age requirements/restrictions, privacy policies and settings, TOU settings, any applicable laws such as anti-discrimination when and where relevant to a particular system function, and the like; and where this data is then incorporate into the cumulative selection 1298 and resource list generated for the Applicant.

The “Technical” 1292 option reviews the Applicants above selections for potential technical issues relevant to the Applicants web connection speed, known attached devices regarding adequate through put and/or capabilities (e.g. a web-cam) where this data is based upon the device manager data, and/or data known previous online connections and/or interviews and the like and where this data is then incorporate into the cumulative selection 1298 and resource list generated for the Applicant.

For example, some assessment systems may require additional hardware, such as for certain types of computer-generated-assessments of a “Lie Detecting” or also referred to as an “Arousal Detecting” or “Truthfulness vs. Deception Testing’ which may require the user to loan, rent and/or purchase certain equipment such as a “blood pressure cuff” and/or go to a location that provides such equipment as be necessary.

While most people see “Lie Detecting” as an intrusive practice, here it can be used as a constructive tool to measure those issues that cause the person/user to become aroused. For some people, certain situations, such as test taking and/or job interviews make them become uncomfortable. This system allows the user to measure, collect, track, and assess what situations cause the user to become more and most uncomfortable to help make mental adjustments and/or recognize what material he/she may need to better prepare for. Right down to what particular questions and/or topics make him/her most uncomfortable.

There can typically three different types of physiological responses that are measured in an arousal test/lie-detecting interview. These physiological responses are measured with different types of equipment to create an arousal assessment, including a pneumograph, a sphygmomanometer, and/or an electrodermal response (EDR) which is sometimes referred to as a galvanic skin response (GDR) or skin conductance response (SCR).

The pneumograph measures the user's rate and depth of respiration and is strapped around the user's chest and abdomen. The sphygmomanometer (also called a blood pressure cuff) is placed around the user's bicep to measure his/her cardiovascular activity. The EDR measures the user's perspiration and requires electrodes be attached to the user's fingertips. However, such elaborate equipment may not realistic for some users, so simpler, less intrusive, and less expensive equipment, such as the EDR, GDR, and/or SCR may be sufficient for the purposes of measuring, collecting, and comparing the user's response data.

In addition to collecting all three measurements in ideal situations, these measurements are also collected during, say three different sessions, such as a Pretest Interview, followed by a questioning procedure interview, and followed by a post-test interview. The system can provide the user with base line “Pretest Interview” questions to build a base line response.

While most lie-detector tests can last for hours, they are typically a one time situation. One benefit of the system and the ability to self administer the tests, the user can take multiple tests over time to help develop a better quality base line response, than what may be possible in one day interview. Further, this data helps the user build a larger comparative database of measurement to isolate any anomalies the could appear in future with the more data collected.

The “Tools” 1294 option the Applicants above selections for potential tool issues relevant to the Applicants Tools, such as software needed for a particular test, web browser version, and the like; where this data is based upon the system's control panel data, task manager, device manager data, and/or data known previous online connections and/or interviews and the like and where this data is then incorporate into the cumulative selection 1298 and resource list generated for the Applicant.

The “Humans” 1296 option allows the Applicant to indicate who views and can interact with his/her content, data, system interactions (e.g. with PACs/PINs) which was covered above under Peers and Experts; and where this data is then incorporate into the cumulative selection 1298 and resource list generated for the Applicant to select from in function 1300.

From the function 1300 the user passes to a query 1302 which asks “Confirm Permission?” where if the answer is “no” the Applicant is passed to a query 1304 which asks “Modify or Skip Analysis?” If the answer to query 1302 is “yes” then the Applicant is instead passed to a function 1306 which has a “Turn on all required components for approved analysis” where the Applicant is then passed to the function 1308.

If the answer back in query 1304 is “Skip” the Applicant and the associated data is passed to a function 1308. From the function 1308, the Applicant and the associated data is passed to a function 1310 with a “Ask Question N” and following the Applicant's answer, he/she is passed to a function 1312 with a “Record Answer” before passing to a function 1314 with an “Interpret whether answer was correct, incorrect, or a judgment response”.

From function 1314 the Applicant and the associated data is passed to a function 1316 with an “Analyze answer, compare with others and display results” before passing the Applicant and the associated data to a query 1318 which asks if “Another question?” is in the preset virtual interview package.

If the answer to query 1318 is “Yes (N=N+1)” then the Applicant and the associated data is passed back to function 1310. If the answer to query 1318 is “No” then the Applicant and the associated data is instead passed back to a terminator 1320 with an “End” Virtual Interview function.

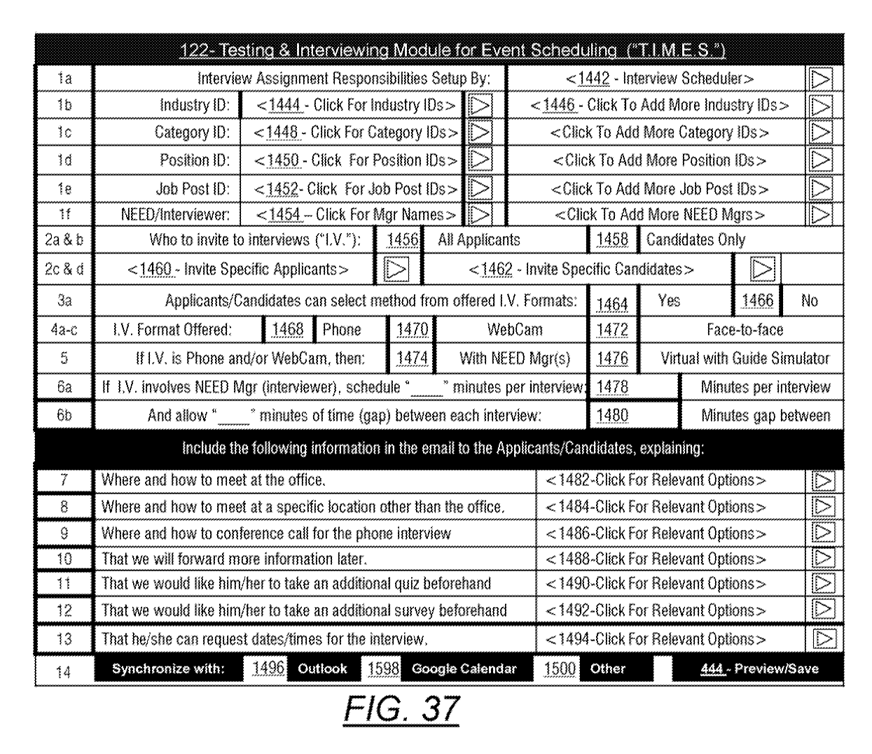

FIG. 37 depicts an embodiment of an example of the “T.I.M.E.S.” 122 module and the process of setting up different pre-criteria for all the Applicants who qualify for a particular NEED/Job Opening and who now have become a “Candidate”. The PAM-MGR/Recruiter (“PAM-MGR 50”) logs into the NEED 82 system connected to the internet or similar networked computer and utilizing the HIRES 102, he/she selects specific actions that he/she would like incorporated into the scheduling process and conditions regarding time availability.

The PAM-MGR 50 can setup an Interview Scheduler 1442 with an associated Industry ID 1444, an associated Category ID 1448, an associated Position ID 1450, an associated Job Post ID 1452 (e.g. PAC or PIN) and add the associated NEED MGRs/Interviewer 1454 IDs and/or names. If the appropriate ID is not found in the preset drop down list of choices, say for the Industry ID 1444, the PAM-MGR 50 can add with a “Click To Add More Industry IDs” 1446 option.

The PAM-MGR 50 can pre-determine who to invite to participate with an “All Applicants” 1456 option or a “Candidates Only” 1458 option. In addition, the PAM-MGR 50 can specify specific Applicants/Candidates with an “Invite Specific Applicants” 1460 drop down option and/or with an “Invite Specific Candidates” 1462.

The PAM-MGR 50 can pre-determine and/or allow candidates to select between interviewing methods with an “Applicants/Candidates can select method from offered interview (I.V.) formats” with a “Yes” 1464 option or a “No” 1466 option.

The PAM-MGR 50 can offer interview methods such as, say a “Phone” 1468 interview option, a “Webcam” 1470 interview option, and/or a “Face to Face” 1472 Interview. In addition, the system could offer a “Virtual with Guide Simulator” 1476 interview type (also referred to as a Virtual Interview). If on the other hand, the PAM-MGR selects a “With NEED MGR(s), he/she can dictate that it must be with a NEED MRG and/or only if Applicant/Candidate selects an interview with a NEED MGR (i.e. not the Virtual Interview option).

The PAM-MGR 50 could pre-select only one option, select more than one option thus leave it up to the Applicants/Candidates and/or leave up to the perimeters preset by those doing the Interviewing. Next, the PAM-MGR 50 and/or the person doing the interviewing would use the System proprietary Calendar and/or a commonly known Calendar program, such as a “Google Calendar” 1598 option or an “Outlook” 1496 option that would be synchronized with the System to indicate what days and times the person who will be conducting the phone interviews, hereinafter the “Interviewer” would be available for the Interviews.

If the Interview involves a NEED MGR (interviewer), the number of minutes to allow per interview could be entered in a “Minutes per Interview” 1478 field. Instead of the PAM-MGR 50 and/or Interviewer having to type in each and every time window, he/she could simply block out times that he/she is available and setup how long they would like the average interview to last and the appropriate gap of time to allow between interviews and the System you calculate and display the scenario. If the scenario needing tweaking, the Interviewer could modify the overall settings or manually change individual entries.

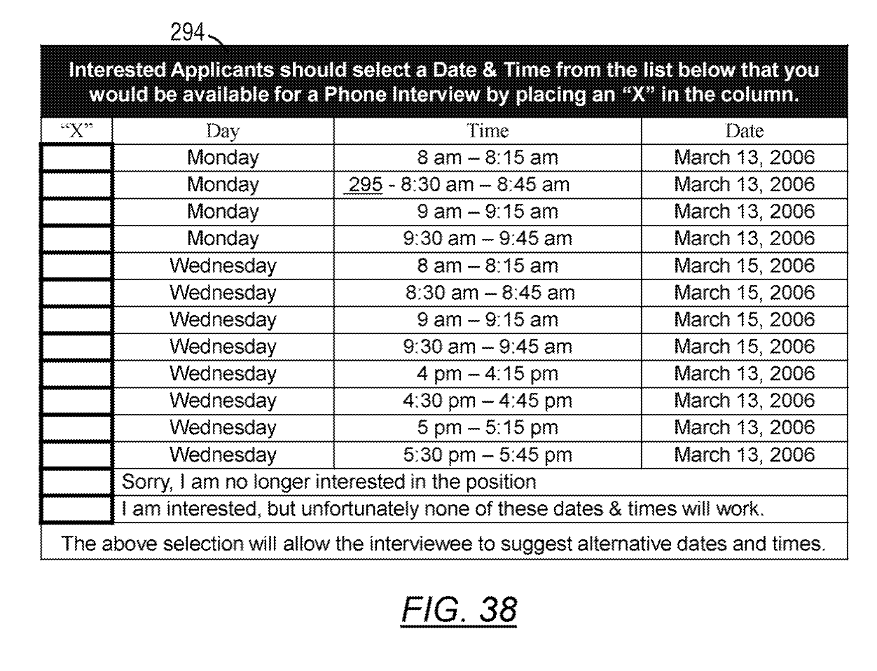

In addition, the NEED MGR (interviewer) could input a “Minutes gap between” 1480 field for the amount of time the system should allow for between interviews. For example, the Interviewer might state that “I would like to schedule 15 minutes per interview” and “I would like to allow a 15 minute of time (gap) between each interview”. Based on the days and times allocated as available, the System produces a Schedule similar to the Schedule shown in FIG. 38. The System would also let the Interviewer know that based on the current selections, this is enough time for twelve interviews and that there currently are eight Candidates.

The System could go on to give the Interviewer known statistics, such as, on-average this type of Job Position needs a two-to-one margin for available dates and times compared to Candidates, or in other words, if there are eight (8) Candidates, the Interviewer should consider sixteen (16) available time slots, verses the twelve (12) currently. The System could give statistics that typically Candidates need more of an advance notice to schedule a phone interview (or face-to-face) than what is being offered. The System could give statistics that typically Candidates prefer different hours in the day for phone interviews, such as lunch hours which are not being offered.

This statically data may vary per region of the country, per time of year, per company, per job category/position/role/responsibilities, size of company, size of department, salary, etc. This data may even vary depending who is doing the interviewing, job posting, recruiting, and/or whether it's a phone interview or a face-to-face.

FIG. 37 also depicts an example user interface screenshot of how the PAM-MGR 50 and/or the Interviewer would also use the TIMES 122 to select what specific information should and/or should not be included in the email and/or weblinks provided to each Candidate, such as: a “Where and how to meet at the office (in a face-to-face interview)” 1482 option, a “Where and how to meet at a specific location other than the office (in a face-to-face interview)” 1484 option, a “Where and how to conference call for the phone interview” 1486 option, a “That the company will forward more information later” 1488 option, a “That the company would like him/her to take an additional quiz beforehand (with a weblink)” 1490 option, and/or a “That the company would like him/her to take an additional survey beforehand (with a weblink)” 1492 option. In addition, the system could ask the Applicant/Candidate a “That he/she can request dates/times for the interview” 1494 option. And all this information can be previewed against an existing TIMES 122 Campaign 103 to see the results and/or saved with a Preview/Save 444 function.

FIG. 38 depicts an embodiment of an example user interface screenshot of an Interview Scheduler generated by the TIMES 114. This Interview Scheduler is what an Applicant and/or a Candidate would see after clicking a weblink, say that was sent to each Candidate by the System, inside of an email. Interested Applicants and/or Candidates (Applicant/Candidate depends on the conditions set in the System for pre-qualifying and at what juncture in the process) are asked to “Select a Date and Time” from the list shown that he/she would be available for a Phone Interview by placing an “X” in the appropriate column.

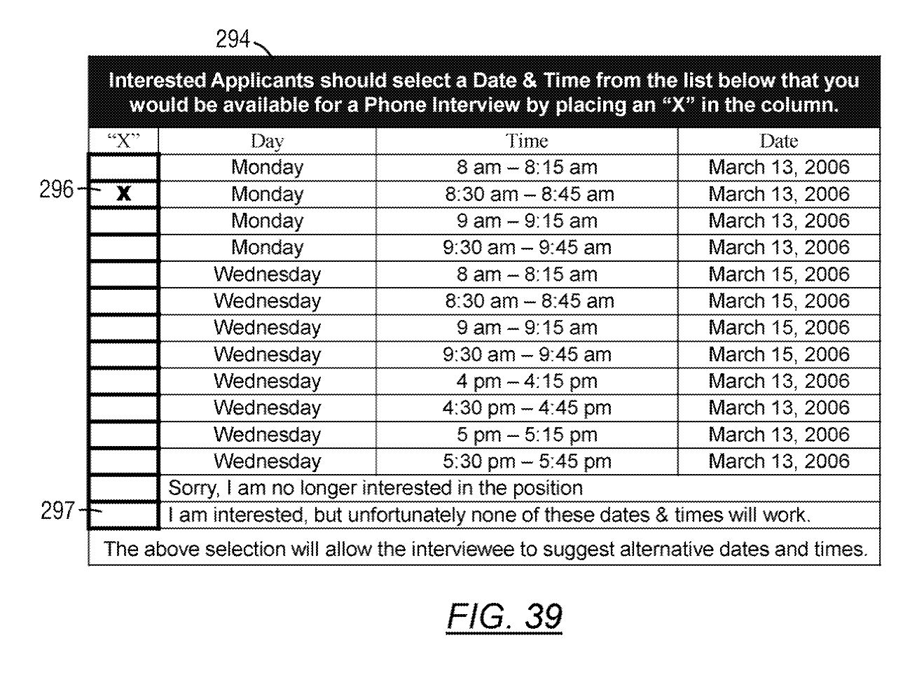

FIG. 39 depicts an embodiment of an example selection made by a particular Applicant/Candidate using the Interview Scheduler. In this example the Applicant/Candidate has selected the time 8:30 am on Monday, Mar. 13, 2006. As the Applicants/Candidates select a date and time for an Interview, the System synchronizes with any other request and notifies each Applicant/Candidate that it may take a few minutes, say 30 minutes, to confirm that no one else has also selected that same Interview Time.

Once the preset amount of time and/or a sufficient amount of time has lapsed to confirm that no other Applicant/Candidate has selected the same time period, before this particular Applicant/Candidate, the System goes on to notify all appropriate parties, such as the PAM-MGR 50, Recruiter, Interviewer, Office Manager, Receptionist and Applicant/Candidate that an interview is now confirmed at the specific date and time and between whom will be in the interview process, along with the other information that was selected. This notification can be via email, mobile SMS/MMS, and/or applied to a Calendar program for all the parties involved.

After a date and time is selected from the list of offered dates/times that options is then removed from future lists generated and displayed for other Applicants/Candidates making a selection. An exception would be if there are more there is more than one Interviewer scheduled to conduct Interviews at that same time. In which case, the System will remove the available date and time when the known resources available have been exhausted, expired, and/or found to be in conflict with other calendar events, such as a meeting.

Should a NEED MGR., such as the Interviewer, schedule to participate in a particular Interview, and where the Applicant/Candidate asks to cancel and/or reschedule the Interview, the System would make Scheduling adjustments accordingly, keeping track of what dates/times are now again available for other Applicants/Candidates, offering what remaining dates/times are available for the Interview, and/or which Party cancelled/rescheduled. It could even email those who remained undecided with the new time that has opened up.

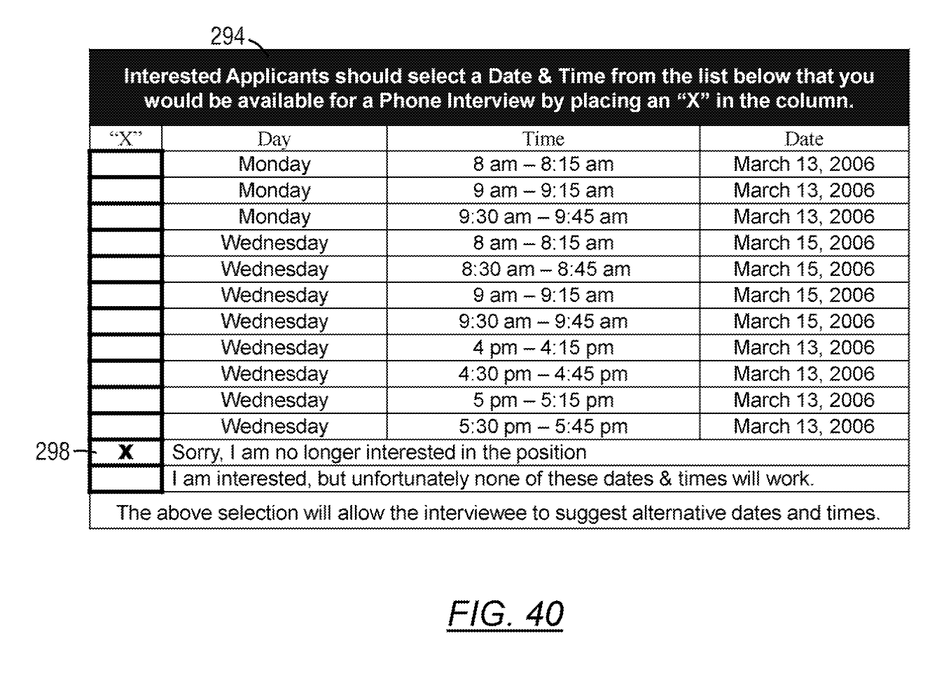

FIG. 40 depicts an embodiment of a response from a particular Applicant/Candidate who has selected “Sorry, I am no longer interested in the position”. The System would track at what juncture Applicants and Candidates typically leave the hiring process relative to his/her qualifications. This data is similar to how an eCommerce System on a website can track when and why an online shopper abandons a shopping cart. The System and its collected data will be helpful in accessing abandonment trends, and perhaps, modifications to the hiring practices of say, a particular Company, PAM-MGR 50, Recruiter, for a specific Job Category, Position, Salary, etc.

For example, data collected by the System might reflect that most Candidates tend to exit the hiring process even before the phone interview. Some investigating and/or A/B testing, where different hiring practices can be tested over time may reveal that the times being offered to Candidates were far too inconvenient or that the Company/PAM-MGR 50 was taking far too long to get back to the Candidates.

On the other hand, data collected by the System might reflect that most Candidates tend to exit the hiring process after coming for a face-to-face Interview. Here again, some investigating and/or A/B testing, where different hiring practices can be tested over time may reveal that Candidates are being asked to wait too long before getting into for their interview, and/or some other issue might become identified, such as: issues with how the Interview was or wasn't conducted by the Interviewer, or as minor as say, the map providing directions to the office was incorrect. Ideally, the System would collect any additional data as to why any particular Interview was cancelled or rescheduled, such as a conflict by the Interviewer and/or the Applicant/Candidate.

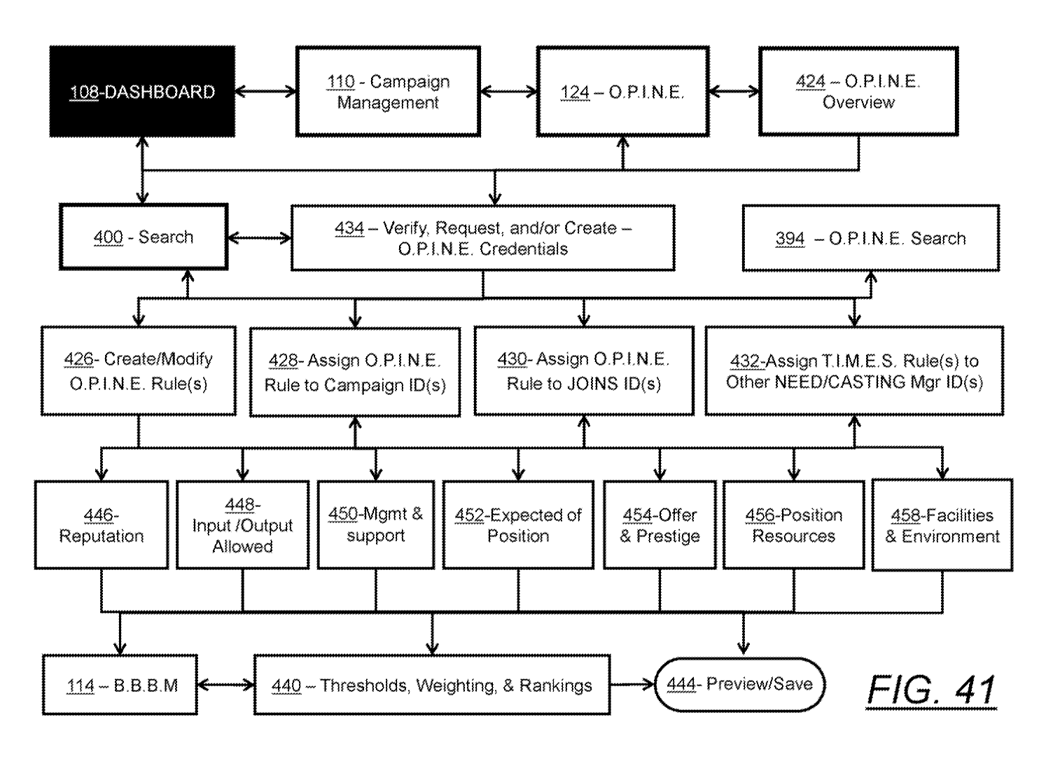

FIG. 41 is a flowchart that depicts an embodiment of an example of the process by which the OPINE Mgr 56 can utilize the OPINE 124 module. The role of the OPINE Mgr 56 is to create and/or manage when, where, how and which Applicants and/or Candidates can provide feedback as an OPINER regarding a Campaign, the Company, the brand, the management team and/or the like. The Campaign Management 110 function is accessible from the Dashboard 108 and from the Campaign Management 110 function, an Account 60 user can access the OPINE 124 and in turn a OPINE Overview 424 that explains the purposes and functionality of using the OPINE 124 module. A Search 400 function allows for overall search and for searching for existing Campaigns 103, Campaign 103 elements and/or other features such as functionality explanations based upon the Account 60 users current role and permissions.

A “Verify, Request, and/or Create O.P.I.N.E. Credentials” 434 function screens and educates the user of what functionality his/her role and permissions has in terms of access and limits. Generally, the proper role for utilizing the OPINE 124 module is the OPINE Mgr 56 and/or someone with at least the same permissions levels as those that are assigned by the default settings to the OPINE Mgr 56 role, by say the CAA 48. Depending on how the particular Account and/or CAA 48 decides to set up the OPINE 124 module, user's who try to access the OPINE 124 module without the proper credentials and/or permissions to view, create, modify or manage the OPINE 124 elements and rules, may or may not have permission to view, access, or utilize certain functions, Campaigns 103, and/or Campaign 103 elements.

A “OPINE Search” 394 allows users with the proper permissions to search for specific OPINE elements and/or features. A “Create/Modify OPINE Rule(s)” 426 function allows an Account 60 user to create a new OPINE 124 element and/or rule from scratch and/or select an existing OPINE 124 element and/or rule to modify and/or use as a template. An “Assign OPINE Rule(s) to Campaign ID(s)” 428, an “Assign OPINE Rule(s) to JOINS ID(s)” 430, and an “Assign OPINE Rule(s) to Other NEED/CASTING Mgr ID(s),” 432, each allow the Account 60 user with the proper permissions the ability to pick and choice where and how to apply existing OPINE elements and/or rule(s) and/or a newly created OPINE element and/or rule.

The Account 60 user can create and/or modify an existing OPINE Rule(s) utilizing a range of options such as a “Reputation” 446 module option, a “Input/Output Allowed” 448 module option, a “Management and Support” 450 module option, a “Expected of Position” 452 module option, an “Offer and Prestige” 454 module option, a “Position Resources” 456 module option, and/or a “Facilities and Environment” 458 module option.

The “Reputation” 446 module option is for selecting elements of an existing Campaign 103 to modify and/or allow Applicants and/or Candidates to give feedback regarding his/her perceptions of the Company's brand, product, marketing, team, management, a Recruiter, a specific advertisement, a specific job posting, and the like, say after each stages of the recruiting and/or hiring process. For example, starting with when the potential Applicant discovered the job opening, say as the Recipient via a job posting, Advertisement, Invitation, Recruiter, and the like; and then for each subsequent stage, for Applicants, Candidates, and so on.

For example, how the Applicant's perceptions changed along the path of subsequent interactions and relative to say the brand, product, marketing, team, management in-general, a specific person, a Recruiting Firm, a specific Recruiter, and the like. For instances, the Applicant could have had a very favorable view of the Company, brand and product, until he/she ran up against a particular CHOP-M MGR 58 or CATCH-M MGR.

While this change of heart/opinion may be relatively inevitable for some Applicants who do not get called back for another interview and/or get hired, over time and with sufficient quantities of measurable and discernable OPINER data, specific trends and issues came be identified. The OPINER and correlated data can also reflect practices and attitudes that may require some changes and/or at least specific internal review, say regarding specific Campaigns, actions, elements, rules, and/or users/people that can be measured and compared against others. And where feedback regarding say a specific CHOP-M MGR 58s and/or other CATCH-M Mgrs 59 can be compared to that specific NEED MGRs relative success of, say finding Candidates, CHOPs, and/or a CATCH against his/her collective or segmented OPINER feedback for such factors as say politeness, promptness, ability to explain the opportunity, willingness to answer questions, and the like. OPINER and correlated data could be relatively valuable at not only improving the likelihood for future successful hires, but the relative future success of the company, the brand, a community, and the like.

The “Input/Output Allowed” 448 module option is for selecting elements of an existing Campaign 103 to modify and/or allow Applicants and/or Candidates to give feedback, as the OPINTER, regarding the Applicants and/or Candidate's perceptions of his/her ability to have access to, say information, resources, and/or people that he/she would desire if he/she were hired. In addition, the Input/Output Allowed would ask the OPINER's perception of how his/her potential position interacts with others, and/or the OPINER's perception towards his/her ability to affect the direction and goals of the Company, the Company's brand, product, marketing, team, management, and/or whatever would be appropriate question, comment, feedback, and/or review subject for the particular position/role with the Company.

Over time and with sufficient discernable and measurable OPINER data, data correlations could be established between what are the appropriate expectations for a particular Position's Input/Output Allowed for, say base upon OPINER feedback from Candidates (Candidate OPINERS) who gone on to become measurably and relatively proven success CATCH stories, say based upon longevity with the company, productiveness, that OPINER feedback the provided the ability to find other successful Applicants/Candidates/Employees; cost savings, and/or revenues and profits generated overall; traceable and measurably attributable cost savings, and/or revenues and profits to a specific product, marketing campaign, segment of time, job functions, and/or the like. Where data correlations can also be related to the either specific OPINER feedback, a segment of OPINER feedback, the subsequent CATCHes following OPINER Feedback and/or changes made due and attributed to OPINER feedback.

For instances, after collecting and tracking the OPINER and correlated data of Applicants for a specific job, say Web Designer, for several years, the OPINER and correlated data could reveal that there is a measurable perception among Applicants who have qualified as Candidates, but who then later dropped out of the interviewing process early and/or does not get hired that the Company does not provide adequate client access to their Web Designer and where these Candidate OPINERs could be allowed to articulate the perceived deficiency, say where the historical data might measurable reflect, for instances: that 78 Candidates felt that the position's had to many management layers between the Web Designer's position and the outside clients hired by the Company; 66 Candidates felt that the Company did not allow its Web Designer enough creative freedom; and so on.

This collected Candidate OPINER data could be compared with historical data for other PACs, other locations for the same job, other companies (if available) and the like to see where and if improves can and/or should be considered. For example, adjustments in policies, might reflect that the perception among Candidates regarding too little creative freedom, has actually seen an improvement in the Candidate OPINER data over, say the last year, and that Candidate OPINER data could then be compared to see if the Company actually did or did not make any changes to the Web Designer's creative freedom. And if so, was a quantifiable link, say to hiring relatively better Candidates, having measurably happier Clients (through, say survey feedback), making relatively more revenue/profit or not.

The “Management and Support” 450 module option is for selecting elements of an existing Campaign 103 to modify and/or allow Applicants and/or Candidates to give feedback, as the OPINER, regarding his/her perception as to whether he/she would have the sufficient management support and his/her ability to work relatively well with the management to be successful, whether actually hired or not.

For instances, after tracking the feedback of Applicants (Applicant OPINERs) for a specific job, say for Field Sales, for several years, the Applicant OPINER and correlated data could reveal that there is a measurable perception among Applicants, who have later qualified as Candidates (now Candidate OPINERs), but who later dropped out of the interviewing process early and/or did not get hired—that the Company does not provide adequate and/or the proper sales/marketing materials to their Field Sales force. And where the Applicant OPINER and Candidate OPINER questions could allow the OPINERs to articulate the perceived deficiency, say where the historical data might show, for instances: 83 Applicant OPINERs felt that the position's boss would be difficult to work with, but where, say only 12 Candidate OPINERs said that the felt the same; 66 Candidate OPINERs felt that the Company's website needed significant updating, but where, say 30 Applicant OPINERs said the same; and so on. So the company can discern OPINER perceptions of Company issues and deceives and relative to stages.

In addition, it can reveal when information is being revealed to Applicants, when the OPINER and correlated data states, for example, that: 61 Applicant OPINERs were very concerned that the Company did not plan on supplying him/her with a laptop, but only 7 Candidate OPINERs were very concerned about the same. And where information later could reveal that the job post/Campaign typically mentions a company provided laptop, but that the Campaign did not this particular time/incident and/or that the 7 Candidate OPINERs who said that they were very concerned, had all interviewed with the same “NEED MGR A”, while others interviewed with other NEED MGRs. And where “NEED MGR A” later shared with the company that he/she did in fact fail to mention the laptop to Candidates during the interviews, and/or actually thought that the position did not come with a laptop, when in fact it did. A traceable issue that can now be corrected going forward.

This collected OPINE data could be compared with historical data for other PACs, other locations for the same job, other companies (if available) and the like, to see where and if improvements can and/or should be considered. For example, if the desire for a laptop drops significantly, but the desire for, say a particular brand of smartphone or, say a particular brand of tablet-like PC, or similar; rises significantly, the Company can incorporate that OPINER and correlated data into its decisions and budgets.

The “Expected of the Position” 452 module option is for selecting elements of an existing Campaign 103 to modify and/or allow Applicants and/or Candidates to give feedback regarding the OPINER's perceptions of what is actually expected of him/her and/or of the particular position For instances, after tracking all the OPINER and correlated data for a specific job, say Account Receivables, for several years, the data could reveal that there is a measurable perception among Candidates, but who later dropped out of the interviewing process early and/or does not get hired that the Company expects the Candidate to perform functions that are not truly part of the position. The Candidate could be asked to elaborate what functions exactly he/she is concerned about and/or where he/she learned about that job/position expectation.

If for example, the information about the job/position expectation was actually incorrect, this collected OPINER and correlated data could reveal that there were, say mistakes/errors in either the original invitation to apply; an advertisement for the PAC/job; a subsequent test, survey, and/or interview; mentioned by a particular Company employee; mentioned by a Particular Recruiter; and/or the like. In addition, historical data may also reveal that errors similar to these are likely to be shared in reviews/comments by an Applicant and/or a Candidate who did not take the position to others, while other revealing issues may more likely come from actual hires in subsequent employee reviews and/or feedback mechanism, as periodic feedback surveys/polls and/or comments. Where the data can be collected and correlated to previous issues and/or concerns.

In addition, this kind of OPINER and correlated data can also reveal where a mistake is taking place in the recruiting path so that it can be corrected, if say found in the text description, and where a correction can be made. Then an email notification can go with the specific correction information to, say all Applicants or just existing Candidates, who may not be aware of the correction. Further, the correction along with the attributable data for who, why, when, and where the correction was needed could reveal if, say the error(s) appear to be a pattern among a particular CHOP-M MGR 58 and/or Recruiting firm. Where perhaps it's only one employee out of dozens at the Recruiting firm who is repeatedly making the error due to such things as misinformation, poor training, poor tools, inexperience, incompetence, and/or the like; but where it is consequently reflecting bad on the entire Recruiting Firms since he/she is the only Recruiting Firm employee currently working the Company's account/Campaigns.

The “Offer and Prestige” 454 module option is for selecting elements of an existing Campaign 103 to modify and/or allow Applicants and/or Candidates to give feedback regarding the OPINER's perceptions regarding the specific Offer and/or any specific Prestige he/she associates with the Offer of the particular position should he/she become the CATCH or not.

For instances, after tracking the OPINER and correlated data for a specific job, say a Chief Marketing Officer, for several years, the OPINER and correlated data could reveal that there is a measurable perception among Applicants who have qualified as Candidates, but who later dropped out of the interviewing process early and/or does not get hired that the Offer and/or the associated position Prestige was not what he/she expected and/or was hoping for from the particular position.

If for example, the Company had recently gone through relatively high number of Chief Marketing Officers when compared to either years previous, other divisions, similar companies, and/or companies in the area; this collected OPINER and correlated data could reveal that there were measurable concerns, comments, and/or feedback among the Candidates regarding the Offer, say in the salary, bonus, travel required, annual budget, and/or the Prestige perceived to be associated with the Company, brand, division, product/service, and/or specific job functions, say events, trade show appearances, marketing materials, web presence, and the like. In addition, historical data may also reveal that particular perceptions tend to flow with say the strength of the economy, the size of the Offer, and/or the strength of the company.

The “Position Resources” 456 module option is for selecting elements of an existing Campaign 103 to modify and/or allow Applicants and/or Candidates to give feedback regarding the OPINER's perceptions regarding the perceived resources available for a particular position. For instances, after tracking the OPINER feedback for a specific job, say a NFL football coach, for several years, the OPINER and correlated data could reveal that there is a measurable perception among Candidates, but who later dropped out of the interviewing process early and/or do not get hired; of what that Company/NFL-team has in terms of perceived available company and position resources.

If for example, the Company/Team had recently gone through relatively high number of NFL football coaches when compared to either years previous or other NFL teams; this collected OPINER and correlated data could reveal that there were measurable concerns, comments, and/or feedback among the Candidates regarding the availability of resources when compared to the Company's competitors, say in comparison to the overall coaches on-board, the salaries; training and locker room facilities; medical and weight training staff; recruiters on-board, recruiter salaries; film viewing rooms, technical equipment, tools and IT support; players on-board, player salaries, and the like. This historical data may reveal what particular resource is perceived to be in relative short supply, and/or relative to what other competitor(s), so the situation and/or the competitor can be assessed when measurable revealed.

The “Facilities and Environment” 458 module option is for selecting elements of an existing Campaign 103 to modify and/or allow Applicants and/or Candidates to give feedback regarding the OPINER's perceptions regarding the perceived Facilities and Environment for a particular position/PAC. For instances, after tracking the feedback of Applicants for a specific job, say for a Brain Surgeon, for several years, the OPINER and correlated data could reveal that there is a measurable perception among Candidates, but who later dropped out of the interviewing process early and/or does not get hired, what the Company/hospital has in terms of perceived Facilities and Environment.

This collected OPINER and correlated data could reveal that there were measurable concerns, comments, and/or feedback among the Candidates regarding the availability of high-tech equipment, cleanliness of the facilities, and the like when compared to competitors, say in the overall medical arena; the geographic area, or the hospital itself. This historical data may reveal what particular Facility and Environment issues are perceived to be in need of changes, repair, updating, short supply, and/or relative to what other competitor(s), so the situation and/or the competitor can be assessed when measurably revealed.

The OPINE Mgr 56 is responsible for making sure that all the required participants, Campaign 103 elements, and schedules coordinate and flow relatively logically and the system can display data relations, such as Gant charts and the like to help make sure all the necessary elements are accounted for and available for each PAC/PIN or NEED. For example, the OPINE Mgr 56 might have and/or request an outline of goals that the NEED wishes to accomplish for a particular PAC.

The system would track feedback suggestions, comments, surveys, polls, questions, answers, and the like made by users (OPINERs/JOINS/CASTING/NEED MGRs and the like), and user-input fields to continually improve further suggestions and minimize the number of required and/or likely adjustments needed to, say a particular job offer for a particular company in the future. In addition, the system would track exactly what subsequent edits were and were not made to the overall content relative to specific feedback, suggestions, and user-input fields to continually monitor, measure, and track for relative improvements. Where further suggestions could include a cost-benefit analysis and suggest the minimum number of required and/or likely adjustment needed for the best return on the invested time, money, resources and the like, relative any and all segments available. The system could also track and create exactly who suggested and/or made the changes. Customization can be personalized into many segments, such as: per OPINE Mgr, per Company, per Job Category, per Job Position, per PAC/PIN, and/or per Applicant.

The OPINE MGR 56 can setup up a Campaign to collect Applicant feedback regardless if they qualify as a Candidate and/or a CATCH. Consequently, the Company can learn such unique data points as who is more likely to qualify, who is most likely to give honest feedback, what feedback from who and at what stage is most relevant to say the revenues, profits, cost savings, client happiness, and the like. In addition, this OPINE feedback data can be collected over time from actual hires, over their time at the company, as his/her roles change, as the company changes, as the management changes, and/or when he/she leaves the company.

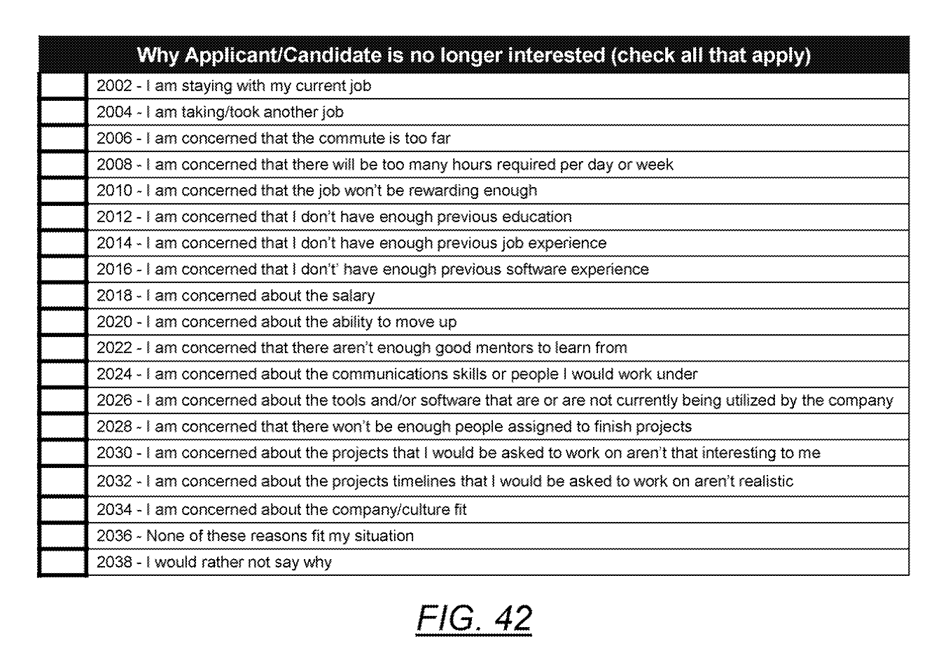

Depending on the conditions set by the OPINE-MGR, a particular Applicant could learn where he/she specifically fell short in the qualifications, why, and how they may correct the issue(s). A significant frustration shared by most Applicants, but where now the Applicant can make the necessary correction for the particular job, if applicable, and/or going forward. In addition the system is uniquely setup to collect OPINER data and correlations why the Company and/or job offer did not meet the Applicant's qualifications. As shown in the embodiment of FIG. 42 ahead, the Applicant could check off all the relevant replies as to why he/she is not interested in pursuing a particular PAC/PIN future.

As was the case for Applicants who responded to concerns about the Job Position he/she did not qualify for, here Candidates (those Applicants who did qualify) also can submit OPINR feedback that is collected and analyzed by the System. For example, collected OPINER and correlated data may reflect that Candidates who dropped out of the hiring process tend to point to the OPINER's concerns with say, “(14) I am concerned that there won't be enough people assigned to finish project(s)”, where that could reveal that either the Interviewer is failing to communicate the Company and/or project resources and team support that will be available, and/or there may truly be a measurable deficiency in, say people who are assigned to the project.

This OPINER and correlated data could prove highly valuable and show fluctuations in the public's on-going perceptions towards certain types of jobs, commutes, companies, etc. For example, OPINER and correlated data could reflect that engineers with more experience may be far more willing to work on the project (or take the position), than say, developers with relatively less experience. Some analysis could help determine that it would be relatively more fruitful and efficient to pay relatively more money to hire a developer with relatively more experience where the System data supports the fact that these relatively more experienced developers tend to get the job and/or projects done relatively well and on time when relatively compared to less experienced developers. On the other hand, the analysis could reflect that data has shown that it tends to be relatively far more fruitful and efficient to hire two developers with relatively less experience than to hire one with relatively more experience for this particular position/project, etc.

Over time, the System data would reflect success trends per Job Industry, Job Category, Job Position, Salary, City, Zip, etc. Such System data and correlations can help employers understand the current hiring trends among Candidates to do specific types of work, and even delineate the current desire for certain types of projects all under the same job position or with very similar job skill requirements. Just as with Applicants, over time, the System will be able to indicate whether this OPINER feedback data and trends from Candidates tend to be leading or lagging indicators, per each Job Category/Job Position; and the like.

The OPINER and correlated data from non-qualified Applicants helps NEEDs/Companies understand what areas they may need to improve, while building a powerful knowledge database with metrics regarding which job criteria elements continually prove to be the most difficult for Applicants, perhaps relatively too stringent or overly lax, and which criteria have proven to be relatively critical for maintaining quality hires. This System data helps create a powerful source of data for future Job Postings for the same particular Company/NEED-MGRs/Recruiter, and/or for other companies within the same industry or posting a similar position and the like.

In addition, if the Applicant shared why he/she was no longer interested in the Job Opening, the System could collected specific OPINER data as to why that was, say regarding his/her concerns and/or perceptions about the Company, the overall Team, a particular Team member, a lack of a Teamwork, lack of adequate resources, the particular Software being used, the overall Project being worked on, the portion of the Project he/she was being asked to work on, the timeline expectations, and the like. This OPINER and correlated data is valuable since it is arguably coming from someone who is less likely to have an agenda or bias than say, someone about to be hired, a current employee, a current software vendor, and/or a current client. And where data can be segmented per category to discern any bias per group and/or individual with a group/segment.

If all the non-qualifying Applicants and all the disinterested Candidates point to, say a different specific reasons as to why he/she was not interest in continuing down the interview/hiring process that would indicate a different circumstance, than say if the overwhelming majority of OPINERS pointed to one particular issue, say the “Concern about the Salary”. This OPINER and correlated data can become a strong indicator about issues that may need to be considered or addressed, where perhaps the salary is relatively too low or perhaps the pre-qualifications are relatively too high.

These OPINE module options 446, 448, 450, 452, 454, 456, and 458 are tracked and measured independently, and collectively as a unit against all data elements and relative to, say a particular Campaign, and/or Campaign 103 element to measure their effectiveness and success rates against different Campaign 103 elements, PAM Rules, MATCH Rules, TIMES Rules, ADSTATS Rules, DREAM Rules, Billing Rules, Budgeting Rules, Bidding Rules, Account Rules, and Real-time Reporting, elements and the like. The OPINE Mgr 56 can use a B.B.B.M. 114 module option to assign Billing, Budgeting, and Bidding Rules to the OPINE Rule(s).

A “Thresholds, Weighting & Ranking 440 module option can be set up to place a variety of weighting, prioritizations, and rules to the collective measurements and results. For example, a particular OPINE Rule ID for a particular Invitation Campaign 103 that allows Applicants to select his/her preferred method when and how to provide his/her OPINER feedback may be far more effective at attracting Applicant OPINER Feedback when relatively compared to another Invitation Campaign 103 that only offers a single method to provide OPINER feedback; and thus relative more weight could be applied towards placing Campaigns 103 with Invitation Campaigns 103 that allow Applicants to select his/her preferred method to OPINE (as the OPINER).

The HIRES 102 system measures a Campaign's success and this data can also be incorporated into the selection of a future Campaigns 103 for similar OPINE Rule(s) and/or OPINE Related Campaigns. A Campaign's relative success in attracting a relatively large pool of potential Applicants, Applicants who provide Applicant OPINER feedback, Candidates who provide Candidate OPINER feedback, and CATCHes who provide CATCH OPINE feedback, and the like; can also be measured and incorporated in the selection of future Campaign(s) and Campaign 103 elements by the OPINE Mgr 56.

Each new OPINE Campaign 103 could be set to run against previous OPINE Campaigns 103 in general and similar OPINE Campaigns 103 to track and validate to what degree that the new OPINE Campaign 103 is in fact performing relatively similar, or report back that it is off by a quantifiable amount and/or relative degree, and make suggested changes based on the areas (e.g. elements, content, rules, etc.) where the new OPINE Campaign 103 deviates from methods that are relatively proven more tried and true, so credit and changes can be suggested and/or made based upon measurable analysis and/or results. New and modified OPINE Rules resulting in OPINE Campaigns, such as invitations to provide OPINE feedback can be previewed against an existing OPINE Campaign 103 to see the results as would be seen in the PAC/PIN and/or saved with a Preview/Save 444 function.

FIG. 42 depicts an embodiment of an example list of potential reasons why a particular Applicant/Candidate may no longer be interested in the Job Opening, e.g. PAC/PIN. The example list of potential reasons where Applicant could check off all the relevant replies that he/she would like to include in his/her OPINER feedback. The OPINER Feedback, in this example list has check box options for an “I am staying with my current job” 2002 checkbox option, an “I am taking/took another job” 2004 checkbox option, an “I am concerned that the commute is too far” 2006 checkbox option, an “I am concerned that there will be too many hours required per day or week” 2008 checkbox option, an “I am concerned that the job won't be rewarding enough” 2010 checkbox option, an “I am concerned that I don't have enough previous education” 2012 checkbox option, an “I am concerned that I don't have enough previous job experience” 2014 checkbox option, an “I am concerned that I don't’ have enough previous software experience” 2016 checkbox option, an “I am concerned about the salary” 2018 checkbox option, an “I am concerned about the ability to move up” 2020 checkbox option, an “I am concerned that there aren't enough good mentors to learn from” 2022 checkbox option, an “I am concerned about the communications skills or people I would work under” 2024 checkbox option, an “I am concerned about the tools and/or software that are or are not currently being utilized by the company” 2026 checkbox option, an “I am concerned that there won't be enough people assigned to finish projects” 2028 checkbox option, an “I am concerned about the projects that I would be asked to work on aren't that interesting to me” 2030 checkbox option, an “I am concerned about the projects timelines that I would be asked to work on aren't realistic” 2032 checkbox option, an “I am concerned about the company/culture fit” 2034 checkbox option, a “None of these reasons fit my situation” 2036 checkbox option, and/or an “I would rather not say why” 2038 checkbox option.

Over time OPINER data, correlations and statistical data generated from the above selection of OPINER feedback options could reflect trends, such as Applicants/Candidates who tend to cancel also tend to have certain demographics and/or psychographic data in common, such as those who are relatively older in age or relatively younger in age to, say the CATCH. The OPINER data and correlations could also reveal such things as, Applicants/Candidates who are currently employed tend to reschedule relatively more often than those that are not. However, the System data may also reflect that those Applicants/Candidates that are employed currently tend to perform relatively better when compared to Applicant/Candidates who are currently unemployed.

The OPINER data and correlations might reflect, for example, that when “Interviewer A” of a particular Company tends to reschedule Interviews more often than all other Interviewers, he/she tends to not only take relatively longer to fill the position, but in addition, his/her CATCHes (hired Candidates) don't perform as well as relatively compared to other Candidates hired by all other Interviewers. However, the System data might instead reflect that Interviewer A, who tends to reschedule Interviews relatively more often than other interviewers, instead also hires the best performers relative to other CATCHes hired by other Interviewers, when incorporating selected measurement segments, such as the CATCHes time spent with the Company, ability to stay on budget (both in time and costs) and work routine performance reviews (e.g. monthly, annually).

Some investigating and/or A/B comparison testing of different hiring practice may reveal that some Interviewers with relatively heavy workloads (with measurable specific duties) are causing, say an Interviewer D to reschedule Interviews relatively more often than others. These other responsibilities could be temporarily and measurably pulled back or permanently and measurably reduced to see if it discernibly helps relatively minimize the number of rescheduled Interviews for a period of time and relatively the improve the output/data. If discernable, attributable, and quantifiable improvements become apparent, the System can generate and display the historical data to reveal where along the time and events path did the benefits become apparent, relatively significant, and what were the other data points in terms of the sample size, workload, events, resources, and the like. The System could also analyze the data against other hiring results to generate a list of suggested areas for review and/or changes for such things as the actual role participants, responsibilities, scheduling practices, workloads, budgets, resources, timelines, and the like.

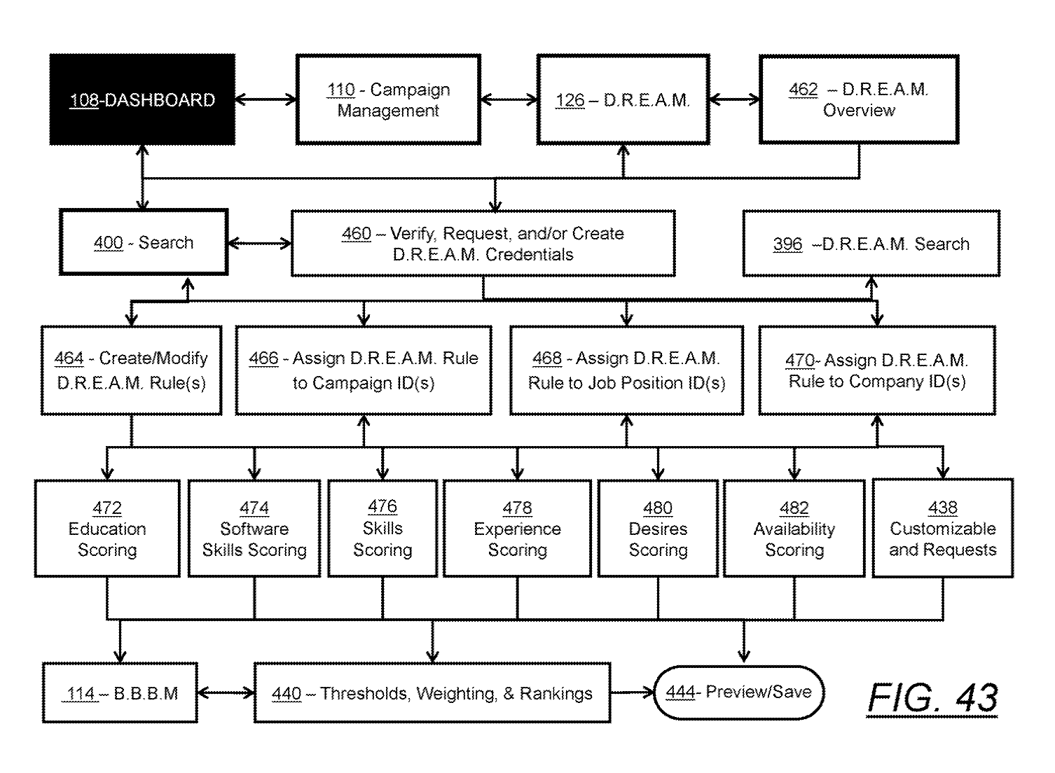

FIG. 43 is a flowchart that depicts an embodiment of an example of the process by which the DREAM Mgr 53 can utilize the DREAM 126 module. The role of the DREAM Mgr 53 is to create and/or manage the MATCH criteria collected for a particular PAC/PIN regarding the associated Applicants and Candidates. The Campaign Management 110 function is accessible from the Dashboard 108 and from the Campaign Management 110 function, an Account 60 user can access the DREAM 126 and in turn a DREAM Overview 462 that explains the purposes and functionality of using the DREAM 126 module. A Search 400 function allows for overall search and for searching for existing Campaigns 103, Campaign 103 elements and/or other features such as functionality explanations based upon the Account 60 users current role and permissions.

In this embodiment, the DREAM 126 functionality is relatively similar to the MATCH 120 functionality, but the MATCH MGR is responsible creating the job MATCH criteria before the Campaign is launched, and can even have a base of default criteria for each job position and postings. Whereas the DREAM MGR 53, in this embodiment, is responsible for any subsequent modifications to the MATCH criteria. The MATCH MGR and DREAM MGR 53can be two different people, the same person, a plurality of people who are MATCH MGRs, and a plurality of people who are DREAM MGRs 53, and where some people may or may not have overlapping roles and responsibilities. Some DREAM MGRs 53 may only handle certain functions, while others may only deal with a particular segment of job categories, and/or job positions.

A “Verify, Request, and/or Create D.R.E.A.M. Credentials” 460 function screens and educates the user of what functionality his/her role and permissions has in terms of access and limits. Generally, the proper role for utilizing the DREAM 126 module is the DREAM Mgr 53 and/or someone with at least the same permissions levels as those that are assigned by the default settings to the DREAM Mgr 53 role, by say the CAA 48. Depending on how the particular Account and/or CAA 48 decides to setup the DREAM 126 module, user's who try to access the DREAM 126 module without the proper credentials and/or permissions to view, create, modify or manage the DREAM 126 elements and rules, may or may not have permission to view, access, or utilize certain functions, Campaigns 103, and/or Campaign 103 elements.

A “DREAM Search” 396 allows users with the proper permissions to search for specific DREAM elements and/or features. A “Create/Modify DREAM Rule(s)” 464 function allows an Account 60 user to create a new DREAM 126 element and/or rule from scratch and/or select an existing DREAM 126 element and/or rule to modify and/or use as a template. An “Assign DREAM Rule(s) to Campaign ID(s)” 466, an “Assign DREAM Rule to Job Position ID(s)” 468, and an “Assign DREAM Rule to Company ID(s),” 470, each allow the Account 60 user with the proper permissions the ability to pick and choice where and how to apply existing DREAM elements and/or rule(s) and/or a newly created DREAM element and/or rule; and the like.

The Account 60 user can create and/or modify an existing DREAM Rule(s) utilizing a range of options such as an “Education Scoring” 472 module option, a “Software Skills Scoring” 474 module option, a “Skills Scoring” 476 module option, an “Experience Scoring” 478 module option, a “Desires Scoring” 480 module option, an “Availability Scoring” 482 module option, and/or a “Customizable and Requests” 438 module option.

The “Education Scoring” 472 module option is for selecting elements of an existing Campaign 103 to modify and/or create new criteria regarding the Education requirements. The “Software Skills Scoring” 474 module option is for selecting elements of an existing Campaign 103 to modify and/or create new criteria regarding the Software Skill requirements. The “Skills Scoring” 476 module option is for selecting elements of an existing Campaign 103 to modify and/or create new criteria regarding the Skill requirements. The “Education Scoring” 472 module option is for selecting elements of an existing Campaign 103 to modify and/or create new criteria regarding the Education requirements.

The “Experience Scoring” 478 module option is for selecting elements of an existing Campaign 103 to modify and/or create new criteria regarding the Experience requirements. The “Desires Scoring” 480 module option is for selecting elements of an existing Campaign 103 to modify and/or create new criteria regarding the Desire(s) requirements. The “Availability Scoring” 482 module option is for selecting elements of an existing Campaign 103 to modify and/or create new criteria regarding the Availability requirements. The “Customizable and Requests” 438 module option is for creating, assigning, and/or requesting new criteria that is not an option within the other six module options and assigning the criteria to the applicant from an overall perspective and/or relative to the job.

The DREAM Mgr 53 is responsible for making sure that all the required participants, Campaign 103 elements, and schedules coordinate and flow relatively logically and the system can display data relations, such as Gant charts and the like to help make sure all the necessary elements are accounted for and available for each PAC/PIN or NEED. For example, the DREAM Mgr 53 might have and/or request an outline of goals that the NEED wishes to accomplish for a particular PAC.

The system would track exactly what edits were and were made to the overall content, suggestions, and user-input fields to continually improve further suggestions and minimize the number of required and/or likely adjustment needed. The system could also track and create exactly who suggested and/or made the changes. Customization can be personalized into many segments, such as: per DREAM Mgr, per Company, per Job Category, per Job Position, per PAC/PIN, and/or per Applicant.

In an embodiment, the DREAM MGR 53 can setup up a Campaign for find a resource that has not a human, but instead a material, element, or part required for a particular project, product, and/or event where instead of Applicants applying for a particular job, the Applicants are representing his/her part, product, and/or service to fulfill the resource be requested and/or sourced. In the same manner where Applicants become qualified or Candidates, the same process would take place for those parties representing his/her particular product or service that qualified as a Candidate and eventually a CATCH.

For example a user could request, say a book about some legal issue, say with a query such as: “How to Convert a C-Corporation Back into a S-Corporation” or different user could request a book about making money with, say a query with: “How to Market My Babysitting Practice” where the NEED/MATCH-MGR in this instance would create a list of minimum criteria for the book, say where the book must have been published within the last five (5) years and have sold some specific number of copies; and/or contain some keywords.

Then the DREAM-MGR, who could be all the NEED-MGRs in this example, could check the DREAM results daily, and/or setup a request whereby the System notifies him/her when either a new title hits the list, and/or when a set number of titles meet the criteria/qualifications. In addition, the NEED-Mgr could set parameters to adjust the MATCH criteria relatively higher or lower to meet a set number of qualified book (book Candidates), say where the MATCH criteria now allows anywhere from three (3) to fifty (5) book Candidates where that criteria adjustment can show the NEED MGR in real-time how many more book Candidates are generated and/or continue to track for new releases. In addition, there could be a MATCH criteria for a completion time, say within a set period of time of three (3) hours, or instead twenty (20) days.

In another embodiment, the system could be utilized to locate a human, but not as an employee, but say for a date or a relationship. Here the user interacts with the NEED 82 and HIRES 102 to establish dating MATCH criteria for Candidates and where he/she can setup specific requirements, rules, and his/her own test questions to be utilized in a “virtual video interview” (VVIV) with Applicants. Applicants could request to take the VVIV from the System in general, where it asks many commonly requested MATCH criteria questions, and/or request to specifically take a particular VVIV a particular NEED MGR (someone looking to date). Interviews with the exact same and/or similar questions could also be normalized to become combined (automatically, and/or by permission from the NEED MGR) to reduce redundantly asking Applicants the same questions.

For instance, one woman (a “woman A”) may have submitted 5 questions for a potential dating-partner (Candidate), while another woman (a “woman B”) may have submitted 10 questions, and where 3 questions overlap between the women A and B. When prospective dating-partners/men answer a series of questions, each potential dating-partner/man could actually answer dozens of questions from a number of different woman, and where the questions and subsequent answers are split up and matched with the criteria requested per woman.

The VVIV video generated in response(s) to all the questions asked of the Applicants could be segmented into video clips (VVIV clips) per, say answer, gesture, and/or interview. These split up answers and subsequent VVIV clips could also incorporate meta-tags that reflect Peer and/or Expert feedback/reviews of the answers and/or of the person (Applicant) while answering the question.

In addition, the women in the above example could send out invites to friends (as a specifically defined Peer Group/segment) to request their feedback and/or reviews where the all VVIV clips could be playback sequentially per potential dating-partner or where the VVIV clips are played for all potential dating-partners per question/answer. The VVIV clips could be reviewed by a plurality of reviewers utilizing a scoring system with continuums, say with ten separate Lickert-like units from “very appropriate response” to “not a very appropriate response”. The system could also look for similarities in interview questions from different NEED Mgrs where the responses could then be reviewed, say once, instead per each NEED Mgr request.

Further, each woman (NEED MGR) can set up a variety of perimeters for who does and doesn't qualify as, say an Expert for Expert Review. So the woman could setup one Expert Review qualification segment/group of anyone who is a licensed clinical therapist, who has been licensed for more than five (5) years, and specifically deals in couple therapy. And another Expert Review qualification segment/group of anyone who is a woman who is divorced with kids and living in the city of San Francisco, Calif.

In this example, the woman could compare the reviews of the two Expert groups, along with the differently defined Peer groups of say, one for “close friends”, one for “family” and another for “my kids”, where the woman could then compare the feedback, reviews and opinions of all these segmented parties to see who and to what degree the parities agree and disagree regarding a potential dating-partner. Further these assessments can also be compared to the non-human computerized tools for assessment. The woman (NEED Mgr.) could even setup a particular Expert group of all the potential dating-partners or Candidates to rate each other.

In addition, the potential dating-partner answers in the come in a multitude of formats, and not necessarily video and/or audio. So the Peer and Expert review may be of text-based answers and/or check-boxes to questions used in general and/or created by the woman (NEED MGR). Depending on the conditions set by the DREAM-MGR, a particular Applicant could learn where he/she or a resource specifically fell short in the qualifications, why, and how they/it may correct the issue(s).

Returning to the DREAM 126 in FIG. 43, where the DREAM 126 and correlated data created over time, would reflect success trends per Job Industry, Job Category, Job Position, Salary, City, Zip, etc. Such data correlations can help employers understand the current hiring trends among Candidates to do specific types of work, and even delineate the current desire for certain types of projects all under the same job position or with very similar job skill requirements. Just as with Applicants, over time, the System will be able to indicate whether this feedback data and trends from Candidates tend to be leading or lagging indicators, per each Job Category/Job Position.

These DREAM module options 472, 474, 476, 478, 489, 482, and 438 are tracked and measured independently, and collectively as a unit against all data elements and relative to, say a particular Campaign, and/or Campaign 103 element to measure their effectiveness and success rates against different Campaign 103 elements, PAM Rules, MATCH Rules, TIMES Rules, ADSTATS Rules, OPINE Rules, Billing Rules, Budgeting Rules, Bidding Rules, Account Rules, and Real-time Reporting. The DREAM Mgr 53 can use a B.B.B.M. 114 module option to assign Billing, Budgeting, and Bidding Rules to the DREAM Rule(s).

A “Thresholds, Weighting & Ranking 440 module option can be set up to place a variety of weighting, prioritizations, and rules to the collective measurements and results. For example, a particular DREAM Rule ID for a particular Campaign 103 where the DREAM MGRs 53 modified a particular DREAM and/or MATCH criteria and was relatively more effective at attracting Candidates, a CATCH and/or the like when relatively compared to the same Campaign 103 where the MATCH and DREAM criteria where not adjusted; and thus more weight could be applied towards placing Campaigns 103 with the modified DREAM and/or MATCH criteria.

The NEED 82 and the HIRES 102 system measures a Campaign's success and this data can also be incorporated into the selection of a future Campaigns 103 for similar DREAM Rule(s) and/or DREAM Related Campaigns. A Campaign's relative success in attracting a relatively large pool of potential Applicants, Applicants who score well within the DREAM, Candidates who score well within the DREAM, and Candidates who become CATCHes; can also be measured and incorporated in the selection of future Campaign(s) and Campaign 103 elements by the DREAM Mgr 53.

Each new DREAM Campaign 103 could be set to run against previous DREAM Campaigns 103 in general and similar DREAM Campaigns 103 to predict, track and validate that the each new DREAM Campaign 103 is in fact performing relatively similarly to predictions, or report back that it is off by a quantifiable amount and/or relative degree, and make suggested changes based on the area where the new DREAM Campaign 103 deviates from methods that are relatively proven more tried and true, so credit and changes can be suggested and/or made based upon measurable results. New and modified DREAMS Rules resulting in DREAM Campaigns, such as Goal scores selected for the DREAM can be previewed against an existing Campaigns 103 to see the number of Applicants and Candidates that would actually qualify/results and/or the System can make future predictions based on historical data where the predictions are tracked and reported. The Dream Mgr 53 can view and/or save the changes and modifications with a Preview/Save 444 function.

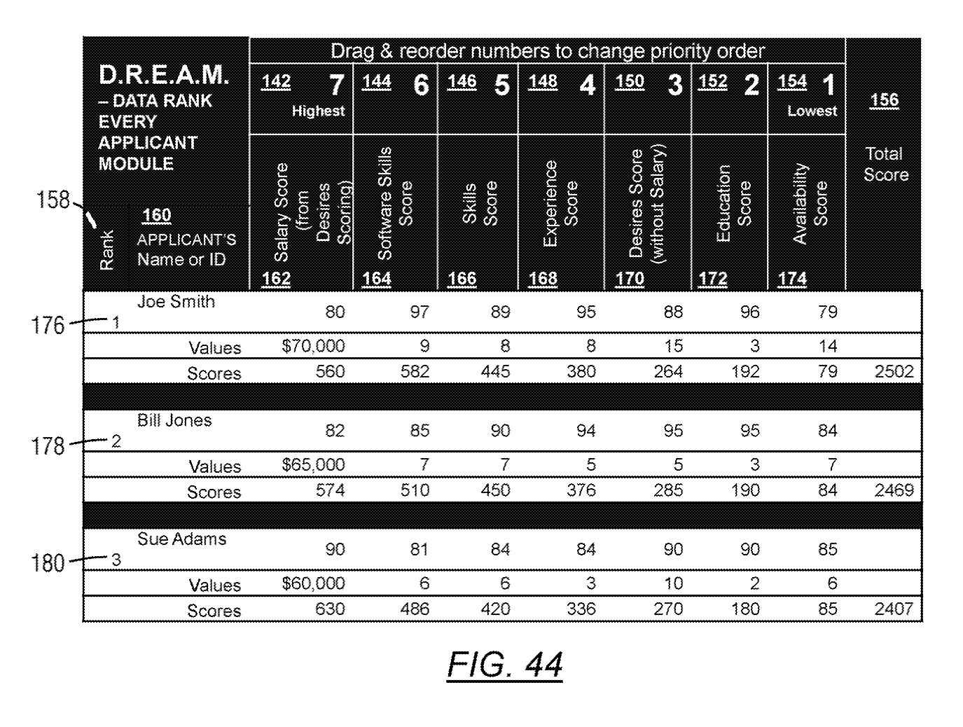

FIG. 44 is an embodiment of an example screenshot of the DREAM user interface depicting a list of Applicants that have been prioritized and ranked based on conditions that have been established by the MATCH-MGR/Recruiter and/or Interviewer. In this example, there are 7 components to qualifying as a Candidate for this particular job opening, starting with the most important component a “Salary Score” 162 section/column, next a “Software Skills Score” 164 section/column, next a “Skills Score” 166 section/column, next an “Experience Score” 168 section/column, next a “Desires Scores (Without Salary) 170 section/column, next an “Education Score” 172 section/column, and last an “Availability Score” 174 section/column, followed by a “Total Score” 156 section/column.

Each section column has an associated rank in areas 142, 144, 146, 148, 150, 152, and 154, where the user can drag and reorder the numbers to change priority order. Currently, the “Salary Score” 162 section/column is most important component, but it could be dragged to lower position, and/or a new component could added placed in front of this component.

In this DREAM qualification scoring example, where “Salary Score” is consider the most important component for qualifying for this job position/opening, the System has been setup to ask each Applicant, either what is his/her current salary (a set amount or range), what is his/her salary expectations (a set value or range), and/or some combination of these values. The Applicant can also be asked to select from a list of predefined values, and/or predefined salary ranges, e.g. (a) a range less than $60 k, (b) somewhere between $60 k to $70 k, (c) somewhere between $70 k to $80 k, (d) somewhere between $80 k to $100 k, or (e) a range of more than $100 k.

Depending on conditions setup in advance by the Company, the Applicant receives points regarding his/her answer(s) to this/these question(s). The salary question could be as simple as put in the salary you expect annually from this position, where the calculation could be set to calculate how far off is the Applicant.

For example, the Applicant states that they would expect $80 k for the position and they company was looking to pay $75 k. Depending on the scoring conditions selected by the MATCH-MGR 51, the System could calculate a number of scoring results with these two values.

For one scoring System condition example, the System could be preset to simply divide the salary being offered by the Company by the salary being sought/requested by the Applicant. In this case, $75 k/$80=88% and score the salary at 88 out of a scale of 100 for the Salary Score. For values, where the Applicant requested a salary less than what's being offered, say $65 k, the calculation would first take the value of $75 k/$65 k=1.15% and subtract the value of 2 from the total to get 85%.

The System could have conditions set by the MATCH-MGR 51, where a number of factors go into a total score and where the total score would max out at 100 and go as low as zero for each category shown by the “Salary Score” 162 section/column, the “Software Skills Score” 164 section/column, the “Skills Score” 166 section/column, the “Experience Score” 168 section/column, the “Desires Scores (Without Salary) 170 section/column, the “Education Score” 172 section/column, and the “Availability Score” 174 section/column.

Continuing with the example depicted in FIG. 44, a particular Applicant “Joe Smith” and his correlated data section 176, ranks above an Applicant “Bill Jones” with his correlated data section 178, and the Joe Smith ranks two above an Applicant “Sue Adams” and her correlated data section 180.

For the Applicant's “Desires Score” the Applicant could utilize a Lickert scale to score and/or rank several factors, say from zero to one-hundred or simply prioritize a list of factors in the order he/she believes are most important to them. One example of such a list (not shown in figure) might contain the following fifty items to prioritize:

1) Salary

2) Bonus and commissions (size, time table, realistically achievable, etc.)

3) Equity plan (ownership, strike price, vesting schedule, restrictions and value)

4) Size of department budget

5) A dedicated secretary or assistant

6) Size and type of your designated work space (enclosed office, size, furniture, view, desk, chairs, storage, etc.)

7) Tools provided (software/applications, desktop PC/monitors, Internet access, laptop, desk phone, cell phone, company car, etc.)

8) Adequate staff under you for job requirements

9) Location of office and commute time

10) How successful is the company and how well funded for the next 3 5 years

11) Ability to hire, manage, and fire own staff

12) Dedicated IT people

13) Clearly defined role, timeline, and responsibilities

14) Hours expected to work per day, per week, per year

15) Type and amount of insurance benefits: health, dental, eye, prescription drugs, co pay, PPO, etc.

16) Level of decision making allowed that directly effects personal income and ability to obtain incentive pay/bonuses

17) Size of expense account allowed (e.g. marketing, travel and entertainment)

18) Timely accounting (Payroll, reimbursements to you, employees, clients, others etc.)

19) Clearly defined company focus and value proposition

20) Size of company contributions on your 401k plan

21) Vacation time, sick pay, and comp time provided

22) Ability to obtain industry recognition with trade show panels

23) Likelihood company will move offices or city located

24) Parking (location, who pays for it, assigned, proximity, after hours, light)

25) Level of decision making allowed that directly effects department success

26) Respect for department talent/employees

27) Level of decision making allowed that directly effects company direction

28) Company's past reputation for honesty and integrity with employees

29) Company's past reputation for honesty and integrity with clients

30) Company's past reputation for delivering on time

31) Company's past reputation for quality and value

32) Quality and quantity of staff you inherit

33) Likelihood the company could be sold before your stock vests

34) Likelihood the company doesn't switch it's focus

35) Performance expectations and deliverables

36) Seniority within organization

37) Respect for upper management

38) Respect for other management

39) Respect for other talent/employees

40) Responsiveness from management (direction and contracts)

41) Work friendly and clean facilities: (AC on if working weekends, bathrooms clean and near offices, kitchen, waiting room)

42) Ability to learn unique skills or technology

43) Ability to meet new contacts

44) Travel requirements (Some like travel, others dislike it)

45) Size and type of office facility as a whole (besides your office)

46) Work environment and corporate culture

47) Prestige of title with position

48) Prestige of work preformed or accomplished

49) Office proximity to other things (clients, restaurants, schools, etc.)

50) Prestige of company's brand name

The system could then generate a score based upon the data collected above that was in comparison to other applicants, other candidates, and/or incorporate what the MATCH MGR and/or DREAM MGR felt should be most important to least important.

In an embodiment, the DREAM module, can be setup by the TIMES-MGR and/or MATCH-MGR to contact all applicants and/or a subset of Applicants who have answered certain questions within a certain present range of replies and/or where the email replies depend on pre-set conditions, such as whether the Applicant:

1Does or does not fit the profile and/or criteria sought by the Company/MATCH-MGR

2Has or has not properly completed the questionnaires and submitted all materials requested

If the Applicant failed to complete all questionnaires, a particular questionnaire, criteria, and/or failed to submit some materials such as a resume (or in the proper format), and/or within a necessary timeframe, the System can be set to send a notifications, say via an email with a designated link with required follow-up.

For example, the System could request that a particular Applicant complete the missing materials because otherwise they would have qualified as a Candidate. This request may or may not include a specified deadline for competition. The System can then track how well the Applicant follows the request/rules set by the MATCH-MGR, whether he/she does end up qualifying as a Candidate, and stores all the associated data for future research, reports, and data correlations regarding Applicants who fail to complete the questionnaire.

For example, people who tend to forget to attach his/her resume, a less like to qualify later than those Applicants that do when it comes to hiring, say an Office Manager. On the other hand, maybe the data will illustrate that relative to other qualifying issues, forgetting to attach one's resume reflects little regarding likelihood of that Applicant to qualify as a Candidate for a specific position. All these data correlations can be pulled into the final decision making for the specific hire from all the Candidates, and for future hiring scenarios.

When the survey is completed by a number of Applicants, and where some Applicants do not meet the criteria for the Job Opening, the System can send an email thanking the Applicant for applying, but that unfortunately he or she has not been selected. Response letters to Applicants can be generated from the data to explain specific reasons why. The Job Seeker can also decide if he/she would like to explain where and how the Applicant was deficient and if the company would consider the specific Applicant, should the conditions be changed.

For example, if the Applicant met most if not all, but one relatively minor component, such as the ideal commute distance set initially by the MATCH-MGR. The System could be setup to notify such an Applicant that he/she would qualify for then next step, say an interview, but that the Company would first like a confirmation regarding the Applicant's willingness to commute the required distance before proceeding.

This data will also support valuable commute correlations. For example, between specific zip codes, a range values reflecting the willingness of Applicants to commute from a specific zip code and a specific zip code; a range of values reflecting the willingness of Applicants to commute to a specific zip code (and/or a range of distances) for specific industries/job categories/job positions; a range of values reflecting the willingness of Applicants to commute a range of distances for specific company, salary, project, work schedule, benefit package, etc.; and/or some combinations of these elements.

This data could prove highly valuable and show fluctuations in the public's on-going perceptions towards certain types of jobs, commutes, companies, etc. For example, data collected could reflect that engineers with similar skills sets have responded that they are far more willing to commute longer distances for positions that have are for developing computer games or mobile applications, than these engineering Applicants are for positions that are for website development. Over time, this data may reflect that the willingness to commute for job developing computer games is moving up well above mobile applications, or it may instead, reflect the opposite and the willingness could be moving down towards website development.

Such data correlations can help employers understand the current perception among Applicants to do specific types of work, and even delineate the current desire for certain types of projects all under the same job position or with very similar job skill requirements. Over time, the System will be able to indicate whether these data trends tend to be leading or lagging indicators, per each Job Category/Job Position.

For a particular Job Opening that gets posted by the PAM-MGR, he/she may find that relatively few people are proving to be qualified by the conditions pre-selected and/or due to some other cause, such as a highly-competitive job market currently, relative to previous times a similar job was posted. Data correlations could show that Job Posting with the same Qualification tend to get filled in a certain number of days, a certain times of year, when other potential causes can be measured and correlated against the range of times to took to fill the position.

For years, NEED-MGRs, Companies, and Recruiters have been challenged to quickly quantify who is qualified and who is not, for specific positions, especially in a timeframe that is most expedient for both the Company and the potential Candidates. The Skillustrate System also helps distinguish which Applicants may have qualified, but for a relatively minor issue (using comparative data), from those Applicants that fall well short of the pre-selected criteria (or previously used criteria). This helps prevent the Company from missing out on talent due to potentially over rigorous and/or unrealistic, pre-select criteria.

Seasonal trends may reflect a need to adjust pre-select criteria based on different times of year, or other conditions, such as the need to fill more than one Job Opening with the same type of Candidate. All collected data points that System will track relative to time, where time can be measured in such things as years/days/hours/minutes regarding the length of time it took before:

1) A pre-set number Applicants Applied for a specific Job Opening

2) A pre-set number of Applicants became Candidates

3) A pre-set or total number of Candidates were phone interviewed

4) A pre-set or total number of Candidates were interviewed in person

5) A pre-set or total number of Candidates were interviewed in person twice

6) A pre-set or total number of Candidates who had his/her references reviewed

7) A pre-set or total number of Candidates who had his/her background or credit reviewed

8) A selected Candidate was offered the position

9) The selected Candidate accepted the position

10) The selected Candidate had his/her drug test or similar pre-job qualification test

11) And the selected Candidate started the job.

In addition, the length of time the Candidate stayed with the Job and/or the Company going forward. All of this data can create correlations for comparing changing job trends.

For example, during the months of July, August, and September the data may reflect that a given company can obtain at least 10 qualified Applicants or Candidates for a specific Job Position, say a Flash front-end developer position, typically averages 9 days, whereas the same position at the same company, typically averages 16 days during the months of November and December. And the trend could be track to see if it's being maintained, how it correlated to other known data, such as new software releases by the Adobe Flash®, the stock markets, the economy locally, the overall economy nationally, the economy for the specific industry the company belongs within, etc.

In another embodiment, the System can also provide the Company, the PAM-MGR (and/or the DREAM MGR), and the Recruiters with a way to sort and rank unqualified Applicants as to the number of short-comings (or deficiencies) and to what degree for each short-coming. This helps the PAM-MGR and others see exactly which components of the current criteria most Applicants are falling short on and to what degree. For example, say the System reflected that most Applicants are falling short in regards to having a four-year degree specifically required in Computer Science. The PAM-MGR can then review what Applicants did have regarding a degree and/or related education.

Furthering the example, say an “Applicant A” had a Bachelor's Degree in Information Systems, while another “Applicant B” may only have two years of college towards their Computer Science degree. The PAM-MGR can manually select individual Applicants from the report to contact as may qualify, based on certain condition. The MATCH-MGR could instead decide to change the pre-qualify criteria to incorporate these Applicants now as Candidates.

Should the MATCH-MGR decide to change the pre-qualifications required to become a Candidate, the TIMES-MGR can decide to go back and contact those who have applied and now qualify and/or only use those setting going forward. The TIMES-MGR can have the System email these Applicants who are still unqualified and provide a means to correct a particular issue or issues, and/or have the Applicant establish why the specific issue(s) are relatively immaterial and allow the Applicant to expand on why and how he/she has the ability to overcome the issue(s) to become a Candidate.

For example, an Applicant is notified that they lack a four year degree in Computer Science and their survey answer reflected that they have less than two years in Computer Science. The Applicant might reply that they have had eight (8) years of what they believe to be equivalent on-job experience working in the same field, or they may explain that they actually have a four year degree in another similar program, and have gone back for the Master's in Computer Science and have less than a year to complete. Now the PAM-MGR can determine on a case by case basis, and/or suggest modifications to the survey to allow for such conditions and improve recruiting in future to the MATCH-Mgr.

After the PAM-MGR select which questions to ask the job Applicant a DREAM-MGR then ranks the importance of each question, starting with the most important question and prioritizing the rest downward. The answers to these questions then creates a spreadsheet which ranks the Applicants according to the criteria setup by the DREAM-MGR, but the order of the questions in the survey may or may not be placed in the priority order specified by the DREAM-MGR. This allows the DREAM-MGR to keep the priority criteria confidential and will help prevent Applicants from ‘gaming the system’.

After the DREAM-MGR has created the list of questions and listed the priority for hiring criteria, the System generates a Preview of the text ad that the DREAM-MGR can then post on any website. There may or may be a fee, but generally this base service is provided by the System for free. The DREAM-MGR can add or modify the associated text as he/she wishes. For example, the DREAM-MGR may want to add a description about the company and its history or tell about the type of people, culture, or atmosphere within the company.

The DREAM-MGR can get more value out of the System, by not only using the automatic text generated to create Job Postings for specific job types, but he/she can also use the following modules:

1) M.A.T.C.H. 120

2) T.I.M.E.S. 122

3) D.R.E.A.M. 126

Four General Sections (generally used for all job openings), regarding Applicant's:
1 Salary Expectations (generally expressed in dollars per year or per hour) e.g. $45,000 per year or $22/hour
2 Commute Distance to Job (generally calculated from Applicants home address zip code)

e.g. Applicant supplies his/her home zip as 91406 and the Job zip is 90405, so the commute distance is then calculated and stored as: 17.32 miles
3 Education (generally expressed as the last year of education completed)

a. High School

b. Some College

c. Two Year Degree

d. Four Year Degree

e. Post Graduate Degree

f. Other Education/Programs

g. Other Equivalency Testing (e.g. GED®, CLEPs®, LSAT®, etc.)
4 Availability, generally expressed as:

a. Employed, but Available full-time in less than seven days (each job candidate can be more specific)

b. Employed, but Available full-time after I give my 14 days notice (each job candidate can be more specific)

c. Available Immediately for Full-time

d. Available Part-time or as an Independent Contractor: Weekends and nights (each job candidate can be more specific)

e. Available Part-time or as an Independent Contractor: Specify days/times/limitations

f. Other (each job candidate can be more specific, e.g. must be able to work from home, willing to travel, etc.)

Three Job-Specific Sections, regarding Applicant's:
5 Job Related Experience (generally expressed in terms of a specific industry, company, role, per a certain number of years and months)

e.g. Online auctions, Ebay®, Lead Software Architect, 3.5 years of job related experience
6 Software and PC Skills
7 Job Related Skills

In another embodiment, the DREAM 126 can allow for manual and/or automatic adjustments to the criteria regarding what makes a candidate from the preset specific criteria to instead allowing the top “X” percent, say ten (10%) percent or an absolute number of applicants, say twelve (12) and/or based on additional minimal criteria where the pool of candidates can be expanded to meet the percentage or absolute number, but with the exception of, say must have a Bachelor's Degree in Computer Science or whatever that minimum criteria setting includes.

In another embodiment and example, a job has a strict line of eight (8) criteria elements, but after five (5) days the NEED looks at the DREAM to see how many applicants qualify as candidates and can make adjustments automatically based upon preset rules and/or be done manually where Boolean operators can say such things as, if less than three (3) applicants qualify, reduce specific criteria, by specific increments until there are at least ten (10) candidates, as long as the criteria does go below “Y” baseline. Here the criteria scores for, say Software Skills can be lowered until the target of ten (10) candidates is met. In addition, these adjustments to change the pool side of qualified candidates can be adjusted in both direction, so not only to increase the pool, but to reduce the pool size of qualified candidates.

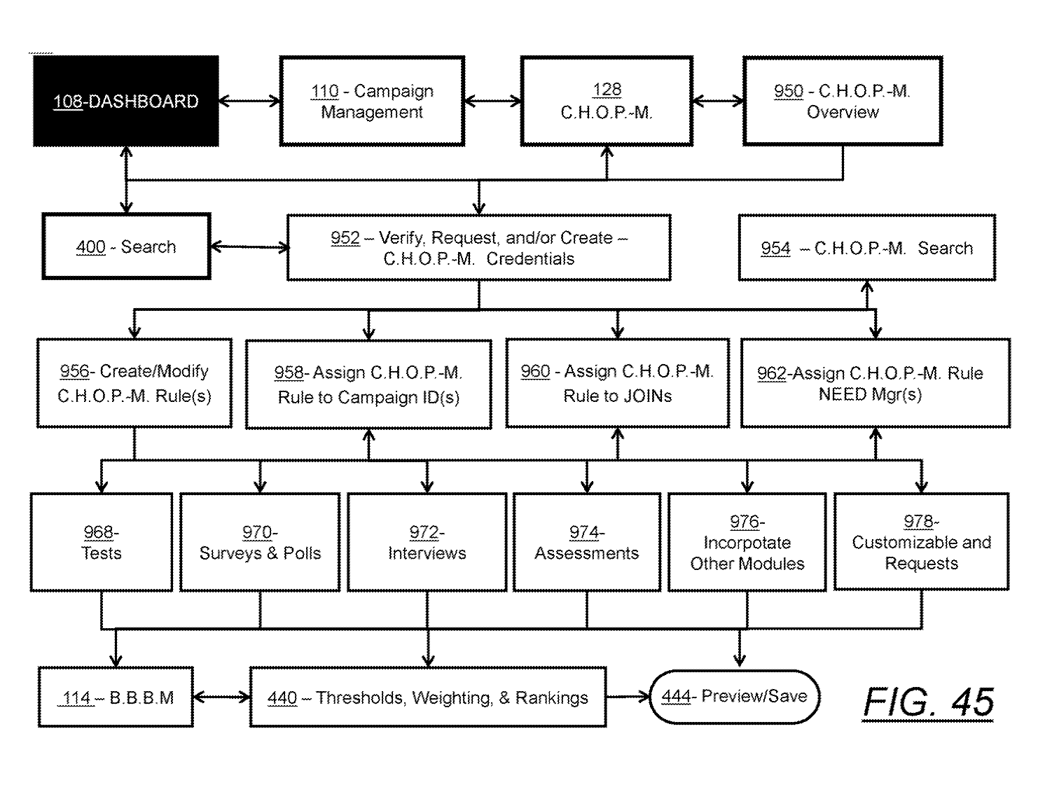

FIG. 45 is a flowchart that depicts an embodiment of an example of the process by which the CHOP-M Mgr 58 can utilize the CHOP-M 128 module. The role of the CHOP-M Mgr 58 is to create and/or manage the surveys, tests and/or interviews and all the necessary content. The CHOP-M Mgr 58 is also someone who typically creates and manages the questions, surveys, and polls; and he/she typically conducts all or some of the interviews for a Campaign. In some cases, there are multiple CHOP-M MGRs, where some NEEDs 82 may setup delineated responsibilities, while other NEEDs may allow and/or require overlapping responsibilities, not only between the CHOP-M MGRs, but among other NEED MGR roles, where the CHOP-M MGR may be all other NEED MGRs in one, or, say both the CHOP-M MGR and the CATCH-M MGR who makes the final CATCH selection.

The Campaign Management 110 function is accessible from the Dashboard 108 and from the Campaign Management 110 function, an Account 60 user can access the CHOP-M 128 and in turn a CHOP-M Overview 950 that explains the purposes and functionality of using the CHOP-M 128 module. A Search 400 function allows for overall search and for searching for existing Campaigns 103, Campaign 103 elements and/or other features such as functionality explanations based upon the Account 60 users current role and permissions.

A “Verify, Request, and/or Create C.H.O.P.-M. Credentials” 952 function screens and educates the user of what functionality his/her role and permissions has in terms of access and limits. Generally, the proper role for utilizing the CHOP-M 128 module is the CHOP-M Mgr 58 and/or someone with at least the same permissions levels as those that are assigned by the default settings to the CHOP-M Mgr 58 role, by say the CAA 48. Depending on how the particular Account and/or CAA 48 decides to set up the CHOP-M 128 module, user's who try to access the CHOP-M 128 module without the proper credentials and/or permissions to view, create, modify or manage the CHOP-M 128 elements and rules, may or may not have permission to view, access, or utilize certain functions, Campaigns 103, and/or Campaign 103 elements.

A “CHOP-M Search” 954 allows users with the proper permissions to search for specific CHOP-M elements and/or features. A “Create/Modify CHOP-M Rule(s)” 956 function allows an Account 60 user to create a new CHOP-M 128 element and/or rule from scratch and/or select an existing CHOP-M 128 element and/or rule to modify and/or use as a template. An “Assign CHOP-M Rule to Campaign ID(s)” 958, an “Assign CHOP-M Rule to JOINS” 960, and an “Assign CHOP-M Rule to NEED MGR(s),” 962, each allow the Account 60 user with the proper permissions the ability to pick and choice where and how to apply existing CHOP-M elements and/or rule(s) and/or a newly created CHOP-M element and/or rule.

The Account 60 user can create and/or modify an existing CHOP-M Rule(s) utilizing a range of options such as a “Tests” 968 module option, a “Surveys & Polls” 970 module option, an “Interview” 972 module option, an “Assessments” 974 module option, an “Incorporate Other Modules” 976 module option, and/or a “Customizable and Requests” 978 module option.

The “Tests” 968 module option is for selecting elements of an existing Campaign 103 to modify and/or create a new Test, a test question and/or group of test questions, a test answer and/or test answer groups, a test question acceptable answer pool, a test question unacceptable answer pool, a test question unrecognized response pool, a test navigation script, and other test related elements and test criteria and the like.

The “Surveys and Polls” 970 module option is for selecting elements of an existing Campaign 103 to modify and/or create a survey or poll, a survey or poll question and/or group of a survey or poll questions, a survey or poll question answer and/or survey/poll question answer groups, a survey or poll question acceptable answer pool, a survey or poll question unacceptable answer pool, a survey or poll question unrecognized response pool, a survey or poll navigation script, and other survey or poll related elements and survey or poll criteria and the like.

The “Interviews” 972 module option is for selecting elements of an existing Campaign 103 to modify and/or create an interview, an interview question and/or group of an interview questions, an interview question answer and/or interview question answer groups, an interview question acceptable answer pool, an interview question unacceptable answer pool, an interview question unrecognized response pool, an interview navigation script, and other interview related elements and interview criteria and the like.

The “Assessments” 974 module option is for selecting elements of an existing Campaign 103 to modify and/or create an assessment, an assessment question and/or group of assessment questions, an assessment question answer and/or assessment question answer groups, an assessment question acceptable answer pool, an assessment question unacceptable answer pool, an assessment question unrecognized response pool, an assessment navigation script, and other assessment related elements and assessment criteria and the like. In addition, the CHOP-M MGR can select which assessment may or may not be utilized per interview, interview type, per interview question, per user segment, per Campaign ID, and/or the like.

The “Incorporate Other Modules” 976 module option is for selecting elements of an existing Campaign 103 to modify and/or create new criteria regarding the other system modules, such as the PAM, the MATCH, the TIMES, the DREAM, the OPINE, the Affiliameter, the ADSTATS and the like, which are HIRES modules that all herein referenced, and are explained throughout specification.

The “Customizable and Requests” 978 module option is for creating, assigning, and/or requesting new criteria that is not an option within the other six module options and assigning the criteria to the applicant from an overall perspective and/or relative to the job.

The CHOP-M Mgr 58 is responsible for making sure that all the required participants, Campaign 103 elements, and schedules coordinate and flow relatively logically and the system can display data relations, such as Gant charts and the like to help make sure all the necessary elements are accounted for and available for each PAC/PIN or NEED. For example, the CHOP-M Mgr 58 might have and/or request an outline of goals that the NEED wishes to accomplish for a particular PAC.

The system would track exactly what edits were and were made to the overall content, suggestions, and user-input fields to continually improve further suggestions and minimize the number of required and/or likely adjustment needed. The system could also track and create exactly who suggested and/or made the changes. Customization can be personalized into many segments, such as: per CHOP-M Mgr, per Company, per Job Category, per Job Position, per PAC/PIN, and/or per Applicant.

The CHOP-M MGR 58 can setup up a Campaign for find a resource that has not a human, but instead a material, element or part required for a particular project and/or event where instead of Applicants applying for a particular job, the Applicants are representing his/her product or service to fulfill the resource be requested and/or sourced. In the same manner where Applicants become qualified or Candidates, the same process would take place for those parties representing his/her particular product or service that qualified as a Candidate and eventually a CATCH. Depending on the conditions set by the CHOP-M-MGR, a particular Applicant and/or Candidate could learn where he/she specifically fell short in the qualifications, why, and how they may correct the issue(s).

Over time, the CHOP-M data and correlate System data would reflect success trends per Job Industry, Job Category, Job Position, Salary, City, Zip, etc. Such System data correlations can help employers understand the current hiring trends among Candidates to do specific types of work, and even delineate the current desire for certain types of projects all under the same job position or with very similar job skill requirements. Just as with Applicants, over time, the System will be able to indicate whether this feedback data and trends from Candidates tend to be leading or lagging indicators, per each Job Category/Job Position.

The CHOP-M module options 968, 970, 972, 974, 976, and 978 are tracked and measured independently, and collectively as a unit against all data elements and relative to, say a particular Campaign, and/or Campaign 103 element to measure their effectiveness and success rates against different Campaign 103 elements, PAM Rules, MATCH Rules, TIMES Rules, DREAM Rules, ADSTATS Rules, OPINE Rules, Billing Rules, Budgeting Rules, Bidding Rules, Account Rules, and Real-time Reporting. The CHOP-M Mgr 58 can use a B.B.B.M. 114 module option to assign Billing, Budgeting, and Bidding Rules to the CHOP-M Rule(s).

A “Thresholds, Weighting & Ranking 440 module option can be set up to place a variety of weighting, prioritizations, and rules to the collective measurements and results. For example, a particular CHOP-M Rule ID for a particular Campaign 103 that allows Applicants to select his/her preferred interview method and/or assessments may be far more effective at attracting applicants when relatively compared to Campaigns 103 that do not; and thus more weight could be applied towards placing Campaigns 103 where Applicants can select his/her preferred interview method and/or assessments.

The HIRES 102 measures a Campaign's success and this data can also be incorporated into the selection of a future Campaigns 103 for similar CHOP-M Rule(s) and/or CHOP-M Related Campaigns. A Campaign's relative success in attracting a relatively large pool of Candidates; can also be measured and incorporated in the selection of future Campaign(s) and Campaign 103 elements by the CHOP-M Mgr 58.

Each new CHOP-M Campaign 103 could be set to run against previous CHOP-M Campaigns 103 in general and similar CHOP-M Campaigns 103 to track and make sure that the new CHOP-M Campaign 103 is in fact performing similarly, or report back that it is off by a quantifiable amount and/or relative degree, and make suggested changes based on the area where the new CHOP-M Campaign 103 deviates from methods that are relatively more tried and true, so credit and changes can be suggested and/or made based upon measurable results. New and modified CHOP-M Rules resulting in CHOP-M Campaigns, such as Goal scores selected for the CHOP-M can be previewed against an existing Campaigns 103 to see the number of Applicants and Candidates that would actually qualify/results and/or saved with a Preview/Save 444 function.

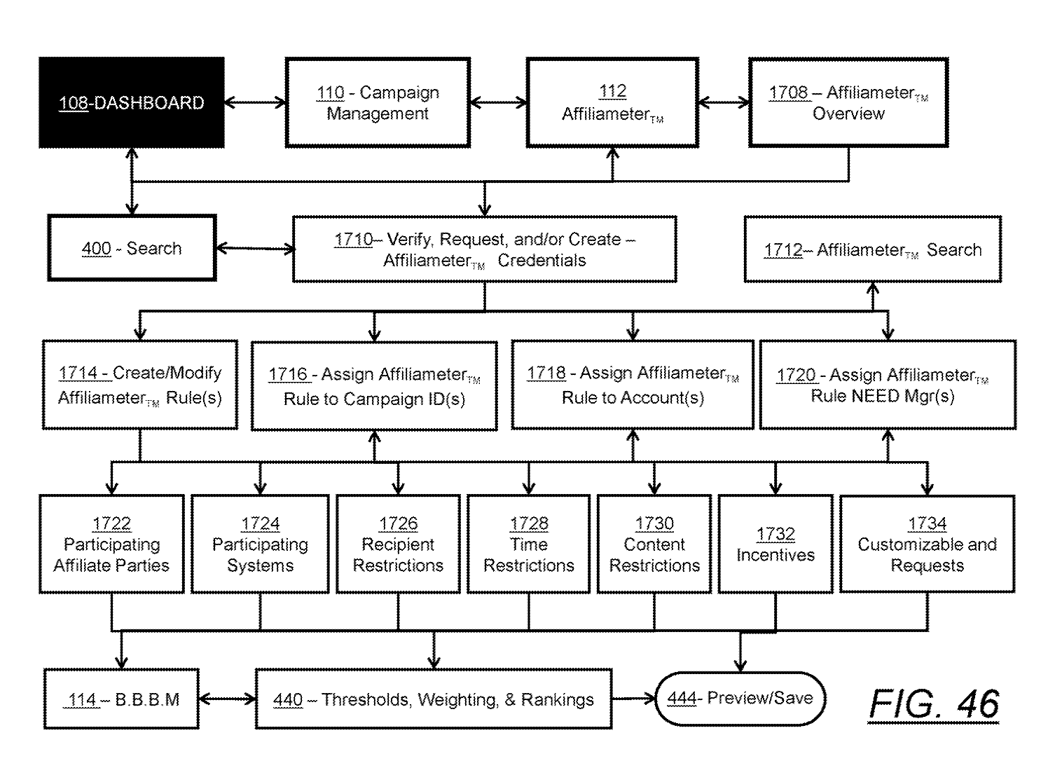

FIG. 46 is a flowchart that depicts another embodiment and example of the process by which the Affiliameter Mgr 41 can utilize the Affiliameter 112 module. The role of the Affiliameter Mgr 41 is to create and/or manage the Affiliations and Affiliation criteria for typically attracting and/or acquiring new participants and/or existing users to a particular PAC/PIN. The Campaign Management 110 function is accessible from the Dashboard 108 and from the Campaign Management 110 function, an Account 60 user can access the Affiliameter 112 and in turn a Affiliameter Overview 1708 that explains the purposes and functionality of using the Affiliameter 112 module. A Search 400 function allows for overall search and for searching for existing Campaigns 103, Campaign 103 elements and/or other features such as functionality explanations based upon the Account 60 users current role and permissions.

A “Verify, Request, and/or Create Affiliameter Credentials” 1710 function screens and educates the user of what functionality his/her role and permissions has in terms of access and limits. Generally, the proper role for utilizing the Affiliameter 112 module is the Affiliameter Mgr 41 and/or someone with at least the same permissions levels as those that are assigned by the default settings to the Affiliameter Mgr 41 role, by say the CAA 48. Depending on how the particular Account and/or CAA 48 decides to set up the Affiliameter 112 module, user's who try to access the Affiliameter 112 module without the proper credentials and/or permissions to view, create, modify or manage the Affiliameter 112 elements and rules, may or may not have permission to view, access, or utilize certain functions, Campaigns 103, and/or Campaign 103 elements.

An “Affiliameter Search” 1712 allows users with the proper permissions to search for specific Affiliameter elements and/or features. A “Create/Modify Affiliameter Rule(s)” 1714 function allows an Account 60 user to create a new Affiliameter 112 element and/or rule from scratch and/or select an existing Affiliameter 112 element and/or rule to modify and/or use as a template. An “Assign Affiliameter Rule to Campaign ID(s)” 1716, an “Assign Affiliameter Rule to Account(s)” 1718, and an “Assign Affiliameter Rule to NEED MGR(s),” 1720, each allow the Account 60 user with the proper permissions the ability to pick and choice where and how to apply existing Affiliameter elements and/or rule(s) and/or a newly created Affiliameter element and/or rule.

The Account 60 user can create and/or modify an existing Affiliameter Rule(s) utilizing a range of options such as a “Participating Affiliate Parties” 1722 module option, a “Participating Systems” 1724 module option, a “Recipient Restrictions” 1726 module option, a Time Restrictions” 1728 module option, a “Content Restrictions” 1730 module option, an “Incentives” 1732 module option, and/or a “Customizable and Requests” 1734 module option.

First, a Campaign Offer Provider (hereinafter “COP”) who would also have the role and privileges of the Affiliameter Mgr. to create campaigns and/or employ the help others to develop a campaign, for instance with a Campaign Content Creator (hereinafter “CCC”). Next, the COP would be directed to a web address portal hosted at the Server Host Location (hereinafter “SHL”) created by the Application and Portal Provider (hereinafter “APP”).

When the COP hits the portal for the first time, the site directs them to create a login Account. This login Account and password creates a unique identifier for this Affiliate client or COP. Next, the COP fills in a form to create a Unique Offer (hereinafter “UO”). When all the fields are completed correctly, the form will ask the COP to verify the Unique Offer (hereinafter “UO”) and then accept the terms provided by the APP. This in turn will create a unique URL with a unique identifier (hereinafter “ID”) for this UO and for a unique ID for Initial Campaign Addressee (hereinafter “ICA”).

By having a unique ID for both the ICA and the UO, the COP can create different UO for the same ICA. The COP can institute and/or complete a number of data fields on the form at the portal and some are outlined here below.

The “Participating Affiliate Parties” 1722 module option is for selecting elements of an existing Campaign 103 to modify and/or create new criteria regarding the Participating Affiliate Parties and associated usages/requirements.

Participating Affiliate Parties (hereinafter “PAPs”) can include:

An “Application and Portal Provider” (“APP”) which is the Account/company actually providing the portal application for sign-ups (the software developer and usage tracker, if also the “SHL”);

A “Server Host Location” (“SHL”) which is the Account/company hosting the portal and the application (and could be the Campaign Offer Provider, an Ad Agency, and/or a third party hosted solution, but typically it would also be the APP);

The “Campaign Content Creator” (“CCC”) which is an Account user other than the COP employed to create the ad campaign (could be the APP, an Ad Agency and/or another third party);

A “Campaign Offer Provider” (“COP”) which is the Account/company or entity offering links/ad campaigns to an Initial Campaign Addressee (“ICA”) that can be tracked (typically, the advertising client);

An “Initial Campaign Addressee” (hereinafter “ICA” or “Parent”) which is the recipient who initially receives the Campaign offer link (typically, the eventual promoter(s));

A “Subordinate Campaign Recipient” (Hereinafter “SCR”, “Child”, or “Children”) which is a recipient who receives the ad Campaign from the ICA/Parent (typically, the promoter's contacts/friends).

The “Participating Systems” 1724 module option is for selecting elements of an existing Campaign 103 to modify and/or create new criteria regarding the Participating Systems and associated usages/requirements. Here the Affiliameter Mgr can setup, suggest, and/or establish minimum technical requirements for each Campaign and/or Campaign rule. In addition, there can be rule and conditions to exclude certain systems by location, address, unique IDs, IP addresses, and the like.

The “Recipient Restrictions” 1726 module option is for selecting elements of an existing Campaign 103 to modify and/or create new criteria regarding the Recipient Restrictions and associated usages/requirements. Here the Affiliameter Mgr. can set restrictions to what Recipients may or may not be invited to participate in a particular Affiliate Campaign, such as there may be a rule that no one under a certain age can participate, say, no one under age 21. In addition, there could be suggestions to target a particular segment of the population, say those like to be looking for a job in the Medical Industry and/or where the Affiliate Program/Campaign will only give credit/pay for those Account that sign up with a particular prerequisite, such as only people over the age of 21, with a Bachelor's Degree and that live in California.

The “Time Restrictions” 1728 module option is for selecting elements of an existing Campaign 103 to modify and/or create new criteria regarding the Time Restriction and associated usages/requirements. There are a variety of methods to setup Time Restrictions. In one embodiment, the Affiliameter Mgr. would pre-establish both a “start” and “end” time. Where the “Start” represents when the Campaign terms/offer begin or on what event does it begin. For instance, the offer starts: now, on a specific day and time in the future, when the ICA first clicks the link, or when the ICA first accepts the terms and/or the like.

And where the “End” represents when the Campaign terms/offer end, or on what event or limitation does it end. For instances, the offer ends: on a certain date and time, after twenty-one (21) days from the start date, when a pre-determined number of Subordinate Campaign Recipients (SCRs) use/click the link, when a pre-determined dollar amount has been exhausted) and/or the like.

The “Content Restrictions” 1730 module option is for selecting elements of an existing Campaign 103 to modify and/or create new criteria regarding the Content Restrictions and associated usages/requirements. Here the Affiliameter Mgr. can set restrictions to what content may or may not appear while participating in a particular Affiliate Campaign, such as PAPs can not use any content that depicts a particular company brand and/or logo in an unfavorable light, violates any trademark, or copyright laws and the like. In addition, it could authorize only specific content be utilized, say a particular logo and only for a limited time, in limited applications, in limited locations, and in a predetermined size and color palette that is not to be altered, reduced, enlarged, and/or rotated.

The “Incentives” 1732 module option is for selecting elements of an existing Campaign 103 to modify and/or create new criteria regarding the Incentives and associated usages/requirements. The Affiliameter Mgr and/or the appropriate PAPs can preset the total incentives and the incentives available for each descending level/subordinate-party within the trackable chain of the Affiliate Campaign. Incentives can include the amount of money, if any, to be paid on an event (such as a “click” event), any points to be awarded on an event, any prizes to be awarded on an event and the like.

The “Customizable and Requests” 1734 module option is for creating, assigning, and/or requesting new criteria that is not an option within the other six module options and assigning the criteria to the applicant from an overall perspective and/or relative to the job.

The Affiliameter Mgr 41 is responsible for making sure that all the required participants, Campaign 103 elements, and schedules coordinate and flow relatively logically and the system can display data relations, such as Gant charts and the like to help make sure all the necessary elements are accounted for and available for each PAC/PIN or NEED. For example, the Affiliameter Mgr 41 might have and/or request an outline of goals that the NEED wishes to accomplish for a particular PAC.

The system would track exactly what edits were and were made to the overall content, suggestions, and user-input fields to continually improve further suggestions and minimize the number of required and/or likely adjustment needed. The system could also track and create exactly who suggested and/or made the changes. Customization can be personalized into many segments, such as: per Affiliameter Mgr, per Company, per Job Category, per Job Position, per PAC/PIN, and/or per Applicant.

The Affiliameter MGR 58 can setup up a Campaign for find a resource that has not a human, but instead a material, element or part required for a particular project and/or event where instead of Applicants applying for a particular job, the Applicants are representing his/her product or service to fulfill the resource be requested and/or sourced. In the same manner where Applicants become qualified or Candidates, the same process would take place for those parties representing his/her particular product or service that qualified as a Candidate and eventually a CATCH.

Over time, the Affiliameter data and System data correlations would reflect success trends per Campaign, per Offer, Per Affiliate Party, per Job Industry, Job Category, Job Position, Salary, City, Zip, etc. Such data correlations can help affiliate parties and Accounts understand the current trends among promotions and marketing to attract participants and the like, and even delineate the rate of click-throughs for each known segmentation of Accounts, CASTING users, and/or JOINS users. Just as with PAC/PINs, over time, the System will be able to indicate whether certain components with an Affiliate Campaign tend to be more or less successful in terms of, say attracting participants, Applicants, Candidates, Peers, Experts, Recruiters, and per each Job Category/Job Position filled and the like.

These Affiliameter module options 1722, 1724, 1726, 1728, 1730, 1732, and 1734 are tracked and measured independently, and collectively as a unit against all data elements and relative to, say a particular Campaign, and/or Campaign 103 element to measure their effectiveness and success rates against different Campaign 103 elements, PAM Rules, MATCH Rules, TIMES Rules, DREAM Rules, ADSTATS Rules, OPINE Rules, Billing Rules, Budgeting Rules, Bidding Rules, Account Rules, and Real-time Reporting. The Affiliameter Mgr 41 can use a B.B.B.M. 114 module option to assign Billing, Budgeting, and Bidding Rules to the Affiliameter Rule(s).

A “Thresholds, Weighting & Ranking 440 module option can be set up to place a variety of weighting, prioritizations, and rules to the collective measurements and results. For example, a particular Affiliameter Rule ID for a particular Campaign 103 that allows Applicants to select his/her preferred method when and how to provide his/her Affiliameter feedback may be far more effective at attracting applicant Affiliameter Participants when relatively compared to other Campaigns 103 that offer different conditions and incentives; and thus more weight could be applied towards placing Campaigns 103 with the more favorable results per the specific situation.

The HIRES 102 measures a Campaign's success and this data can also be incorporated into the selection of a future Campaigns 103 for similar Affiliameter Rule(s) and/or Affiliameter Related Campaigns. A Campaign's relative success in attracting a relatively large pool of Candidates; can also be measured and incorporated in the selection of future Campaign(s) and Campaign 103 elements by the Affiliameter Mgr 41.

Each new Affiliameter Campaign 103 could be set to run against previous Affiliameter Campaigns 103 in general and similar Affiliameter Campaigns 103 to track and make sure that the new Affiliameter Campaign 103 is in fact performing similarly, or report back that it is off by a quantifiable degree, and make suggested changes based on the area where the new Affiliameter Campaign 103 deviates from methods that are relatively more tried and true, so credit and changes can be suggested and/or made based upon measurable results. New and modified Affiliameter Rules resulting in Affiliameter Campaigns, such as goal scores selected for the Affiliameter can be previewed against an existing Campaigns 103 to see the number of Applicants and Candidates that would actually qualify/results and/or saved with a Preview/Save 444 function.

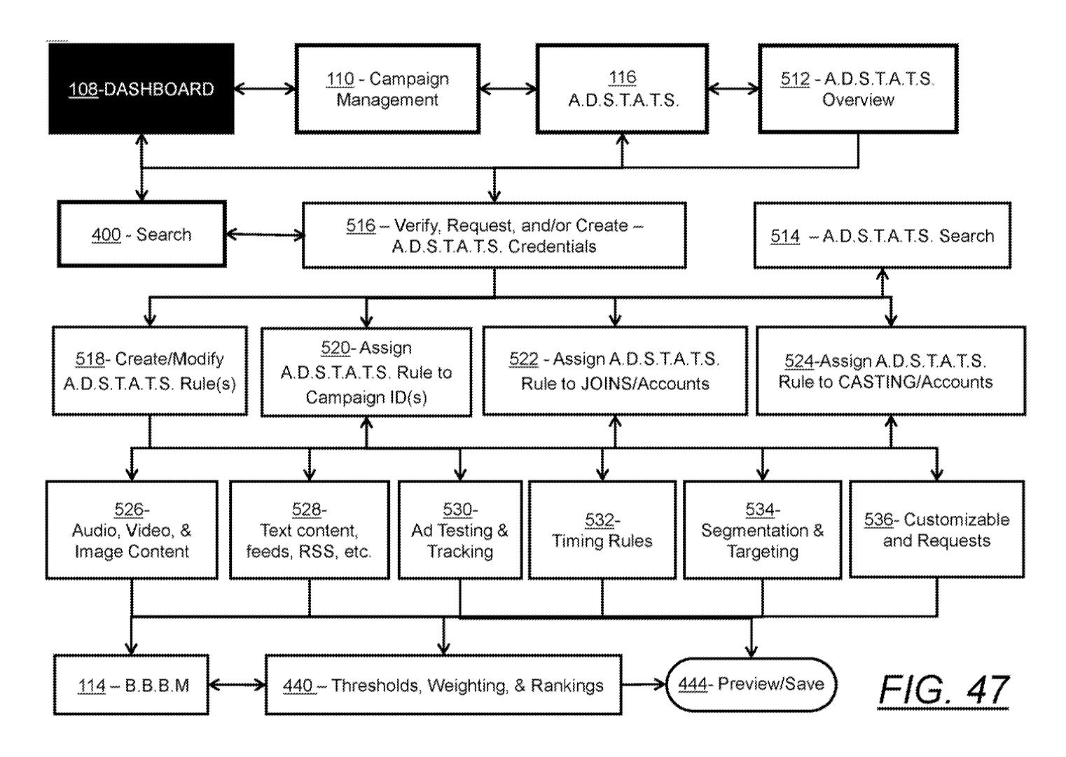

FIG. 47 is a flowchart that depicts an embodiment and example of the process by which the ADSTATS Mgr 57 can utilize the ADSTATS 116 module. The role of the ADSTATS Mgr 57 is to create and/or manage the Advertising and Advertisement Targeting criteria. The Campaign Management 110 function is accessible from the Dashboard 108 and from the Campaign Management 110 function, an Account 60 user can access the ADSTATS 116 and in turn a ADSTATS Overview 512 that explains the purposes and functionality of using the ADSTATS 116 module. A Search 400 function allows for overall search and for searching for existing Campaigns 103, Campaign 103 elements and/or other features such as functionality explanations based upon the Account 60 users current role and permissions.

A “Verify, Request, and/or Create ADSTATS Credentials” 516 function screens and educates the user of what functionality his/her role and permissions has in terms of access and limits. Generally, the proper role for utilizing the ADSTATS 116 module is the ADSTATS Mgr 57 and/or someone with at least the same permissions levels as those that are assigned by the default settings to the ADSTATS Mgr 57 role, by say the CAA 48. Depending on how the particular Account and/or CAA 48 decides to set up the ADSTATS 116 module, user's who try to access the ADSTATS 116 module without the proper credentials and/or permissions to view, create, modify or manage the ADSTATS 116 elements and rules, may or may not have permission to view, access, or utilize certain functions, Campaigns 103, and/or Campaign 103 elements.

An “ADSTATS Search” 514 allows users with the proper permissions to search for specific ADSTATS elements and/or features. A “Create/Modify ADSTATS Rule(s)” 518 function allows an Account 60 user to create a new ADSTATS 116 element and/or rule from scratch and/or select an existing ADSTATS 116 element and/or rule to modify and/or use as a template. An “Assign ADSTATS Rule to Campaign ID(s)” 520, an “Assign ADSTATS Rule to JOINS/Accounts” 522, and an “Assign ADSTATS Rule to CASTING/Accounts” 524, each allow the Account 60 user with the proper permissions the ability to pick and choice where and how to apply existing ADSTATS elements and/or rule(s) and/or a newly created ADSTATS element and/or rule.

The Account 60 user can create and/or modify an existing ADSTATS Rule(s) utilizing a range of options such as an “Audio, Video, & Image Content” 526 module option, a “Text content, feeds, RSS, etc.” 528 module option, an “Ad Testing & Tracking” 530 module option, a “Timing Rules” 532 module option, an “Segmentation & Targeting” 534 module option, and/or a “Customizable and Requests” 536 module option.

The “Audio, Video, & Image Content” 526 module option is for selecting elements of an existing Campaign 103 and/or view, creating, modifying, placing, and/or inserting, Audio, Video, & Image Content elements for ADSTATS usage, conditional requirements, and the like.

The “Text content, feeds, RSS, etc.” 528 module option is for selecting elements of an existing Campaign 103 and/or view, creating, modifying, placing, and/or inserting, Text content, feeds, RSS, etc elements for ADSTATS usage, conditional requirements, and the like.

The “Ad Testing & Tracking” 530 module option is for selecting elements of an existing Campaign 103 and/or view, creating, and modifying Ad Testing & Tracking for ADSTATS usage, conditional requirements, and the like. The “Ad Testing & Tracking” 530 module option is also where the ADSTATS MGR 57 can setup A/B testing rules per Campaign, per element in the Campaign, per location published and the like.

The “Timing Rules” 532 module option is for assigning, modifying, creating, linking, tracking and scheduling an Advertisement (e.g. Ad Campaign), and/or Ad Campaign element. And not to be confused with the TIMES module and TIMES criteria for coordinating and scheduling between the NEED and the Applicants, whereas the “Timing Rules” is specific for coordinating, scheduling, and tracking the actual Ad Campaign(s), and any associated elements, content, times, links, locations, and/or weblinks.

The “Segmentation & Targeting” 534 module option is for selecting segment targets for existing Campaign 103 and/or view, creating, and modifying Segmentation & Targeting rules and elements for ADSTATS usage, conditional requirements, and the like. The “Segmentation & Targeting” 534 module option is also where the ADSTATS MGR 57 can setup conditional rules per Campaign, per element in the Campaign, per location published and the like.

The “Customizable and Requests” 536 module option is for creating, assigning, and/or requesting new criteria that is not an option within the other six module options and assigning the criteria to the applicant from an overall perspective and/or relative to the job.

The ADSTATS Mgr 57 is responsible for making sure that all the required participants, Campaign 103 elements, and schedules coordinate and flow relatively logically and the system can display data relations, such as Gant charts and the like to help make sure all the necessary elements are accounted for and available for each PAC/PIN or NEED. For example, the ADSTATS Mgr 57 might have and/or request an outline of goals that the NEED wishes to accomplish for a particular PAC.

The system would track exactly what edits were and were made to the overall content, suggestions, and user-input fields to continually improve further suggestions and minimize the number of required and/or likely adjustment needed. The system could also track and create exactly who suggested and/or made the changes. Customization can be personalized into many segments, such as: per ADSTATS Mgr, per Company, per Job Category, per Job Position, per PAC/PIN, and/or per Applicant.

The ADSTATS MGR 58 can setup up a Campaign for find a resource that has not a human, but instead a material, element or part required for a particular project and/or event where instead of Applicants applying for a particular job, the Applicants are representing his/her product or service to fulfill the resource be requested and/or sourced. In the same manner where Applicants become qualified or Candidates, the same process would take place for those parties representing his/her particular product or service that qualified as a Candidate and eventually a CATCH.

Depending on the conditions set by the ADSTATS-MGR, a particular CASTING, NEED, and/or NEED MGR could learn where each Ad Campaign specifically appeared and how well it performed, and relative to temporal changes, content changes, A/B testing, and the like. Over time, the ADSTATS data and correlated System data would reflect success trends per Ad Campaign, Campaign element, per any associated Job Industry, Job Category, Job Position, Salary, City, Zip, etc. Such ADSTATS data correlations can help ADSTATS MGRs and the like understand the current trends among Ad Campaigns.

These ADSTATS module options 526, 528, 530, 532, 534, and 536 are also tracked and measured independently, and collectively as a unit against all data elements and relative to, say a particular Campaign, and/or Campaign 103 element to measure their effectiveness and success rates against different Campaign 103 elements, PAM Rules, MATCH Rules, TIMES Rules, DREAM Rules, Affiliate Rules, OPINE Rules, Billing Rules, Budgeting Rules, Bidding Rules, Account Rules, and Real-time Reporting. The ADSTATS Mgr 57 can use a B.B.B.M. 114 module option to assign Billing, Budgeting, and Bidding Rules to the ADSTATS Rule(s).

A “Thresholds, Weighting & Ranking 440 module option can be set up to place a variety of weighting, prioritizations, and rules to the collective measurements and results. For example, a particular ADSTATS Rule ID for a particular Campaign 103 that targets a particular segment of, say Job Recruiters may be relatively more effective at obtaining relatively successful Recruiters when relatively compared to other Campaigns 103.

The HIRES 102 measures a Campaign's success and this data can also be incorporated into the selection of a future Campaigns 103 for similar ADSTATS Rule(s) and/or ADSTATS Related Campaigns. A Campaign's relative success in attracting a relatively large pool of Candidates; can also be measured and incorporated in the selection of future Campaign(s) and Campaign 103 elements by the ADSTATS Mgr 57.

Each new ADSTATS Campaign 103 could be set to run against previous ADSTATS Campaigns 103 in general and similar ADSTATS Campaigns 103 to track and make sure that the new ADSTATS Campaign 103 is in fact performing similarly, or report back that it is off by a quantifiable degree, and make suggested changes based on the area where the new ADSTATS Campaign 103 deviates from methods that are relatively more tried and true, so credit and changes can be suggested and/or made based upon measurable results. New and modified ADSTATS Rules resulting in ADSTATS Campaigns, such as goal scores selected for the ADSTATS can be previewed against an existing Campaigns 103 to see the number of Applicants and Candidates that would actually qualify/results and/or saved with a Preview/Save 444 function.

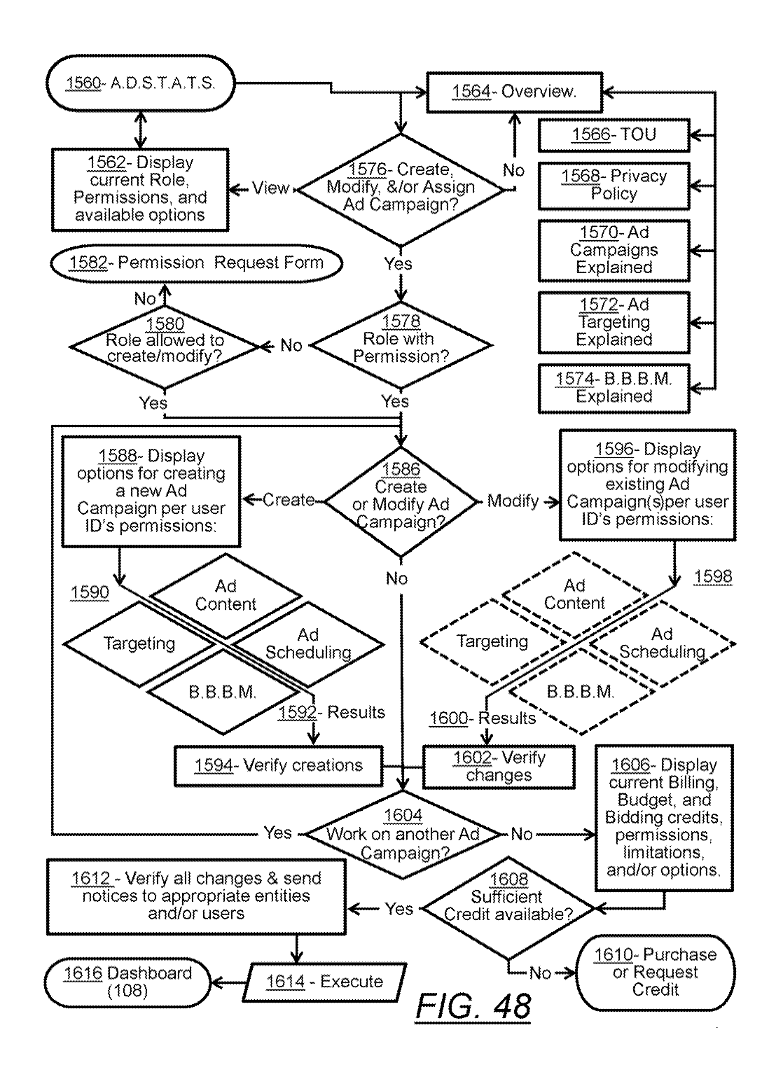

FIG. 48 is a flowchart depicting an embodiment and an example whereby the ADSTATS MGR 57 can utilize the ADSTATS module to create and/or modify a particular Campaign 103 with target advertising. Starting with a step 1560 the “ADSTATS” module allows the user the option to view an “Overview” 1564 function, whereby the user has the option to select and view a “TOU” 1566, a “Privacy Policy” 1568, an “Ad Campaigns Explained” 1570, an “Ad Targeting Explained” 1572 and/or a “BBBM Explained” 1574.

A function 1562 with a “Display current Role, Permissions, and available options” will tell the user what he/she can or cannot view, access, create and/or modify. Generally the Account 60 users who is designated as the ADSTATS MGR 57 would be the primary user of the ADSTATS module, but other Account 60 users who are granted equal permissions as the ADSTATS MGR 57 can also use the ADSTATS module and/or some Account 60 users can be given limited access and/or for a limited time.

From terminator 1560 the Account 60 user can advance to a query 1576 that asks if he/she wants to “Create, Modify, and/or Assign Ad Campaign?” where if the answer is “no” the user is passed to the Overview 1564 function. If the answer to query 1576 is simply “view” the user is passed to the 1562 function, but if the answer to query 1576 is instead “yes” then Account 60 user advances to a query 1578 that asks if the user has a “Role with Permission?” 1578 to proceed.

If the answer to query 1578 is “no” the user is passed to a query 1580 that asks if a “Role allowed to create/modify?”, where if the answer is “no” the user is passed to a terminator 1582 with a “Permission Request Form” where the user can request permission from the appropriate users within the Account who can make such changes. If the answer to query 1580 is “yes” the user is instead passed to a query 1586 which asks the user if he/she wants to “Create or Modify Ad Campaign?”

If the answer back at query 1578 is “yes” the user is also passed to the query 1586. If the answer to query 1586 is “no” the user is passed to a query 1604 which asks the user if he/she would “Work on another Ad Campaign?” If the answer to query 1586 is “Modify” the user is passed to a function 1596 with a “Display options for modifying existing Ad Campaign(s) per user ID's permissions:”

If answer back in query 1586 is “Create” then the user is passed to a function 1588 with a “Display options for creating a new Ad Campaign per user ID's permissions:” where the user advances to an option pool 1590 section which contains the options of an “Ad Content” option, a “Targeting” option, an “Ad Scheduling” option, and a “BBBM” option where the cumulative selections appear in a results 1592 and are passed to a “Verify creations” 1594 function.

An option pool 1598 section which contains the options for modifying existing Ad Campaign works very similar to option pool 1590, but it generates a list options based upon existing Ad Campaigns and the user's ID permissions; where the cumulative selections appear in a results 1600 and are passed to a “Verify changes” 1602 function.

Both verification functions 1594 and 1602 get passed to the query 1604 where if the answer to query 1604 is “yes” the user gets sent back to the query 1586. If on the other hand, the answer to query 1604 is “no” the user gets passed to a function 1606 with a “Display current Billing, Budget, and Bidding credits, permissions, limitations, and/or options”.

From function 1606 the user gets passed to a query 1608 which asks if he/she has “Sufficient Credit available?” to execute the desired selections. If the answer to query 1608 is “no” the user is passed to a terminator 1610 with a “Purchase or Request Credit” functionality. If on the other hand, the answer to query 1608 is “yes” the user is passed to a function 1612 with a “Verify all changes and send notices to appropriate entities and/or users” where such users might be other NEED MGRs within the same Account and/or from other Accounts. From function 1612 the user passes to an “Execute” 1614 function to execute all the decisions made and then the users passes back to the Dashboard (108) with a terminator 1616.

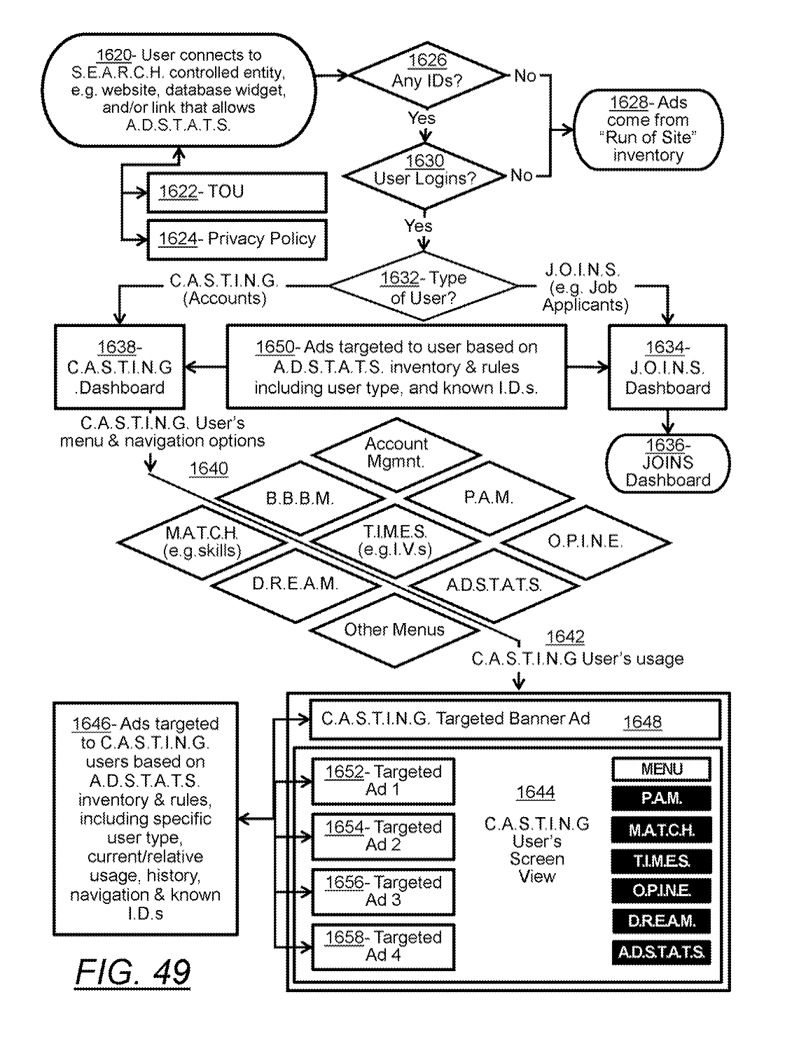

FIG. 49 is a combination flowchart and block diagram depicting an example embodiment whereby an Account user with a particular role receives targeted advertisements, when he/she connects to the HIRE or a SEARCH-controlled or enabled entity. Starting with a terminator 1620 with an “User connects to a SEARCH controlled entity, e.g. widget, database widget, and/or link that allows ADSTATS” and where the user can utilize a “TOU” 1622 function to read the Terms of Use and a “Privacy Policy” 1624 to review the Privacy Policies.

From the terminator 1620 the user is passed to a query 1626 with asks if there are “Any IDs?” known about the particular user and if the answer is “no” the user is passed to a terminator 1628 with an “Ads come from ‘Run of Site’ Inventory” where in this example, the system would send “Run of Site” inventory in lieu of any specific targeting instructions based upon, say a user ID back in query 1626. However, the system could target ads even without the user ID, based upon other known or possible known IDs, such as session IDs, cookie IDs, IP addresses, historical usage data and the like.

If the answer to query 1626 is “yes” the user is passed to a query 1630 which asks if a “User Logins?” where if the answer is “no” the user can get passed back to terminator 1628. If the answer to query 1630 is instead “yes” the user is passed to a query 1632 which asks for a “Type of User?” where if the user is a JOINS type user (e.g. Job Applicants), he/she is passed to a function 1634 with a JOINS Dashboard and it's functionality as shown in a terminator 1636.

An “Ads targeted to user based on ADSTATS inventory and rules including user type, and known IDs” 1650 function is depicted in FIG. 49 to show that this functionality can push targeted ads out to both the JOINS Dashboard 1634 and the JOINS user, as well as a “CASTING DASHBOARD” 1638 and the CASTING USER.

If the answer to query 1632 is instead a CASTING type user, he/she is passed to a function 1638 with the CASTING Dashboard and on to a “CASTING User's menu and navigation options in a 1640 section, contains an “Account Management” menu option, a BBBM menu option, a PAM menu option, a MATCH (e.g. skills) menu option, a TIMES (e.g. Interview and Times) menu option, an OPINE (e.g. applicant and candidate feedback) menu option, a DREAM menu option, an ADSTATS menu option, and an Other Menus menu options where the navigation and selections of a particular CASTING user can be continually tracked, collected, and stored in a CASTING User's Usage 1642 function.

That CASTING User's Usage 1642 and information known about the particular CASTING user is stored into a database and incorporated into an advertising targeting algorithm where other Accounts can select individual characteristics to target and/or a set of characteristics to target ads as depicted in a CASTING User's Screen View 1644 where, say a “CASTING Targeted Banner Ad” 1648 was generated and displayed base upon known information.

An “Ads targeted to CASTING user's based on ADSTATS inventory and rules, including specific user type, current/relative usage, history, navigation and known IDs” 1646 function represents the wide range of targeting metrics, tools and functionality where the Ad targeting can also incorporate relative changes in, say the CASTING user's usage from, for example, using traditionally only using the PAM to now starting to use another module, say the MATCH, where the ad targeting could incorporate this relative change in system and/or module usage for this particular user and/or for ads known to be, say relatively more successful for CASTING user's who were traditionally PAM users and are now starting to utilize the MATCH or whatever change is tracked.

These targeted ads can appear within the CASTING User's Screen View 1644 as prioritized stack of ads where a “Targeted Ad 1” 1652, which is above a “Targeted Ad 2” 1654, which is above a “Targeted Ad 3”, which is above a “Targeted Ad 4” based up a number of rules and conditions setup in the ADSTATS where for example, the Targeted Ad 1 bid a higher rate than the subsequent Ads down the page to appear on top for such a navigation change example as described in the previous paragraph.

There could be a variety of mechanism and bids that determine which target advertisements appear and in what order based upon historical success relative to the known data conditions on the webpage that lead to the current point within the navigation in general, relative to other CASTING users within the Account, relative to other similar users, relative to this particular CASTING user's navigation and usage, and/or some combination of these trackable and measurable metrics for creating relative success data and pricing models for other to bid upon for advertisement placement.

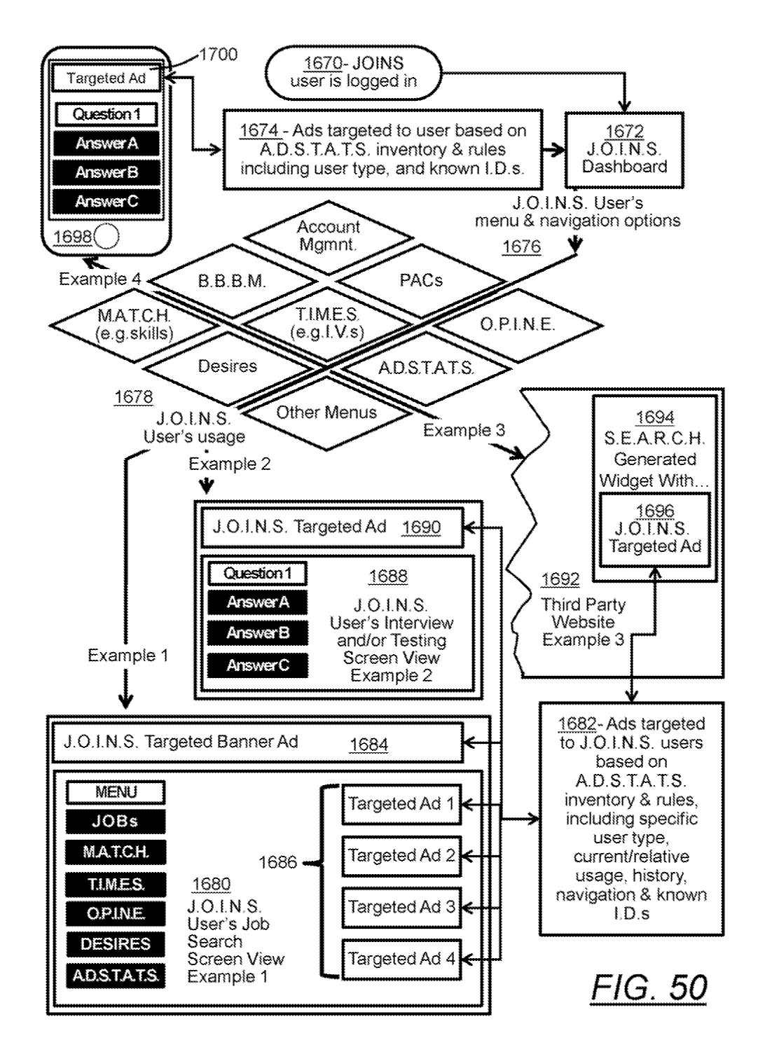

FIG. 50 is a combination flowchart and block diagram depicting an example embodiment whereby a JOINS user receives targeted advertisements, when he/she connects to the HIRE or a SEARCH-controlled or enabled entity. Starting with a terminator 1670 where a “JOINS user is logged in” and is connected to a SEARCH controlled entity, e.g. widget, database widget, and/or link that allows ADSTATS″ and where the JOINS user can utilize a “JOINS DASHBOARD” 1672 function.

From function 1672 a “JOINS User's menu and navigation options 1676 section contains an “Account Management” menu option, a BBBM menu option, a PACs menu option, a MATCH (e.g. skills) menu option, a TIMES (e.g. Interview and Times) menu option, an OPINE (e.g. applicant and candidate feedback) menu option, a Desires menu option, an ADSTATS menu option, and an Other Menus menu options where the navigation and selections of a particular JOINS user can be continually tracked, collected, and stored in a JOINS User's Usage 1678 function.

That JOINS User's Usage 1678 and information known about the particular JOINS user is stored into a database and incorporated into an advertising targeting algorithm where other Accounts can select individual characteristics to target and/or a set of characteristics to target ads as depicted in the four examples, starting with an “Example 1” for a JOINS User's Job Search Screen View Example 1” 1680 where, say a “JOINS Targeted Banner Ad” 1684 was generated and displayed base upon known information.

An “Ads targeted to JOINS user's based on ADSTATS inventory and rules, including specific user type, current/relative usage, history, navigation and known IDs” 1682 function represents the wide range of targeting metrics, tools and functionality where the Ad targeting can also incorporate relative changes in, say the JOINS user's usage from, for example, traditionally searching only jobs within a particular level of education to now starting to use search jobs requiring a higher education level, say with a Bachelor's Degree and for a specific Job Position, say Web Developer, where the ad targeting could incorporate this relative change in JOINS status and/or navigation usage for this particular user (even before the person has indicated such a change in his/her resume or data) and/or for ads known to be, say relatively more successful for JOINS user's who were traditionally searching Web Developer job not requiring a Bachelor's Degree to those JOINS who are now starting to search Web Developer jobs that do require a Bachelor's Degree or whatever change is tracked.

These targeted ads can appear within the JOINS User's Screen View 1680 as prioritized stack of ads where like FIG. 49 the targeted Ads in a section 1686 are positioned/ranked based up a number of rules and conditions setup in the ADSTATS. Where for example, the Targeted Ad 1 bid a higher rate than the subsequent Ads down the page to appear on top for such a navigation change example as described in the previous paragraph.

There could be a variety of mechanism and bids that determine which target advertisements appear and in what order based upon historical success relative to the known data conditions on the webpage that lead to the current point within the navigation in general, relative to other JOINS users within the Account, relative to other similar users, relative to this particular JOINS user's navigation and usage, and/or some combination of these trackable and measurable metrics for creating relative success data and pricing models for other to bid upon for advertisement placement.

In an example 2, a “JOINS User's Interview and/or Testing Screen View Example 2” 1688 with the questions and answer choices, also has a “JOINS Targeted Ad” 1690 where the Ads could be targeted based upon subjects and/or skills the user needs to work on and where the user can request that the information in the target Ad simply be stored verses actually navigating to a particular website during the Interview and/or Testing. And this cumulated data for Ad Targeting can also be for subsequent visit by this particular JOINS user.

In an Example 3, a “Third Party Website Example 3” 1692 contains a “SEARCH generated Widget With . . . (A JOINS Targeted Ad)” 1694 with a “JOINS Targeted Ad” 1696 where the Ads could be targeted based upon a list of brands and/or advertisements that have either been approved to appear or restricted from appearing on the Third Party website by, say the publisher and/or Web Developer of the Third Party website. These targeted ads that appear on the Third Party website can be setup to incorporate keywords found currently and/or historically on the Third Party website, so in addition to targeting the JOINS user's known data, the ADSTATS MGR could be incorporating keywords for locations to post on Third Party websites.

In an Example 4, a “Targeted Ad” 1700 appears on a mobile device 1698 during a particular Question for a particular PAC, for a particular JOINS user, and where all of those components are also targetable in all four examples. And where the targeting can also incorporate the format of the platform, OS, and applications on the device, such as a Blackberry® verses an Android® OS, or an iphone® 3G verses the 4G.

In addition, to the above embodiments, the system also allows NEED Mgrs to post MATCH requirements even though a Job Position may not be open at the time, to monitor the on-going relative skills, quality, and size of the available pool of potential Applicants and/or Candidates for a give Job Category, Job Position, and/or location of the country. For instances, comparison data for month-over-month, and/or year-over-year data comparisons may reflect that the number of available Candidates for a particularly critical position within the company has increased or decreased dramatically. This time of data can help the company adjust for such things as internal training programs, salaries, and/or future plans for expansion.

In some circumstances a company may be limited as to what I:hey can or cannot ask a job Candidate to answer unless they directly related to the Job opening and/or where tests can or cannot be performed. So another benefit of the NEED is that it allows users to share details and analysis about themselves that may never be asked or addressed in an interview.

In addition, the system can ask questions to Peers and Experts regarding, say the user's appearance, where quantifiable data over time may reveal that those Applicants and/or Candidates that are perceived to be, for instance: relatively more kind, honest, attractive and/or confident to other Candidates by the user's Peers and/or Experts are in fact, actually indicators of, for instance poor performers for a certain age group of a certain task within a certain Job based when compared to the historical data of those Candidates that were considered relatively less kind, honest, attractive, and/or confident.

In addition, the system can be setup to screen out any comments, remarks, assessments, answers and/or specific words, comments, and/or answers; where a particular company, say in a particular industry and/or location would rather not know about any Applicants and/or Candidates and/or where the company is legally obligated to not know, so where that content is removed from any company access and/or decision process.

In another embodiment, there is a central data repository and control location referred to as a “Sourcing Employers, Applicants, Resources, and Criteria Hub” (hereinafter “S.E.A.R.C.H.”) that include a “Hiring Entity's Recruiting Database and System” (“H.E.R.D.S.”) and the SEARCH is generally connected to the “Node or Entity with Employee Demand” 82 (hereinafter “N.E.E.D.” 82 or “NEED” 82), and in some embodiments herein also referred to as a “Hiring Entity”, such as an Individual and/or Company.

As an individual, the N.E.E.D. 82 representatives can be assigned and/or request a specific role with specific permissions to participate and/or manage Campaigns 103. The separate modules each have at least one key role called a Manager assigned to the separate modules. The same manager can have many roles and the collections of NEED managers are referred to as a NEED MGRs 49 group (or NEED MGRs).

The N.E.E.D. 82 can also have several users who have several roles, but generally have at least one specific NEED MGRs 49 role. The NEED MGR 49 role who is assigned to creating Campaigns 103 to locate, assess, test, and engage a resource/need, such as an employee, a contractor, and/or material(s)/resource(s) is referred to as a Posting Automated Module Mgr(s) 50, hereinafter “PAM-MGR” 50.

The PAM Mgr 50 is a specific NEED MGR 49 with a specific role and permissions that allow him/her to utilize a P.A.M. 118 module within the HIRES 102 system to create such Campaigns 103 as a Job Posting. These Job Postings can be based on what others, who have created similar job postings, have considered as important criteria or necessary qualifications when hiring for the same type of position. This data comparison can also include data that is not regarding a specific job opening, but instead regarding such things as other companies with say a similar office location and what they regard as a reasonable commute distance.

The NEED 82 is comprised of hardware and software including: the “Hiring Entity's Recruiting Database and System” (hereinafter “H.E.R.D.S.” or “HERDS”) 61, utilizing a “Hiring, Interviewing, and Recruiting Exchange Software” (hereinafter “H.I.R.E.S.” or “HIRES”) 102 user-interface. The HIRES 102 user-interface is sometimes referred to as a HIRES 102 system, which can represent the entire system available and interconnected to the NEED 82.

If after using the HIRES 102 System's tools to quickly post a job opening with PAM 118, the PAM-MGR wanted to manually sort all the Applicants on his/her own, he/she could do so. However, the HIRES System includes features that, say for an additional fee, allow the PAM-MGR to save time and improve the likelihood of finding the best Applicants by employing the surveys created by the System for the Applicants. For example, the HIRES 102 System has functionality where the PAM-MGR can utilized the MATCH 120 module to post a weblink back to a Job survey for the Applicants interested in a particular Job Posting. This weblink can appear on the company's own website, and/or it can be posted on other popular and appropriate job websites, sites such as CraigsList®, Monster®, HotJobs®, Linkedln®, etc.

In one embodiment, the data collected by the MATCH 120 survey's, in turn, ranks the Applicants based on pre-determined qualifications regarding who is best qualified to who is less qualified and/or not qualified. In addition, the HIRES 102 System can automatically schedule interviews with qualified Applicants, who are hereinafter referred to as “Candidates” using the TIMES 122 module. For example, Candidates can be sent a weblink that shows dates and times available for interviews based on preset conditions and an “Interviewer's” availability. The Interviewer is generally assigned to at least one manager or/and or decision groups, such groups include, but are not limited to a “DREAM-MGR” 53, a “CHOP-M MGR” 58, and/or a “CATCH-M MGR” 59, all explained in detail throughout.

There are three main modules within the HIRES 102 system (sometimes referred to as the “Skillustrate™” system):

1) An ACCOUNT MANAGEMENT 109 MODULE (see each below)

2) A BILLING, BUDGETING, AND BIDDING MODULE 114

3) A CAMPAIGN MANAGEMENT 110 MODULE
1) The Account Management 109 module is module for creating Account(s) 60, roles and/or permissions.
2) The BILLING, BUDGETING, AND BIDDING MODULE 114 (Herein after “BBBM”) is a module for such financial tasks and considerations as billing other Accounts, budgeting for Campaigns 103 and resources, and bidding on Ad Targeting inventory and placement.
3) The CAMPAIGN MANAGEMENT 110 MODULE is module for creating and managing Campaigns. Besides the Account Management 109 and the BBBM 114 there is there are nine main modules for creating Campaigns 103, Campaign Rules, and/or Campaign 103 Elements within the Skillustrate™ HIRES 102 System:

4) An Affiliameter 112 module (see each below)

5) A PAM 118 module

6) A MATCH 120 module

7) A TIMES 122 module

8) An O.P.I.N.E. 124 module

9) A DREAM 126 module

10) A CHOP-M 128 module

11) A CATCH-M. 130 module

12) An ADSTATS 116 module
1) The Affiliameter 112 module is a module which can generate Campaigns, for such things as inviting, acquiring, compensating, and tracking new and/or existing participants, who depending on terms of use, may also become Affiliates.
2) The Posting Automated Module 118 (or P.A.M.) 118 is a module which can generate Campaigns, for such things as a Job Posting and could potentially be a free module for companies, Accounts 60, and/or NEED-MGRs to utilize. For instances:

A) Job Post Creation
I) Use existing Job Categories
II) Use existing Job Positions categories
III) Pick qualifications from existing list of previously used qualifications, e.g. type of degree, years of experience, certificate of some type
IV) Pick other requirements from a list of previously used requirements, e.g. Education level completed, maximum commute distance, etc.

B) Advanced Job Post Creation Options
I) Modify existing and/or Add a Job Category
II) Modify existing and/or Add a Job Position category
III) Modify existing and/or Add qualifications, e.g. 4+years experience with MS-SQL
IV) Modify existing and/or Add requirements, e.g. Must have the Microsoft® Certified Database Administrator (MCDA)® credentials

C) Job Post Link Creation and Other Weblink Tools
3) The “Module for Applicant Testing & Criteria Hiring” 120 (or M.A.T.C.H.) 120

A) The MATCH 120 is a module for establishing the initial criteria for say, the Applicants to become Candidates
I) Survey questions and answers
II) Prioritize questions and answers
4) The “Testing & Interviewing Module for Event Scheduling” 122 (or T.I.M.E.S.) 122

A) The TIMES 122 is a module that can automatically schedules events or appointments for such things as surveys, tests, and/or interviews, which can take place through a variety of methods and venues, such as on the phone or a face-to-face interview with a variety of participants, such as humans, assessment tools, Peers, Experts, software companies, and the like, all based on conditions preset, such as dates and times a NEED-MGR and/or an Interviewer selects as “Open” times on his/her calendar for the event, communications, and/or interview with the resource, such as an Applicant and/or a Candidate. For instances:
I) Conditions such as:
   (a) After a specific period of time
II) e.g. After 72 hours
   (a) If the candidate fits the Job Posting criteria
III) e.g. Applicant fits all seven Job Posting criteria (“DREAM” more later)
   (a) A combination of the above
IV) Modify existing and/or Create new schedule appointment dates and times
V) Modify existing and/or Create new scheduling conditions
VI) Modify existing and/or Create new pre-schedule questions
VII) Modify existing and/or Create new post-schedule questions
VIII) Modify existing and/or Create new schedule tools
5) The “Opinions and Pointers to Improve a NEED or an Employee” 124 module (or O.P.I.N.E.) 124 Module allows the company via an OPINE MGR to selectively allow and/or limit feedback that others; such as the Applicants can give towards a particular and/or grouping of Campaign(s) 103, Campaign 103 element(s), CASTING Account(s), JOINS users, and/or JOINS Account(s).
6) The “Data Rank Every Applicant Module” 126 (or D.R.E.A.M.) 126 module

A) The DREAM 126 is a module that all allows the company via a DREAM MGR to search, Sort, and Rank Applicants and Candidates

B) Potential Fee schedule (example and instance)
I) $X/qualified lead (where X =the dollar amount charged), and/or
II) 4×$X/job posting and up to 50 leads
III) 10×$X/month and up to 200 leads
IV) 60×$X/year and up to 500 leads
V) And where the above fees can be base upon measurable data and/or success
7) The “Candidate(s) with Hiring Offer(s) Pending-Module” 128 (or C.H.O.P.-M) 128 is a module that allows the company via a CHOP-M MGR to further reducing the number of Candidates to those the company/NEED would consider hiring, via tests, surveys, interviews, that he/she can create and the like.
8) The “Candidate who Accepts The Company Hire-Module” 130 (or C.A.T.C.H.-M.) 130 is a module that allows the company via a CATCH-M MGR to make an offer to a specific Candidate and/or Candidates and track the progress from offer to acceptance or rejection. If accepted the Candidate becomes a CATCH.
9) The “Applicant Data & Skills Tied to Advertising Targeting System” 134 module (or A.D.S.T.A.T.S.) 134 is a module for a ADSTATS MGR for targeting advertisements via Campaign 103 elements, such as Ads, Job Posting, Job Tests, and the like on all platforms available for the Campaigns, such as web, mobile, kiosk, and the like.

There are so many components and factors to discovering whether a particular job Applicant is a suitable Candidate for a particular position that companies often spend an extraordinary amount of time, resources and energy through the process, only to repeat it over and over, and often with limited success. The SEARCH and NEED systems combine to reduce wasted time, costs, and resources for not only the company but for the Applicants and Candidate as well. And a system whereby the Applicants and Candidates can quantifiably see where he/she needs to improve relative to others for, say the same Job Position or Career.

Using the retail industry as an example, it has been said that over 60% of new retail hires quit or get terminated within their first ninety days of employment and that large retailer can spend over $3,700 dollars to locate, hire, and train a replacement. Meanwhile, according to Fortune® (as of 2010) retailers such as Wal-Mart® employ over 2.1 million employees, Target® over 350 k, Kroger's® over 330 k, Sears® over 320 k, Home Depot® over 250 k, Lowes® over 200 k, and Walgreen's® over 200 k. So here an example where there is a tremendous amount of time and money being spent to not only try to locate so called “good Candidates”, but employees who fit the job and the company's culture.

So another aspect of the invention is to capture not only what characteristics and traits that make a good Candidate, but what characteristics and traits make a good fit for the company's culture, management style, and other quantifiable metrics that are collected through the variety of means and assessment tests and reviews (by both automated computerized assessment tools and by online/computerized and collected human assessments) to compare with other employees who have happily and successfully stayed with the company when compared to those traits and characteristics that are shown to not fit and/or stay with the company. In addition, those Applicants and/or Candidates who do not get hired, but where the data appears to suggest a strong cultural fit for another career, company, and/or job opening, the system can either notify the appropriate parties at the company, and/or the Applicant/Candidate of the potential fit/opportunity.

The foregoing description of the present invention has been provided for purposes of illustration and description. It is not intended to be exhaustive or to limit the invention to we precise forms disclosed. Many modifications and variations will be apparent to the practitioner skilled in the art. Embodiments were chosen and described in order to best explain the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed:

1. A computer-implemented method for providing an evaluation of a video review of a user response, comprising a processor at a server configured for: playing a video of the user retrieved from an electronic storage media;
displaying at least one prompt from a plurality of prompts;
displaying a plurality of selectable responses to said at least one prompt;
receiving a selection of one said plurality of selectable responses by said user along with a biometric feedback of the user;
identifying said selection of one of the plurality of selectable responses by said user;
receiving at least one video viewer review from at least one video viewer who has evaluated the selection of one of the plurality of selectable responses by the user along with the biometric feedback of the user;
displaying a performance review based on said at least one video viewer review;
determine which of said at least one video viewer reviews to include in a segmentation review according to a set of requirements for segmentation inclusion; and
sending said segmentation review to the user.

2. The computer-implemented method of claim 1, wherein executing the instructions further causes the computing system to determine if said performance response selection is correct.

3. The computer-implemented method of claim 2, wherein executing the instructions further causes the computing system to determine if said performance response selection is relatively correct according to a criteria.

4. The computer-implemented method of claim 3, further comprising:
repeating the steps of claim 1 for a plurality of users;
generating a captured response from at least two of the plurality of users with respect to a first set of prompts selected from the plurality of prompts; and
generating a scored ranking from the captured response.

5. The computer-implemented method of claim 4, further comprising:
allowing a first user of the plurality of users to review the scored ranking as part of a user session.

6. The computer-implemented method of claim 4, further comprising:
allowing the first user to select a set of prompts from the plurality of prompts;
generating a scored assessment of the first user to the set of prompts based upon an analysis of responses of the plurality of users to the set of prompts; and
allowing the first user to review the scored assessment.

7. The computer-implemented method of claim 4, further comprising:
receiving an employer set of prompts from a first employer for a first employer job position;
receiving permission from an applicant pool of the plurality of users to release their user response file; and
generating an applicant pool ranking from the applicant pool through use of the employer set of prompts and the user response file of the applicant pool.

8. The computer-implemented method of claim 7, wherein the plurality of prompts contains a protected set of prompts containing at least one protected prompt which is not included in the set of prompts.

9. The computer-implemented method of claim 8, wherein responses by the applicant pool to the protected set of prompts are also used in generating the applicant pool ranking.

10. The computer-implemented method of claim 7, wherein the first employer is provided with the user data file of a selected applicant from the applicant pool that contains at least one of the video responses and the audio responses of the selected applicant to at least one of employer set of prompts.

11. The computer-implemented method of claim 7, wherein the captured response is analyzed electronically with respect to the biometric factor of the user in determining the assessment.

12. The computer-implemented method of claim 11, wherein the at least one biometric factor is obtained from the audio response of the user.

13. The computer-implemented method of claim 11, wherein the at least one biometric factor is obtained from the video response of the user.

14. The computer-implemented method of claim 11, wherein the user is permitted to review an analysis of the at least one biometric factor.

15. The computer-implemented method of claim 14, wherein the captured response is analyzed electronically with respect to at least one biometric factor in determining the assessment and the user is permitted to review a comparison analysis to other users of the at least one biometric factor.

16. A computer-implemented method for providing an evaluation of a video review of a user response, comprising a processor at a server configured for: receiving a selection of a plurality of selectable responses by said user along with a biometric feedback of the user;
identifying said selection of one of the plurality of selectable responses by said user;
receiving at least one video viewer review from at least one video viewer who has evaluated the selection of one of the plurality of selectable responses by the user along with the biometric feedback of the user;
displaying a performance review based on said at least one video viewer review;
determine which of said at least one video viewer reviews to include in a segmentation review according to a set of requirements for segmentation inclusion; and
sending said segmentation review to the user.

17. A system comprising:
one or more biometric sensors coupled to a user;
a processor at a server configured for providing an evaluation of the user cause the computing system to:
for providing a biometric feedback of the user;
receiving a selection of a plurality of selectable responses by said user along with the biometric feedback of the user;
identifying said selection of one of the plurality of selectable responses by said user;
receiving at least one video viewer review from at least one video viewer who has evaluated the selection of one of the plurality of selectable responses by the user along with the biometric feedback of the user;
displaying a performance review based on said at least one video viewer review;
determine which of said at least one video viewer reviews to include in a segmentation review according to a set of requirements for segmentation inclusion; and
sending said segmentation review to the user.
